(19) United States
(12) Patent Application Publication
(10) Pub. No.: US 2021/0056479 A1
(43) Pub. Date: Feb. 25, 2021

(54) Automated Strategic Planning System And Method

(71) Applicant: M3 Planning, Inc., Reno, NV (US)

(72) Inventors: Howard W. Olsen, Reno, NV (US); Nancy D. Olsen, Reno, NV (US); Erica J. Olsen, Reno, NV (US); Johnathan Wagoner, Reno, NV (US); Russell Persson, Reno, NV (US)

(73) Assignee: M3 Planning, Inc., Reno, NV (US)

(21) Appl. No.: 16/841,458

(22) Filed: Apr. 6, 2020

Related U.S. Application Data
(63) Continuation of application No. 15/849,490, filed on Dec. 20, 2017, now abandoned.
Application No. 15/849,490 is a continuation of application No. 13/650,004, filed on Oct. 11, 2012, now abandoned.
Application No. 13/650,004 is a continuation of application No. 11/888,391, filed on Jul. 31, 2007, now abandoned.
Application No. 11/888,391 is a continuation-in-part of application No. 11/131,037, filed on May 16, 2005, now abandoned.
(60) Provisional application No. 60/571,397, filed on May 14, 2004.

(51) Int. Cl. G06Q 10/06; G06Q 10/10

(52) U.S. Cl. CPC G06Q 10/0637; G06Q 10/10; G06Q 10/06398; G06Q 10/06393

(57) ABSTRACT

Various new and non-obvious apparatus and methods for creating a strategic plan for a business, implementing the strategic plan, and measuring progress towards the plan are disclosed. One of the disclosed embodiments is a guided method for creating corporate goals, and from the goals creating action items. The action items are then used to create department goals. Using the department goals, departments then set department action items. The department action items then become individual goals. The individuals then use the goals to set individual action items. The corporation can track progress by tracking progress made towards the individual action items. The individual action items are aggregated to (at least partially) produce the department scorecard. Department scorecards can then be aggregated to (at least partially) produce the corporate scorecard.

### CROSS REFERENCE TO RELATED APPLICATION

This application is a continuation of U.S. patent Ser. No. 15/849,490, filed Jan. 20, 2017, and entitled “AUTOMATED STRATEGIC PLANNING SYSTEM AND METHOD,” which is a continuation of U.S. patent application Ser. No. 13/650,004, filed Oct. 11, 2012, and entitled “AUTOMATED STRATEGIC PLANNING SYSTEM AND METHOD”, which is a continuation of U.S. patent application Ser. No. 11/888,391, filed Jul. 31, 2007, and entitled “AUTOMATED STRATEGIC PLANNING SYSTEM AND METHOD”, which is a continuation in part of applicant's prior Utility Patent Application, filed May 16, 2005, entitled AUTOMATED STRATEGIC PLANNING SYSTEM AND METHOD OF USE, Ser. No. 11/131,037, which claims priority through and also incorporates by reference in its entirety the applicant's prior Provisional Patent Application, filed May 14, 2004, entitled AUTOMATED STRATEGIC PLANNING SYSTEM AND METHOD, Serial No. 60/571,397, all of which prior Applications are hereby incorporated by reference in their entirety. It is to be understood, however, that in the event of any inconsistency between this specification and any information incorporated by reference in this specification, this specification shall govern.

### COPYRIGHT NOTICE

Copyright 2007 by M3 Planning, Inc., Reno, Nev. The copyright owner has no objection to the facsimile reproduction by anyone of the patent document or the patent disclosure as it appears in the Patent and Trademark Office patent file or records, but otherwise reserves all copyright rights whatsoever.

### REFERENCE TO COMPUTER LISTING APPENDIX

This application includes a transmittal under 37 C.F.R. Sec. 1.52(e) of a Computer Program Listing Appendix stored on each of two duplicate compact disks which accompany this Specification. Each disk contains computer program listings which illustrate implementations of the invention, and is herein incorporated by reference. The computer program in the Computer Program Listing Appendix is written in the PHP server-side scripting environment. The specific languages used in the development were VB Script and Javascript. The database was developed in MySQL. The listings are recorded as ASCII text in IBM PC, MS Windows compatible files which have the directory structures, creation dates and times, sizes (in bytes), and names listed below:

D:\MSP System Files-Patent-ASCII
0 files; 0 bytes
D:\MSP System Files-Patent-ASCII\development.20071030

| | | | | |
|---|---|---|---|---|
| addtoplans.php | 1,019 | 10/22/2007 | 3:46pm | R |
| class.DevelopmentDb.php | 11,761 | 10/31/2007 | 10:24am | R |
| class.OGATemplates.php | 6,256 | 10/31/2007 | 10:24am | R |
| class.Templates.php | 6,066 | 10/31/2007 | 10:24am | |
| class.Utilities.php | 2,683 | 10/31/2007 | 10:24am | R |
| cvs | 0 | 04/18/2007 | 11:22pm | R |
| sendCustObjEmail.php | 1,568 | 10/18/2007 | 8:46pm | R |
| summary.php | 67 | 04/18/2007 | 11:22pm | R |
| treeview.html | 20,166 | 09/10/2007 | 5:17pm | R |

9 files; 49,586 bytes
D:\MSP System Files-Patent-ASCII\development.20071030\development
0 files; 0 bytes
D:\MSP System Files-Patent-ASCII\mystrat_main_071030.sql

| | | | | |
|---|---|---|---|---|
| mystrat_main_071030.sql | 6,102,569 | 10/30/2007 | 9:08pm | R |

1 file; 6,102,569 bytes
D:\MSP System Files-Patent-ASCII\mystrat_main_live_071103.spl

| | | | | |
|---|---|---|---|---|
| mystrat_main_live_071103.sql | 6,186,634 | 11/03/2007 | 11:49pm | R |

1 file; 6,186,634 bytes
D:\MSP System Files-Patent-ASCII\plan

| | | | | |
|---|---|---|---|---|
| class.Page.php | 4,739 | 10/09/2007 | 3:36pm | R |
| class.PlanDb.php | 6,867 | 12/19/2007 | 8:45pm | R |
| class.PlanDb071017.php | 3,309 | 10/17/2007 | 4:04pm | R |
| class.PlanEnums.php | 7,393 | 12/20/2007 | 11:05pm | R |
| class.Session.php | 8,400 | 12/28/2007 | 10:10pm | R |
| class.ShareDb.php | 7,647 | 11/21/2007 | 11:43pm | |
| inactiveUsers.php | 302 | 10/03/2007 | 9:50am | R |
| index.php | 9,063 | 12/19/2007 | 6:04pm | R |
| page_properties.php | 3,910 | 11/21/2007 | 11:43pm | R |

9 files; 51,630 bytes
D:\MSP System Files-Patent-ASCII\plan\account

| | | | | |
|---|---|---|---|---|
| .#class.AccountDb.php.1.8 | 21,855 | 07/14/2007 | 11:38pm | R |
| class.AccountDb.php | 19,304 | 11/13/2007 | 9:19pm | R |
| class.AccountPage.php | 4,700 | 10/09/2007 | 3:36pm | R |
| index.php | 31,190 | 11/06/2007 | 5:50pm | R |
| page_properties.php | 3,799 | 08/16/2007 | 4:41pm | |

5 files; 80,848 bytes
D:\MSP System Files-Patent-ASCII\plan\account\071011forRussell

| | | | | |
|---|---|---|---|---|
| admin_1.ihtml | 4,910 | 10/11/2007 | 4:25pm | R |
| admin_2_1.ihtml | 7,765 | 10/11/2007 | 4:24pm | R |
| admin_plan.ihtml | 2,185 | 10/11/2007 | 4:25pm | R |
| admin_udef.ihtml | 1,263 | 10/11/2007 | 4:24pm | R |
| error.ihtml | 120 | 10/11/2007 | 4:24pm | R |
| setup_2.ihtml | 2,549 | 10/11/2007 | 4:24pm | R |
| setup_3.ihtml | 4,484 | 10/11/2007 | 4:24pm | R |

7 files; 23,276 bytes
D:\MSP System Files-Patent-ASCII\plan\account\content

| | | | | |
|---|---|---|---|---|
| add_order.ihtml | 1,173 | 06/14/2007 | 4:55am | R |
| admin_1.ihtml | 4,914 | 10/22/2007 | 8:51pm | R |
| admin_2.ihtml | 2,708 | 06/14/2007 | 4:55am | R |
| admin_2_1.ihtml | 8,002 | 11/06/2007 | 5:50pm | R |
| admin_2_2.ihtml | 1,751 | 06/14/2007 | 4:55am | R |
| admin_d.ihtml | 2,557 | 10/23/2007 | 7:06pm | R |
| admin_edit.ihtml | 333 | 06/14/2007 | 4:55am | R |
| admin_home.ihtml | 2,396 | 06/14/2007 | 4:55am | |
| admin_m.ihtml | 2,146 | 10/23/2007 | 7:06pm | R |
| admin_plan.ihtml | 2,167 | 09/05/2007 | 7:13pm | R |
| admin_s.ihtml | 1,235 | 11/06/2007 | 5:50pm | R |
| admin_udef.ihtml | 1,007 | 07/16/2007 | 8:25pm | R |
| cant_add_order.ihtml | 551 | 06/14/2007 | 4:55am | |
| comp_logo.ihtml | 1,435 | 11/30/2007 | 3:20pm | R |
| dept_pulldown.ihtml | 298 | 06/14/2007 | 4:55am | |
| error.ihtml | 135 | 06/14/2007 | 4:55am | R |
| index.ihtml | 33 | 04/19/2007 | 2:22am | R |
| ins_dept_inherit.ihtml | 434 | 10/11/2007 | 5:58pm | R |
| left_nav_box_extra_this_module.ihtml | 961 | 06/14/2007 | 4:55am | R |
| left_nav_box_this_module.ihtml | 195 | 06/14/2007 | 4:55am | R |
| setup_1.ihtml | 3,066 | 10/24/2007 | 6:46pm | R |
| setup_2.ihtml | 2,346 | 06/14/2007 | 4:55am | R |
| setup_3.ihtml | 4,242 | 06/14/2007 | 4:55am | R |
| setup_admin.ihtml | 1,473 | 06/14/2007 | 4:55am | R |
| setup_complete.ihtml | 8 | 04/19/2007 | 2:22am | R |
| setup_dept.ihtml | 276 | 06/14/2007 | 4:55am | R |
| setup_login.ihtml | 1,025 | 06/14/2007 | 4:55am | R |
| sub_nav.ihtml | 157 | 06/14/2007 | 4:55am | R |
| verify.js | 1,032 | 09/11/2007 | 10:49am | R |

29 files; 48,056 bytes
D:\MSP System Files-Patent-ASCII\plan\account\content\CVS

| | | | | |
|---|---|---|---|---|
| Entries | 1,448 | 11/30/2007 | 3:20pm | R |
| Repository | 21 | 04/19/2007 | 2:23am | R |
| Root | 15 | 04/19/2007 | 2:23am | R |

3 files; 1,484 bytes
D:\MSP System Files-Patent-ASCII\plan\account\content\iframes

| | | | | |
|---|---|---|---|---|
| admin_1_help.html | 2,585 | 08/20/2007 | 3:56pm | |
| setup_1_help.html | 1,150 | 04/19/2007 | 2:22am | R |
| setup_2_help.html | 708 | 04/19/2007 | 2:22am | R |
| setup_3_help.html | 693 | 04/19/2007 | 2:22am | R |
| setup_4_help.html | 540 | 04/19/2007 | 2:22am | R |
| setup_login_help.html | 760 | 04/19/2007 | 2:22am | |

6 files; 6,436 bytes
D:\MSP System Files-Patent-ASCII\plan\account\content\iframes\CVS

| | | | | |
|---|---|---|---|---|
| Entries | 326 | 08/20/2007 | 3:56pm | R |
| Repository | 29 | 04/19/2007 | 2:23am | R |
| Root | 15 | 04/19/2007 | 2:23am | R |

3 files; 370 bytes
D:\MSP System Files-Patent-ASCII\plan\account\CVS

| | | | | |
|---|---|---|---|---|
| Entries | 216 | 11/13/2007 | 9:19pm | R |
| Repository | 13 | 04/19/2007 | 2:23am | R |
| Root | 15 | 04/19/2007 | 2:23am | R |

3 files; 244 bytes
D:\MSP System Files-Patent-ASCII\plan\admin

| | | | | |
|---|---|---|---|---|
| class.AdminDb.php | 2,551 | 04/19/2007 | 2:22am | |
| class.AdminPage.php | 1,501 | 04/19/2007 | 2:22am | R |
| gen_emails.php | 2,502 | 12/05/2007 | 8:26pm | R |
| index.php | 6,512 | 04/19/2007 | 2:22am | R |
| page_properties.php | 838 | 11/22/2007 | 12:03am | |

5 files; 13,904 bytes
D:\MSP System Files-Patent-ASCII\plan\admin\content

| | | | | |
|---|---|---|---|---|
| index.ihtml | 2,136 | 04/19/2007 | 2:22am | R |
| ins_popup_link.ihtml | 262 | 04/19/2007 | 2:22am | |
| plan_view.ihtml | 4,738 | 04/19/2007 | 2:22am | R |
| setupURL.ihtml | 847 | 04/19/2007 | 2:22am | R |
| sub_nav.ihtml | 241 | 04/19/2007 | 2:22am | R |
| swot_users.ihtml | 207 | 04/19/2007 | 2:22am | R |

6 files; 8,431 bytes
D:\MSP System Files-Patent-ASCII\plan\admin\content\CVS

| | | | | |
|---|---|---|---|---|
| Entries | 313 | 04/19/2007 | 2:23am | R |
| Repository | 19 | 04/19/2007 | 2:23am | R |
| Root | 15 | 04/19/2007 | 2:23am | R |

3 files; 347 bytes
D:\MSP System Files-Patent-ASCII\plan\admin\CVS

| | | | | |
|---|---|---|---|---|
| Entries | 270 | 12/05/2007 | 8:26pm | R |
| Repository | 11 | 04/19/2007 | 2:23am | R |
| Root | 15 | 04/19/2007 | 2:23am | R |

3 files; 296 bytes
D:\MSP System Files-Patent-ASCII\plan\assessments

| | | | | |
|---|---|---|---|---|
| class.AssessmentsPage.php | 3,907 | 10/09/2007 | 3:36pm | R |
| index.php | 795 | 04/19/2007 | 2:22am | R |
| page_properties.php | 2,029 | 06/25/2007 | 4:23pm | |

3 files; 6,731 bytes
D:\MSP System Files-Patent-ASCII\plan\assessments\content

| | | | | |
|---|---|---|---|---|
| competitive.ihtml | 2,934 | 06/25/2007 | 4:37pm | R |
| curr_bus.ihtml | 900 | 04/19/2007 | 2:22am | R |
| environmental.ihtml | 1,167 | 06/19/2007 | 6:17pm | |
| index.ihtml | 2,472 | 12/14/2007 | 5:35pm | R |
| left_nav_box_this_module.ihtml | 200 | 04/19/2007 | 2:22am | R |
| report_card.ihtml | 1,499 | 04/19/2007 | 2:22am | R |
| strat_perf.ihtml | 1,652 | 04/19/2007 | 2:22am | R |
| sub_nav.ihtml | 543 | 06/25/2007 | 3:40pm | R |
| surveys.ihtml | 2,054 | 04/19/2007 | 2:22am | R |

9 files; 13,421 bytes
D:\MSP System Files-Patent-ASCII\plan\assessments\content\CVS

| | | | | |
|---|---|---|---|---|
| Entries | 529 | 12/14/2007 | 5:35pm | R |
| Repository | 25 | 04/19/2007 | 2:23am | R |
| Root | 15 | 04/19/2007 | 2:23am | R |

3 files; 569 bytes
D:\MSP System Files-Patent-ASCII\plan\assessments\content\iframes

| | | | | |
|---|---|---|---|---|
| competitive.html | 1,482 | 06/25/2007 | 5:26pm | R |
| competitive.ihtml | 1,478 | 06/25/2007 | 5:23pm | R |
| curr_bus.html | 1,443 | 07/02/2007 | 12:52pm | R |
| environmental.html | 1,155 | 04/19/2007 | 2:22am | |
| homepage.html | 2,144 | 04/19/2007 | 2:22am | R |
| report_card.html | 1,141 | 04/19/2007 | 2:22am | R |
| strat_perf.html | 1,714 | 04/19/2007 | 2:22am | R |
| surveys.html | 1,217 | 04/19/2007 | 2:22am | R |

8 files; 11,774 bytes
D:\MSP System Files-Patent-ASCII\plan\assessments\content\iframes\CVS

| | | | | |
|---|---|---|---|---|
| Entries | 406 | 07/02/2007 | 12:52pm | R |
| Repository | 33 | 04/19/2007 | 2:23am | R |
| Root | 15 | 04/19/2007 | 2:23am | R |

3 files; 454 bytes
D:\MSP System Files-Patent-ASCII\plan\assessments\CVS

| | | | | |
|---|---|---|---|---|
| Entries | 170 | 10/09/2007 | 3:36pm | R |
| Repository | 17 | 04/19/2007 | 2:23am | R |
| Root | 15 | 04/19/2007 | 2:23am | R |

3 files; 202 bytes
D:\MSP System Files-Patent-ASCII\plan\cobranding
0 files; 0 bytes
D:\MSP System Files-Patent-ASCII\plan\cobranding\delge
0 files; 0 bytes
D:\MSP System Files-Patent-ASCII\plan\cobranding\delge\plan
0 files; 0 bytes
D:\MSP System Files-Patent-ASCII\plan\cobranding\delge\plan\account
0 files; 0 bytes
D:\MSP System Files-Patent-ASCII\plan\cobranding\delge\plan\account\content

| | | | | |
|---|---|---|---|---|
| admin_plan.ihtml | 784 | 06/26/2007 | 9:36pm | R |

1 file; 784 bytes
D:\MSP System Files-Patent-ASCII\plan\cobranding\delge\plan\development
0 files; 0 bytes
D:\MSP System Files-Patent-ASCII\plan\cobranding\delge\plan\development\content
0 files; 0 bytes
D:\MSP System Files-Patent-ASCII\plan\cobranding\delge\plan\development\content\iframes

| | | | | |
|---|---|---|---|---|
| comp_examples.html | 5,037 | 09/20/2007 | 5:42pm | R |
| comp_help.html | 3,973 | 09/20/2007 | 4:05pm | R |
| comp_intro.html | 3,758 | 09/20/2007 | 4:05pm | R |
| financial_examples.html | 102 | 11/05/2007 | 12:18pm | R |
| financial_help.html | 1,390 | 09/20/2007 | 6:31pm | R |
| financial_intro.html | 2,068 | 09/20/2007 | 6:31pm | R |
| groups_examples.html | 2,139 | 10/15/2007 | 3:45pm | R |
| groups_help.html | 2,405 | 10/15/2007 | 3:39pm | R |
| groups_intro.html | 1,436 | 10/15/2007 | 3:39pm | R |
| ideas_examples.html | 1,833 | 09/20/2007 | 6:31pm | |
| ideas_help.html | 2,761 | 09/20/2007 | 6:31pm | R |
| ideas_intro.html | 5,274 | 09/20/2007 | 6:31pm | R |
| index_examples.html | 96 | 10/09/2007 | 10:23am | |
| index_help.html | 2,294 | 10/09/2007 | 10:22am | R |
| index_intro.html | 4,737 | 10/09/2007 | 10:22am | R |
| key_examples.html | 658 | 11/09/2007 | 3:00pm | |
| key_help.html | 1,236 | 11/09/2007 | 3:00pm | R |
| key_intro.html | 5,277 | 09/20/2007 | 4:05pm | R |
| mission_examples.html | 2,556 | 09/17/2007 | 4:07pm | R |
| mission_help.html | 1,591 | 09/17/2007 | 4:07pm | R |
| mission_intro.html | 1,163 | 11/27/2007 | 11:02pm | |
| oga_a_examples.html | 1,304 | 11/09/2007 | 2:52pm | R |
| oga_a_help.html | 3,271 | 11/09/2007 | 2:52pm | R |
| oga_a_intro.html | 1,797 | 11/09/2007 | 2:52pm | R |
| oga_examples.html | 99 | 10/05/2007 | 12:34pm | |
| oga_g_examples.html | 6,733 | 10/12/2007 | 8:26pm | R |
| oga_g_help.html | 10,961 | 10/15/2007 | 4:03pm | |
| oga_g_intro.html | 6,547 | 10/12/2007 | 8:26pm | R |
| oga_help.html | 95 | 10/05/2007 | 12:34pm | R |
| oga_intro.html | 96 | 10/05/2007 | 12:34pm | R |
| oga_o_examples.html | 8,451 | 10/12/2007 | 8:26pm | R |
| oga_o_help.html | 7,184 | 10/15/2007 | 4:03pm | R |
| oga_o_intro.html | 6,787 | 10/12/2007 | 8:26pm | R |
| org_strats_examples.html | 1,377 | 09/20/2007 | 4:05pm | R |
| org_strats_help.html | 712 | 09/20/2007 | 4:05pm | R |
| org_strats_intro.html | 1,343 | 09/20/2007 | 4:05pm | R |
| swot_examples.html | 100 | 09/19/2007 | 5:55pm | R |
| swot_help.html | 96 | 09/19/2007 | 5:55pm | R |
| swot_intro.html | 1,564 | 09/19/2007 | 5:55pm | R |
| swot_o_examples.html | 2,075 | 09/19/2007 | 5:55pm | R |
| swot_o_help.html | 4,288 | 09/19/2007 | 5:55pm | R |
| swot_o_intro.html | 1,597 | 09/19/2007 | 5:55pm | R |
| swot_s_examples.html | 2,048 | 09/19/2007 | 5:55pm | R |
| swot_s_help.html | 3,416 | 09/19/2007 | 5:55pm | R |
| swot_s_intro.html | 1,508 | 09/19/2007 | 5:55pm | R |
| swot_t_examples.html | 2,069 | 09/19/2007 | 5:55pm | R |
| swot_t_help.html | 3,786 | 09/19/2007 | 5:55pm | R |
| swot_t_intro.html | 1,433 | 09/19/2007 | 5:55pm | R |
| swot_w_examples.html | 2,122 | 09/19/2007 | 5:55pm | R |
| swot_w_help.html | 3,270 | 09/19/2007 | 5:55pm | |
| swot_w_intro.html | 1,479 | 09/19/2007 | 5:55pm | |
| values_examples.html | 3,897 | 09/20/2007 | 4:05pm | R |
| values_help.html | 1,637 | 10/15/2007 | 3:54pm | R |
| values_intro.html | 1,107 | 09/20/2007 | 5:42pm | R |
| vision_examples.html | 4,542 | 09/20/2007 | 5:42pm | R |
| vision_help.html | 3,484 | 10/15/2007 | 4:03pm | R |
| vision_intro.html | 3,136 | 09/20/2007 | 5:42pm | R |

57 files; 157,195 bytes
D:\MSP System Files-Patent-ASCII\plan\content

| | | | | |
|---|---|---|---|---|
| choose_role.ihtml | 1,001 | 04/19/2007 | 2:22am | R |
| contact.ihtml | 758 | 04/19/2007 | 2:22am | R |
| help.ihtml | 2,152 | 04/19/2007 | 2:22am | R |
| home_admin.ihtml | 657 | 11/09/2007 | 7:11pm | |
| home_dept.ihtml | 3,115 | 06/14/2007 | 12:00pm | |
| home_mem.ihtml | 518 | 11/09/2007 | 7:11pm | |
| index.ihtml | 3,339 | 04/19/2007 | 2:22am | R |
| left_nav_box_this_module.ihtml | 198 | 04/19/2007 | 2:22am | R |
| login.ihtml | 1,010 | 06/19/2007 | 6:53pm | R |
| login_sorry.ihtml | 896 | 06/19/2007 | 6:53pm | R |
| logout.ihtml | 53 | 04/19/2007 | 2:22am | R |
| lost_pwd.ihtml | 850 | 04/19/2007 | 2:22am | R |
| plan_review.ihtml | 1,136 | 04/19/2007 | 2:22am | R |
| sub_nav.ihtml | 62 | 04/19/2007 | 2:22am | R |
| topics.ihtml | 433 | 08/06/2007 | 11:16am | R |
| topics_before.ihtml | 1,834 | 08/06/2007 | 8:44pm | R |
| topics_build.ihtml | 2,011 | 08/06/2007 | 8:24pm | R |
| topics_execute.ihtml | 1,896 | 08/06/2007 | 8:52pm | |
| topics-build.ihtml | 1,826 | 08/06/2007 | 10:33am | R |
| topics-execute.ihtml | 1,663 | 08/06/2007 | 11:09am | |
| topics-flow2.ihtml | 1,826 | 08/06/2007 | 10:48am | R |
| topics-flow-build.ihtml | 1,826 | 08/06/2007 | 10:45am | |
| tutorial.ihtml | 5,594 | 06/27/2007 | 6:24pm | R |
| videos.ihtml | 970 | 04/19/2007 | 2:22am | R |
| welcome.ihtml | 1,267 | 04/19/2007 | 2:22am | R |

25 files; 36,891 bytes
D:\MSP System Files-Patent-ASCII\plan\content\CVS

| | | | | |
|---|---|---|---|---|
| Entries | 1,280 | 11/09/2007 | 7:11pm | R |
| Repository | 13 | 04/19/2007 | 2:23am | R |
| Root | 15 | 04/19/2007 | 2:23am | R |

3 files; 1,308 bytes
D:\MSP System Files-Patent-ASCII\plan\content\iframes

| | | | | |
|---|---|---|---|---|
| choose_role.html | 714 | 04/19/2007 | 2:22am | R |
| contact.html | 745 | 04/19/2007 | 2:22am | R |
| help.html | 714 | 04/19/2007 | 2:22am | R |
| homepage.html | 574 | 04/19/2007 | 2:22am | R |
| plan_review.html | 775 | 04/19/2007 | 2:22am | R |
| topics.html | 706 | 04/19/2007 | 2:22am | R |
| tutorial.html | 668 | 04/19/2007 | 2:22am | R |
| videos.html | 692 | 04/19/2007 | 2:22am | R |
| welcome.html | 925 | 04/19/2007 | 2:22am | R |
| whats_new.html | 2,501 | 12/18/2007 | 8:10pm | R |

10 files; 9,014 bytes
D:\MSP System Files-Patent-ASCII\plan\content\iframes\CVS

| | | | | |
|---|---|---|---|---|
| Entries | 495 | 12/18/2007 | 8:10pm | R |
| Repository | 21 | 04/19/2007 | 2:23am | R |
| Root | 15 | 04/19/2007 | 2:23am | R |

3 files; 531 bytes
D:\MSP System Files-Patent-ASCII\plan\CVS

| | | | | |
|---|---|---|---|---|
| Entries | 589 | 12/28/2007 | 10:10pm | R |
| Repository | 5 | 04/19/2007 | 2:23am | R |
| Root | 15 | 04/19/2007 | 2:23am | R |

3 files; 609 bytes
D:\MSP System Files-Patent-ASCII\plan\development

| | | | | |
|---|---|---|---|---|
| 1107dbConvert.html | 5,998 | 11/23/2007 | 5:51pm | R |
| addtoplans.php | 986 | 10/22/2007 | 6:46pm | R |
| buildnewga.php | 9,540 | 11/12/2007 | 9:21pm | R |
| class.DevelopmentDb.php | 17,738 | 12/20/2007 | 8:44pm | R |
| class.DevelopmentPage.php | 4,555 | 12/27/2007 | 5:43pm | R |
| class.OGATemplates.php | 11,690 | 12/27/2007 | 5:32pm | R |
| class.Templates.php | 5,956 | 12/27/2007 | 5:32pm | |
| class.Templatesx.php | 6,287 | 12/18/2007 | 5:45pm | |
| class.Utilities.php | 2,250 | 12/16/2007 | 8:42pm | R |
| comments.php | 3,374 | 09/17/2007 | 4:11pm | R |
| index.php | 7,461 | 12/20/2007 | 8:44pm | R |
| logon.php | 2,751 | 04/19/2007 | 10:11am | R |
| movecompads.php | 4,408 | 12/17/2007 | 12:57pm | R |
| oga_mmh.html | 36,566 | 12/14/2007 | 3:07pm | |
| oga_pb.html | 33,637 | 11/20/2007 | 4:18am | R |
| page_properties.php | 4,293 | 11/23/2007 | 12:20am | |
| progress.php | 3,117 | 12/20/2007 | 8:44pm | R |
| reorderOGA.php | 2,072 | 12/18/2007 | 6:01pm | |
| sendCustObjEmail.php | 1,520 | 10/18/2007 | 11:46pm | R |
| summary.php | 64 | 04/19/2007 | 2:22am | R |

20 files; 164,263 bytes
D:\MSP System Files-Patent-ASCII\plan\development\content

| | | | | |
|---|---|---|---|---|
| action_any_1.ihtml | 6,150 | 08/20/2007 | 5:18pm | |
| action_any_summary.ihtml | 2,708 | 08/08/2007 | 6:44pm | R |
| action_cust_1.ihtml | 1,758 | 04/19/2007 | 2:22am | R |
| action_cust_summary.ihtml | 5,120 | 04/19/2007 | 2:22am | R |
| action_head_cust_1.ihtml | 712 | 04/19/2007 | 2:22am | R |
| action_head_op_1.ihtml | 696 | 04/19/2007 | 2:22am | R |
| action_head_people_1.ihtml | 689 | 04/19/2007 | 2:22am | R |
| action_home.ihtml | 2,984 | 08/06/2007 | 5:07pm | |
| action_op_1.ihtml | 3,108 | 04/19/2007 | 2:22am | R |
| action_op_summary.ihtml | 2,231 | 04/19/2007 | 2:22am | R |
| action_people_1.ihtml | 1,761 | 04/19/2007 | 2:22am | |
| action_people_summary.ihtml | 5,157 | 04/19/2007 | 2:22am | R |
| comments_addnewform.ihtml | 1,500 | 09/17/2007 | 4:05pm | R |
| comments_addnewlink.ihtml | 95 | 09/17/2007 | 4:05pm | R |
| comments_container.tpl | 881 | 09/17/2007 | 4:05pm | R |
| comments_showall.ihtml | 415 | 09/17/2007 | 4:05pm | R |
| comp_1.ihtml | 749 | 12/18/2007 | 5:00pm | R |
| comp_2.ihtml | 1,273 | 09/18/2007 | 7:08pm | R |
| comp_3.ihtml | 1,954 | 08/11/2007 | 7:31pm | R |
| comp_4.ihtml | 1,369 | 04/19/2007 | 2:22am | R |
| comp_5.ihtml | 1,271 | 10/06/2007 | 3:46am | R |
| contextmenuOGA.js | 11,421 | 12/06/2007 | 7:56pm | R |
| contextmenustuff.js | 3,885 | 12/18/2007 | 4:12pm | R |
| financial_1.ihtml | 825 | 11/27/2007 | 2:57am | R |
| financial_2.ihtml | 2,453 | 08/02/2007 | 11:32am | R |
| ga_edit.ihtml | 3,585 | 11/27/2007 | 2:57am | R |
| ga_show.ihtml | 2,236 | 11/29/2007 | 10:12am | R |
| ga_summary.ihtml | 13,551 | 12/18/2007 | 5:47pm | R |
| goals_any_1.ihtml | 6,314 | 05/15/2007 | 4:32pm | R |
| goals_any_new.ihtml | 6,356 | 04/19/2007 | 2:22am | R |
| goals_any_summary.ihtml | 2,898 | 08/02/2007 | 11:32am | R |
| goals_cust_1.ihtml | 782 | 04/19/2007 | 2:22am | R |
| goals_cust_2.ihtml | 2,289 | 04/19/2007 | 2:22am | R |
| goals_cust_3_p1.ihtml | 2,051 | 04/19/2007 | 2:22am | R |
| goals_cust_3_p2.ihtml | 1,246 | 04/19/2007 | 2:22am | R |
| goals_cust_4.ihtml | 1,150 | 04/19/2007 | 2:22am | R |
| goals_cust_5.ihtml | 1,578 | 04/19/2007 | 2:22am | R |
| goals_cust_summary.ihtml | 2,255 | 08/27/2007 | 5:44pm | R |
| goals_fin_1.ihtml | 2,756 | 04/19/2007 | 2:22am | R |
| goals_fin_summary.ihtml | 2,160 | 04/19/2007 | 2:22am | R |
| goals_group_summary.ihtml | 2,779 | 08/27/2007 | 6:04pm | R |
| goals_head_cust_1.ihtml | 748 | 07/25/2007 | 6:27pm | R |
| goals_head_cust_3_p2.ihtml | 349 | 07/25/2007 | 6:27pm | R |
| goals_head_cust_3_p3.ihtml | 330 | 07/25/2007 | 6:27pm | R |
| goals_head_cust_5.ihtml | 1,075 | 07/25/2007 | 6:27pm | R |
| goals_head_fin_1.ihtml | 826 | 07/25/2007 | 6:27pm | |
| goals_head_op_1.ihtml | 807 | 07/25/2007 | 6:27pm | R |
| goals_head_people_1.ihtml | 870 | 07/25/2007 | 6:27pm | R |
| goals_home.ihtml | 2,652 | 08/06/2007 | 5:07pm | R |
| goals_op_1.ihtml | 2,035 | 04/19/2007 | 2:22am | R |
| goals_op_summary.ihtml | 2,168 | 04/19/2007 | 2:22am | R |
| goals_people_1.ihtml | 2,063 | 04/19/2007 | 2:22am | |
| goals_people_summary.ihtml | 2,224 | 04/19/2007 | 2:22am | R |
| group_edit.ihtml | 496 | 12/06/2007 | 2:30am | R |
| group_singlerow.ihtml | 468 | 11/23/2007 | 12:19am | R |
| groups_1.ihtml | 5,693 | 12/18/2007 | 6:09pm | R |
| groups_11203.ihtml | 4,621 | 12/03/2007 | 4:54pm | |
| groups_viewonly.ihtml | 806 | 11/19/2007 | 9:36pm | R |
| ideas_1.ihtml | 1,052 | 10/29/2007 | 5:37pm | R |
| ideas_2.ihtml | 835 | 09/17/2007 | 4:11pm | R |
| index.ihtml | 1,624 | 11/16/2007 | 1:36am | R |
| ins_cg_next_buttons.ihtml | 288 | 04/19/2007 | 2:22am | R |
| ins_cust_edit_row.ihtml | 273 | 04/19/2007 | 2:22am | |
| ins_edit_button.ihtml | 250 | 04/19/2007 | 2:22am | R |
| ins_goal_cust_head.ihtml | 216 | 07/25/2007 | 6:27pm | R |
| ins_index_popup_2.ihtml | 1,699 | 04/19/2007 | 2:22am | R |
| ins_index_popup_3.ihtml | 1,519 | 04/19/2007 | 2:22am | R |
| ins_multisavable.ihtml | 609 | 12/06/2007 | 2:34pm | |
| ins_multiviewonly.ihtml | 0 | 11/11/2007 | 8:18pm | |
| ins_next_button.ihtml | 209 | 04/19/2007 | 2:22am | |
| ins_simplesavable.ihtml | 639 | 12/06/2007 | 2:34pm | |
| ins_simplestuff.ihtml | 3,416 | 11/05/2007 | 8:30pm | |
| ins_simpleviewonly.ihtml | 224 | 11/12/2007 | 9:21pm | R |
| ins_strat_obj_head.ihtml | 210 | 04/19/2007 | 2:22am | |
| ins_summary_button.ihtml | 216 | 04/19/2007 | 2:22am | R |
| key_1.ihtml | 1,802 | 11/13/2007 | 5:18am | R |
| key_2.ihtml | 1,486 | 08/11/2007 | 7:31pm | R |
| key_home.ihtml | 1,778 | 04/19/2007 | 2:22am | R |
| key_mem.ihtml | 433 | 04/19/2007 | 2:22am | R |
| left_nav_box_this_module.ihtml | 1,001 | 10/09/2007 | 10:23am | R |
| map_1.ihtml | 17 | 04/19/2007 | 2:22am | R |
| mission_1.ihtml | 747 | 11/19/2007 | 12:17pm | R |
| mission_2.ihtml | 1,700 | 09/17/2007 | 4:11pm | R |
| mission_3.ihtml | 1,227 | 10/06/2007 | 3:46am | R |
| obj_cust.ihtml | 2,860 | 08/03/2007 | 9:41pm | R |
| obj_edit.ihtml | 554 | 12/12/2007 | 6:44pm | R |
| obj_fin.ihtml | 2,843 | 08/03/2007 | 9:41pm | R |
| obj_home.ihtml | 2,043 | 07/30/2007 | 10:00pm | R |
| obj_op.ihtml | 3,867 | 08/03/2007 | 9:41pm | R |
| obj_people.ihtml | 2,823 | 08/03/2007 | 9:41pm | R |
| obj_summary.ihtml | 2,184 | 08/03/2007 | 9:41pm | |
| oga.ihtml | 2,808 | 10/03/2007 | 12:54pm | R |
| org_strats_1.ihtml | 510 | 11/19/2007 | 12:24pm | R |
| org_strats_2.ihtml | 1,866 | 09/17/2007 | 4:11pm | R |
| org_strats_3.ihtml | 853 | 10/06/2007 | 3:46am | R |
| progress.tpl | 1,198 | 12/26/2007 | 5:36pm | R |
| sub_nav.ihtml | 148 | 04/19/2007 | 2:22am | R |
| swot_1.ihtml | 8,729 | 12/11/2007 | 6:39pm | R |
| swot_2.ihtml | 1,320 | 09/17/2007 | 4:11pm | R |
| swot_3.ihtml | 1,297 | 09/17/2007 | 4:11pm | R |
| swot_4.ihtml | 1,423 | 09/17/2007 | 4:11pm | R |
| swot_5.ihtml | 1,195 | 09/17/2007 | 4:11pm | R |
| swot_6.ihtml | 1,724 | 10/06/2007 | 3:46am | R |
| treetest.ihtml | 1,651 | 09/07/2007 | 3:41pm | R |
| update_response.ihtml | 35 | 10/18/2007 | 10:18am | |
| values_1.ihtml | 703 | 11/19/2007 | 12:24pm | R |
| values_2.ihtml | 1,121 | 10/06/2007 | 3:46am | R |
| verify.js | 5,264 | 10/27/2007 | 2:31pm | R |
| visdesc_1.ihtml | 1,624 | 09/17/2007 | 4:11pm | R |
| visdesc_2.ihtml | 985 | 10/06/2007 | 3:46am | R |
| vision_1.ihtml | 7,214 | 12/11/2007 | 6:39pm | R |
| vision_2.ihtml | 1,556 | 09/17/2007 | 4:11pm | R |
| vislead_1.ihtml | 1,019 | 04/19/2007 | 2:22am | R |
| vislead_2.ihtml | 1,376 | 04/19/2007 | 2:22am | R |
| vislead_3.ihtml | 624 | 04/19/2007 | 2:22am | R |

115 files; 230,269 bytes
D:\MSP System Files-Patent-ASCII\plan\development\content\CVS

| | | | | |
|---|---|---|---|---|
| Entries | 6,063 | 12/26/2007 | 5:37pm | R |
| Repository | 25 | 04/19/2007 | 2:23am | R |
| Root | 15 | 04/19/2007 | 2:23am | R |

3 files; 6,103 bytes
D:\MSP System Files-Patent-ASCII\plan\development\content\iframes

| | | | | |
|---|---|---|---|---|
| comp_examples.html | 5,037 | 09/20/2007 | 5:42pm | R |
| comp_help.html | 3,973 | 09/20/2007 | 4:05pm | R |
| comp_intro.html | 3,758 | 09/20/2007 | 4:05pm | R |
| financial_examples.html | 102 | 11/05/2007 | 12:18pm | R |
| financial_help.html | 1,390 | 09/20/2007 | 6:31pm | R |
| financial_intro.html | 2,068 | 09/20/2007 | 6:31pm | R |
| groups_examples.html | 2,139 | 10/15/2007 | 3:45pm | R |
| groups_help.html | 2,405 | 10/15/2007 | 3:39pm | R |
| groups_intro.html | 1,436 | 10/15/2007 | 3:39pm | R |
| ideas_examples.html | 1,833 | 09/20/2007 | 6:31pm | |
| ideas_help.html | 2,761 | 09/20/2007 | 6:31pm | R |
| ideas_intro.html | 5,274 | 09/20/2007 | 6:31pm | R |
| index_examples.html | 96 | 10/09/2007 | 10:23am | |
| index_help.html | 2,294 | 10/09/2007 | 10:22am | R |
| index_intro.html | 4,737 | 10/09/2007 | 10:22am | R |
| key_examples.html | 2,468 | 11/26/2007 | 5:53pm | |
| key_help.html | 1,234 | 11/19/2007 | 1:46pm | R |
| key_intro.html | 5,277 | 09/20/2007 | 4:05pm | R |
| mission_examples.html | 2,556 | 09/17/2007 | 4:07pm | R |
| mission_help.html | 1,591 | 09/17/2007 | 4:07pm | R |
| mission_intro.html | 1,163 | 11/27/2007 | 11:02pm | |
| oga_a_examples.html | 1,304 | 11/09/2007 | 2:52pm | R |
| oga_a_help.html | 3,271 | 11/09/2007 | 2:52pm | R |
| oga_a_intro.html | 1,543 | 12/14/2007 | 5:27pm | R |
| oga_examples.html | 99 | 10/05/2007 | 12:34pm | |
| oga_g_examples.html | 6,733 | 10/12/2007 | 8:26pm | R |
| oga_g_help.html | 10,961 | 10/15/2007 | 4:03pm | |
| oga_g_intro.html | 6,303 | 12/14/2007 | 5:27pm | R |
| oga_help.html | 95 | 10/05/2007 | 12:34pm | R |
| oga_intro.html | 96 | 10/05/2007 | 12:34pm | R |
| oga_o_examples.html | 8,451 | 10/12/2007 | 8:26pm | R |
| oga_o_help.html | 7,184 | 10/15/2007 | 4:03pm | R |
| oga_o_intro.html | 6,515 | 12/14/2007 | 5:27pm | R |
| org_strats_examples.html | 1,378 | 12/14/2007 | 5:27pm | R |
| org_strats_help.html | 5,168 | 12/14/2007 | 7:22pm | |
| org_strats_intro.html | 1,343 | 09/20/2007 | 4:05pm | R |
| swot_examples.html | 100 | 09/19/2007 | 5:55pm | |
| swot_help.html | 96 | 09/19/2007 | 5:55pm | R |
| swot_intro.html | 1,564 | 09/19/2007 | 5:55pm | R |
| swot_o_examples.html | 2,075 | 09/19/2007 | 5:55pm | R |
| swot_o_help.html | 4,288 | 09/19/2007 | 5:55pm | R |
| swot_o_intro.html | 1,597 | 09/19/2007 | 5:55pm | R |
| swot_s_examples.html | 2,048 | 09/19/2007 | 5:55pm | R |
| swot_s_help.html | 3,416 | 09/19/2007 | 5:55pm | R |
| swot_s_intro.html | 1,508 | 09/19/2007 | 5:55pm | R |
| swot_t_examples.html | 2,069 | 09/19/2007 | 5:55pm | R |
| swot_t_help.html | 3,786 | 09/19/2007 | 5:55pm | R |
| swot_t_intro.html | 1,433 | 09/19/2007 | 5:55pm | R |
| swot_w_examples.html | 2,122 | 09/19/2007 | 5:55pm | R |
| swot_w_help.html | 3,270 | 09/19/2007 | 5:55pm | |
| swot_w_intro.html | 1,479 | 09/19/2007 | 5:55pm | |
| values_examples.html | 3,897 | 09/20/2007 | 4:05pm | R |
| values_help.html | 1,637 | 11/19/2007 | 12:29pm | R |
| values_intro.html | 1,547 | 11/26/2007 | 5:49pm | R |
| vision_examples.html | 4,542 | 09/20/2007 | 5:42pm | R |
| vision_help.html | 3,484 | 10/15/2007 | 4:03pm | R |
| vision_intro.html | 3,136 | 09/20/2007 | 5:42pm | R |

57 files; 163,130 bytes
D:\MSP System Files-Patent-ASCII\plan\development\content\iframes\CVS

| | | | | |
|---|---|---|---|---|
| Entries | 2,870 | 12/18/2007 | 6:00pm | R |
| Repository | 33 | 04/19/2007 | 2:23am | R |
| Root | 15 | 04/19/2007 | 2:23am | R |

3 files; 2,918 bytes
D:\MSP System Files-Patent-ASCII\plan\development\dev_cpi

| | | | | |
|---|---|---|---|---|
| groups.html | 20,407 | 12/12/2007 | 2:24pm | R |
| mission.html | 19,852 | 12/10/2007 | 12:07pm | R |
| swot.htm | 39,475 | 12/11/2007 | 5:40pm | R |
| swot.html | 22,938 | 12/07/2007 | 7:29pm | R |
| vision.htm | 38,217 | 12/11/2007 | 5:40pm | R |
| vision.html | 22,856 | 12/07/2007 | 7:29pm | R |

6 files; 163,745 bytes
D:\MSP System Files-Patent-ASCII\plan\development\sam_nee

| | | | | |
|---|---|---|---|---|
| oga_nee.html | 38,882 | 12/06/2007 | 8:07pm | R |

1 file; 38,882 bytes
D:\MSP System Files-Patent-ASCII\plan\development070921

| | | | | |
|---|---|---|---|---|
| addtoplans.php | 987 | 09/21/2007 | 8:02pm | R |
| buildnewga.php | 10,042 | 09/21/2007 | 8:02pm | R |
| class.DevelopmentDb.php | 28,324 | 09/21/2007 | 8:02pm | R |
| class.DevelopmentPage.php | 4,831 | 09/21/2007 | 8:02pm | R |
| class.Templates.php | 41,556 | 09/21/2007 | 8:02pm | |
| class.Utilities.php | 6,212 | 09/21/2007 | 8:02pm | R |
| comments.php | 3,374 | 09/21/2007 | 8:02pm | R |
| index.php | 19,629 | 09/21/2007 | 8:02pm | R |
| logon.php | 2,751 | 09/21/2007 | 8:02pm | R |
| movecompads.php | 1,671 | 09/21/2007 | 8:02pm | R |
| page_properties.php | 15,721 | 09/21/2007 | 8:02pm | |
| progress.php | 874 | 09/21/2007 | 8:02pm | R |
| summary.php | 64 | 09/21/2007 | 8:02pm | R |
| testga0.ihtml | 354 | 09/21/2007 | 8:02pm | R |
| treeview.html | 20,166 | 09/21/2007 | 8:02pm | R |

15 files; 156,556 bytes
D:\MSP System Files-Patent-ASCII\plan\development070921\content

| | | | | |
|---|---|---|---|---|
| action_any_1.ihtml | 6,150 | 09/21/2007 | 8:02pm | |
| action_any_summary.ihtml | 2,708 | 09/21/2007 | 8:02pm | R |
| action_cust_1.ihtml | 1,758 | 09/21/2007 | 8:02pm | R |
| action_cust_summary.ihtml | 5,120 | 09/21/2007 | 8:02pm | R |
| action_head_cust_1.ihtml | 712 | 09/21/2007 | 8:02pm | R |
| action_head_op_1.ihtml | 696 | 09/21/2007 | 8:02pm | R |
| action_head_people_1.ihtml | 689 | 09/21/2007 | 8:02pm | R |
| action_home.ihtml | 2,984 | 09/21/2007 | 8:02pm | |
| action_op_1.ihtml | 3,108 | 09/21/2007 | 8:02pm | R |
| action_op_summary.ihtml | 2,231 | 09/21/2007 | 8:02pm | R |
| action_people_1.ihtml | 1,761 | 09/21/2007 | 8:02pm | R |
| action_people_summary.ihtml | 5,157 | 09/21/2007 | 8:02pm | R |
| comments_addnewform.ihtml | 1,500 | 09/21/2007 | 8:02pm | R |
| comments_addnewlink.ihtml | 95 | 09/21/2007 | 8:02pm | R |
| comments_container.tpl | 881 | 09/21/2007 | 8:02pm | R |
| comments_showall.ihtml | 415 | 09/21/2007 | 8:02pm | R |
| comp_1.ihtml | 1,726 | 09/21/2007 | 8:02pm | R |
| comp_2.ihtml | 1,273 | 09/21/2007 | 8:02pm | R |
| comp_3.ihtml | 1,954 | 09/21/2007 | 8:02pm | R |
| comp_4.ihtml | 1,369 | 09/21/2007 | 8:02pm | R |
| comp_5.ihtml | 1,253 | 09/21/2007 | 8:02pm | R |
| financial_1.ihtml | 1,204 | 09/21/2007 | 8:02pm | R |
| financial_2.ihtml | 2,453 | 09/21/2007 | 8:02pm | R |
| ga_summary.ihtml | 2,878 | 09/21/2007 | 8:02pm | |
| goals_any_1.ihtml | 6,314 | 09/21/2007 | 8:02pm | R |
| goals_any_new.ihtml | 6,356 | 09/21/2007 | 8:02pm | R |
| goals_any_summary.ihtml | 2,898 | 09/21/2007 | 8:02pm | R |
| goals_cust_1.ihtml | 782 | 09/21/2007 | 8:02pm | R |
| goals_cust_2.ihtml | 2,289 | 09/21/2007 | 8:02pm | R |
| goals_cust_3_p1.ihtml | 2,051 | 09/21/2007 | 8:02pm | R |
| goals_cust_3_p2.ihtml | 1,246 | 09/21/2007 | 8:02pm | R |
| goals_cust_4.ihtml | 1,150 | 09/21/2007 | 8:02pm | R |
| goals_cust_5.ihtml | 1,578 | 09/21/2007 | 8:02pm | R |
| goals_cust_summary.ihtml | 2,255 | 09/21/2007 | 8:02pm | R |
| goals_fin_1.ihtml | 2,756 | 09/21/2007 | 8:02pm | R |
| goals_fin_summary.ihtml | 2,160 | 09/21/2007 | 8:02pm | R |
| goals_group_summary.ihtml | 2,779 | 09/21/2007 | 8:02pm | R |
| goals_head_cust_1.ihtml | 748 | 09/21/2007 | 8:02pm | R |
| goals_head_cust_3_p2.ihtml | 349 | 09/21/2007 | 8:02pm | R |
| goals_head_cust_3_p3.ihtml | 330 | 09/21/2007 | 8:02pm | R |
| goals_head_cust_5.ihtml | 1,075 | 09/21/2007 | 8:02pm | R |
| goals_head_fin_1.ihtml | 826 | 09/21/2007 | 8:02pm | |
| goals_head_op_1.ihtml | 807 | 09/21/2007 | 8:02pm | R |
| goals_head_people_1.ihtml | 870 | 09/21/2007 | 8:02pm | R |
| goals_home.ihtml | 2,652 | 09/21/2007 | 8:02pm | R |
| goals_op_1.ihtml | 2,035 | 09/21/2007 | 8:02pm | R |
| goals_op_summary.ihtml | 2,168 | 09/21/2007 | 8:02pm | R |
| goals_people_1.ihtml | 2,063 | 09/21/2007 | 8:02pm | |
| goals_people_summary.ihtml | 2,224 | 09/21/2007 | 8:02pm | R |
| ideas_1.ihtml | 1,583 | 09/21/2007 | 8:02pm | R |
| ideas_2.ihtml | 835 | 09/21/2007 | 8:02pm | R |
| index.ihtml | 10,542 | 09/21/2007 | 8:02pm | R |
| ins_cg_next_buttons.ihtml | 288 | 09/21/2007 | 8:02pm | R |
| ins_cust_edit_row.ihtml | 273 | 09/21/2007 | 8:02pm | |
| ins_edit_button.ihtml | 250 | 09/21/2007 | 8:02pm | R |
| ins_goal_cust_head.ihtml | 216 | 09/21/2007 | 8:02pm | R |
| ins_index_popup_2.ihtml | 1,699 | 09/21/2007 | 8:02pm | R |
| ins_index_popup_3.ihtml | 1,519 | 09/21/2007 | 8:02pm | R |
| ins_next_button.ihtml | 209 | 09/21/2007 | 8:02pm | |
| ins_strat_obj_head.ihtml | 210 | 09/21/2007 | 8:02pm | |
| ins_summary_button.ihtml | 216 | 09/21/2007 | 8:02pm | R |
| key_1.ihtml | 1,831 | 09/21/2007 | 8:02pm | R |
| key_2.ihtml | 1,486 | 09/21/2007 | 8:02pm | R |
| key_home.ihtml | 1,778 | 09/21/2007 | 8:02pm | R |
| key_mem.ihtml | 433 | 09/21/2007 | 8:02pm | R |
| left_nav_box_this_module.ihtml | 1,990 | 09/21/2007 | 8:02pm | R |
| map_1.ihtml | 17 | 09/21/2007 | 8:02pm | R |
| mission_1.ihtml | 1,153 | 09/21/2007 | 8:02pm | R |
| mission_2.ihtml | 1,700 | 09/21/2007 | 8:02pm | R |
| mission_3.ihtml | 1,173 | 09/21/2007 | 8:02pm | R |
| obj_cust.ihtml | 2,860 | 09/21/2007 | 8:02pm | R |
| obj_fin.ihtml | 2,843 | 09/21/2007 | 8:02pm | R |
| obj_home.ihtml | 2,043 | 09/21/2007 | 8:02pm | R |
| obj_op.ihtml | 3,867 | 09/21/2007 | 8:02pm | R |
| obj_people.ihtml | 2,823 | 09/21/2007 | 8:02pm | R |
| obj_summary.ihtml | 2,184 | 09/21/2007 | 8:02pm | |
| org_strats_1.ihtml | 1,047 | 09/21/2007 | 8:02pm | R |
| org_strats_2.ihtml | 1,866 | 09/21/2007 | 8:02pm | R |
| org_strats_3.ihtml | 768 | 09/21/2007 | 8:02pm | R |
| progress.tpl | 4,835 | 09/21/2007 | 8:02pm | R |
| sub_nav.ihtml | 148 | 09/21/2007 | 8:02pm | R |
| swot_1.ihtml | 1,987 | 09/21/2007 | 8:02pm | R |
| swot_2.ihtml | 1,320 | 09/21/2007 | 8:02pm | R |
| swot_3.ihtml | 1,297 | 09/21/2007 | 8:02pm | R |
| swot_4.ihtml | 1,423 | 09/21/2007 | 8:02pm | R |
| swot_5.ihtml | 1,195 | 09/21/2007 | 8:02pm | R |
| swot_6.ihtml | 1,666 | 09/21/2007 | 8:02pm | R |
| treetest.ihtml | 1,651 | 09/21/2007 | 8:02pm | R |
| values_1.ihtml | 1,624 | 09/21/2007 | 8:02pm | R |
| values_2.ihtml | 1,060 | 09/21/2007 | 8:02pm | R |
| verify.js | 5,268 | 09/21/2007 | 8:02pm | R |
| visdesc_1.ihtml | 1,624 | 09/21/2007 | 8:02pm | R |
| visdesc_2.ihtml | 908 | 09/21/2007 | 8:02pm | R |
| vision_1.ihtml | 1,595 | 09/21/2007 | 8:02pm | R |
| vision_2.ihtml | 1,556 | 09/21/2007 | 8:02pm | R |
| vislead_1.ihtml | 1,019 | 09/21/2007 | 8:02pm | R |
| vislead_2.ihtml | 1,376 | 09/21/2007 | 8:02pm | R |
| vislead_3.ihtml | 624 | 09/21/2007 | 8:02pm | R |

98 files; 182,714 bytes
D:\MSP System Files-Patent-ASCII\plan\development070921\content\CVS

| | | | | |
|---|---|---|---|---|
| Entries | 5,248 | 09/21/2007 | 8:02pm | R |
| Repository | 25 | 09/21/2007 | 8:02pm | R |
| Root | 15 | 09/21/2007 | 8:02pm | R |

3 files; 5,288 bytes
D:\MSP System Files-Patent-ASCII\plan\development070921\content\iframes

| | | | | |
|---|---|---|---|---|
| action_cust_1_assess.html | 344 | 09/21/2007 | 8:02pm | R |
| action_cust_1_examples.html | 425 | 09/21/2007 | 8:02pm | R |
| action_cust_1_info.html | 831 | 09/21/2007 | 8:02pm | R |
| action_cust_summary_assess.html | 344 | 09/21/2007 | 8:02pm | R |
| action_cust_summary_examples.html | 425 | 09/21/2007 | 8:02pm | R |
| action_cust_summary_info.html | 344 | 09/21/2007 | 8:02pm | R |
| action_home_assess.html | 344 | 09/21/2007 | 8:02pm | R |
| action_home_examples.html | 559 | 09/21/2007 | 8:02pm | R |
| action_home_info.html | 2,140 | 09/21/2007 | 8:02pm | R |
| action_op_1_assess.html | 344 | 09/21/2007 | 8:02pm | R |
| action_op_1_examples.html | 425 | 09/21/2007 | 8:02pm | R |
| action_op_1_info.html | 831 | 09/21/2007 | 8:02pm | |
| action_op_summary_assess.html | 344 | 09/21/2007 | 8:02pm | R |
| action_op_summary_examples.html | 425 | 09/21/2007 | 8:02pm | R |
| action_op_summary_info.html | 344 | 09/21/2007 | 8:02pm | R |
| action_people_1_assess.html | 344 | 09/21/2007 | 8:02pm | R |
| action_people_1_examples.html | 425 | 09/21/2007 | 8:02pm | R |
| action_people_1_info.html | 831 | 09/21/2007 | 8:02pm | R |
| action_people_summary_assess.html | 344 | 09/21/2007 | 8:02pm | R |
| action_people_summary_examples.html | 425 | 09/21/2007 | 8:02pm | R |
| action_people_summary_info.html | 344 | 09/21/2007 | 8:02pm | R |
| comp_1_assess.html | 344 | 09/21/2007 | 8:02pm | |
| comp_1_examples.html | 2,015 | 09/21/2007 | 8:02pm | R |
| comp_1_info.html | 1,833 | 09/21/2007 | 8:02pm | |
| comp_2_assess.html | 344 | 09/21/2007 | 8:02pm | |
| comp_2_examples.html | 1,209 | 09/21/2007 | 8:02pm | R |
| comp_2_info.html | 2,001 | 09/21/2007 | 8:02pm | R |
| comp_3_assess.html | 344 | 09/21/2007 | 8:02pm | R |
| comp_3_examples.html | 1,254 | 09/21/2007 | 8:02pm | R |
| comp_3_info.html | 627 | 09/21/2007 | 8:02pm | R |
| comp_4_assess.html | 344 | 09/21/2007 | 8:02pm | |
| comp_4_examples.html | 2,015 | 09/21/2007 | 8:02pm | R |
| comp_4_info.html | 1,296 | 09/21/2007 | 8:02pm | |
| comp_5_assess.html | 344 | 09/21/2007 | 8:02pm | |
| comp_5_examples.html | 1,366 | 09/21/2007 | 8:02pm | R |
| comp_5_info.html | 2,762 | 09/21/2007 | 8:02pm | |
| comp_examples.html | 5,037 | 09/21/2007 | 8:02pm | R |
| comp_help.html | 3,973 | 09/21/2007 | 8:02pm | R |
| comp_intro.html | 3,758 | 09/21/2007 | 8:02pm | R |
| financial_1_assess.html | 344 | 09/21/2007 | 8:02pm | R |
| financial_1_examples.html | 431 | 09/21/2007 | 8:02pm | R |
| financial_1_info.html | 1,837 | 09/21/2007 | 8:02pm | |
| financial_2_examples.html | 429 | 09/21/2007 | 8:02pm | R |
| financial_2_info.html | 1,167 | 09/21/2007 | 8:02pm | |
| financial_help.html | 1,390 | 09/21/2007 | 8:02pm | R |
| financial_intro.html | 2,068 | 09/21/2007 | 8:02pm | R |
| goals_cust_1_assess.html | 344 | 09/21/2007 | 8:02pm | R |
| goals_cust_1_examples.html | 445 | 09/21/2007 | 8:02pm | R |
| goals_cust_1_info.html | 448 | 09/21/2007 | 8:02pm | |
| goals_cust_2_assess.html | 344 | 09/21/2007 | 8:02pm | R |
| goals_cust_2_examples.html | 462 | 09/21/2007 | 8:02pm | R |
| goals_cust_2_info.html | 1,663 | 09/21/2007 | 8:02pm | R |
| goals_cust_3_p1_assess.html | 344 | 09/21/2007 | 8:02pm | R |
| goals_cust_3_p1_examples.html | 1,967 | 09/21/2007 | 8:02pm | R |
| goals_cust_3_p1_info.html | 2,277 | 09/21/2007 | 8:02pm | R |
| goals_cust_3_p2_assess.html | 344 | 09/21/2007 | 8:02pm | R |
| goals_cust_3_p2_examples.html | 458 | 09/21/2007 | 8:02pm | R |
| goals_cust_3_p2_info.html | 805 | 09/21/2007 | 8:02pm | R |
| goals_cust_4_assess.html | 344 | 09/21/2007 | 8:02pm | R |
| goals_cust_4_examples.html | 344 | 09/21/2007 | 8:02pm | R |
| goals_cust_4_info.html | 344 | 09/21/2007 | 8:02pm | |
| goals_cust_5_assess.html | 344 | 09/21/2007 | 8:02pm | R |
| goals_cust_5_examples.html | 1,176 | 09/21/2007 | 8:02pm | R |
| goals_cust_5_info.html | 1,329 | 09/21/2007 | 8:02pm | R |
| goals_cust_summary_assess.html | 344 | 09/21/2007 | 8:02pm | R |
| goals_cust_summary_examples.html | 1,176 | 09/21/2007 | 8:02pm | R |
| goals_cust_summary_info.html | 1,330 | 09/21/2007 | 8:02pm | R |
| goals_fin_1_assess.html | 344 | 09/21/2007 | 8:02pm | R |
| goals_fin_1_examples.html | 1,078 | 09/21/2007 | 8:02pm | R |
| goals_fin_1_info.html | 1,329 | 09/21/2007 | 8:02pm | |
| goals_fin_summary_assess.html | 344 | 09/21/2007 | 8:02pm | R |
| goals_fin_summary_examples.html | 1,078 | 09/21/2007 | 8:02pm | R |
| goals_fin_summary_info.html | 1,329 | 09/21/2007 | 8:02pm | R |
| goals_home_assess.html | 344 | 09/21/2007 | 8:02pm | R |
| goals_home_examples.html | 820 | 09/21/2007 | 8:02pm | R |
| goals_home_info.html | 2,936 | 09/21/2007 | 8:02pm | R |
| goals_op_1_assess.html | 344 | 09/21/2007 | 8:02pm | R |
| goals_op_1_examples.html | 1,172 | 09/21/2007 | 8:02pm | R |
| goals_op_1_info.html | 1,329 | 09/21/2007 | 8:02pm | R |
| goals_op_summary_assess.html | 344 | 09/21/2007 | 8:02pm | R |
| goals_op_summary_examples.html | 1,170 | 09/21/2007 | 8:02pm | R |
| goals_op_summary_info.html | 1,330 | 09/21/2007 | 8:02pm | R |
| goals_people_1_assess.html | 344 | 09/21/2007 | 8:02pm | R |
| goals_people_1_examples.html | 983 | 09/21/2007 | 8:02pm | R |
| goals_people_1_info.html | 1,329 | 09/21/2007 | 8:02pm | R |
| goals_people_summary_assess.html | 344 | 09/21/2007 | 8:02pm | R |
| goals_people_summary_examples.html | 981 | 09/21/2007 | 8:02pm | R |
| goals_people_summary_info.html | 1,329 | 09/21/2007 | 8:02pm | R |
| ideas_1_assess.html | 344 | 09/21/2007 | 8:02pm | R |
| ideas_1_examples.html | 1,549 | 09/21/2007 | 8:02pm | R |
| ideas_1_info.html | 3,712 | 09/21/2007 | 8:02pm | R |
| ideas_2_assess.html | 344 | 09/21/2007 | 8:02pm | R |
| ideas_2_examples.html | 2,482 | 09/21/2007 | 8:02pm | R |
| ideas_2_info.html | 1,652 | 09/21/2007 | 8:02pm | R |
| ideas_examples.html | 1,833 | 09/21/2007 | 8:02pm | |
| ideas_help.html | 2,761 | 09/21/2007 | 8:02pm | R |
| ideas_intro.html | 5,274 | 09/21/2007 | 8:02pm | R |
| iframe.htm | 344 | 09/21/2007 | 8:02pm | R |
| index_assess.html | 344 | 09/21/2007 | 8:02pm | R |
| index_examples.html | 451 | 09/21/2007 | 8:02pm | |
| index_home.html | 4,395 | 09/21/2007 | 8:02pm | |
| index_info.html | 2,033 | 09/21/2007 | 8:02pm | R |
| key_1_assess.html | 344 | 09/21/2007 | 8:02pm | R |
| key_1_examples.html | 976 | 09/21/2007 | 8:02pm | R |
| key_1_info.html | 2,669 | 09/21/2007 | 8:02pm | R |
| key_2_assess.html | 344 | 09/21/2007 | 8:02pm | R |
| key_2_examples.html | 344 | 09/21/2007 | 8:02pm | R |
| key_2_info.html | 344 | 09/21/2007 | 8:02pm | R |
| key_examples.html | 1,242 | 09/21/2007 | 8:02pm | |
| key_help.html | 684 | 09/21/2007 | 8:02pm | R |
| key_home_examples.html | 976 | 09/21/2007 | 8:02pm | R |
| key_home_info.html | 2,685 | 09/21/2007 | 8:02pm | R |
| key_intro.html | 5,277 | 09/21/2007 | 8:02pm | R |
| map_1_assess.html | 344 | 09/21/2007 | 8:02pm | |
| map_1_examples.html | 344 | 09/21/2007 | 8:02pm | R |
| map_1_info.html | 1,756 | 09/21/2007 | 8:02pm | R |
| mission_examples.html | 2,556 | 09/21/2007 | 8:02pm | R |
| mission_help.html | 1,591 | 09/21/2007 | 8:02pm | R |
| mission_intro.html | 1,116 | 09/21/2007 | 8:02pm | R |
| obj_cust_assess.html | 344 | 09/21/2007 | 8:02pm | R |
| obj_cust_examples.html | 1,559 | 09/21/2007 | 8:02pm | R |
| obj_cust_info.html | 1,157 | 09/21/2007 | 8:02pm | R |
| obj_fin_assess.html | 344 | 09/21/2007 | 8:02pm | R |
| obj_fin_examples.html | 1,171 | 09/21/2007 | 8:02pm | R |
| obj_fin_info.html | 1,402 | 09/21/2007 | 8:02pm | R |
| obj_home_examples.htm | 1,260 | 09/21/2007 | 8:02pm | R |
| obj_home_examples.html | 1,422 | 09/21/2007 | 8:02pm | R |
| obj_home_info.htm | 3,215 | 09/21/2007 | 8:02pm | R |
| obj_home_info.html | 2,734 | 09/21/2007 | 8:02pm | R |
| obj_op_assess.html | 344 | 09/21/2007 | 8:02pm | R |
| obj_op_examples.html | 2,820 | 09/21/2007 | 8:02pm | R |
| obj_op_info.html | 1,061 | 09/21/2007 | 8:02pm | R |
| obj_people_assess.html | 344 | 09/21/2007 | 8:02pm | R |
| obj_people_examples.html | 1,312 | 09/21/2007 | 8:02pm | R |
| obj_people_info.html | 1,171 | 09/21/2007 | 8:02pm | |
| obj_summary_assess.html | 344 | 09/21/2007 | 8:02pm | R |
| obj_summary_examples.html | 470 | 09/21/2007 | 8:02pm | R |
| obj_summary_info.html | 726 | 09/21/2007 | 8:02pm | R |
| org_strats_1_assess.html | 344 | 09/21/2007 | 8:02pm | |
| org_strats_1_examples.html | 1,060 | 09/21/2007 | 8:02pm | R |
| org_strats_1_info.html | 1,022 | 09/21/2007 | 8:02pm | |
| org_strats_2_assess.html | 344 | 09/21/2007 | 8:02pm | |
| org_strats_2_examples.html | 1,061 | 09/21/2007 | 8:02pm | R |
| org_strats_2_info.html | 1,022 | 09/21/2007 | 8:02pm | |
| org_strats_3_assess.html | 344 | 09/21/2007 | 8:02pm | |
| org_strats_3_examples.html | 1,060 | 09/21/2007 | 8:02pm | R |
| org_strats_3_info.html | 1,022 | 09/21/2007 | 8:02pm | |
| org_strats_examples.html | 1,377 | 09/21/2007 | 8:02pm | R |
| org_strats_help.html | 712 | 09/21/2007 | 8:02pm | R |
| org_strats_intro.html | 1,343 | 09/21/2007 | 8:02pm | R |
| swot_examples.html | 100 | 09/21/2007 | 8:02pm | |
| swot_help.html | 96 | 09/21/2007 | 8:02pm | R |
| swot_intro.html | 1,564 | 09/21/2007 | 8:02pm | R |
| swot_o_examples.html | 2,075 | 09/21/2007 | 8:02pm | R |
| swot_o_help.html | 4,288 | 09/21/2007 | 8:02pm | R |
| swot_o_intro.html | 1,597 | 09/21/2007 | 8:02pm | R |
| swot_s_examples.html | 2,048 | 09/21/2007 | 8:02pm | R |
| swot_s_help.html | 3,416 | 09/21/2007 | 8:02pm | R |
| swot_s_intro.html | 1,508 | 09/21/2007 | 8:02pm | R |
| swot_t_examples.html | 2,069 | 09/21/2007 | 8:02pm | R |
| swot_t_help.html | 3,786 | 09/21/2007 | 8:02pm | R |
| swot_t_intro.html | 1,433 | 09/21/2007 | 8:02pm | R |
| swot_w_examples.html | 2,122 | 09/21/2007 | 8:02pm | R |
| swot_w_help.html | 3,270 | 09/21/2007 | 8:02pm | |
| swot_w_intro.html | 1,479 | 09/21/2007 | 8:02pm | |
| values_1_assess.html | 344 | 09/21/2007 | 8:02pm | |
| values_1_examples.html | 3,607 | 09/21/2007 | 8:02pm | R |
| values_1_info.html | 1,802 | 09/21/2007 | 8:02pm | |
| values_2_assess.html | 344 | 09/21/2007 | 8:02pm | |
| values_2_examples.html | 1,201 | 09/21/2007 | 8:02pm | R |
| values_2_info.html | 1,505 | 09/21/2007 | 8:02pm | |
| values_examples.html | 3,897 | 09/21/2007 | 8:02pm | R |
| values_help.html | 1,637 | 09/21/2007 | 8:02pm | R |
| values_intro.html | 1,107 | 09/21/2007 | 8:02pm | R |
| visdesc_1_assess.html | 344 | 09/21/2007 | 8:02pm | |
| visdesc_1_examples.html | 2,650 | 09/21/2007 | 8:02pm | R |
| visdesc_1_info.html | 1,092 | 09/21/2007 | 8:02pm | |
| visdesc_2_assess.html | 344 | 09/21/2007 | 8:02pm | |
| visdesc_2_examples.html | 2,651 | 09/21/2007 | 8:02pm | R |
| visdesc_2_info.html | 2,543 | 09/21/2007 | 8:02pm | |
| vision_1_assess.html | 344 | 09/21/2007 | 8:02pm | R |
| vision_1_examples.html | 1,976 | 09/21/2007 | 8:02pm | R |
| vision_1_info.html | 1,213 | 09/21/2007 | 8:02pm | R |
| vision_2_assess.html | 344 | 09/21/2007 | 8:02pm | R |
| vision_2_examples.html | 1,979 | 09/21/2007 | 8:02pm | R |
| vision_2_info.html | 2,005 | 09/21/2007 | 8:02pm | R |
| vision_examples.html | 4,542 | 09/21/2007 | 8:02pm | R |
| vision_help.html | 3,486 | 09/21/2007 | 8:02pm | R |
| vision_intro.html | 3,136 | 09/21/2007 | 8:02pm | R |
| vislead_1_assess.html | 344 | 09/21/2007 | 8:02pm | R |
| vislead_1_examples.html | 793 | 09/21/2007 | 8:02pm | R |
| vislead_1_info.html | 767 | 09/21/2007 | 8:02pm | R |
| vislead_2_assess.html | 344 | 09/21/2007 | 8:02pm | |
| vislead_2_examples.html | 793 | 09/21/2007 | 8:02pm | R |
| vislead_2_info.html | 759 | 09/21/2007 | 8:02pm | R |
| vislead_3_assess.html | 344 | 09/21/2007 | 8:02pm | |
| vislead_3_examples.html | 793 | 09/21/2007 | 8:02pm | R |
| vislead_3_info.html | 767 | 09/21/2007 | 8:02pm | R |

198 files; 252,616 bytes
D:\MSP System Files-Patent-ASCII\plan\development070921\content\iframes\CVS

| | | | | |
|---|---|---|---|---|
| Entries | 11,424 | 09/21/2007 | 8:02pm | R |
| Repository | 33 | 09/21/2007 | 8:02pm | R |
| Root | 15 | 09/21/2007 | 8:02pm | R |

3 files; 11,472 bytes
D:\MSP System Files-Patent-ASCII\plan\development071010

| | | | | |
|---|---|---|---|---|
| addtoplans.php | 987 | 10/11/2007 | 3:44am | R |
| buildnewga.php | 8,848 | 10/11/2007 | 3:44am | R |
| class.DevelopmentDb.php | 14,842 | 10/11/2007 | 3:44am | R |
| class.DevelopmentPage.php | 4,784 | 10/11/2007 | 3:44am | R |
| class.OGATemplates.php | 6,351 | 10/11/2007 | 3:44am | R |
| class.Templates.php | 4,409 | 10/11/2007 | 3:44am | |
| class.Utilities.php | 2,532 | 10/11/2007 | 3:44am | R |
| comments.php | 3,374 | 10/11/2007 | 3:44am | R |
| index.php | 9,434 | 10/11/2007 | 3:44am | R |
| logon.php | 2,751 | 10/11/2007 | 3:44am | R |
| movecompads.php | 2,314 | 10/11/2007 | 3:44am | R |
| page_properties.php | 7,287 | 10/11/2007 | 3:44am | |
| progress.php | 874 | 10/11/2007 | 3:44am | R |
| summary.php | 64 | 10/11/2007 | 3:44am | R |
| treeview.html | 20,166 | 10/11/2007 | 3:44am | R |

15 files; 89,017 bytes
D:\MSP System Files-Patent-ASCII\plan\dhtml

| | | | | |
|---|---|---|---|---|
| popin.html | 2,810 | 04/19/2007 | 2:22am | R |

1 file; 2,810 bytes
D:\MSP System Files-Patent-ASCII\plan\dhtml\CVS

| | | | | |
|---|---|---|---|---|
| Entries | 823 | 12/28/2007 | 3:41pm | R |
| Repository | 11 | 04/19/2007 | 2:23am | R |
| Root | 15 | 04/19/2007 | 2:23am | R |

3 files; 849 bytes
D:\MSP System Files-Patent-ASCII\plan\dhtml\domTT

| | | | | |
|---|---|---|---|---|
| alphaAPI.js | 6,239 | 04/19/2007 | 2:22am | R |
| domLib.js | 16,943 | 04/19/2007 | 2:22am | R |
| domTT.js | 30,108 | 04/19/2007 | 2:22am | R |
| domTT_drag.js | 2,594 | 04/19/2007 | 2:22am | R |
| fadomatic.js | 4,590 | 04/19/2007 | 2:22am | R |

5 files; 60,474 bytes
D:\MSP System Files-Patent-ASCII\plan\dhtml\domTT\CVS

| | | | | |
|---|---|---|---|---|
| Entries | 289 | 04/19/2007 | 2:23am | R |
| Repository | 17 | 04/19/2007 | 2:23am | R |
| Root | 15 | 04/19/2007 | 2:23am | R |

3 files; 321 bytes
D:\MSP System Files-Patent-ASCII\plan\dhtml\dynCalendar

| | | | | |
|---|---|---|---|---|
| browserSniffer.js | 10,479 | 04/19/2007 | 2:22am | R |
| calendar.html | 1,610 | 04/19/2007 | 2:22am | R |
| dynCalendar.html | 849 | 04/19/2007 | 2:22am | R |
| dynCalendar.js | 14,419 | 04/19/2007 | 2:22am | R |

4 files; 27,357 bytes
D:\MSP System Files-Patent-ASCII\plan\dhtml\dynCalendar\CVS

| | | | | |
|---|---|---|---|---|
| Entries | 262 | 04/19/2007 | 2:23am | R |
| Repository | 23 | 04/19/2007 | 2:23am | R |
| Root | 15 | 04/19/2007 | 2:23am | R |

3 files; 300 bytes
D:\MSP System Files-Patent-ASCII\plan\dhtml\nifty

| | | | | |
|---|---|---|---|---|
| nifty.js | 8,736 | 04/19/2007 | 2:22am | R |

1 file; 8,736 bytes
D:\MSP System Files-Patent-ASCII\plan\dhtml\nifty\CVS

| | | | | |
|---|---|---|---|---|
| Entries | 100 | 04/19/2007 | 2:23am | R |
| Repository | 17 | 04/19/2007 | 2:23am | R |
| Root | 15 | 04/19/2007 | 2:23am | R |

3 files; 132 bytes
D:\MSP System Files-Patent-ASCII\plan\dhtml\slider

| | | | | |
|---|---|---|---|---|
| mootools.js | 88,500 | 08/06/2007 | 10:16am | R |

1 file; 88,500 bytes
D:\MSP System Files-Patent-ASCII\plan\dhtml\slider\CVS

| | | | | |
|---|---|---|---|---|
| Entries | 89 | 08/06/2007 | 8:11pm | R |
| Repository | 18 | 08/06/2007 | 10:41am | R |
| Root | 15 | 08/06/2007 | 10:41am | R |

3 files; 122 bytes
D:\MSP System Files-Patent-ASCII\plan\execution

| | | | | |
|---|---|---|---|---|
| class.ExecutionDb.php | 11,414 | 12/19/2007 | 9:37pm | R |
| class.ExecutionPage.php | 2,957 | 11/22/2007 | 12:12am | R |
| class.Templates.php | 18,033 | 12/18/2007 | 1:15pm | |
| index.php | 26,165 | 12/28/2007 | 11:28pm | R |
| page_properties.php | 2,819 | 11/22/2007 | 12:12am | |

5 files; 61,388 bytes
D:\MSP System Files-Patent-ASCII\plan\execution\content

| | | | | |
|---|---|---|---|---|
| admin.ihtml | 3,551 | 06/06/2007 | 3:04pm | R |
| alert.ihtml | 3,431 | 12/07/2007 | 12:25pm | R |
| alert.tpl | 375 | 06/19/2007 | 4:19pm | R |
| dashboard.ihtml | 10 | 04/19/2007 | 2:22am | R |
| ga_item.ihtml | 480 | 11/07/2007 | 12:58pm | R |
| ga_status.ihtml | 737 | 11/07/2007 | 12:58pm | R |
| goals.ihtml | 4,168 | 11/16/2007 | 4:26pm | R |
| index.ihtml | 5,732 | 11/20/2007 | 3:26am | R |
| index_ach_item.ihtml | 918 | 06/01/2007 | 7:38pm | R |
| index_goal_item.ihtml | 1,109 | 11/19/2007 | 9:33pm | R |
| index_status.ihtml | 1,170 | 05/30/2007 | 4:09am | R |
| ins_print_link.ihtml | 262 | 06/11/2007 | 7:12pm | R |
| kpi.ihtml | 6,780 | 12/15/2007 | 5:08pm | R |
| kpi_actual.ihtml | 483 | 12/19/2007 | 9:37pm | R |
| kpi_item.ihtml | 951 | 11/19/2007 | 9:33pm | R |
| kpi_targ.ihtml | 643 | 11/21/2007 | 1:05pm | R |
| printpage.tpl | 750 | 05/18/2007 | 3:02pm | R |
| sub_nav.ihtml | 148 | 04/19/2007 | 2:22am | R |
| subsub_nav.ihtml | 157 | 05/09/2007 | 10:04pm | R |

19 files; 31,855 bytes
D:\MSP System Files-Patent-ASCII\plan\execution\content\CVS

| | | | | |
|---|---|---|---|---|
| Entries | 915 | 12/19/2007 | 9:37pm | R |
| Repository | 23 | 04/19/2007 | 2:23am | R |
| Root | 15 | 04/19/2007 | 2:23am | R |

3 files; 953 bytes
D:\MSP System Files-Patent-ASCII\plan\execution\CVS

| | | | | |
|---|---|---|---|---|
| Entries | 275 | 12/28/2007 | 11:28pm | R |
| Repository | 15 | 04/19/2007 | 2:23am | R |
| Root | 15 | 04/19/2007 | 2:23am | R |

3 files; 305 bytes
D:\MSP System Files-Patent-ASCII\plan\executionx

| | | | | |
|---|---|---|---|---|
| class.ExecutionDb.php | 11,985 | 11/01/2007 | 3:42pm | R |
| class.ExecutionPage.php | 2,957 | 11/01/2007 | 3:42pm | R |
| index.php | 46,399 | 11/01/2007 | 3:42pm | R |
| page_properties.php | 2,691 | 11/01/2007 | 3:42pm | |

4 files; 64,032 bytes
D:\MSP System Files-Patent-ASCII\plan\executionx\content

| | | | | |
|---|---|---|---|---|
| admin.ihtml | 3,551 | 11/01/2007 | 3:42pm | R |
| alert.ihtml | 3,191 | 11/01/2007 | 3:42pm | R |
| alert.tpl | 375 | 11/01/2007 | 3:42pm | R |
| dashboard.ihtml | 10 | 11/01/2007 | 3:42pm | R |
| ga_item.ihtml | 514 | 11/01/2007 | 3:42pm | R |
| ga_status.ihtml | 681 | 11/01/2007 | 3:42pm | R |
| goals.ihtml | 4,329 | 11/01/2007 | 3:42pm | R |
| index.ihtml | 5,837 | 11/01/2007 | 3:42pm | R |
| index_ach_item.ihtml | 918 | 11/01/2007 | 3:42pm | |
| index_goal_item.ihtml | 1,119 | 11/01/2007 | 3:42pm | R |
| index_status.ihtml | 1,170 | 11/01/2007 | 3:42pm | R |
| ins_print_link.ihtml | 262 | 11/01/2007 | 3:42pm | R |
| kpi.ihtml | 7,101 | 11/01/2007 | 3:42pm | R |
| kpi_actual.ihtml | 484 | 11/01/2007 | 3:42pm | R |
| kpi_item.ihtml | 1,120 | 11/01/2007 | 3:42pm | R |
| kpi_targ.ihtml | 647 | 11/01/2007 | 3:42pm | R |
| printpage.tpl | 750 | 11/01/2007 | 3:42pm | R |
| sub_nav.ihtml | 148 | 11/01/2007 | 3:42pm | R |
| subsub_nav.ihtml | 157 | 11/01/2007 | 3:42pm | R |

19 files; 32,364 bytes
D:\MSP System Files-Patent-ASCII\plan\executionx\content\CVS

| | | | | |
|---|---|---|---|---|
| Entries | 912 | 11/01/2007 | 3:42pm | R |
| Repository | 23 | 11/01/2007 | 3:42pm | R |
| Root | 15 | 11/01/2007 | 3:42pm | R |

3 files; 950 bytes
D:\MSP System Files-Patent-ASCII\plan\executionx\CVS

| | | | | |
|---|---|---|---|---|
| Entries | 222 | 11/01/2007 | 3:42pm | R |
| Repository | 15 | 11/01/2007 | 3:42pm | R |
| Root | 15 | 11/01/2007 | 3:42pm | R |

3 files; 252 bytes
D:\MSP System Files-Patent-ASCII\plan\progress

| | | | | |
|---|---|---|---|---|
| class.ProgressPage.php | 4,122 | 10/09/2007 | 3:36pm | R |
| index.php | 28,472 | 04/19/2007 | 2:22am | R |
| page_properties.php | 1,705 | 04/19/2007 | 2:22am | R |

3 files; 34,299 bytes
D:\MSP System Files-Patent-ASCII\plan\progress\content

| | | | | |
|---|---|---|---|---|
| ga_item.ihtml | 455 | 04/19/2007 | 2:22am | R |
| ga_status.ihtml | 1,096 | 04/19/2007 | 2:22am | R |
| goals.ihtml | 5,533 | 04/19/2007 | 2:22am | R |
| index.ihtml | 5,466 | 04/19/2007 | 2:22am | R |
| kpi.ihtml | 5,958 | 04/19/2007 | 2:22am | R |
| kpi_actual.ihtml | 556 | 04/19/2007 | 2:22am | R |
| kpi_targ.ihtml | 545 | 04/19/2007 | 2:22am | R |
| left_nav_box_this_module.ihtml | 844 | 04/19/2007 | 2:22am | R |
| sub_nav.ihtml | 146 | 04/19/2007 | 2:22am | R |

9 files; 20,599 bytes
D:\MSP System Files-Patent-ASCII\plan\progress\content\CVS

| | | | | |
|---|---|---|---|---|
| Entries | 467 | 04/19/2007 | 2:23am | R |
| Repository | 22 | 04/19/2007 | 2:23am | R |
| Root | 15 | 04/19/2007 | 2:23am | R |

3 files; 504 bytes
D:\MSP System Files-Patent-ASCII\plan\progress\CVS

| | | | | |
|---|---|---|---|---|
| Entries | 171 | 10/09/2007 | 3:36pm | R |
| Repository | 14 | 04/19/2007 | 2:23am | R |
| Root | 15 | 04/19/2007 | 2:23am | R |

3 files; 200 bytes
D:\MSP System Files-Patent-ASCII\plan\remote_sites
0 files; 0 bytes
D:\MSP System Files-Patent-ASCII\plan\remote_sites\CVS

| | | | | |
|---|---|---|---|---|
| Entries | 37 | 04/19/2007 | 2:23am | R |
| Repository | 18 | 04/19/2007 | 2:23am | R |
| Root | 15 | 04/19/2007 | 2:23am | R |

3 files; 70 bytes
D:\MSP System Files-Patent-ASCII\plan\remote_sites\mychurchplan
0 files; 0 bytes
D:\MSP System Files-Patent-ASCII\plan\remote_sites\mychurchplan\CVS

| | | | | |
|---|---|---|---|---|
| Entries | 62 | 04/19/2007 | 2:23am | R |
| Repository | 31 | 04/19/2007 | 2:23am | R |
| Root | 15 | 04/19/2007 | 2:23am | R |

3 files; 108 bytes
D:\MSP System Files-Patent-ASCII\plan\remote_sites\mychurchplan\templates

| | | | | |
|---|---|---|---|---|
| container.tpl | 12,449 | 04/19/2007 | 2:22am | R |

1 file; 12,449 bytes
D:\MSP System Files-Patent-ASCII\plan\remote_sites\mychurchplan\templates\CVS

| | | | | |
|---|---|---|---|---|
| Entries | 52 | 04/19/2007 | 2:23am | R |
| Repository | 41 | 04/19/2007 | 2:23am | R |
| Root | 15 | 04/19/2007 | 2:23am | R |

3 files; 108 bytes
D:\MSP System Files-Patent-ASCII\plan\remote_sites\mynonprofit
0 files; 0 bytes
D:\MSP System Files-Patent-ASCII\plan\remote_sites\mynonprofit\CVS

| | | | | |
|---|---|---|---|---|
| Entries | 2 | 04/19/2007 | 2:23am | R |
| Repository | 30 | 04/19/2007 | 2:23am | R |
| Root | 15 | 04/19/2007 | 2:23am | R |

3 files; 47 bytes
D:\MSP System Files-Patent-ASCII\plan\reports

| | | | | |
|---|---|---|---|---|
| class.ReportsPage.php | 5,063 | 10/09/2007 | 3:36pm | R |
| index.php | 23,606 | 12/18/2007 | 4:22pm | R |
| page_properties.php | 3,561 | 04/19/2007 | 2:22am | |
| reportsOGA.php | 28,666 | 12/04/2007 | 6:28pm | |

4 files; 60,896 bytes
D:\MSP System Files-Patent-ASCII\plan\reports\content

| | | | | |
|---|---|---|---|---|
| actionsheet.ihtml | 4,072 | 08/02/2007 | 11:32am | R |
| actionsheet.tpl | 720 | 07/25/2007 | 11:02pm | R |
| bigsheet.tpl | 733 | 07/25/2007 | 11:02pm | R |
| bigsheet_depts.ihtml | 2,656 | 10/19/2007 | 5:21pm | |
| bigsheet_nodepts.ihtml | 2,514 | 11/15/2007 | 4:10pm | R |
| index.ihtml | 2,083 | 12/26/2007 | 4:03pm | R |
| index_team.ihtml | 3,069 | 09/11/2007 | 1:04pm | R |
| ins_action_table_hdept.ihtml | 502 | 08/12/2007 | 4:25pm | R |
| ins_action_table_header.ihtml | 510 | 11/13/2007 | 6:53am | R |
| ins_cust_needs.ihtml | 697 | 11/21/2007 | 6:06pm | R |
| ins_cust_objlist.ihtml | 356 | 07/25/2007 | 11:02pm | R |
| ins_cust_onepage.ihtml | 201 | 04/19/2007 | 2:22am | |
| ins_report_desc.ihtml | 1,183 | 04/19/2007 | 2:22am | |
| ins_stratplan_iframe_top.ihtml | 49 | 04/19/2007 | 2:22am | R |
| ins_stratplan_top.ihtml | 215 | 12/18/2007 | 1:15pm | |
| ins_visdesc.ihtml | 85 | 04/19/2007 | 2:22am | R |
| left_nav_box_this_module.ihtml | 995 | 04/19/2007 | 2:22am | R |
| onepageplan.ihtml | 10,266 | 11/24/2007 | 1:19pm | |
| onepageplan.tpl | 720 | 07/25/2007 | 11:02pm | R |
| scorecard.ihtml | 4,421 | 08/02/2007 | 11:32am | R |
| scorecard.tpl | 720 | 07/25/2007 | 11:02pm | R |
| stratplan.ihtml | 5,124 | 11/24/2007 | 1:19pm | R |
| stratplan.tpl | 732 | 07/25/2007 | 11:02pm | R |
| stratplan_iframe.tpl | 720 | 07/25/2007 | 11:02pm | R |
| stratplan_new.ihtml | 4,982 | 11/24/2007 | 1:19pm | R |
| stratplan_obj_type.ihtml | 1,462 | 07/25/2007 | 11:02pm | R |
| sub_nav.ihtml | 148 | 04/19/2007 | 2:22am | R |
| swot.ihtml | 4,680 | 07/25/2007 | 11:02pm | R |
| swot.tpl | 720 | 07/25/2007 | 11:02pm | R |

29 files; 55,335 bytes
D:\MSP System Files-Patent-ASCII\plan\reports\content\CVS

| | | | | |
|---|---|---|---|---|
| Entries | 1,597 | 12/26/2007 | 4:03pm | R |
| Repository | 21 | 04/19/2007 | 2:23am | R |
| Root | 15 | 04/19/2007 | 2:23am | R |

3 files; 1,633 bytes
D:\MSP System Files-Patent-ASCII\plan\reports\content\iframes

| | | | |
|---|---|---|---|
| index_home.html | 2,161 | 12/26/2007 | 4:43pm |

1 file; 2,161 bytes
D:\MSP System Files-Patent-ASCII\plan\reports\content\iframes\CVS

| | | | | |
|---|---|---|---|---|
| Entries | 50 | 12/26/2007 | 4:43pm | R |
| Repository | 29 | 04/19/2007 | 2:23am | R |
| Root | 15 | 04/19/2007 | 2:23am | R |

3 files; 94 bytes
D:\MSP System Files-Patent-ASCII\plan\reports\CVS

| | | | | |
|---|---|---|---|---|
| Entries | 215 | 12/18/2007 | 4:22pm | R |
| Repository | 13 | 04/19/2007 | 2:23am | R |
| Root | 15 | 04/19/2007 | 2:23am | R |

3 files; 243 bytes
D:\MSP System Files-Patent-ASCII\plan\reportsx

| | | | | |
|---|---|---|---|---|
| class.ReportsPage.php | 5,063 | 10/18/2007 | 5:37pm | R |
| index.php | 52,760 | 10/18/2007 | 5:37pm | R |
| page_properties.php | 3,561 | 10/18/2007 | 5:37pm | |

3 files; 61,384 bytes
D:\MSP System Files-Patent-ASCII\plan\reportsx\content

| | | | | |
|---|---|---|---|---|
| actionsheet.ihtml | 4,072 | 10/18/2007 | 5:37pm | R |
| actionsheet.tpl | 720 | 10/18/2007 | 5:37pm | R |
| bigsheet.tpl | 733 | 10/18/2007 | 5:37pm | R |
| bigsheet_depts.ihtml | 2,664 | 10/18/2007 | 5:37pm | |
| bigsheet_nodepts.ihtml | 2,522 | 10/18/2007 | 5:37pm | R |
| index.ihtml | 2,337 | 10/18/2007 | 5:37pm | R |
| index_team.ihtml | 3,069 | 10/18/2007 | 5:37pm | R |
| ins_action_table_hdept.ihtml | 502 | 10/18/2007 | 5:37pm | R |
| ins_action_table_header.ihtml | 502 | 10/18/2007 | 5:37pm | R |
| ins_cust_needs.ihtml | 200 | 10/18/2007 | 5:37pm | R |
| ins_cust_objlist.ihtml | 356 | 10/18/2007 | 5:37pm | R |
| ins_cust_onepage.ihtml | 201 | 10/18/2007 | 5:37pm | |
| ins_report_desc.ihtml | 1,183 | 10/18/2007 | 5:37pm | |
| ins_stratplan_iframe_top.ihtml | 49 | 10/18/2007 | 5:37pm | R |
| ins_stratplan_top.ihtml | 223 | 10/18/2007 | 5:37pm | |
| ins_visdesc.ihtml | 85 | 10/18/2007 | 5:37pm | R |
| len_nav_box_this_module.ihtml | 995 | 10/18/2007 | 5:37pm | R |
| onepageplan.ihtml | 10,525 | 10/18/2007 | 5:37pm | |
| onepageplan.tpl | 720 | 10/18/2007 | 5:37pm | R |
| scorecard.ihtml | 4,421 | 10/18/2007 | 5:37pm | R |
| scorecard.tpl | 720 | 10/18/2007 | 5:37pm | R |
| stratplan.ihtml | 5,404 | 10/18/2007 | 5:37pm | R |
| stratplan.tpl | 732 | 10/18/2007 | 5:37pm | R |
| stratplan_iframe.tpl | 720 | 10/18/2007 | 5:37pm | R |
| stratplan_new.ihtml | 5,254 | 10/18/2007 | 5:37pm | R |
| stratplan_obj_type.ihtml | 1,462 | 10/18/2007 | 5:37pm | R |
| sub_nav.ihtml | 148 | 10/18/2007 | 5:37pm | R |
| swot.ihtml | 4,680 | 10/18/2007 | 5:37pm | R |
| swot.tpl | 720 | 10/18/2007 | 5:37pm | R |

29 files; 55,919 bytes
D:\MSP System Files-Patent-ASCII\plan\reportsx\content\CVS

| | | | | |
|---|---|---|---|---|
| Entries | 1,604 | 10/18/2007 | 5:37pm | R |
| Repository | 21 | 10/18/2007 | 5:37pm | R |
| Root | 15 | 10/18/2007 | 5:37pm | R |

3 files; 1,640 bytes
D:\MSP System Files-Patent-ASCII\plan\reportsx\content\iframes

| | | | |
|---|---|---|---|
| index_home.html | 1,677 | 10/18/2007 | 5:37pm |

1 file; 1,677 bytes
D:\MSP System Files-Patent-ASCII\plan\reportsx\content\iframes\CVS

| | | | | |
|---|---|---|---|---|
| Entries | 50 | 10/18/2007 | 5:37pm | R |
| Repository | 29 | 10/18/2007 | 5:37pm | R |
| Root | 15 | 10/18/2007 | 5:37pm | R |

3 files; 94 bytes
D:\MSP System Files-Patent-ASCII\plan\reportsx\CVS

| | | | | |
|---|---|---|---|---|
| Entries | 167 | 10/18/2007 | 5:37pm | R |
| Repository | 13 | 10/18/2007 | 5:37pm | R |
| Root | 15 | 10/18/2007 | 5:37pm | R |

3 files; 195 bytes
D:\MSP System Files-Patent-ASCII\plan\speller

| | | | | |
|---|---|---|---|---|
| blank.html | 0 | 04/19/2007 | 2:22am | R |
| controls.html | 3,237 | 04/19/2007 | 2:22am | R |
| controlWindow.js | 2,216 | 04/19/2007 | 2:22am | R |
| index.php | 826 | 04/19/2007 | 2:22am | R |
| spellchecker.html | 2,255 | 04/19/2007 | 2:22am | R |
| spellChecker.js | 15,663 | 04/19/2007 | 2:22am | R |
| spellchecker.php | 5,551 | 04/19/2007 | 2:22am | R |
| wordWindow.js | 7,560 | 04/19/2007 | 2:22am | R |

8 files; 37,308 bytes
D:\MSP System Files-Patent-ASCII\plan\speller\CVS

| | | | | |
|---|---|---|---|---|
| Entries | 460 | 04/19/2007 | 2:23am | R |
| Repository | 13 | 04/19/2007 | 2:23am | R |
| Root | 15 | 04/19/2007 | 2:23am | R |

3 files; 488 bytes
D:\MSP System Files-Patent-ASCII\plan\templates

| | | | | |
|---|---|---|---|---|
| comments_addnewform.ihtml | 1,500 | 04/19/2007 | 2:22am | R |
| comments_addnewlink.ihtml | 93 | 04/19/2007 | 2:22am | R |
| comments_container.tpl | 527 | 04/19/2007 | 2:22am | R |
| comments_showall.ihtml | 415 | 04/19/2007 | 2:22am | R |
| container.tpl | 7,005 | 12/12/2007 | 1:33pm | R |
| container_admin.tpl | 3,245 | 04/19/2007 | 2:22am | |
| container_execution.tpl | 7,514 | 11/24/2007 | 1:19pm | |
| container_login.tpl | 4,287 | 04/19/2007 | 2:22am | R |
| container_setup.tpl | 4,263 | 04/19/2007 | 2:22am | R |
| content_container.ihtml | 531 | 04/19/2007 | 2:22am | |
| content_container_execution.ihtml | 484 | 05/09/2007 | 3:49pm | R |
| content_container_iframe.ihtml | 2,286 | 04/19/2007 | 2:22am | R |
| left_nav.ihtml | 4,578 | 12/15/2007 | 2:01pm | R |
| spellcheck_js.ihtml | 53 | 04/19/2007 | 2:22am | R |

14 files; 36,781 bytes
D:\MSP System Files-Patent-ASCII\plan\templates\CVS

| | | | | |
|---|---|---|---|---|
| Entries | 811 | 12/15/2007 | 2:01pm | R |
| Repository | 15 | 04/19/2007 | 2:23am | R |
| Root | 15 | 04/19/2007 | 2:23am | R |

3 files; 841 bytes
D:\MSP System Files-Patent-ASCII\plan_main_DEV_071103_lastGood.sql

| | | | | |
|---|---|---|---|---|
| plan_main_DEV_071103_lastGood.sql | 8,265,566 | 11/03/2007 | 11:49pm | R |

1 file; 8,265,566 bytes
D:\MSP System Files-Patent-ASCII\plan_main_DEVpostMovePreDelete071103.sql

| | | | | |
|---|---|---|---|---|
| plan_main_DEVpostMovePreDelete071103.sql | 9,051,042 | 11/03/2007 | 11:50pm | R |

1 file; 9,051,042 bytes
Total: 97 directories; 993 files; 32,363,948 bytes

### FIELD OF INVENTION

The present invention relates to strategic planning systems and methods and, more particularly, to automated systems and methods for interactively developing strategic plans and planning tools or documents.

### BACKGROUND

Strategic planning has long been a central aspect of business and other organizational development and operations. It has typically been a very time consuming, cumbersome, and expensive process, frequently requiring businesses or other organizations to hire consultants or specially trained employees to aid in developing and implementing a strategic plan.

In this regard, prior art strategic planning processes have typically been less than comprehensive, particularly for medium and small businesses or organizations. They typically are manual, piecemeal processes that require a great deal of time as well as expertise to implement and then manage. For example, many prior art strategic planning tools, such as guidelines or tools for generating mission and vision statements or determining competitive advantage, organization objectives, goals, scorecards, or strengths and weaknesses, have long been commonly available in individualized, disparate, and differing forms and via use of disparate procedures.

Certain aspects of prior art strategic planning processes have involved some level of automation. Some prior art strategic planning processes involve utilization of spreadsheet templates for gathering and organizing of possibly pertinent information for portions of the strategic planning process. Word processing applications are commonly utilized as well. These types of processes are far from holistic or comprehensive and require large amounts of time independent expertise to provide a meaningful strategic plan alone. Management of execution or modification of plans with such processes has presented yet additional layers of complexity, cost, and difficulty.

One important aspect of strategic planning is plan modification of the strategic plan as circumstances change. Prior art processes have been particularly weak in providing any modification of a strategic plan once it has been created, much less relatively quick, easy, and efficient, modification of a strategic plan.

As a result, it has long been the case that many, if not most, organizations never develop, much less implement or modify, a strategic plan. Many organizations have not been able to afford the historically large cost of doing so, particularly when in-house experts are not available. For many others, the time and resource consumption involved in developing a strategic plan has been too great for those involved in the business to develop, and then if possible manage implementation of, a strategic plan. For many organizations, particularly small organizations, the lack of access to any strategic planning expertise has also presented an insurmountable obstacle to engaging in strategic planning and management of plan implantation.

### BRIEF SUMMARY OF ASPECTS OF THE INVENTION AND VARIOUS EMBODIMENTS

The applicants have invented an automated strategic planning system and method (collectively “system”). In certain embodiments, the system is highly interactive and leads the user through a series of stages to develop a strategic plan and/or Manage execution or modification of a strategic plan. In certain embodiments, the system can automatically organize the user's responses to queries in order to provide strategic planning output or manage execution or modification of the plan. In certain embodiments, the plan comprises two portions, a “build your plan” portion and an “execute your plan” portion. In the “build your plan” portion, in some embodiments, goals determined at one hierarchical level, such as the top, e.g., corporate, level are used to create action items for the next, e.g., department level, and so on, down through the organization. At each (or at least some) levels, progress on the action items is tracked. The progress at the lowest, e.g., individual level for each (or some) individuals is then aggregated to create the next level (e.g., department) progress report, up through the organization. Thus, goals cascade downward, producing action items, where progress on the action items cascades up through the organization, producing progress reports.

Variously achievable advantages of certain embodiments include the following among others:

the resulting strategic plan can provide a dynamic documentation;

the user/planner need not have had training in strategic planning to generate, manage, and modify a complete strategic plan for an organization;

the user need not manage the implementation process as the system manages the process for the user.

Benefits of the system are:

economical, quick, and easy to understand and utilize;

provides relatively comprehensive strategic planning and related tools;

requires a short time, such as, e.g., one to two days, to create a strategic plan;

assists the organization in finding its competitive advantage or strengths and sharpening the focus of the organization;

aids managers and others thinking more strategically and less tactically;

provides boundaries to ensure purpose-driven action;

is customer driven to target and serve profitable customers;

cascades goals and actions down, e.g., three levels for multiple users of the plan;

provides managerial implementation and management of the plan execution; and

roll up levels, e.g., 3 levels of status of goals and actions during implementation.

Conventional strategic plans are typically internally focused whereas this embodiment of the System can be externally focused on the customer and marketplace.

Goals are written for each specific group. Thus goals are created to support the company's efforts in meeting the needs and preferences of specific customers.

Certain embodiments of the automated strategic planning system may be comprehensive, and others may be less so. Features that may be provided may include:

ubiquitous (or near-ubiquitous) availability of web-based strategic planning processes; and

market-focused strategic planning process that helps users develop a strategic plan based on the marketplace environment, customers, and competitors.

a balanced scorecard framework implemented throughout the plan;

a set of tools to build, monitor, measure, or modify the plan;

upgradeability through the web;

automatic transfer of information throughout the system and, if desired, implementation of changes automatically throughout the system;

a self-guided, do-it-yourself interface;

strategic plan generation in a number of, a given number of automated stages; some implementation allow strategic plan generation in, e.g., twelve automated stages;

SWOT (Strengths, Weaknesses, Opportunities, Threats) graph generation, which show attributes of the organization that are helpful (strengths) and harmful (weaknesses) to achieving an objective, as well as external attributes that are helpful (opportunities) and harmful (threat) with respect to the same objective.

content synthesis to provide understanding of the strategic planning process for the skilled or unskilled user; and

goal cascading occurring from the top user level to the bottom user level;

implementation of the plan through goal and action item status tracking;

performance management through a dynamic scorecard that automatically calculates the running total of key performance indicators against the established target;

visual representation of goals and actions items on a timeline chart; and

automated email alerts that are triggered on a periodic basis to let users know the status of their goals and action items.

The system allows for up to a predetermined number of different permission-based user levels, which enables the user to see the information about the plan that is relevant to their work only. Some implementations allow up to three different permission-based user levels.

Since the system is dynamic, the user can make revisions whenever new information is available. The new information is entered in the appropriate input field and pulled through to the various Reports.

The output reports provide an integration of the user's inputs made in the strategic planning process.

The automated strategic planning output for reporting, implementing, managing, or modifying the strategic plan may include output such as:

one or more Full Strategic Plans for viewing, understanding, or adapting the plan;

one or more Executive Summaries to provide a summary of the plan to boards and executives;

one or more Strategy Maps for illustrating the plan and how stages in the strategic planning process work with others stages to provide the plan;

one or more One-Page Plans that shows the plan on one page;

one or more SWOTs to assess and strengthen the organization, and to provide better fit between the organization's core competencies and environment;

one or more Scorecards to monitor implementation of the plan on a periodic basis;

one or more Financial Summaries for forecasting and for determining if the plan makes financial sense;

one or more Action Sheet Plans that provides a sortable summary of each tactic by, e.g., Responsible Person and Deadline;

one or more Plan Progress reports to monitor progress of goals and action items;

one or more Plan Performance charts to monitor performance of Goals and Key Performance Indicators;

one or more Plan Performance graphics to visualize performance of Goals and Key Performance Indicators; and

one or more Timelines to monitor start and end dates for goals and action items;

The above outputs are also provided for each of the, e.g., three user levels with a specific user level's data displayed.

In another aspect, embodiments of the present invention may also provide novel business methods, including: (i) providing the strategic planning application or components of it on a fee-for-use basis or other basis; or (ii) if desired, providing other services, such as on-line, telephonic, video-based, web-based, on on-site help or consulting services.

There are other aspects and advantages of the invention and/or the preferred embodiments. They will become apparent to those skilled in the art as this specification proceeds. In this regard, it is to be understood that not all such aspects or advantages need be achieved to fall within the scope of the present invention, nor need all issues in the prior art noted above be solved or addressed in order to fall within the scope of the present invention.

### BRIEF DESCRIPTION OF THE DRAWINGS

The preferred embodiment is shown in the accompanying drawings in which:

FIG. 1 shows the Welcome first page of (i.e., screen provided to the user by) the system when in operation.

FIG. 2 shows an overview of the stages in “Build Your Plan” tab for plan development.

FIG. 3 shows the left toolbar “View Plan Summary” under My Plan.

Plan Summary of the plan is viewable on the right side.

FIG. 4 shows the left toolbar “View Plan Progress” under My Plan.

Plan Progress of the plan is viewable on the right side.

FIG. 5 shows the left toolbar “More Info” under Plan Development Tools. More Information for each stage is viewable on the right side.

FIG. 6 shows the left toolbar “Examples” under Plan Development Tools. Examples for each stage are viewable on the right side.

FIG. 7 shows the left toolbar “Team Comments” under Plan Development Tools. Team Comments for each stage can be added and viewed on the right side.

FIG. 8 shows show a page that describes writing a company's mission statement. This is the first stage in “Build Your Plan”.

FIG. 9 shows a page that states the company's mission statement and effective criteria.

FIG. 10 shows a page that describes identifying a company's core values.

FIG. 11 shows a page that states the company's values statement and guidelines for values.

FIG. 12 shows a page that describes the process for assessing a company's Internal and External Environment, which yields a SWOT matrix diagram.

FIG. 13 shows a page that describes listing the company's Strengths that is the basis for developing the Internal Assessment section of the SWOT graphical output.

FIG. 14 shows a page that describes listing the company's Weaknesses that is the basis for developing the Internal Assessment section of the SWOT graphical output.

FIG. 15 shows a page that describes listing the company's Opportunities that is the basis for developing the External Assessment section of the SWOT graphical output.

FIG. 16 shows a page that describes listing the company's Threats that is the basis for developing the External Assessment section of the SWOT graphical output.

FIG. 17 shows SWOT matrix output.

FIG. 18 shows a page that describes identifying a company's competitive advantage.

FIG. 19 shows a page that describes writing the company's unique strengths.

FIG. 20 shows a page that describes writing the unique strengths of similar organizations.

FIG. 21 shows a page that describes what the company does best when compared to similar organizations.

FIG. 22 shows a page that states what the company does best and how to use its competitive advantage.

FIG. 23 shows a page that describes a leader's vision.

FIG. 24 shows a page that describes writing a leader's vision.

FIG. 25 shows a page that states the leader's vision.

FIG. 26 show a page that describes writing a company's vision statement.

FIG. 27 shows a page that states the company's vision statement and criteria for an effective vision statement.

FIG. 28 shows a page that describes writing a description of the company's vision statement.

FIG. 29 shows a page that states the company's vision statement and vision description.

FIG. 30 shows a page that describes writing ideas for implementation of the plan.

FIG. 31 shows a page that states the company's implementation plan.

FIG. 32 shows a page that describes organization-wide strategies.

FIG. 33 shows a page that describes writing organization-wide strategies.

FIG. 34 shows a page that states the company's organization-wide strategies.

FIG. 35 shows a page describing the process for writing strategic objectives in four key areas based upon the company's mission, vision, and competitive advantage.

FIG. 36 shows a page that describes writing Financial/Mission Strategic Objectives.

FIG. 37 shows a page that describes writing Customer/Constituent Strategic Objectives.

FIG. 38 shows a page that describes writing Internal/Operational Strategic Objectives.

FIG. 39 shows a page that describes writing People/Learning Strategic Objectives written in FIGS. 36 through 39.

FIG. 40 shows a page that summarizes all the company objectives in the four key areas.

FIG. 41 shows a page describing the process for writing goals to support the four key areas of strategic objectives written in FIGS. 36 through 39.

FIG. 42 shows a page that describes the goal-writing procedure or writing Financial/Mission Goals based on the strategic objectives.

FIG. 43 shows a page for identifying and describing customer groups for the company to target based upon its competitive advantage(s).

FIG. 44 shows a page for identifying and describing product, services and programs groups based upon its competitive advantage(s).

FIG. 45 shows a page for identifying and describing growth strategies based upon its competitive advantage(s).

FIG. 46 shows a page that summarizes Customer/Constituent groups, Products/Services/Programs groups and Strategies groups identified in FIGS. 43 through 45.

FIG. 47 shows a page, which describes the goal-writing procedure for Customer/Constituent Goals based on the related targeted group.

FIG. 48 shows a page that describes the goal-writing procedure for Internal/Operational Goals based on the related strategic objectives.

FIG. 49 shows a page that describes the goal-writing procedure for People/Learning Goals based on the related strategic objectives.

FIGS. 50 and 50A shows a page that summarizes all the company goals based on the strategic objectives in the four key areas.

FIG. 51 shows a page that begins the process for developing Action Items necessary to achieve the goals written in the page of FIG. 42 and FIG. 47 through 49.

FIG. 52 shows a page describing a detailed process for writing Customer/Constituent Action Items for each related goal.

FIG. 53 shows a page describing a detailed process for writing Internal/Operational Action Items for each related goal.

FIG. 54 shows a page describing a detailed process for writing Innovation/Learning Action Items for each related goal.

FIGS. 55 and 55A shows a page that summarizes Action Items written in FIG. 52 through 54.

FIG. 56 shows a page that describes Key Performance Indicators.

FIG. 57 shows a page that lists a company's goals, measures and targets to select the top Key Performance Indicators.

FIG. 58 shows a page that indicates the company's Key Performance Indicators.

FIG. 59 shows a page that introduces the initial discussion about performing a Financial Assessment of a user's strategic plan development.

FIG. 60 shows a page that discusses and provides a link to a Financial Projection worksheet.

FIGS. 61 and 61A shows a page of a Financial Projection worksheet.

FIGS. 62 and 62A shows a page for Tracking Progress for company goals, action items, and achievements. This page is the first tab under “Execute Your Plan” for plan implementation.

FIG. 62B shows a page for tracking the goals and action items 357.

FIG. 63 shows a page displaying a system output for Tracking Goals and Action Items as well as Achievements.

FIGS. 64, 64A, 64B, and 64C show a page for tracking Scorecard Performance of the company's Key Performance Indicators. FIG. 64A shows a page for tracking Scorecard Performance for all the company's goals.

FIG. 65 shows a page displaying a Timeline to track progress for goals and action items.

FIG. 66 shows a page that displays a system output Timeline in order to track progress for goals and action items.

FIG. 67 shows a page for Administration Settings of meeting dates and data collection.

FIG. 68 shows a page that lists, e.g., six outputs for the Corporate Plan Reports. This page is the first tab under “Reports”.

FIGS. 69, 69A, 69B, 69C, 69D, 69E, 69F, 69G, 69H, and 69I show pages and output for the Corporate Report-Full Strategic Plan with date.

FIGS. 70, 70A, 70B, 70C, and 70D show pages and output for the Corporate Report-Executive Summary with date.

FIG. 71 shows a page and output for the Corporate Report-Strategy

Map.

FIGS. 72 and 72A shows pages and output for the Corporate Report-One-Page Plan.

FIG. 73 shows a page and output for the Corporate Report SWOT.

FIG. 74 shows a page and output for the Corporate Report Scorecard.

FIG. 75 shows a page that lists the seven outputs for the Department Plan Reports.

FIGS. 76, 76A, 76B, 76C, and 76D show pages and output for the Department Report-Full Strategic Plan with date.

FIGS. 77, 77A and 77B show pages and output for the Department Report-Executive Summary with date.

FIG. 78 shows a page and output for the Department Report-Strategy

Map.

FIG. 79 shows a page and output for the Department Report-One-Page Plan.

FIG. 80 shows a page and output for the Department Report-Scorecard.

FIG. 81 shows a page and output for the Department Report-Action

Sheet.

FIG. 82 shows a page that lists the, e.g., two outputs for the Team Member Plan Reports.

FIG. 83 shows a page and outputs for the Team Member Report-Action Sheet.

FIG. 84 shows a page and output for the Team Member Report-One-Page Plan. This concludes the outputs under the “Reports” tab described in FIGS. 68 through 84.

FIGS. 85, 85A, 85B, and 85C show a page for Plan Administration to set up departments, active members and inactive members. This is the first tab under “Accounts”.

FIG. 86 shows a page for Company Information and login access.

FIG. 87 shows a page for Account Information.

FIG. 88 shows a page to upload a company logo.

FIG. 89 shows a page to change user name and password. This concludes the information under the “Accounts tab described in FIGS. 85 through 89.

FIG. 90 shows a layout of the entire Strategic Plan development and execution. It shows stages for “Build Your Plan” and “Execute Your Plan”. It also shows the Report Outputs.

FIG. 91 shows an exemplary embodiment with three levels, specifically the Corporate Plan, Department Plan and Team Member Plan for “Building Your Plan.” It displays the downward flow of information and the permission structure at each level.

FIG. 92 shows the Strategic Planning System with the “Build Your Plan” stages for an exemplary embodiment of FIG. 91, specifically the Corporate Plan, Department Plan and Team Member Plan. It displays the downward cascading of the action items.

FIG. 93 shows the three levels of the exemplary embodiment of FIG. 91, specifically the Team Member Plan, Department Plan and Corporate Plan for “Executing Your Plan.” It displays the upward flow of information and the execution pieces at each level.

FIG. 94 is a flow diagram of an exemplary process flow in conjunction with which described embodiments can be implemented.

FIG. 95 is an operational flow diagram in conjunction with which described embodiments of a method of building a strategic plan can be implemented.

FIG. 96 is an operational flow diagram showing data flow between different levels of a strategic plan.

FIG. 96A shows four exemplary areas of interest that any or all of the portions of the plan may be divided into.

FIG. 97 is an operational flow diagram in conjunction with which described embodiments of a method of executing a strategic plan can be implemented.

FIG. 97A shows an exemplary implementation of executing a plan.

FIG. 98 is a functional block diagram illustrating an embodiment of an example strategic plan structure.

FIG. 99 is an operational flow diagram in conjunction with which described embodiments of a method of formulating goals can be implemented.

FIG. 100 is an operational flow diagram in conjunction with which described embodiments of using goals to create a plan can be implemented.

FIG. 101 is an operational flow diagram in conjunction with which described embodiments of tracking progress of a plan can be implemented.

FIG. 102 is a block diagram illustrating an exemplary computing environment for implementing the strategic plan systems and methods as taught herein.

### DETAILED DESCRIPTION OF THE PREFERRED EMBODIMENTS

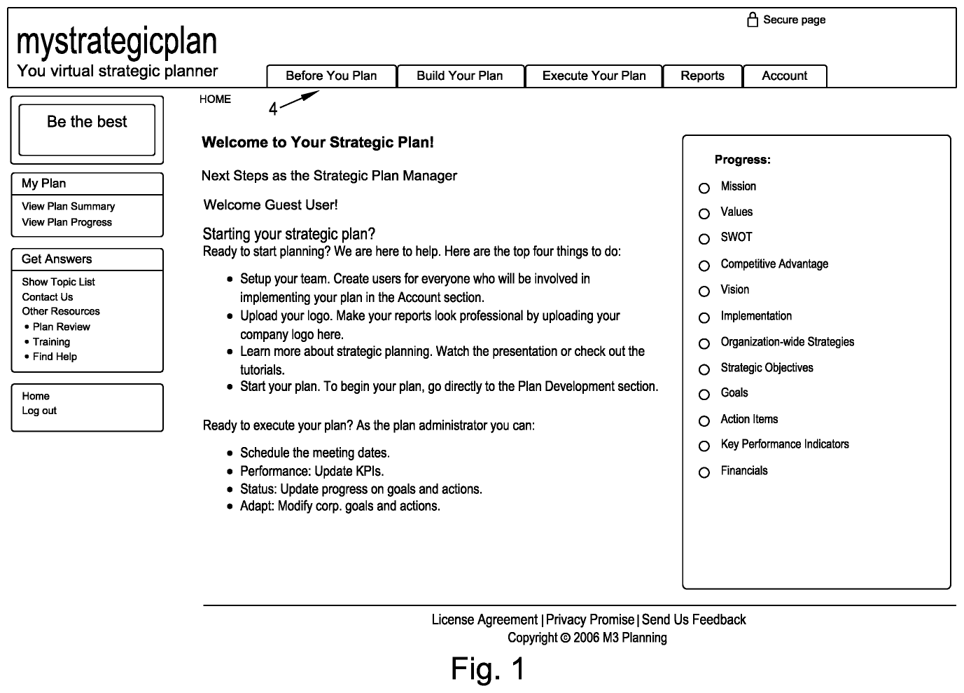

In the following discussion, a page and group of output described above as consisting of a main Figure and sub-Figure A, B, C, D, E, F and/or G, are often identified by the first Figure number. For example, the page collectively shown in FIGS. 1 and 1A is referenced as “the page of FIG. 1” or “FIG. 1”.

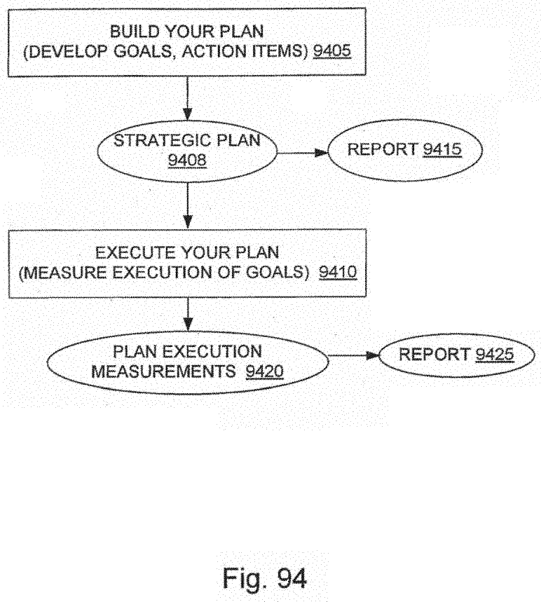

FIG. 94 shows an overview of exemplary embodiments that can be used to build and execute a strategic plan. At process block 9405, a strategic plan for an organization is built, resulting in a strategic plan 9408. A strategic plan may provide a business with the roadmap it needs to pursue a specific strategic direction and set of performance goals, deliver customer value, and be successful. This strategic plan, ideally, allows an organization to see the “big picture” of where it is going and then allows the organization to formulate goals and action items, both for the organization as a whole, for individual members of the organization, and for organization levels (such as departments) in between. Strategic plans are valuable for organizations both large and small for the simple reason that it is difficult to travel somewhere when you don't know where you are going. A user may access the plan at various stages as shown throughout the specification, etc., by using a web-based browser, with the plan at its various stages of completion being stored at a location separate from the specific computer that the user uses to access the plan. In such a system, Microsoft Explorer 6.0 or above can be used to establish a connection to website associated with the strategic plan. Firefox 2.0 and above may also be used, as may other web browsers.

Specifically, organizations with a strategic plan may gain greater focus, buy-on from team members, as they understand the underlying reason for corporate behaviors, better use of resources, and so on. Examples of organizations that might use such a strategic plan are, e.g., entrepreneurs whose companies have less than 150 employees. Certain implementations of the embodiments taught herein might have special features specifically for such entrepreneurs.

Organizations with 150 employees or greater might also use such a strategic plan. Certain implementations of the embodiments taught herein might have special features specifically for such entrepreneurs. Nonprofits looking for a self-guided strategic planning process might also use such a strategic plan. Certain implementations may be customized to the nonprofit strategic planning processes, complete with examples and guidelines relevant to developing a strategy for an organization that is mission-driven.

Churches that want to strategically focus their activities might also be interested in such a strategic plan. Certain implementations may be customized to provide a self-guided, cost-effective process, to help church personnel effectively build a plan to fulfill a church's mission and vision.

The strategic planning software can be:
Self-directed. Users are guided through practical stages, resulting in a strategic plan.
Web-based. In certain implementations, there is no need to download software.
Dynamic. The system allows users to easily build, monitor and revise their plans.
Integrated. The system produces a comprehensive strategic plan.
Interactive. The strategic plan is easily updatable.
Purpose-driven. The process of creating a strategic plan, as well as the plan itself, can provide meaning to organizational activities.
Industry relevant. Examples are provided specific to the type of organization.
Report heavy. Many reports are available to help build, execute, and monitor the strategic plan.
Market-driven. Users are focused to develop a comprehensive understanding of their marketplace.

Reports 9415 can be generated from the plan 9408. At process block 9410, the strategic plan is executed. Plan execution creates plan execution measurements 9420. Reports 9425 can then be generated from the measurements that show, for example, progress towards goals generated when the strategic plan 9408 was built. This allows a business to, e.g., measure how much progress is being made towards implementation of the strategic plan.

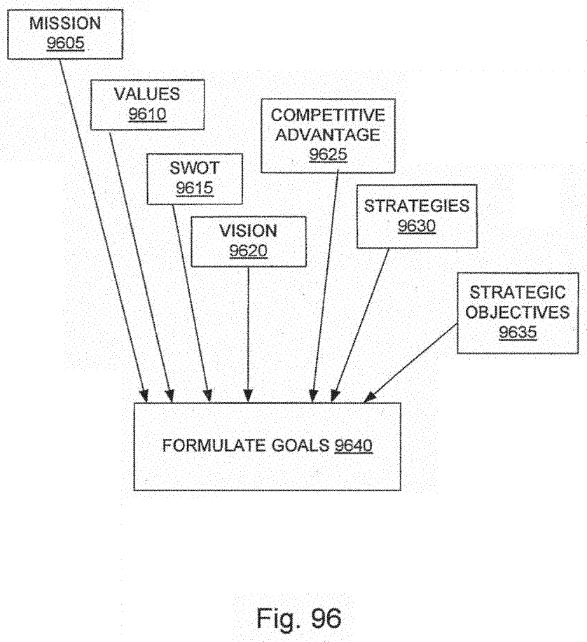

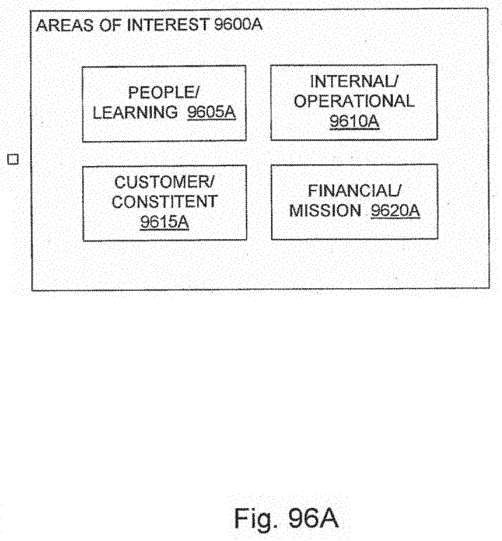

FIG. 96A shows four exemplary areas of interest 9600A that any or all of the portions of the plan may be divided into. They are: financial/mission 9605A, customer/constituent 9610A, internal/operational 9615A, and people/learning 9620A.

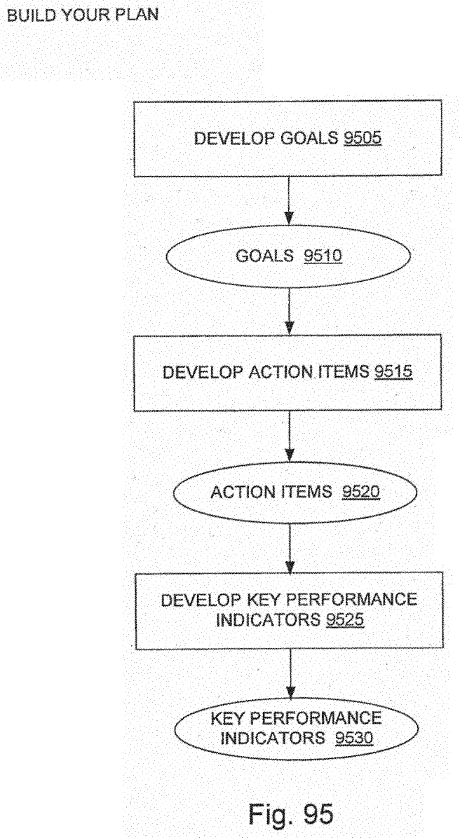

Turning to FIG. 95, an exemplary method for building a plan (such as shown in FIG. 94 at 9405) is shown. At 9505, a user is taken through a process which allows the user to develop goals for an organization (or smaller unit within the organization), leading to a set of goals 9510. Using the goals 9510, at 9515, the user can then develop performance measures that can be used to determine progress towards the goals—action items 9520. Using the goals 9510, and/or the action items 9520, a user can then develop key performance indicators 9525, leading to a specific set of key performance indicators 9530, which can be used to track progress.

FIG. 96 shows an exemplary method to formulate goals, such as the goals 9510 shown in FIG. 95. Gathering information from many areas of interest to a company (of whatever size) results in a much more objective, comprehensive picture of what sort of realistic goals can be set by the company. The list of possible inputs shown within FIG. 96 is not meant to be comprehensive, but is intended to give an idea of the sorts of issues a company should consider when formulating goals 9940. Similarly, the list of possible outputs is also not meant to be comprehensive, but is also intended to give an idea of the areas in which a company may formulate goals.

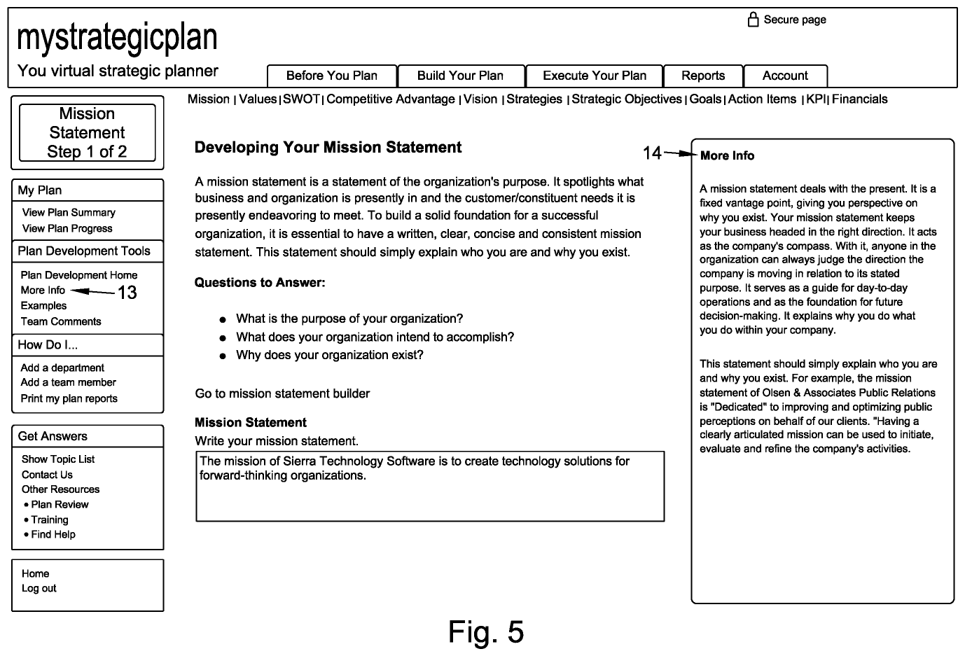

At process block 9605, a company may develop or further refine a Mission statement—a concise statement of what the organization is, and why it exists. An exemplary implementation is described with reference to FIGS. 5-9.

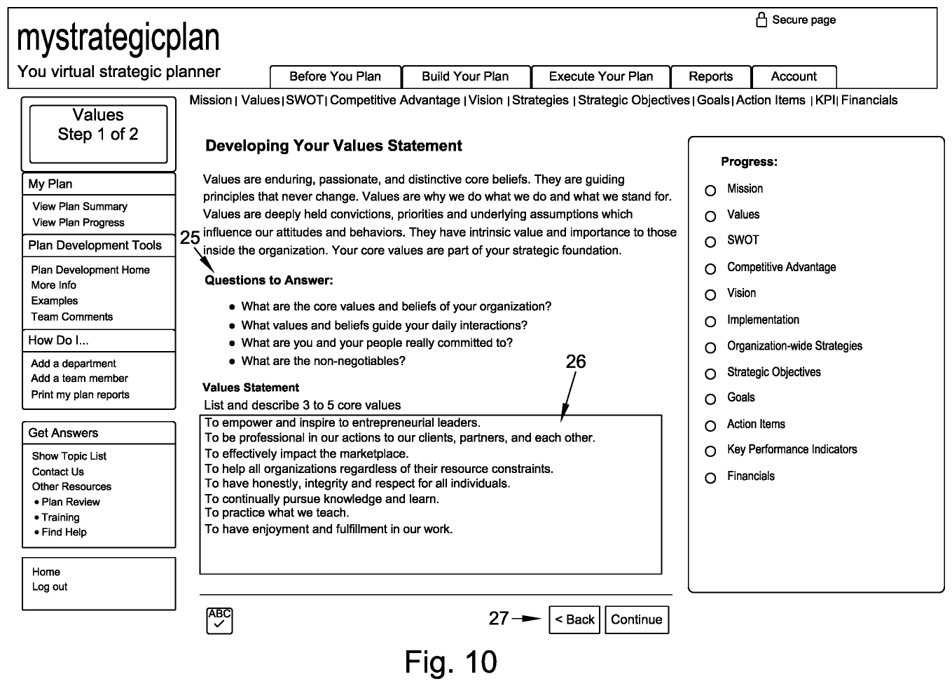

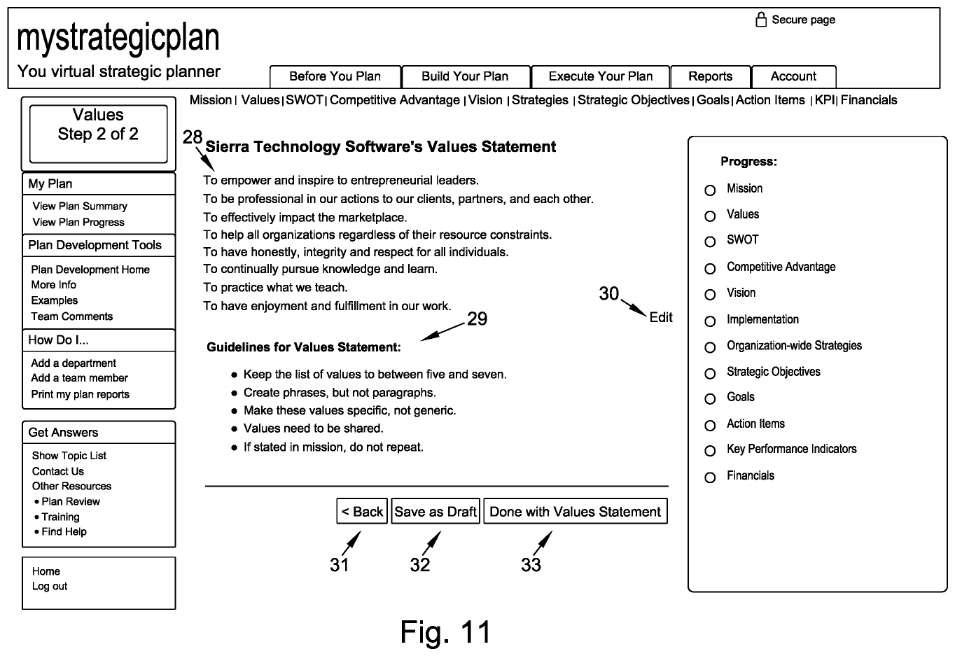

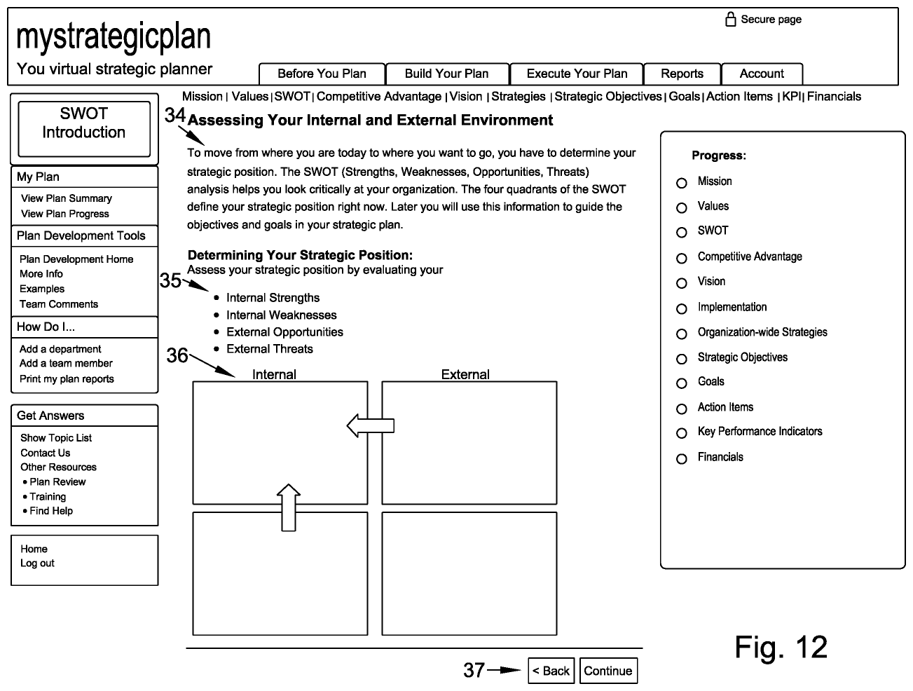

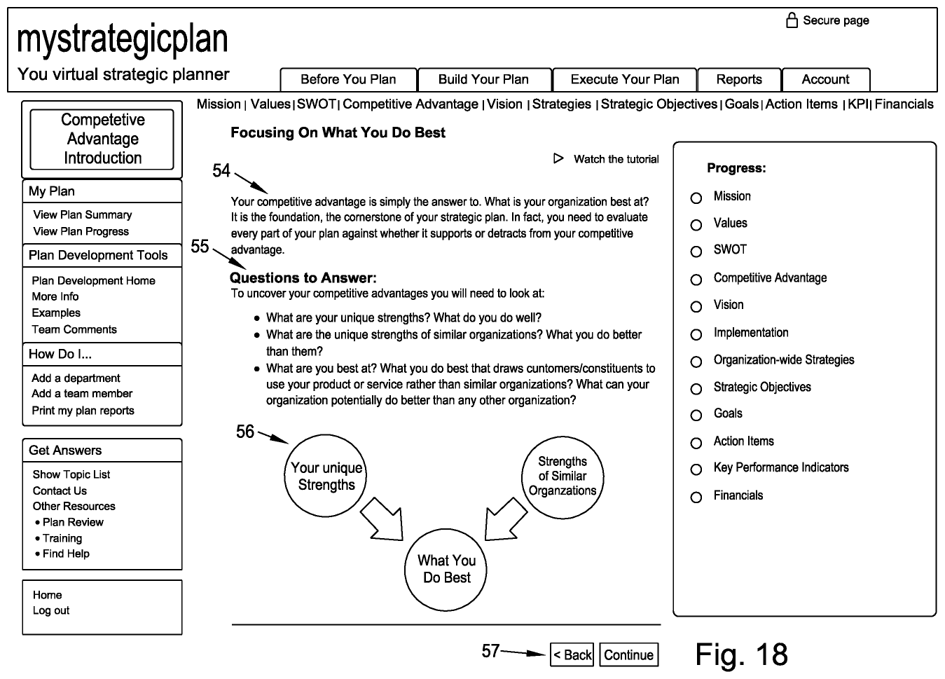

At process block 9610, a company may develop or refine a value statement. Values may be considered enduring, passionate, distinctive and/or non-negotiable core beliefs. An exemplary implementation to input a values statement is described with reference to FIGS. 10 and 11. At process block 9615, a company may perform a SWOT (Strength, Weaknesses, Opportunity, Threat) analysis. An exemplary implementation to perform such an analysis is described with reference to FIGS. 12 through 17. At process block 9625, an organization may determine what it is best at; i.e., its competitive advantage. An exemplary implementation to determine such an advantage is described with reference to FIGS. 18 to 22.

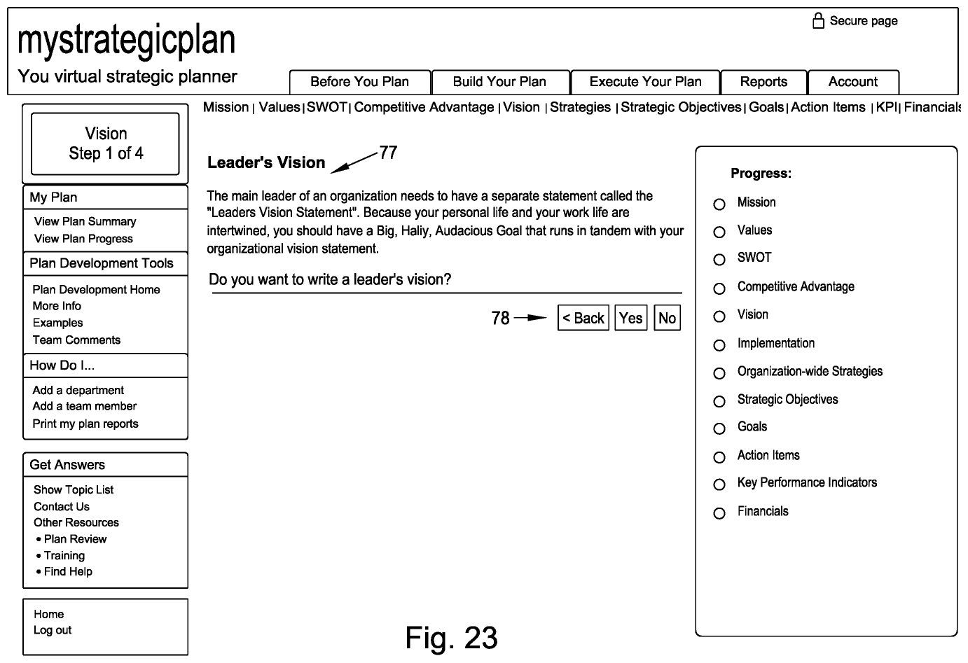

At process block 9620, one or more vision statements may be determined. Certain embodiments allow, e.g., separate organization and leader vision statements. An exemplary implementation to determine vision statements is described with reference to FIGS. 23 to 29.

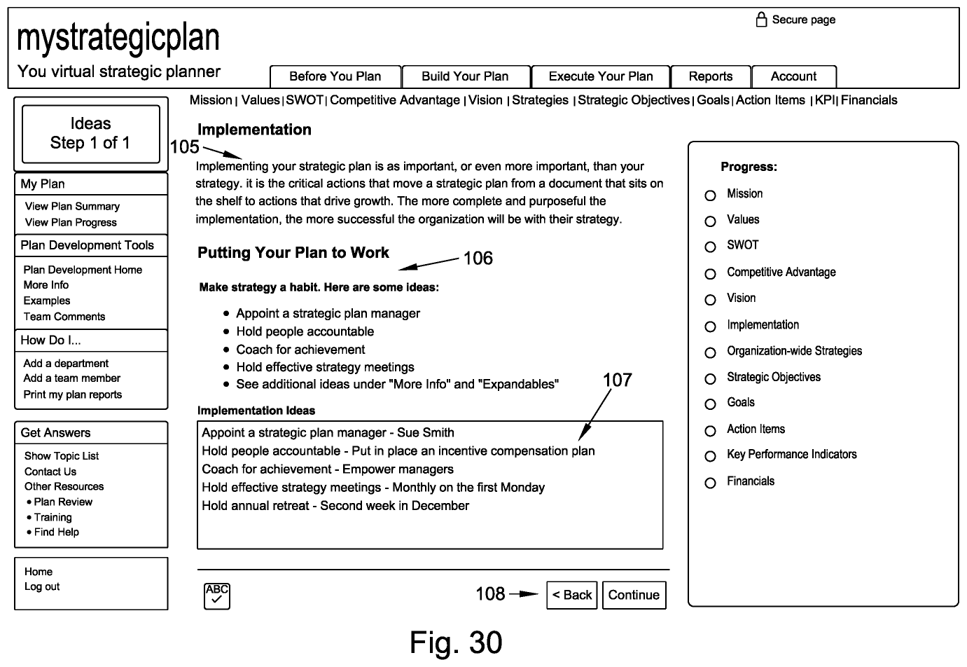

At process block 9630, strategies may be crafted. Strategies are long-term activities an organization may pursue to achieve its vision. Certain embodiments also suggest or have a user determine implementations-concrete stages to put such strategies into work. An exemplary implementation to craft and, potentially, implement, strategies is described with reference to FIGS. 30 to 34. In some embodiments, strategies may be crafted for one or more of the exemplary areas of interest 9600A.

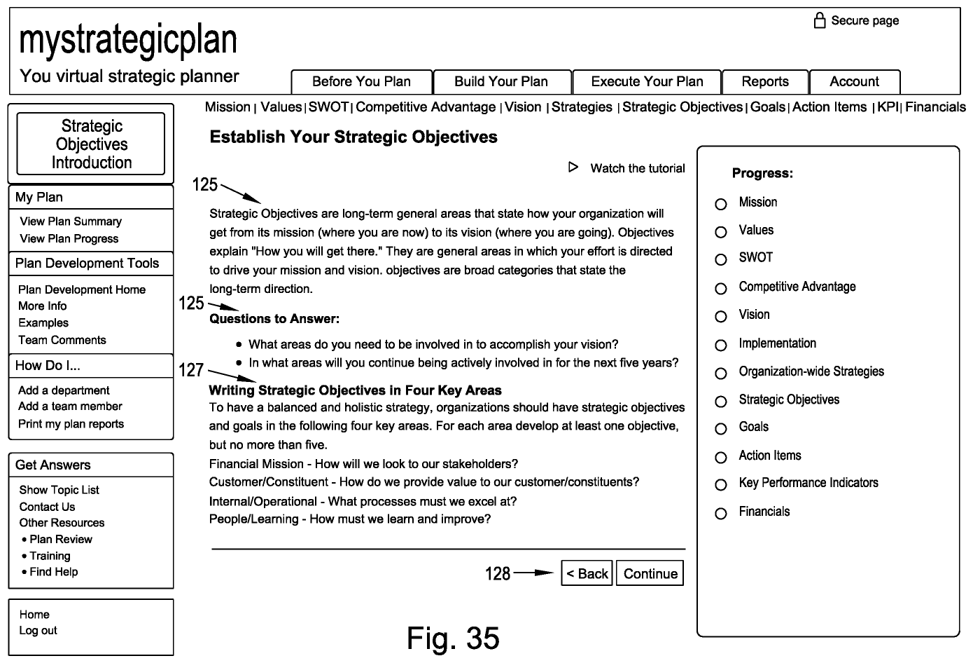

At process block 9635, strategic objectives may be established. Strategic objectives are long-term general areas that, e.g., state how an organization will get from its mission (where the organization is now) to its vision (where the organization is going.) Certain embodiments also suggest concrete stages to put such strategies into work. An exemplary implementation to establish strategic objectives is described with reference to FIGS. 35 to 40. In some embodiments, strategic objectives may be crafted for one or more of the exemplary areas of interest 9600A.

At process block 9640, goals are formulated. These goals may be used to convert the organizations mission, 9605, values 9610, vision 9620, etc., into performance targets, which may be measurable performance targets. Further, these goals may be determined for one or more of the exemplary areas of interest 9600A

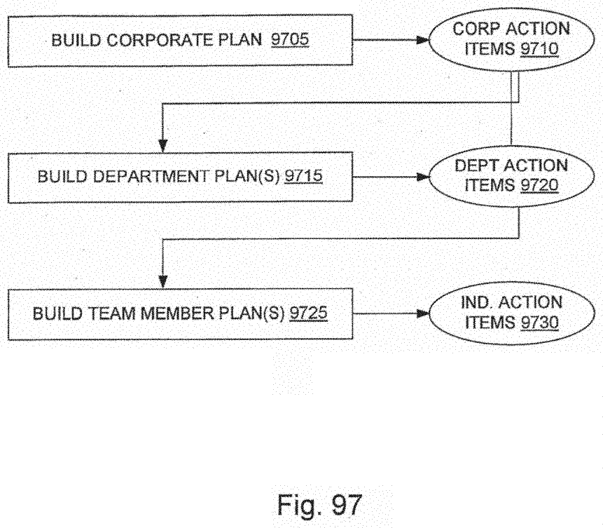

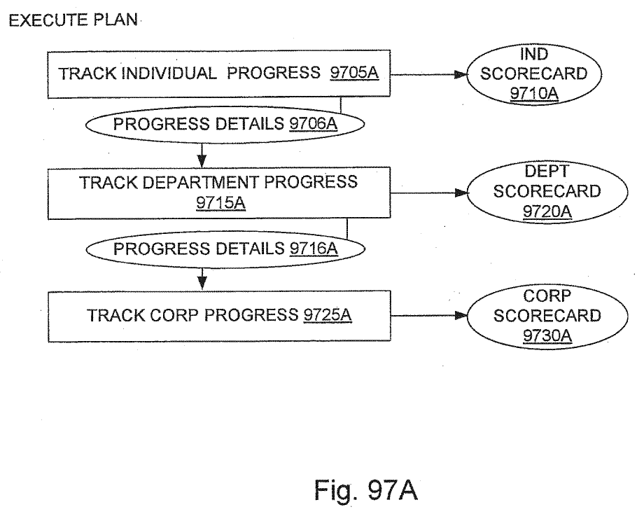

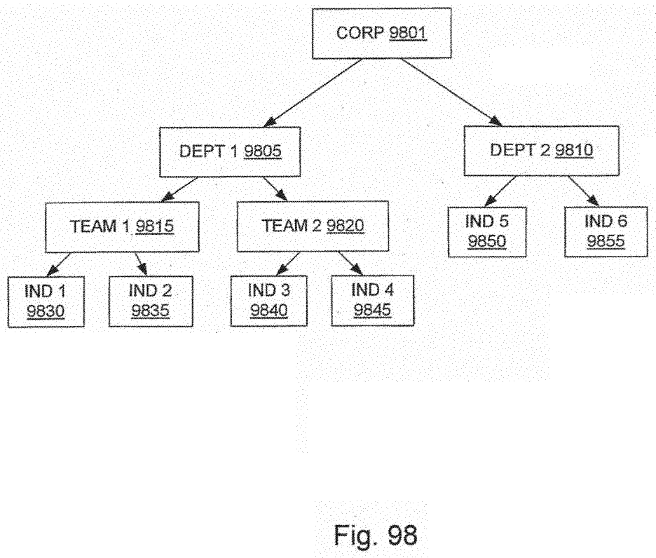

Turning to FIG. 97, an exemplary method for executing a plan (such as shown in FIG. 904 at 9410) is shown. Businesses may be organized at different levels of hierarchical depth. An exemplary business, for example, may have three levels: corporate, departmental, and individual. This structure is used in many of the examples below for convenience, but is not limiting. Another exemplary business which could have a strategic plan built is shown in FIG. 98 and may comprise, e.g., four levels: Corp 9801, Department level 9805, 9810, Team level 9815, 9820, and individual level 9830-9855. Other structure depths are also envisioned but not presented to save time and paper.

When an organization comprises more than one hierarchical level, as, for example, shown with reference to FIG. 98, information, such as, e.g., goal and action item information, flows down from higher to lower levels. In an exemplary embodiment with three levels, separate plans may be built at each (or some) of the levels, and at each (or some) of the organization units within the levels. For example, at 9705, a corporate plan is built. This may be built such as shown in FIG. 95. The corporate plan may include goals and action items 9710 associated with the corporation. These action items 9710 may then be used to help build the plans (which includes goals and action items) for the next organizational level down 9715, in this case, a department. Some organizations may be divided into multiple departments, in which case some or all of the departments could build plans, each with information from the corporate plan being incorporated. In some embodiments, the corporate action items may then become the department goals, with no modification. The departments, in such a case, would then use the goals defined at the corporate level to develop their own action items. Building the department plan generates department action items 9720. The department action items are then used to build plans (which comprise, e.g., individual goals and individual action items) for members of the department 9725. In some embodiments, the department action items are used as member goals, with no modifications. These goals, then, in turn, are used to generate individual action items 9730.

Turning to FIG. 97A, an exemplary implementation executing a plan (such as shown with reference to 9410 in FIG. 94) is shown. At 9705A, the progress of a single individual is tracked. This tracking may comprise determining how an individual has performed with reference to individual action items (e.g., 9730 in FIG. 97) developed for an individual (e.g., team member) plan 9725 (FIG. 97). An individual scorecard 9710A may also be generated. Progress details 9706A for one or more individuals in the parent hierarchy (e.g., a department) may then flow upward (i.e., be aggregated in some fashion) to track the department progress 9715A. The individual action items may be averaged per action item, or may be otherwise statistically examined to determine a department progress. For example, a running average may be made of progress over time, and so on. Other items may also go into determining department progress. A department scorecard 9720A may also be generated. The department progress details 9716A may then be combined, averaged, etc., (optionally, with other information) to track progress at the corporation level 9725A. A corporation scorecard 9730A may also be generated which comprises, at least in part, the department scorecards.

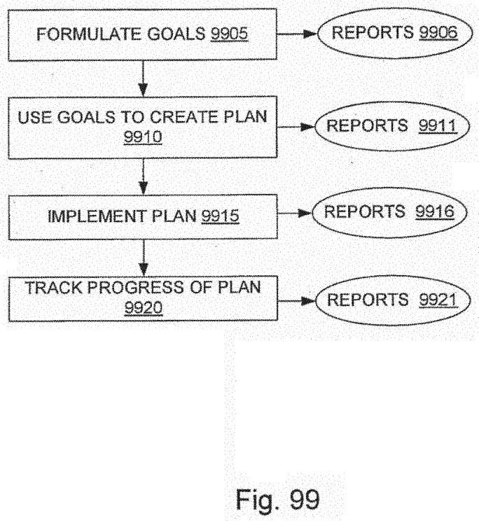

FIG. 99 describes another implementation of strategic plan system and methods. At 9905, goals are formulated. Reports 9906 may also be generated based at least in part on the formulated goals. At 9910, the goals are used to create a strategic plan 9910. Reports 9911 may also be generated. At 9915, the plan is implemented. Reports 9916 may also be generated. At 9920, the progress of the plan is tracked. Reports 9921 may also be generated.

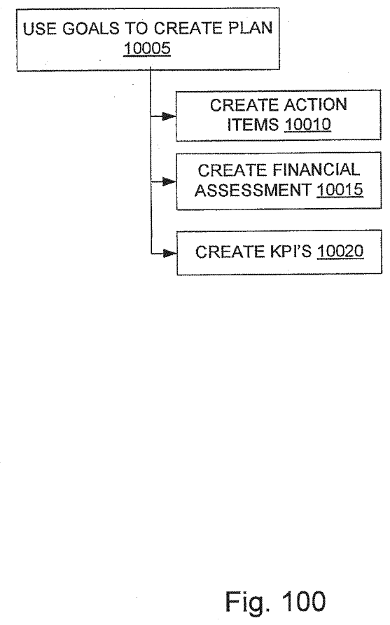

FIG. 100 describes an embodiment that uses goals to create a plan 10005 (such as shown at 9910 in FIG. 99.) At 10010, using goals, such as the goals formulated with reference to FIG. 96, action items are created. At 10015, a financial assessment is formulated. This financial assessment may help determine the financial viability of the strategic plan. A financial plan may be created for one or more of the areas of interest 9600A, and/or a single financial plan may be created, encompassing them all.

At 10020, one or more key performance indicators (KPIs) may be created. These KPI's may be created for one or more of the areas of interest 9600A, and/or a single KPI may be created encompassing them all.

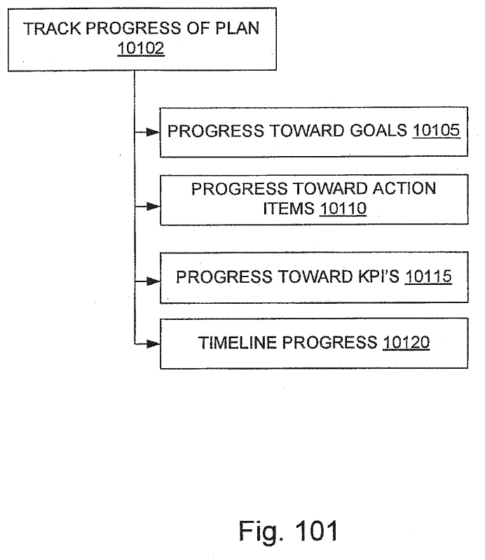

FIG. 101 shows an exemplary embodiment to track progress of a plan, such as shown at 9920 in FIG. 99. At 10105, the progress towards one or more goals is tracked. At 10110, progress towards one or more action items is tracked. At 10115, progress towards one or more KPI's is tracked. At 10120, progress towards a timeline (which may be set up in conjunction with goals, action items, KPIs, etc.) is tracked. Reports (not shown) can be generated to show progress of any or all of the individual plan items such as the goals 10105, action items 10110, KPI's 10115, and timeline 10120, at various stages.

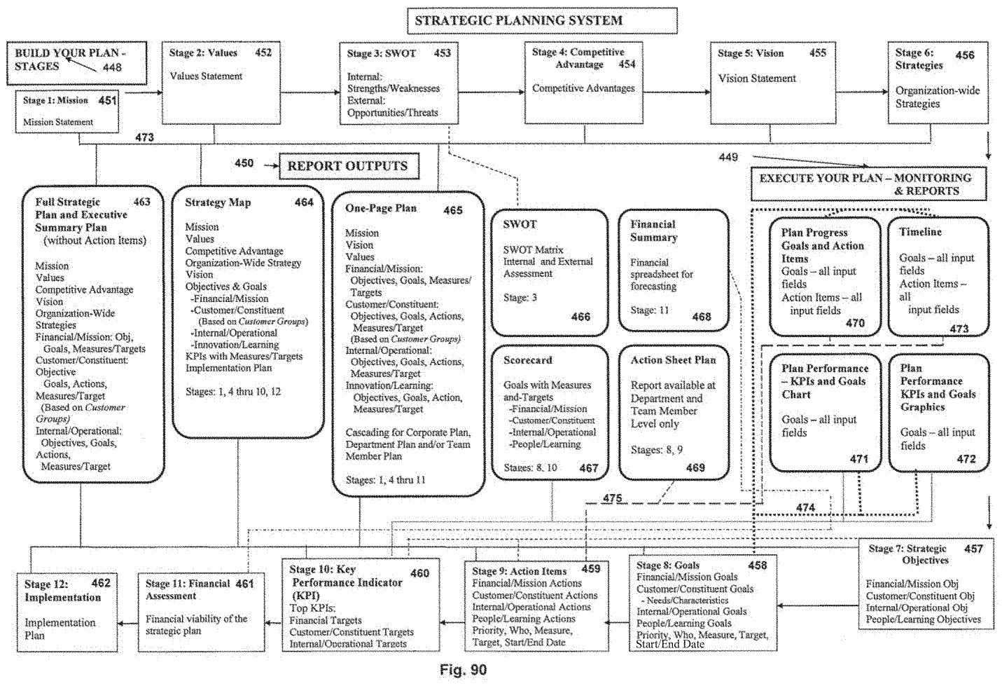

FIG. 90 shows the layout of one embodiment of the Strategic Plan system. This embodiment of the Strategic Plan system is composed of, e.g., two parts: the Build you Plan process blocks 448, and the Execute Your Plan process blocks 449. The Build your plan process blocks 448 show, e.g., twelve separate stages. It is not necessary, however, in some embodiments, for a user to proceed through the system in an orderly fashion. Different stages can be filled in at different times.

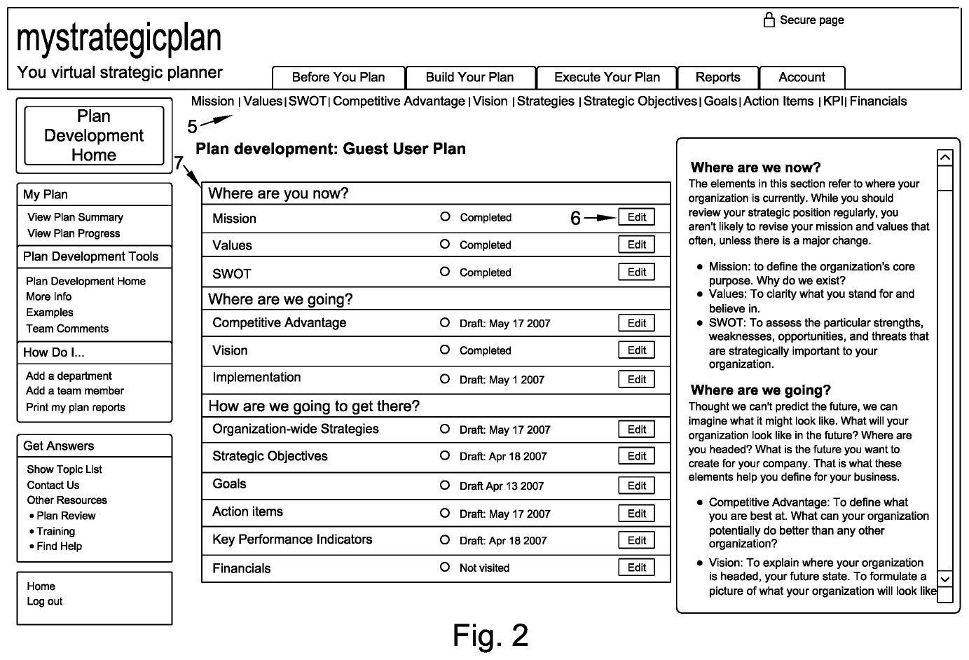

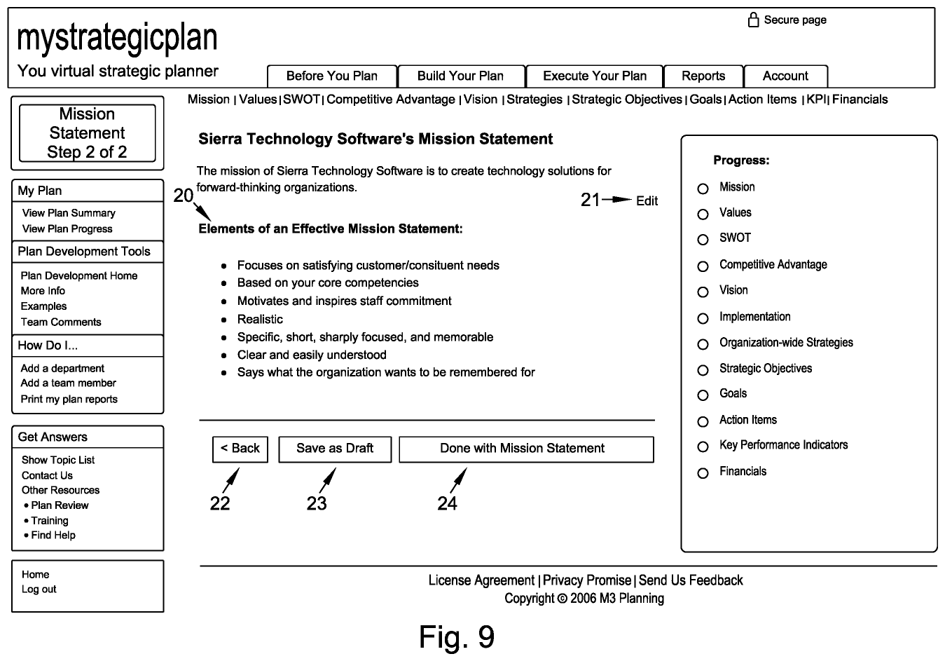

With continuing reference to FIG. 90, and also shown with reference to FIG. 2, when the user completes a particular stage, it can be revisited by clicking on the stage name in the top toolbar 5 (FIG. 2) or on the “edit” button 6 (FIG. 2) to the right of the name of the stage. The user can edit any input at any time, as the system is dynamic. To save the revisions, the user may click on, for example FIG. 9, the “Save as Draft” button 23 (shown in FIG. 9) or “Done with (name of stage)” button 24 (FIG. 9) located at the bottom of each stage input page. The user may also click on the “Back” button 22 (FIG. 9) to view the previous page.

FIG. 1 shows the first page of the system—the “Welcome” page. This page provides the basic instructions to begin the strategic planning process. This page does not have an input function, but rather it provides helpful information for the user to navigate and manage the strategic plan. In certain embodiments, the user gains access to this page after visiting a system provider's web-site and purchasing access to the system or otherwise purchasing a version of the system that may run on the user's system.

As shown in FIG. 1, the user can select any of the e.g., five tabs from the top toolbar 4. The tabs are as follows: “Before You Plan,” which has organizational assessments that can provide insightful information in developing the strategic plan; “Build Your Plan” which has the stages for developing the plan; “Execute Your Plan” which has a process for implementing the plan; “Report” which has output summaries that are populated automatically as the user progresses through the process; and “Account” which has information to setup the plan, such as user name, password and log.

FIG. 2 shows a summary page that shows the progress the user has made in the strategic planning process. The top toolbar 5 lists, in some embodiments each (or most of) the stages that should be completed to develop a strategic plan. The stages, e.g., are: Mission, Values, SWOT (Strengths, Weaknesses, Opportunities, and Threats analysis), Competitive Advantage, Vision, Strategies, Strategic Objectives, Goals, Action Items, KPI, and Financials. The user can click on a stage in the toolbar to travel to that stage's page.

At the end of a stage, the user is taken to this summary page which displays Plan Progress 7. The stages may be categorized in three general categories: Where we are Now; Where are we going; and How we are going to get there. Each stage, itself, is divided into separate sections. The stage Where we are Now may comprise the sections Mission, Values, and SWOT. The stage Where are we going may comprise the sections Competitive Advantage, Vision, and Implementation. The stage How we are going to get there may comprise the sections Organization-wide Strategies; Strategic Objectives, Goals, Action Items, Key Performance Indicators and Financials. Other intermediate progress is also marked using, e.g., an icon 7a. This icon may represent a light, or may have a different shape. If the stage has not been visited, the, e.g., light icon 7a is displayed with a specific color or pattern, such as a gray tone. If the stage was partially completed by clicking the, e.g., “Save as Draft” button 23 as in FIG. 9, then the light icon 7a changes a partially-completed color, such as yellow. If the stage was completed by clicking “Done with (name of stage)” button 24 as in FIG. 9, then light icon 7a changes to a fully-completed color or pattern, such as green.

FIG. 90 provides an overview of the entire system and the interrelationship of the respective stages in the process and the outputs that can be developed. “Build Your Plan” stages 1 through 12 in the Strategic Plan system 448 are depicted in white boxes that do not have a bold border. The Strategic Plan “Report Outputs” 450 are shown in the center of the page with in medium gray boxes with bold borders. “Execute Your Plan” monitoring functions in the Strategic Plan system 449 are depicted in dark gray boxes with bold boarders.

As shown in FIG. 90, the stages depicted include components of each stage within the body. For example, process block Strategic Objectives 457 is composed of, e.g., Financial/Mission Objectives, Customer/Constituent Objectives and Internal/Operational Objectives, and People/Learning Objectives. Other embodiments may have different elements. The information from this stage, in some embodiments, then flows into stage 8: Goals 458. The transition is illustrated by an arrow. In this stage, the user develops Goals in areas of interest, such as those shown with reference to FIG. 96A. This embodiment has the areas of interest Financial/Mission Goals, Customer/Constituent Goals based on customer needs and characteristics, Internal/Operational Goals and People/Learning Goals. For a goal, the user identifies at least some of: one or more priorities, who is responsible, how the goal is measured, target, start date and end date. The user can, as desired, proceed through the system recording inputs as appropriate in each stage. The Build Your Plan stages are described in the pages of the specification associates with FIGS. 5 through 61A.

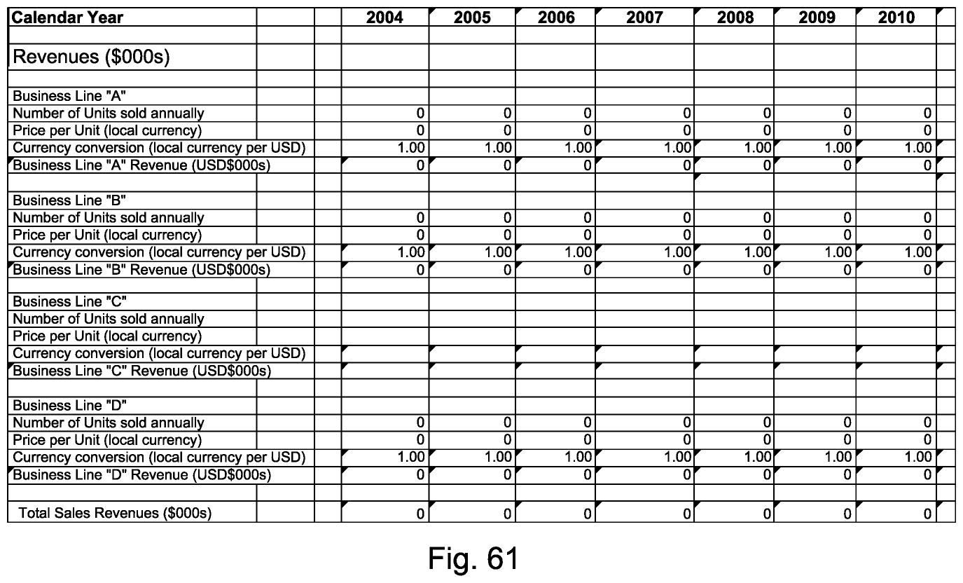

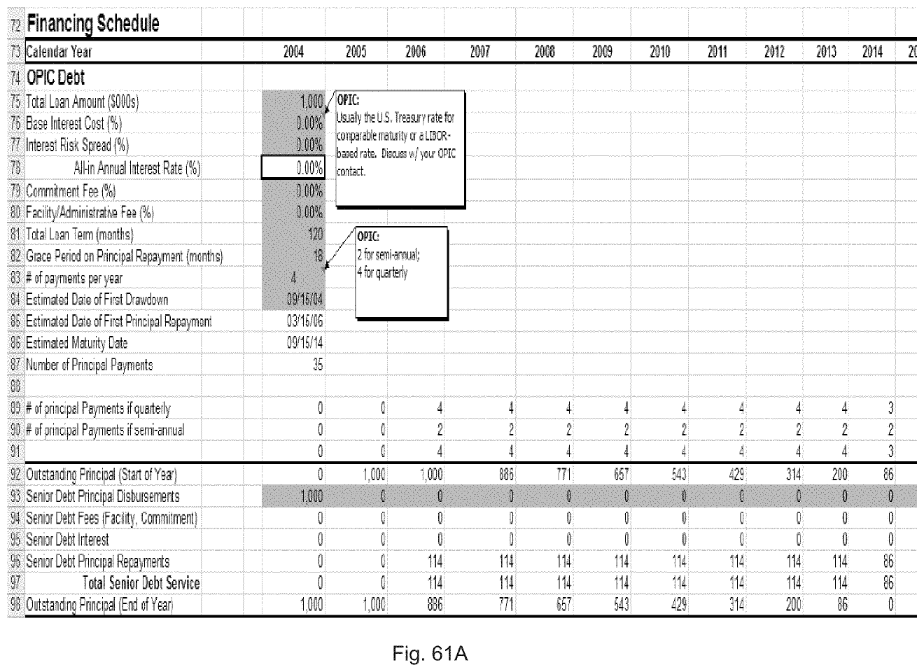

As shown in FIG. 90, another feature of the system is illustrated by the Strategic Plan Report Outputs 450. The Plan outputs are described in the pages referencing FIGS. 68 through 84, 61, 61A, 63, 64B, 64C, and 66. FIG. 90 also highlights the interconnectedness of the system. For example, the Full Strategic Plan 463 is, e.g., composed of Mission, Values, Competitive Advantage, Vision, Organization-wide Strategies, Strategic Objectives, Goals, Action Items with Measures and Targets, and Implementation. These items take as inputs information provided by a user that are accumulated and integrated from, e.g., stages 1, 2, 4-10 and 12. A solid line 473 connects the appropriate stages to Full Strategic Plans summary, which indicates the necessary inputs for this output. The Executive Summary 463 is composed of similar inputs as the Full Strategic Plan, but without the Action Items. The Strategy Map 464 is composed of similar inputs as the Full Strategic Plan. The One-Page Plan 465 is composed of similar inputs as the Full Strategic Plan.

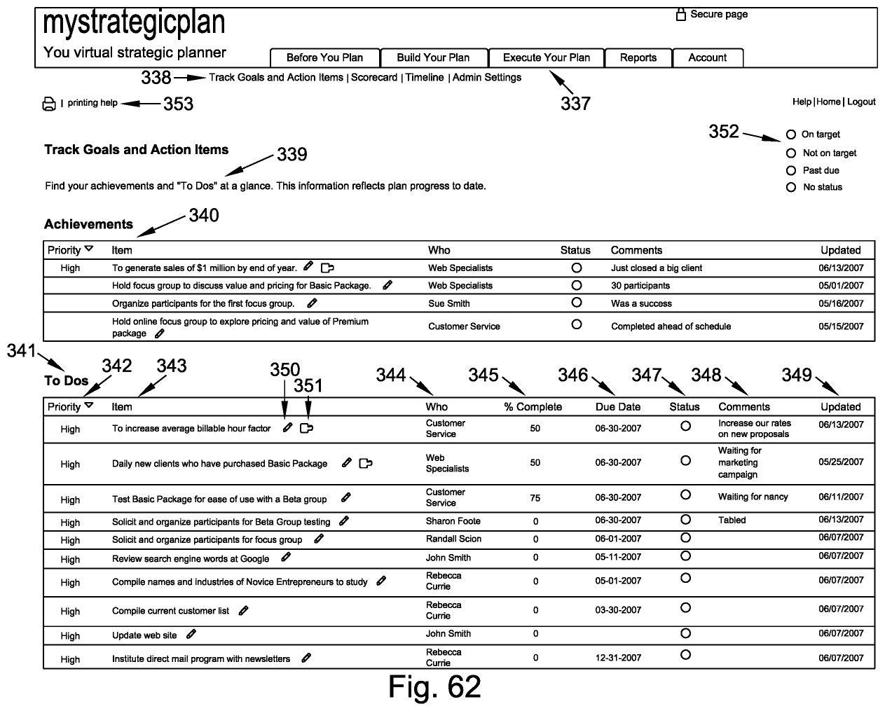

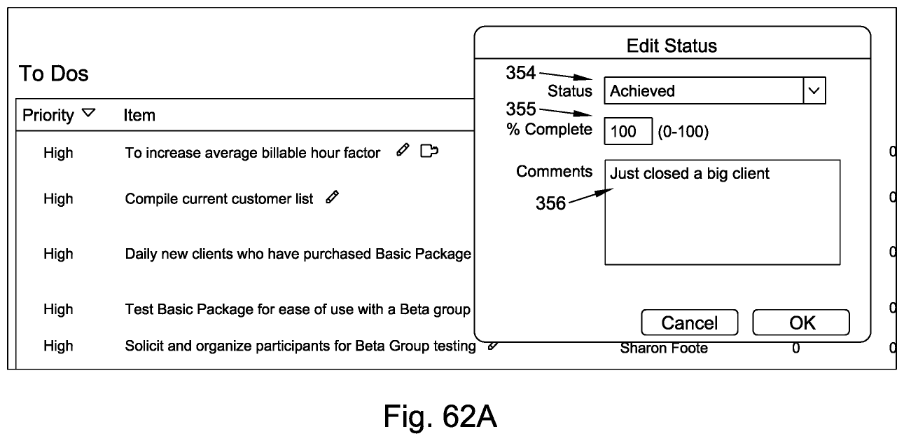

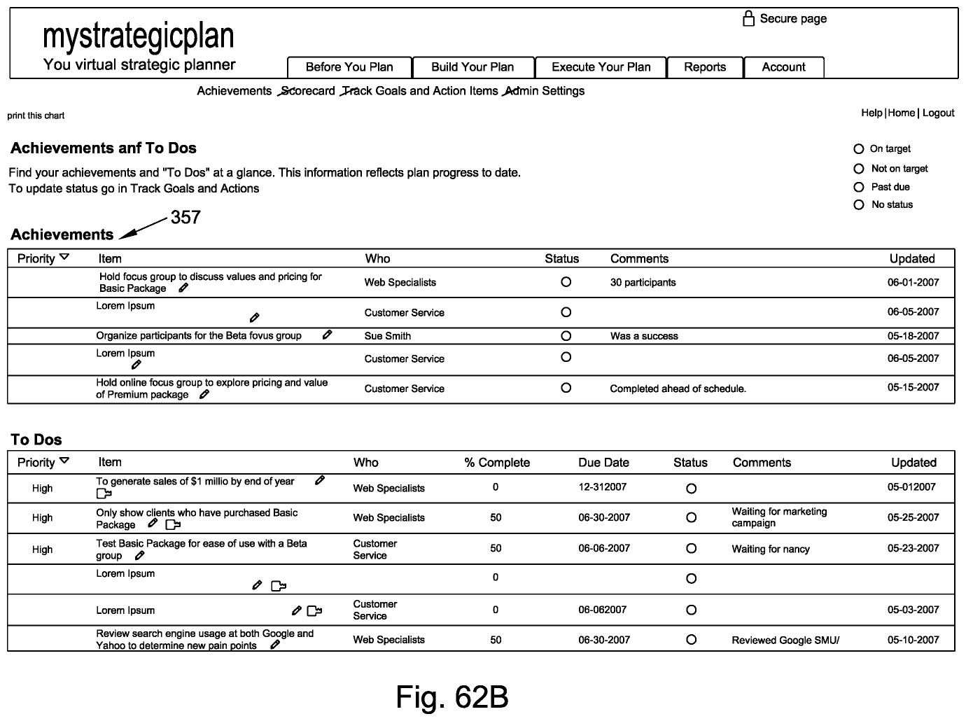

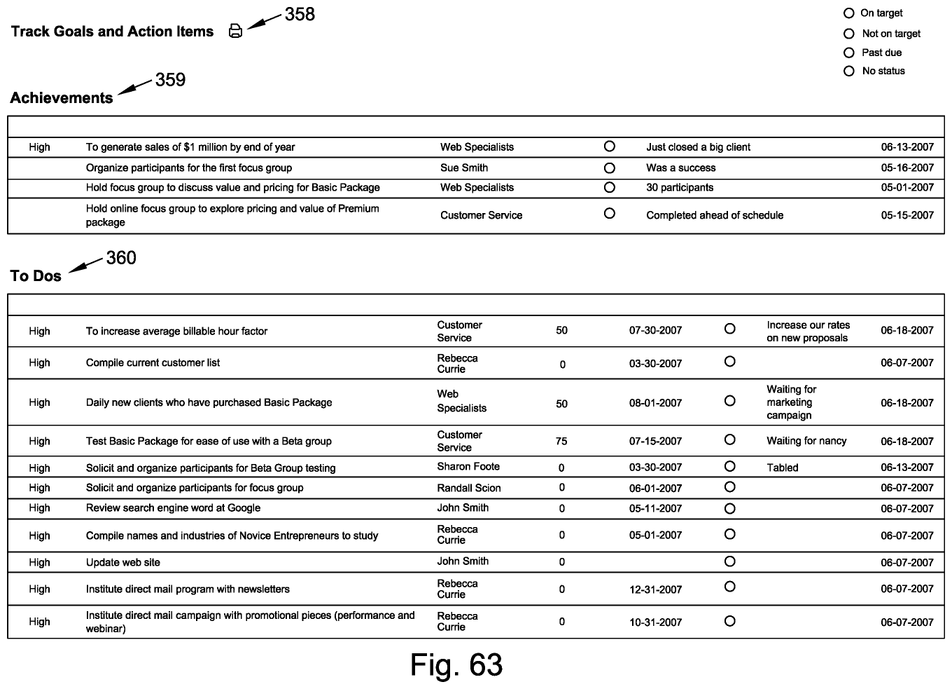

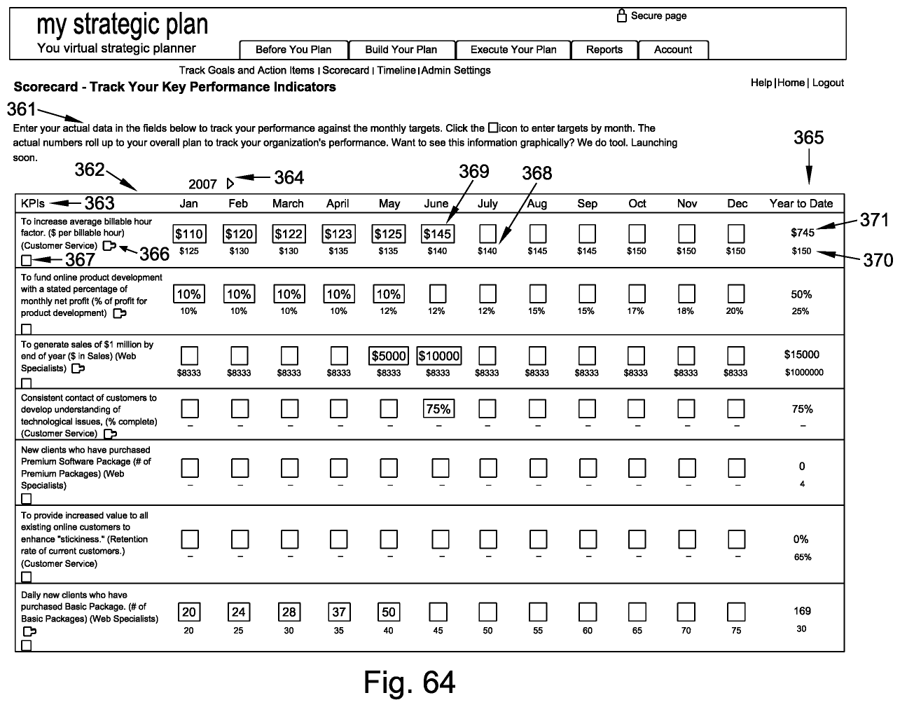

Another feature of the system is the ability to monitor progress and track performance. The “Execute Your Plan” 449 is both for tracking and reporting purposes. The Executing outputs are described in the Specification with reference to FIGS. 62 through 66. Again the interconnectedness of the system is highlighted by this page. For example, Plan Progress 470 is composed of Goals and Action Items that are accumulated and integrated from stages 8 and 9. A dotted line 474 and 475 connects the appropriate stages to the box for the Plan Progress 470. A Report Output is generated as shown on the page of FIG. 63.

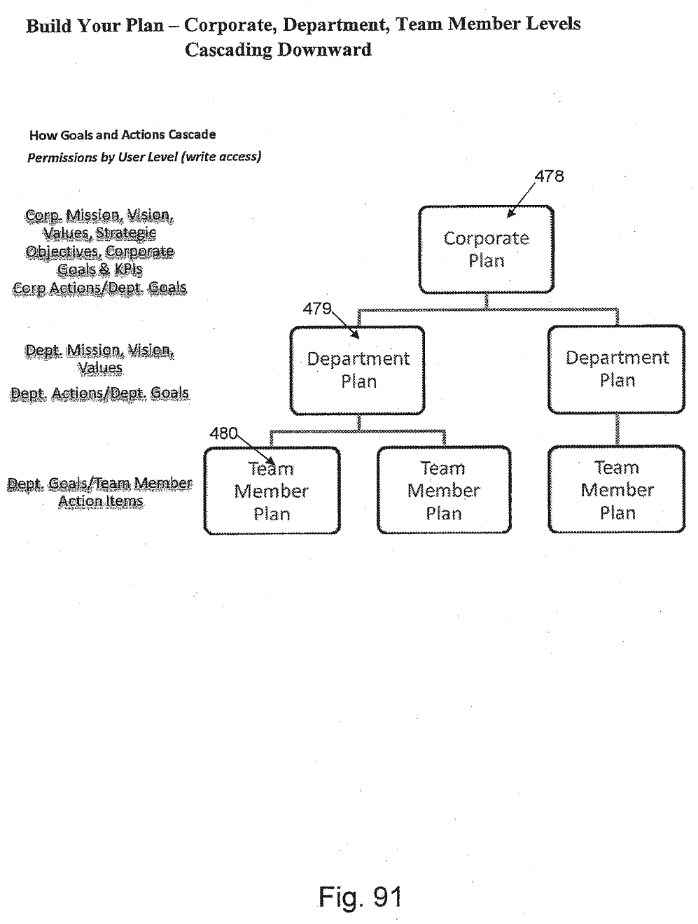

As shown in FIG. 91, another feature is the ability of the Strategic Plan system to cascade information downward through different levels. The described embodiment shows three levels, but other implementations may have more, or fewer. As shown, information flows, for example, from the Corporate Plan 478 to Department Plans 479, and from there to the Team Member Plans 480. Certain items in the lower hierarchical stages may be determined by values that have been given for items in upper levels of the hierarchy, and so, in some systems, may not be modifiable by those that otherwise would have write access to those levels. Other systems may still have information from higher levels used to determine values for lower levels, but may still allow users to then modify the resulting values.

For example, a user may be granted permission to modify information across an entire level, such as “Corporate plan 478.” A different user may be granted permission to modify a specific instantiation of a level. For example, two department plans 479A, 479B are shown as children of the initial Corporate plan 478. A user could receive permission to modify (e.g., write access) a single department plan 479A, or could receive permission to modify all plans at a specific hierarchical depth, e.g., all department plans 479A, 479B. In the embodiment illustrated in FIG. 91, information from upper levels determines certain values in lower levels with the expectation that users will not be able to change such values, or at least need special permission to do so. For example, a user with write access to the Corporate Plan 478, in the illustrated embodiment, has full write access 481 to the following items of the corporate plan: corporate mission, vision and values; strategic objectives; corporate goals and KPIs; and corporate action items. Portions of these items are then used to help determine department goals for Department Plan 479A and 479B. A user with write access to Department Plan 479A or 479B may have write access 482 to the following portions of the Department plan: department mission, vision, and values; and department actions. Portions of these then are used to help determine team member goals within Team Member plans. A user with writer access to a Team Member Plan may have write access 483 to Team. Member Goals and/or Team Member Action Items. As many departments and team members as needed can be added to the corporate plan.

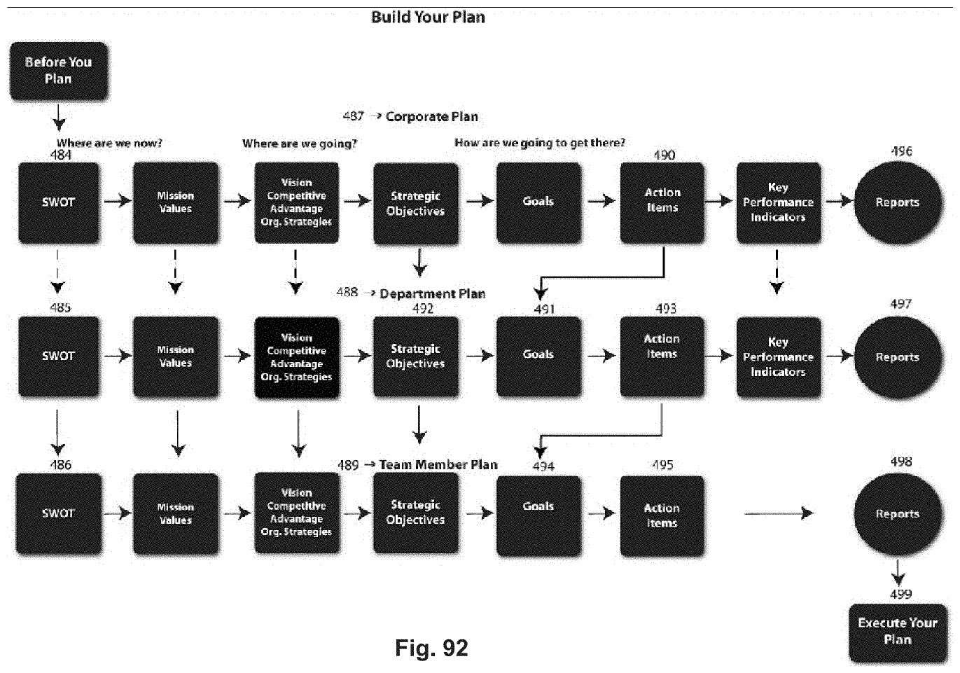

As shown in FIG. 92, another feature is the ability of the Strategic Plan system to cascade information downward through different hierarchical levels. The stages for the Corporate Plan 484, Department Plan 485 and Team Member Plan 486 are the stages described in FIG. 90, references 451 through 462. The plan that is developed in the Corporate Plan 487 flows down to the Department Plan 488 and then to the Team Member Plan 489, as the action items for one level are used to help generate the goals for the next level down.

As shown in FIG. 92, the levels may have different write access permission levels for each of the stages. Permission by user level with write access in the illustrated embodiment is as follows: Corporate Plan has full write access 484 to the corporate SWOT, mission, values, vision competitive advantage, implementation, strategic objectives; goals, action items and KPIs. The corporate action items 490 become, in part, the department goals 491. Department Plan has write access (in some implementations) 485 to the department SWOT, mission, values, vision competitive advantage, implementation, action items and KPIs. The Department Plan has limited write access to the strategic objectives 492 and goals 491. The department action items 493 are used to generate the Team Member Plan goals 494. Team Member Plan has write access to the team member action items 495. The Team Member Plan has limited write access to the SWOT, mission, values, vision competitive advantage, implementation, strategic objectives; and goals. The department action items 493 are used to determine the Team Member Plan goals 494. Reports are generated for level, reference 496, 497, and 498 to “Execute the Plan” 499.

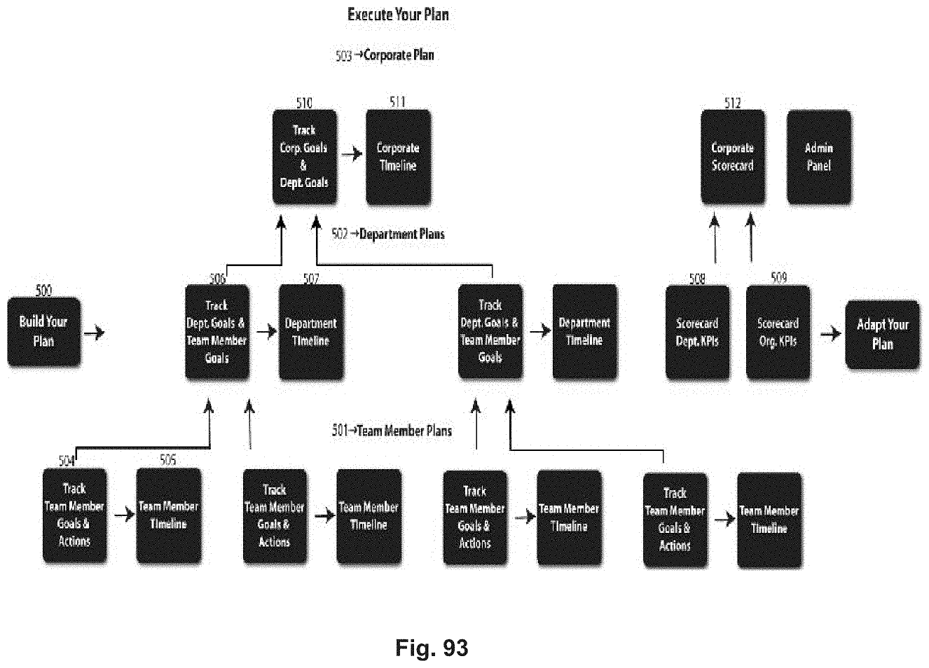

As shown in FIG. 93, the Strategic Plan system cascades information upward from level to level. Information entered at the Corporate, Department, and Team Member level in “Build Your Plan” 500 is tracked and monitored in executing the plan at the corresponding Team Member Plan 501, Department Plan 502 and Corporate Plan 503 levels. Team Members track their progress for individual goals and action item 504. Their progress numbers are reported upwards to the department 506 and corporate 510. The team members can view their individual goals and action items in a timeline 505.

With continuing reference to FIG. 93, departments can track their progress for goals and action item 506. Their numbers are reported upwards to Corporate 510. Departments can view their goals and actions in a timeline 507. Departments can track their performance for Department KPIs 508 and Corporate KPIs 509. Both their progress and performance numbers are reported upwards to corporate.

As shown in FIG. 93 Corporate can track their progress for goals and action items 510. Corporate can view their goals and actions in a timeline 511. Corporate can track their performance for Corporate Key Performance Indicators (KPIs) 512.

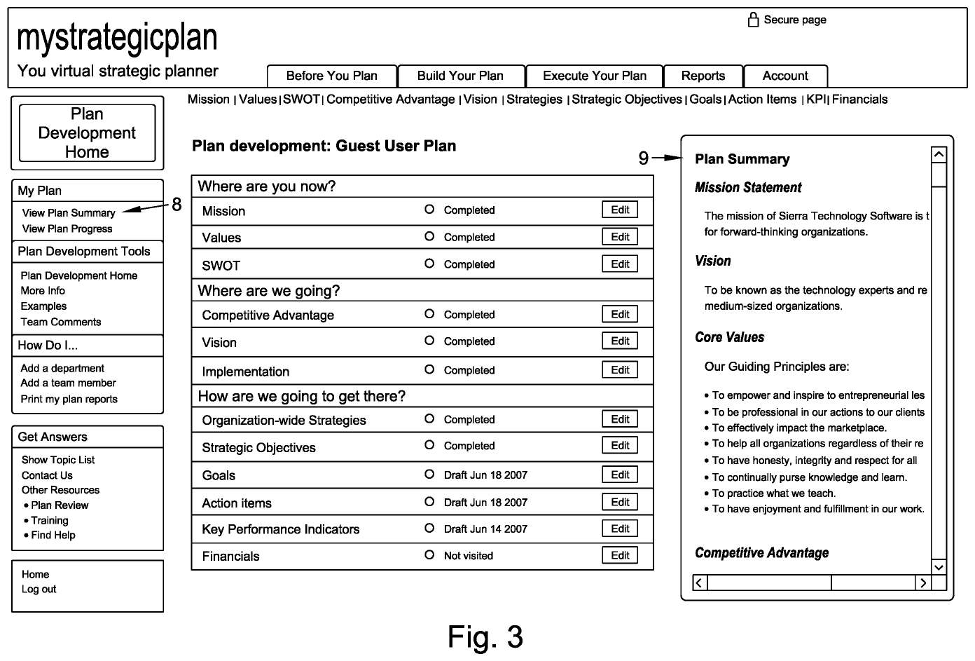

Another feature of the system may be a Plan Summary, as shown in FIG. 3, which allows a user to quickly view the current plan. The plan summary can be viewed during a stage by clicking “View Plan Summary” 8 under the My Plan section located on the left toolbar. The Plan Summary displays, e.g., in the right iframe box 9.

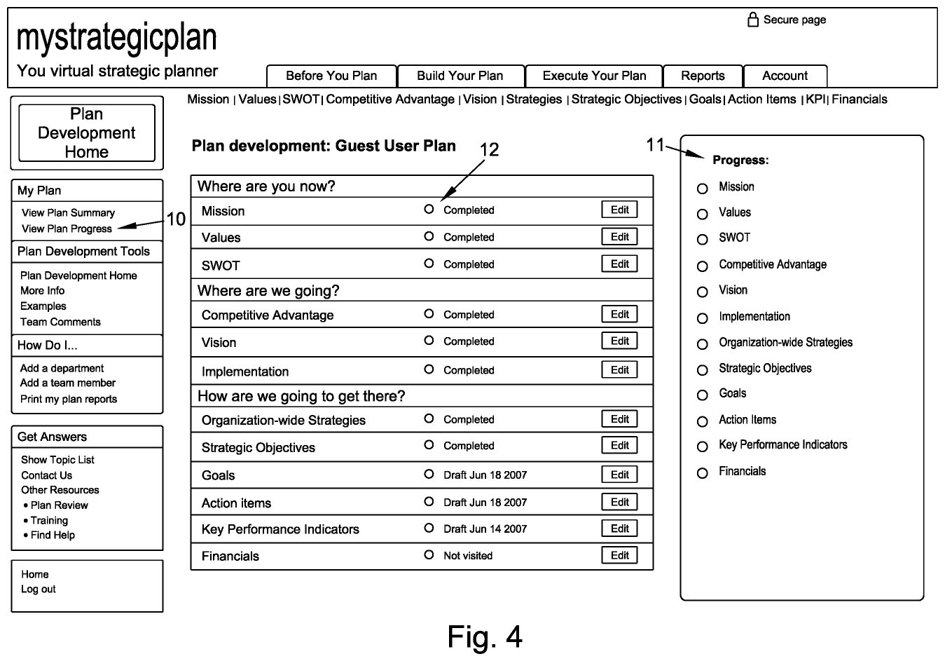

Another feature of the system may be Plan Progress, as shown in FIG. 4, which allows user to quickly see an up-to-date progress summary of strategic planning work accomplished. The plan progress can be viewed by clicking “View Plan Progress” 10 under the My Plan section located, e.g., on the left toolbar. In some implementations, the Plan Progress displays in a right iframe box 11. Progress icons 12A (e.g., lights) display user progress toward completing a plan. Initially the progress icon 12A displays in a neutral color, such as grey. When a draft has been completed for an item, such as by, e.g., clicking “Save as Draft” button 23 (FIG. 9), then the icon 12A changes color to, e.g., yellow. If the item was completed by, e.g., clicking “Done with (name of stage)” button 24 (FIG. 9), then icon changes to a “completed” color, such as, e.g., green.

Another feature of the system may be the “More Info” option, as shown in FIG. 5. More information for each stage and within each stage can be viewed by clicking “More Info” 13 under Plan Development tools, located, in some embodiments, on the left toolbar. More Info displays in the right iframe box 14 that is relevant to the stage.

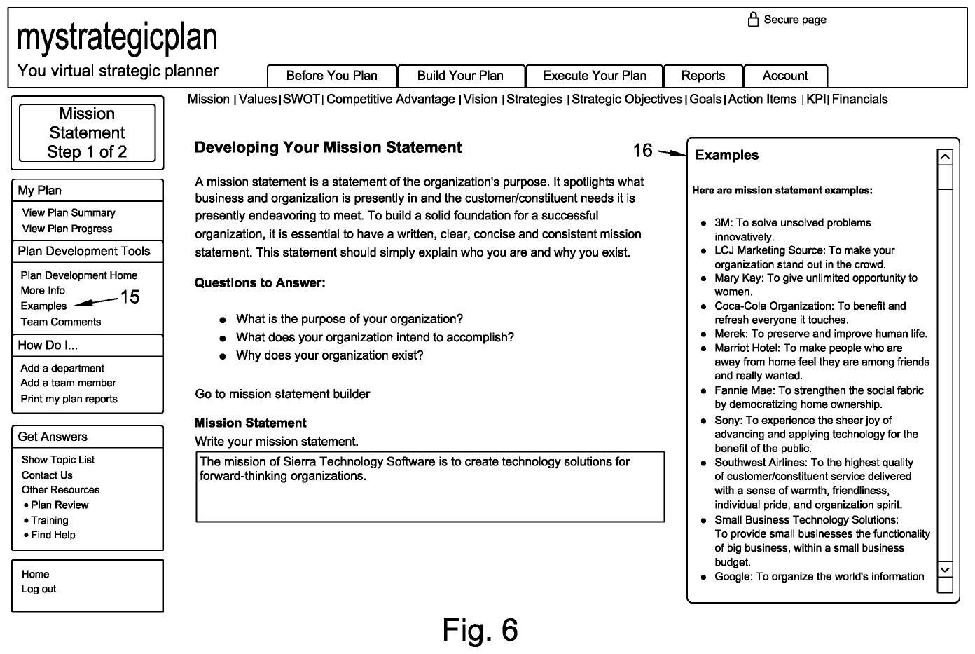

Another feature of the system may be “Examples” as shown in FIG. 6. Relevant examples for each stage can be viewed by clicking “Examples” 15 under Plan Development tools located on the left toolbar. Examples display in the right iframe box 16 that are relevant to the stage, which helps the user in developing their own plan.

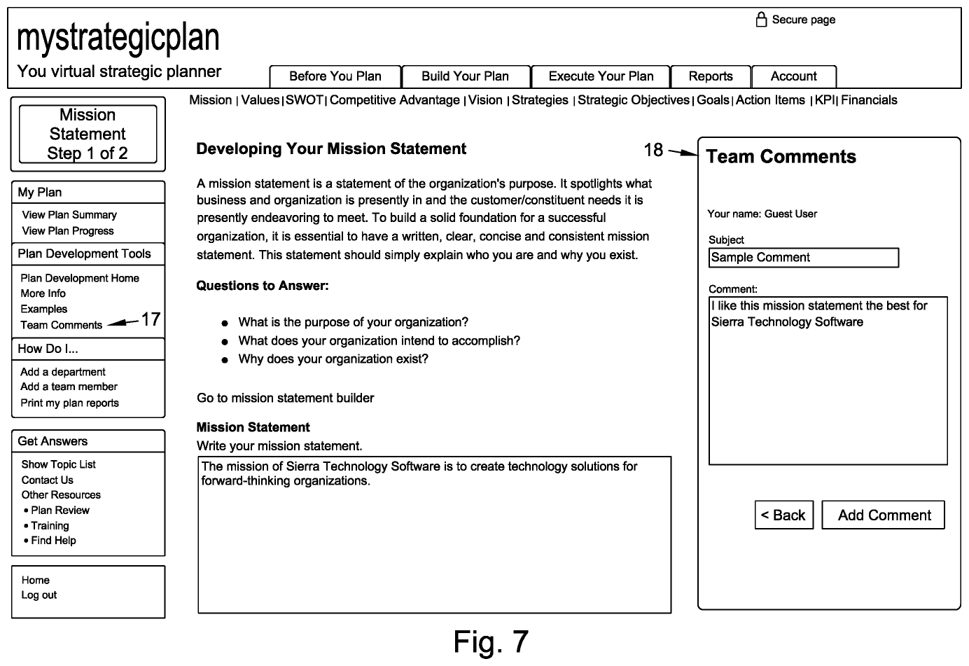

Another feature of the system may be “Team Comments” as shown in FIG. 7. Team comments for each stage can be viewed by clicking “Team Comments” 17 under Plan Development tools located on the left toolbar. Comments from team members that e.g, are relevant to the organization's plan display in the right iframe box 18.

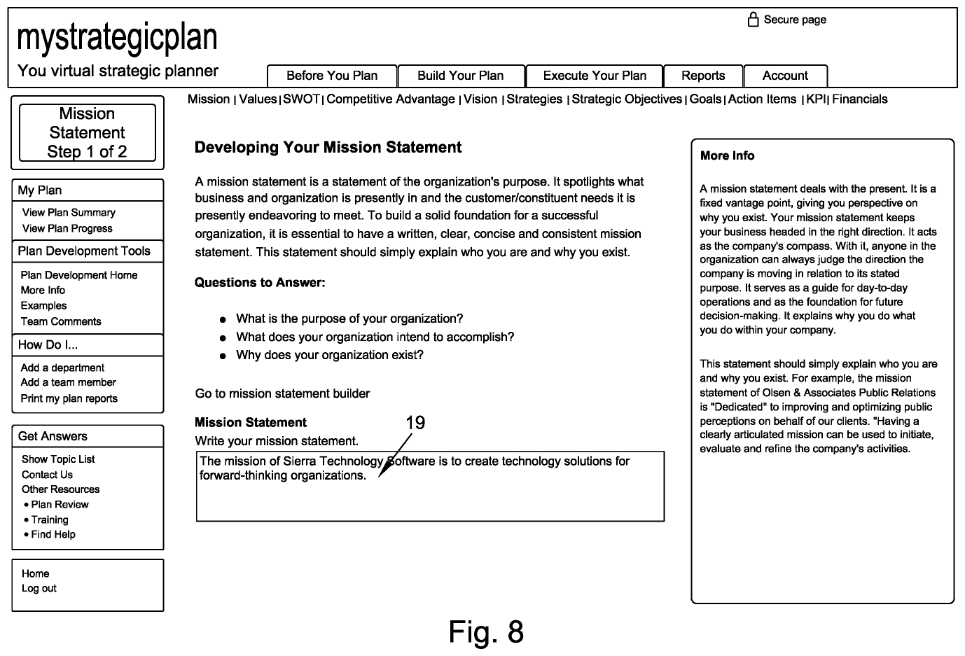

FIG. 8 shows a page describing development of a company's mission statement 19. First, a narrative explaining the purpose of an organization's mission statement is provided to assist the user in eventually developing one for his or her company. Next, a series of questions are presented for the user to answer in the process of developing the mission statement. The user then records the firm's mission statement in the input field 19. This mission statement is used in respective outputs as shown, e.g., in FIG. 90.

FIG. 9 shows a page that states the mission statement input, e.g., using the input screen shown in FIG. 8.

A group of descriptive statements 20, termed Elements of an Effective Mission Statement, provide criteria for developing a mission statement. The user can edit the mission statement by clicking the “edit” link 21. The user makes the necessary revisions and then clicks on the “Save as Draft” button 23 or “Done with Mission” button 24 located at the bottom of this stage. The user may also click on the “Back” button 22 to view the previous page.

FIG. 10 shows a page that describes identifying a company's core values 26. First, a narrative explains the utility of company values to strategic planning. Next, a series of questions 25 are presented for the user to answer in the process of developing values that are particular to the company. The user then records the company's core values in the input field 26. These core values can then be used in other places as shown, e.g., in FIG. 90. The user may click the “Back” button to view the previous page viewed or “Continue” button 27 to view the next page, which continues this stage.

FIG. 11 shows a page stating the company's values statement 28. A group of guidelines 29, termed Guidelines for Values Statement, provide a guide to help develop useful values statements. Once input, the user can edit the values statement 28 by clicking the “edit” link 30. The user makes the necessary revisions and then clicks on the “Save as Draft” button 32 or “Done with Values Statement” button 33 located at the bottom of this page. The user may also click on the “Back” button 31 to view the previous page.

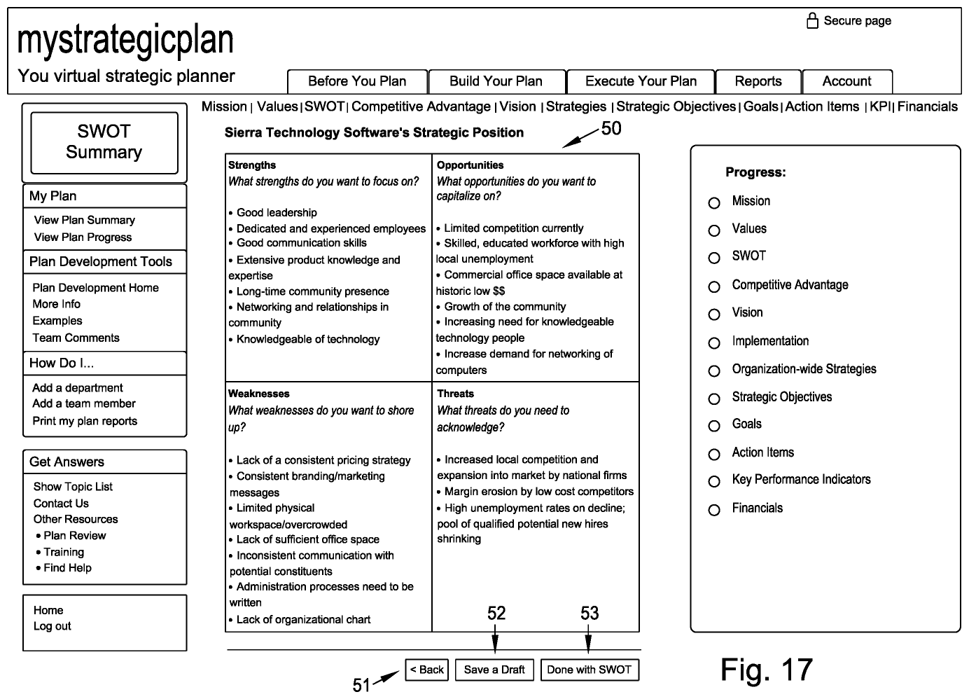

FIG. 12 shows a page that can be used to describe the process for assessing a company's Internal and External Environment, which yields a SWOT matrix diagram 36. First a narrative 34 provides an explanation of an Internal and External assessment (SWOT) as a tool to help an organization critically analyze how it interacts with the marketplace. It can help establish a fit between the internal aspects of an organization and the various facets of the external marketplace. This page also lists four integral parts of a SWOT 35. These four areas are pulled through and summarized into, e.g., a SWOT matrix 36, the SWOT output summary in the page of FIG. 17, the SWOT Report output in the page of FIG. 73, and the system SWOT output outlined in the page of FIG. 90. The user may click the “Back” button to view the previous page viewed or “Continue” button 37 to view the next page, which continues this item.

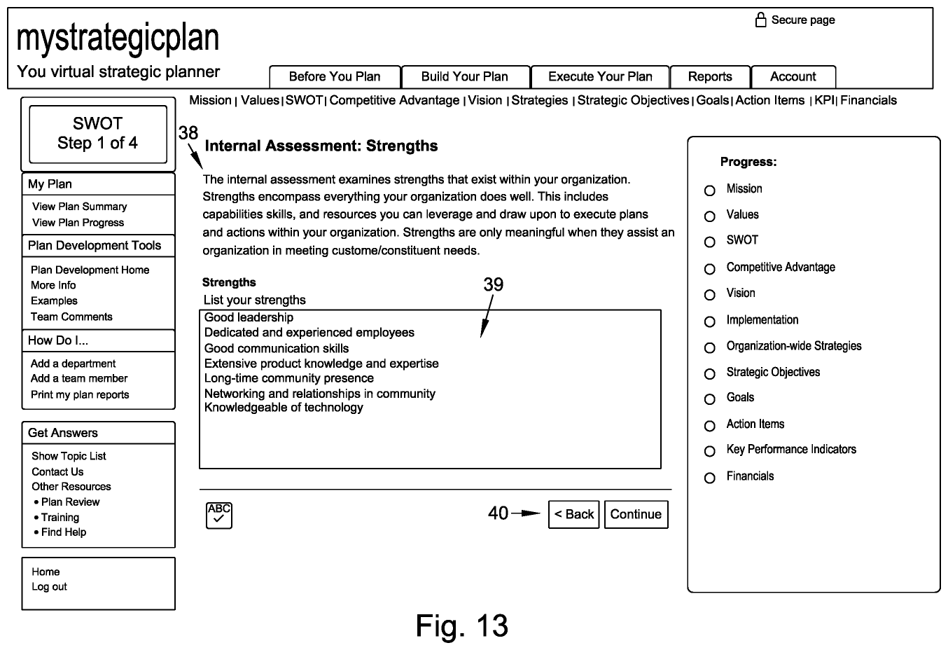

FIG. 13 shows a page that can be used to support an assessment of the company's Internal Strengths 38 (referenced at 36 in FIG. 12). Input field 39 is used to list the company's strengths. These inputs 39 then are pulled through to the respective quadrant of the SWOT Report output, FIG. 73. The user may click the “Back” button to view the previous page viewed or “Continue” button 37 to view the next page, which continues this stage.

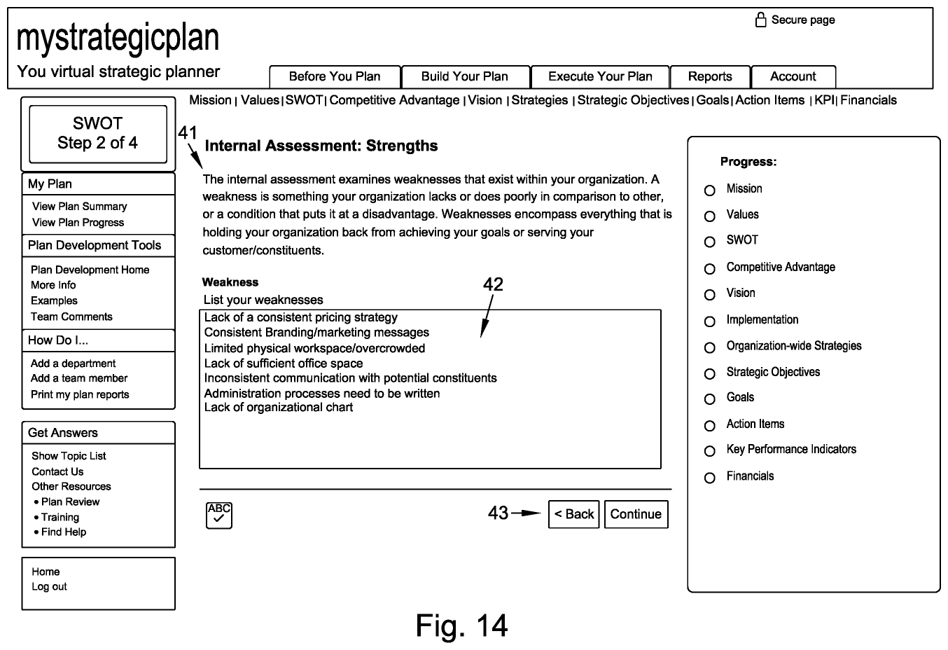

FIG. 14 shows a page that can be used to support an assessment of the company's Internal Weaknesses 41 (referenced at 36 in FIG. 12). Input field 42 is used to list the company's weaknesses. These inputs 42 then are pulled through to the respective quadrant of the SWOT Report output, FIG. 73. The user may click the “Back” button to view the previous page viewed or “Continue” button 37 to view the next page, which continues this stage.

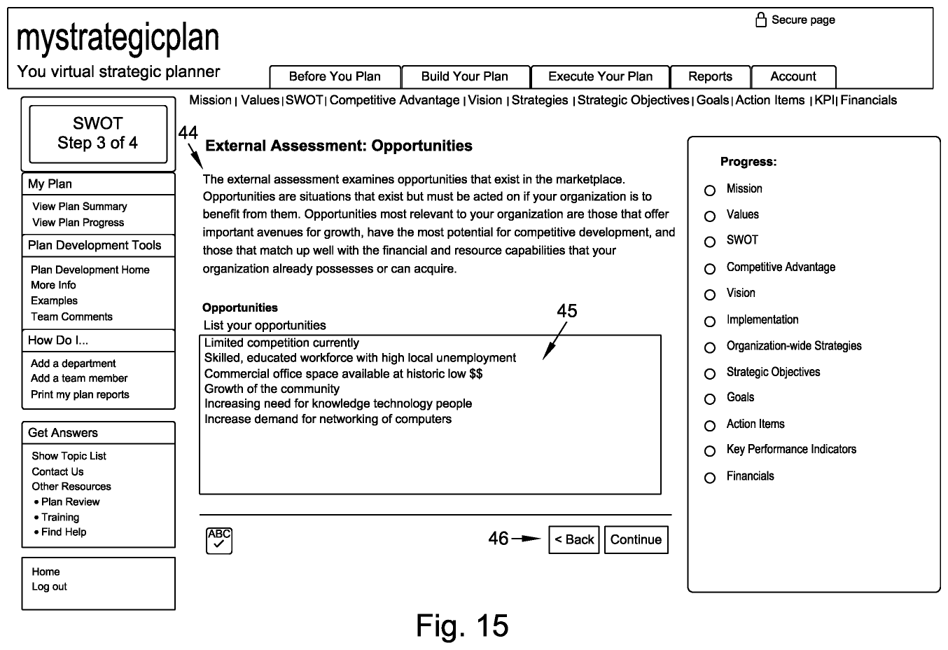

FIG. 15 shows a page that can be used to support the assessment of the company's External Opportunities 44 (referenced at 36 in FIG. 12). Input field 45 is used to list the company's opportunities. These inputs 45 then are pulled through to the respective quadrant of the SWOT Report output, FIG. 73. The user may click the “Back” button to view the previous page viewed or “Continue” button 37 to view the next page, which continues this stage.

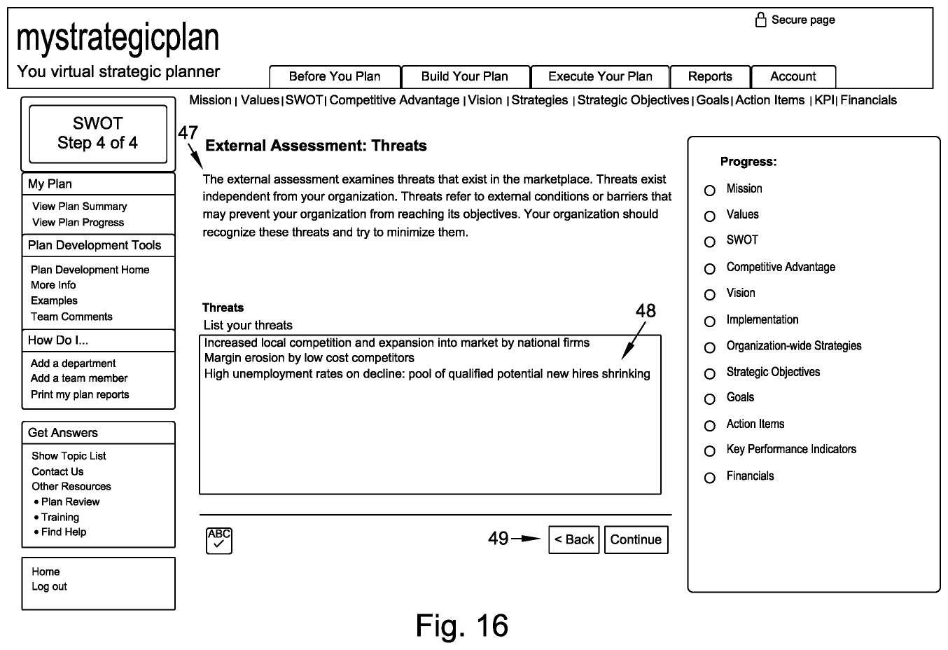

FIG. 16 shows a page that can be used to support the assessment of the company's External Threats 47 (referenced at 36 in FIG. 12). Input field 48 is used to list the company's external threats. These inputs 48 then are pulled through to the respective quadrant of the SWOT Report output, FIG. 73. The user may click the “Back” button to view the previous page viewed or “Continue” button 37 to view the next page, which continues this stage.

FIG. 17 shows the final SWOT matrix. This page is a summary of the SWOT inputs, i.e., strengths 39 (FIG. 13), weaknesses 42 (FIG. 14), opportunities 45 (FIG. 15) and threats 48 (FIG. 16). These various inputs are pulled through into the SWOT Report output FIG. 73 to provide the user with a visual summary of the internal strengths and weaknesses of the company and the external opportunities and threats facing it. This visualization may be used to allow members of the company to determine how to use the strengths, stop the weaknesses, exploit the opportunities, and defend against the threats so exposed. As such, the visualization can be used to provide a framework for a company's strategic fit in the marketplace. A visual output for members of a company to review can also be offered, and may be used to review the elements of the core competencies. This may allow the company to more easily determine strategies for, e.g., meeting the needs of customers. Such output may also be used to visualize the strategic objectives and goals for the organization. The user may click on the “Back” button 51 to view and make revision to the previous page. The user may click on the “Save as Draft” button 52 or “Done with SWOT” button 53 located at the bottom of this page.

FIG. 18 shows a page that may be used to describe a process for identifying an organization's competitive advantage 56 specific to its operations. Aa narrative 54 describes what a competitive advantage is and its purpose. Next the user is asked questions 55 to uncover their competitive advantage: e.g., What are your unique strengths? What are the unique strengths of similar organizations? What are you best at? This is graphically illustrated 56. The user may click the “Back” button to view the previous page viewed or “Continue” button 57 to view the next page, which continues this stage.

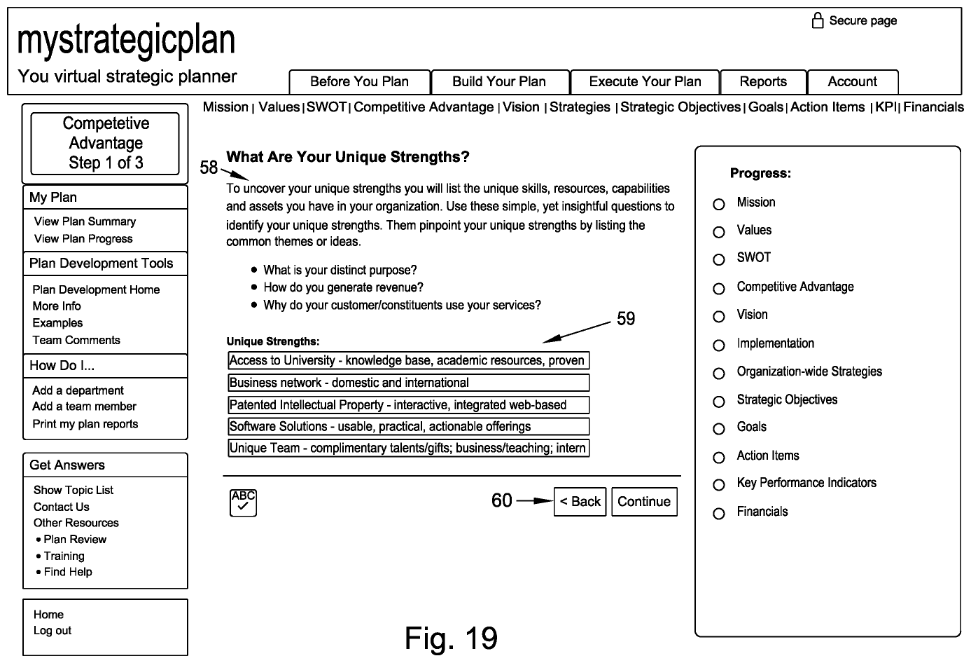

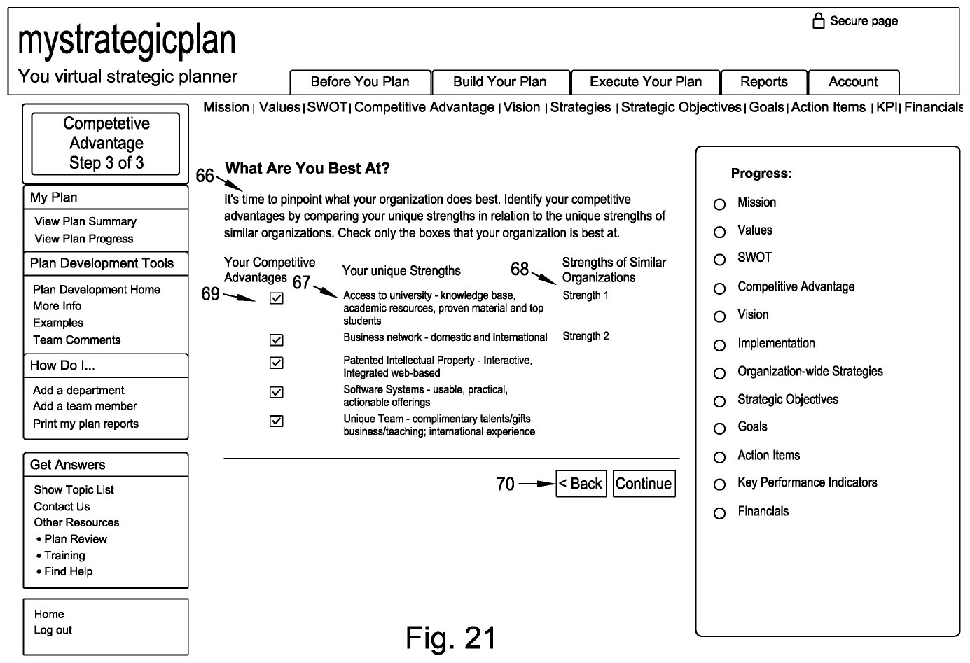

FIG. 19 shows a page that can be used to help a user identify a company's unique strengths 59. First, a narrative explains the process of identifying the unique strengths of an organization. A few questions are presented for the user to answer 58. The user then records the company's unique strengths in the input field 59. These unique strengths are pulled through to FIG. 21, described later. The user may click the “Back” button to view the previous page viewed or “Continue” button 60 to view the next page, which is: a continuation of this process.

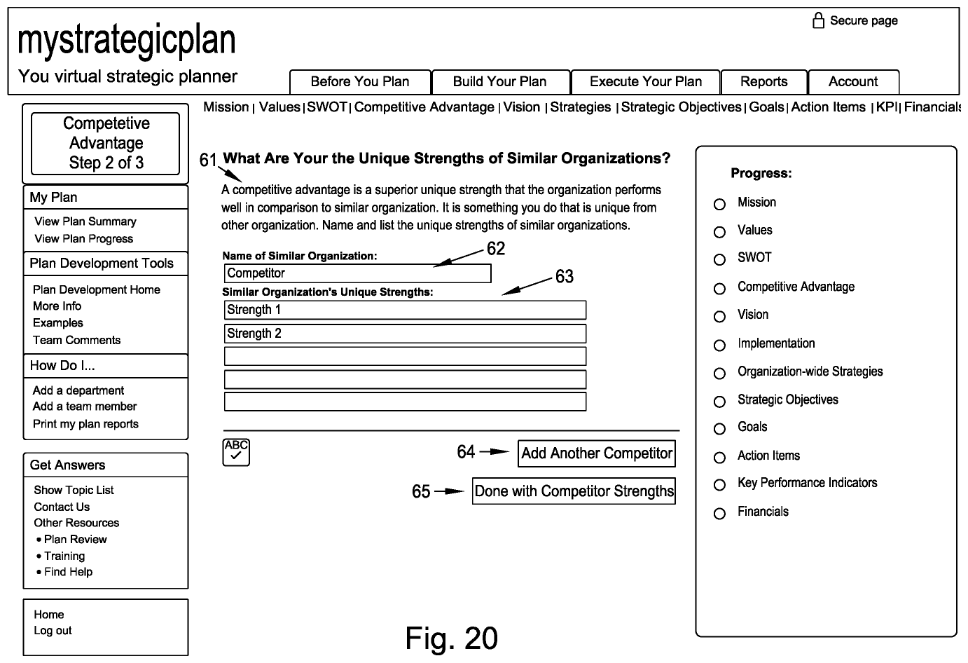

FIG. 20 shows a page that can be used to begin the process of identifying the strengths, such as unique strengths, of similar organizations. A narrative, such as shown at 61 can be used to explain that a competitive advantage is a unique strength that the organization performs well in comparison to similar organizations. Thus the user is guided through a process of evaluating strengths of its competitors. The user names the competitor or similar organization in an input field 62. The user then records the strengths of the similar organization in an input field 63. These unique strengths of competitors are pulled through to FIG. 21, described below. The user may add another competitor by clicking “Add Another Competitor” button 64, which generated the same information as shown in FIG. 20. When finished listing competitors, the user may select a “Done with Competitor Strengths” button 65.

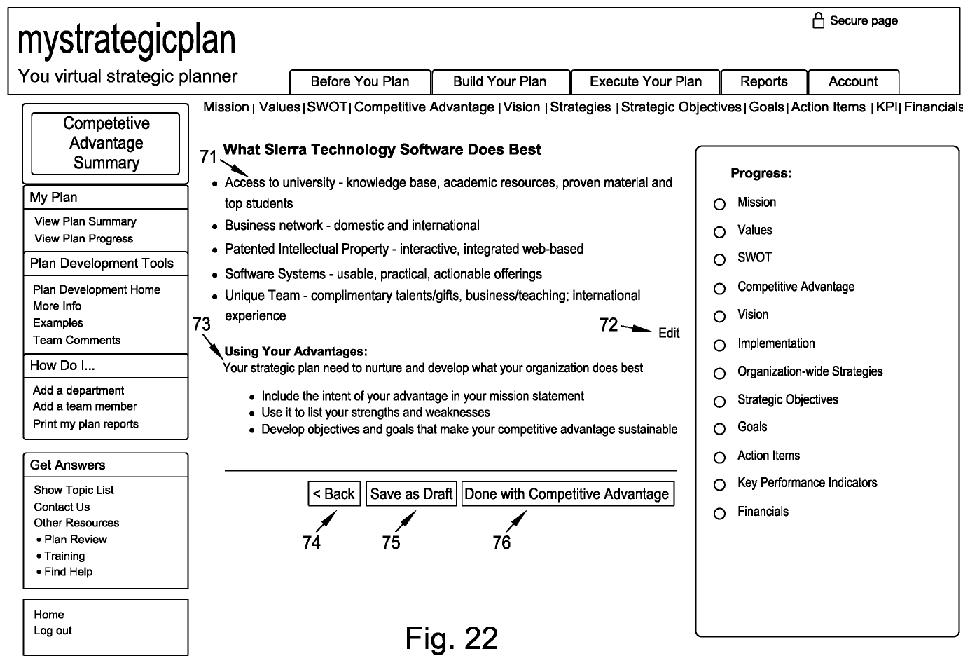

FIG. 21 provides the user with a process to help determine what the organization at issue is best at 69. A narrative, such as that shown at 66 explains the process of identifying what the organization does best 66. The user is directed to examine the unique strengths of the organization 67 (initially entered as shown in FIG. 19) in relation to the unique strengths of similar organizations 68 (initially entered as shown in FIG. 20). The “competitive advantage” check boxes 69 can then be checked by the user to indicate those items which the organization is best at in comparison to the competitors 68. Only the boxes that are checked are pulled through to FIG. 22, described below, which summarizes the organization's strengths. The user may click the “Back” button to view the previous page viewed or “Continue” button 70 to view the next page.

FIG. 22 shows a page that can be used to state the company's competitive advantages 71. A group of guidelines 73, termed Using Your Advantages, provides guidelines on how to develop objectives and goals that make the organization's competitive advantage sustainable. The user can edit the competitive advantage list by clicking the “edit” link 72. The user makes the necessary revisions and then clicks on the “Save as Draft” button 75 or “Done with Competitive Advantage” button 76 located at the bottom of this page. The user may also click on the “Back” button 74 to view the previous page.

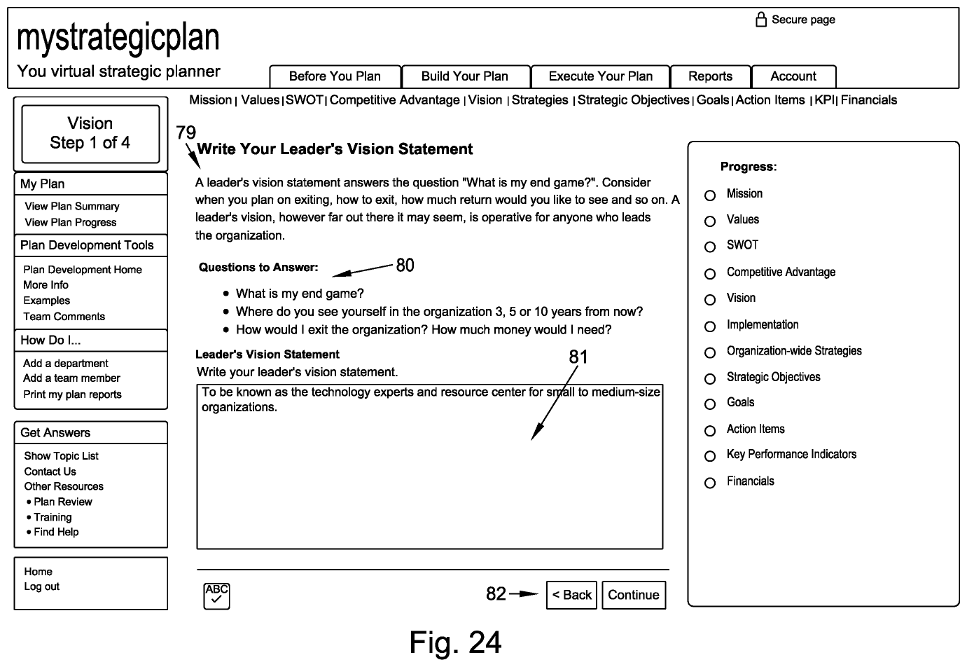

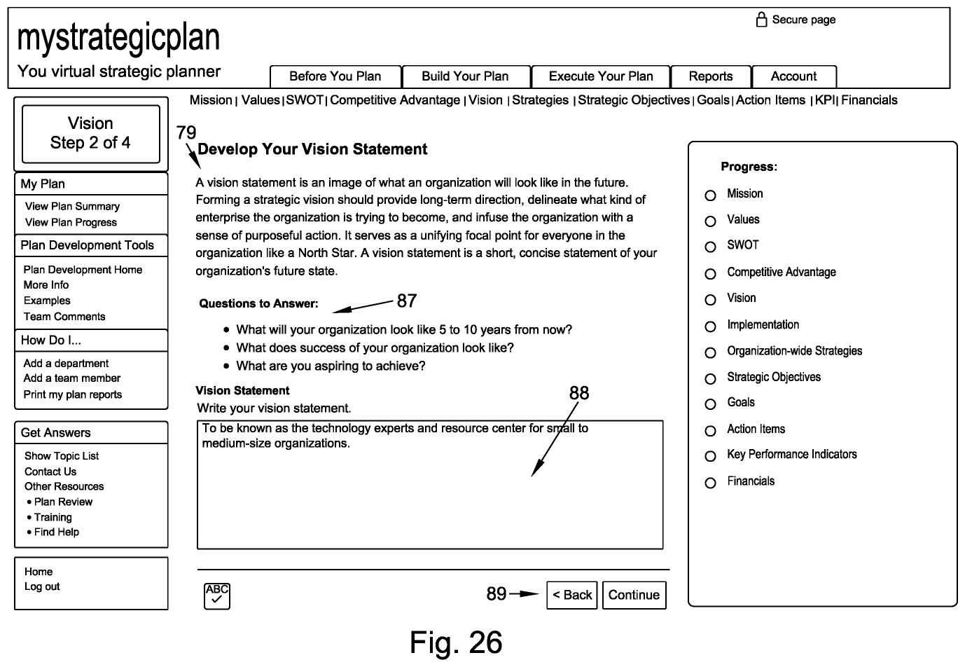

FIG. 23 shows a page that can be used to introduce the concept of writing a Leader's Vision 77. The user is given a choice to write a leader's vision. The user my select the “Yes” button or “No” button 78. If the “No” button is selected the user is directed to writing a vision statement as shown in the page of FIG. 26. If the “Yes” button” is selected the user is directed to write a Leader's Vision Statement as shown in the page of FIG. 24.

FIG. 24 shows a page that can be used to write a Leader's Vision Statement 81. First, a narrative explains the concept of the leader of the organization having a personal vision that runs in tandem with the organizational vision statement 79. Next, a series of questions 80 are presented for the user to consider in the process of developing a leader's vision. The user then records the leader's vision statement in the input field 81. The leader's vision statement, in some embodiments, does not pull through to outputs outlined in the page of FIG. 90, and as such, is not displayed. Other implementations display the leader's vision statement. The user may click the “Back” button to view the previous page viewed or “Continue” button 82 to view the next page, which continues this stage.

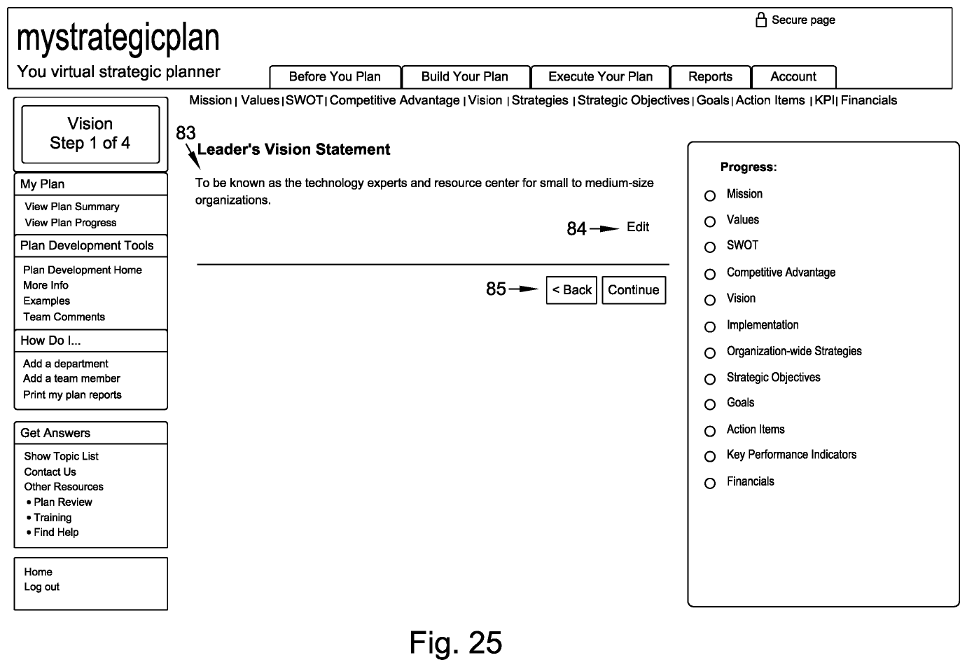

FIG. 25 shows a page that can be used to state the Leader's Vision Statement 83. The user can edit the leader's vision statement by clicking the “edit” link 84 and make the necessary revisions. The user may click the “Back” button to view the previous page viewed or “Continue” button 85 to view the next page, which continues the vision statement input.

FIG. 26 shows a page that can be used to describe a company's Vision Statement 88. A narrative 86 explaining the purpose of a company's vision statement is provided, to, e.g., assist the user in developing one for his/her company. Next, a series of questions 87 are presented for the user to answer. The user then records the organization's vision statement in the input field 88. This statement may be pulled through to respective outputs outlined in the page of FIG. 90. The user may click the “Back” button to view the previous page viewed or “Continue” button 89 to view the next page, which continues this stage.

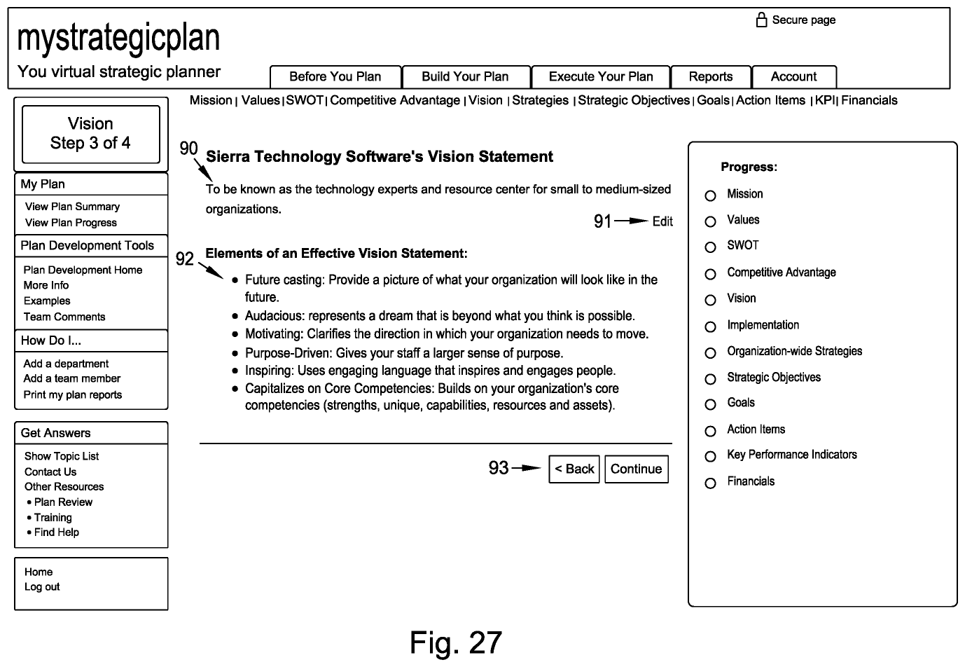

FIG. 27 shows a page stating the company's Vision Statement 90. A group of descriptive statements 92, termed Elements of an Effective Vision Statement, provide perspective for developing a vision statement. The user can edit the mission statement by clicking the “edit” link 91. The user may click the “Back” button to view the previous page viewed or “Continue” button 93 to view the next page, which continues this stage.

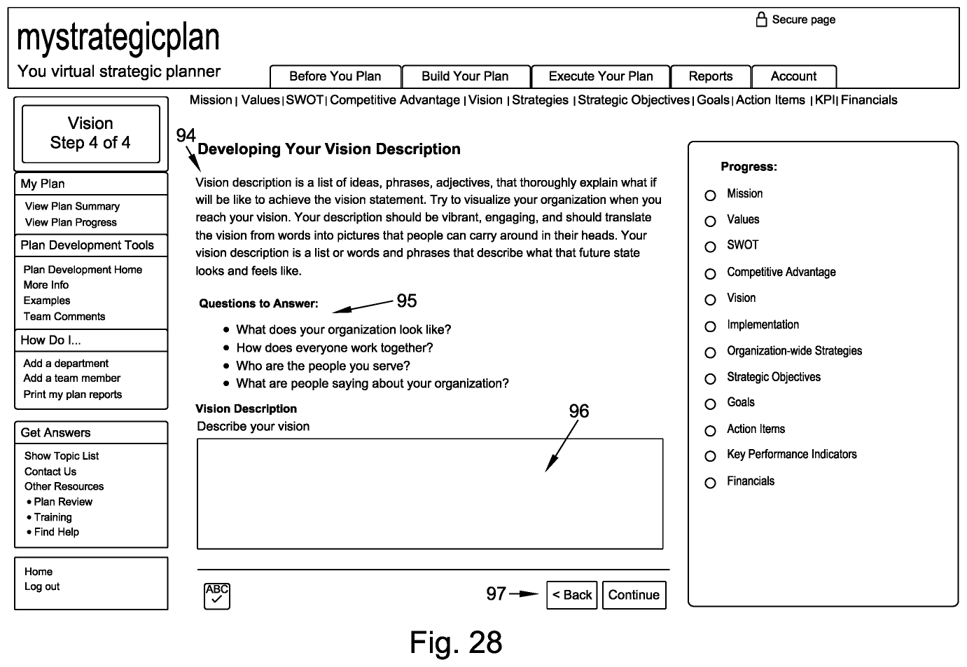

FIG. 28 shows a page that describes in detail the company's vision—the Vision Description 96. First, a narrative explaining the concept of the vision description and how to creatively write a description of the company's vision 94 is presented. Next, a series of questions 95 are presented for the user to answer in the process of describing the vision. The user then records the vision description in the input field 96. This statement is pulled through to respective outputs outlined in the page of FIG. 90. The user may click the “Back” button to view the previous page viewed or “Continue” button 97 to view the next page, which continues this stage.

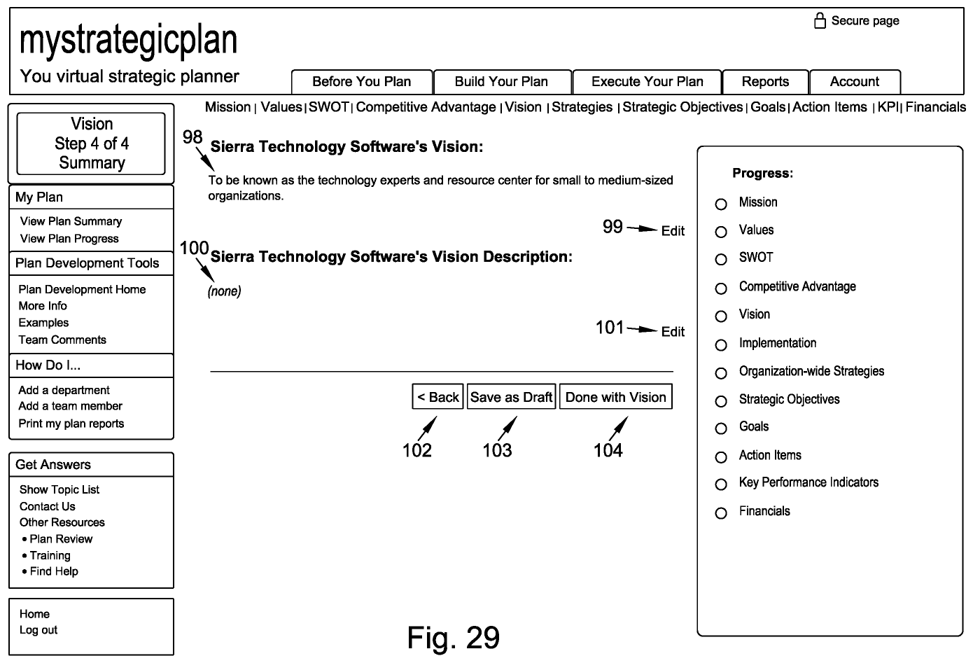

FIG. 29 shows a page stating both the company's Vision Statement 98 and Vision Description 100. The user can edit the vision statement by clicking the “edit” link 99. As previously mentioned both statements are pulled through to respective outputs outlined in the page of FIG. 90. The user can edit the vision description by clicking the “edit” link 101. The user makes the necessary revisions and then clicks on the “Save as Draft” button 103 or “Done with Vision” button 104 located at the bottom of this page. The user may also click on the “Back” button 102 to view the previous page.

FIG. 30 shows a page that can be used for the company's Implementation 10′7 of the plan. First, a narrative explaining the initial discussion on strategic plan Implementation 105 is provided. The page goes on to list points that describe the process for implementation of the organization's plan, termed Putting Your Plan to Work 106. The actual plan addresses the what and why of activities, while implementation addresses the who, where, when, and how of the plan. Implementation is as important as the strategic plan itself. The user records the company specific implantation ideas in the input filed 107. These ideas are pulled through to respective outputs outlines in the page of FIG. 90. The user may click the “Back” button to view the previous page viewed or “Continue” button 108 to view the next page, which continues this stage.

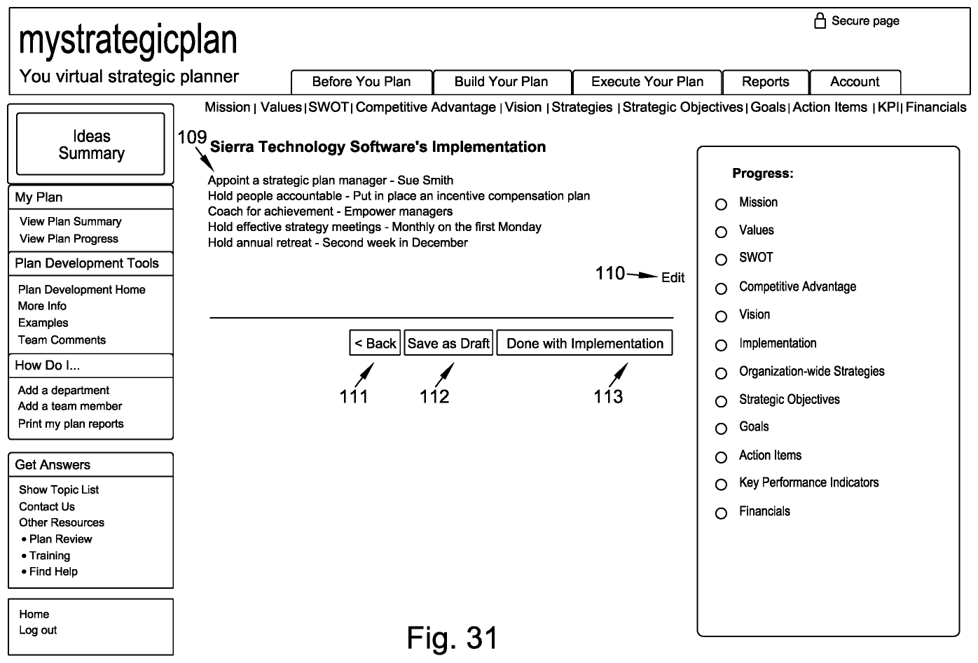

FIG. 31 shows a page that can be used to state the company's implementation plan 109. The user can edit the implementation by clicking the “edit” link 110. The user makes revisions and then clicks on the “Save as Draft” button 112 or “Done with Implementation” button 113 located at the bottom of this page. The user may also click on the “Back” button 111 to view the previous page.

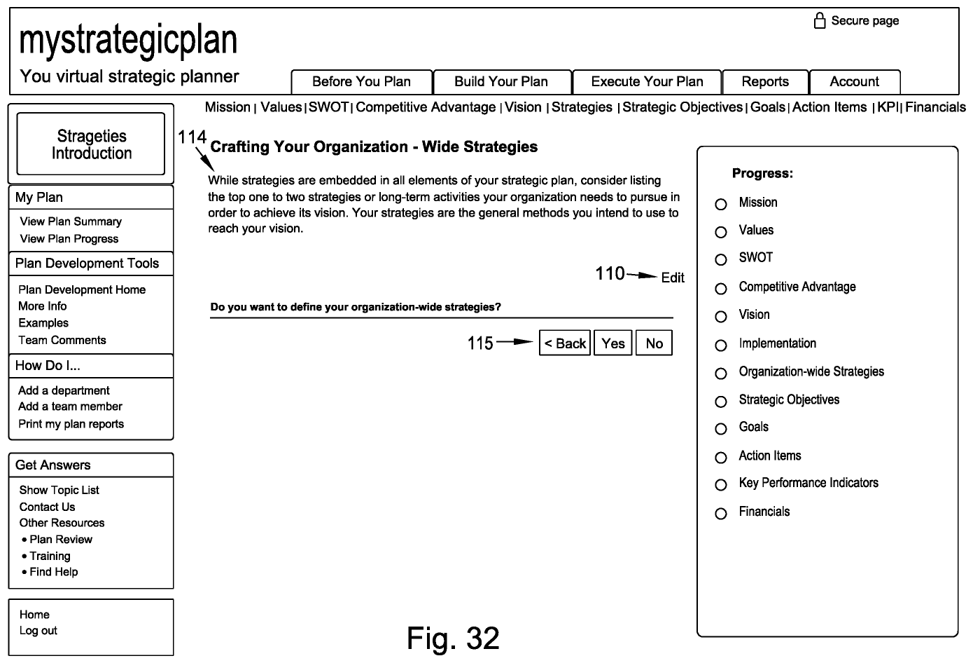

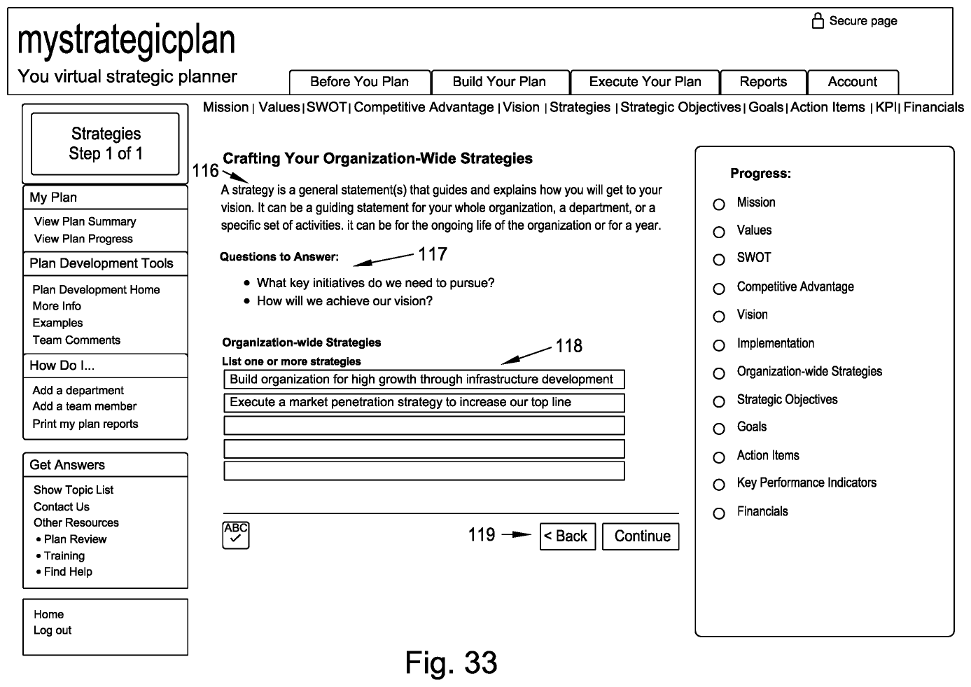

FIG. 32 shows a page that can be used to introduce the concept of crafting Organization-Wide Strategies 114. The user is given a choice to define top long-term strategies. The user my select the “Yes” button or “No” button 115. If the “No” button” is selected the user is directed to the Plan Development page as shown in FIG. 2 to select the next stage. If the “Yes” button” is selected the user is directed to list one or more strategies as shown in the page of FIG. 33, below.

FIG. 33 shows a page that can be used to describe writing Organization-Wide Strategies 118. A narrative 116 explains the concept of crafting organization-wide strategies as top level general statements that guide the organization. Next, a series of questions 117 are presented for the user to consider in the process of developing organization-wide strategies. The user then records the organization-wide strategies in the input field 118. The strategy statements are pulled through to respective outputs outlined in the page of FIG. 90. The user may click the “Back” button 119 to view the previous page viewed or “Continue” button to view the next page.

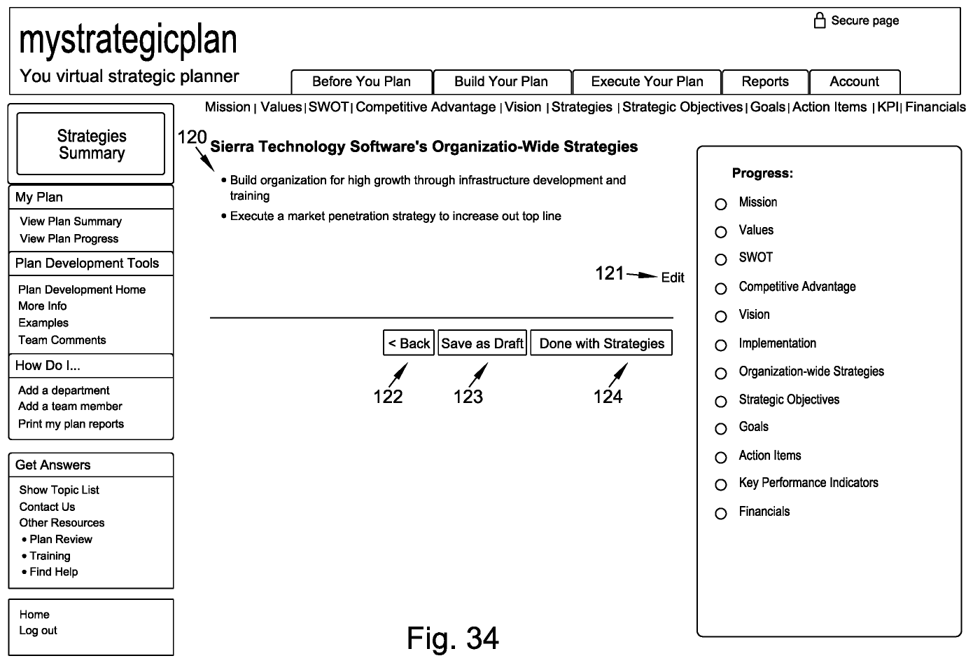

FIG. 34 shows a page stating the Organization-Wide Strategies 120 entered, e.g., using the page shown in FIG. 33. The user can edit the organization-wide strategies by clicking the “edit” link 121 to make the necessary revisions. To save, clicks A “Save as Draft” button 123 or “Done with Strategies” button 124. The user may also click on the “Back” button 122 to view the previous page.

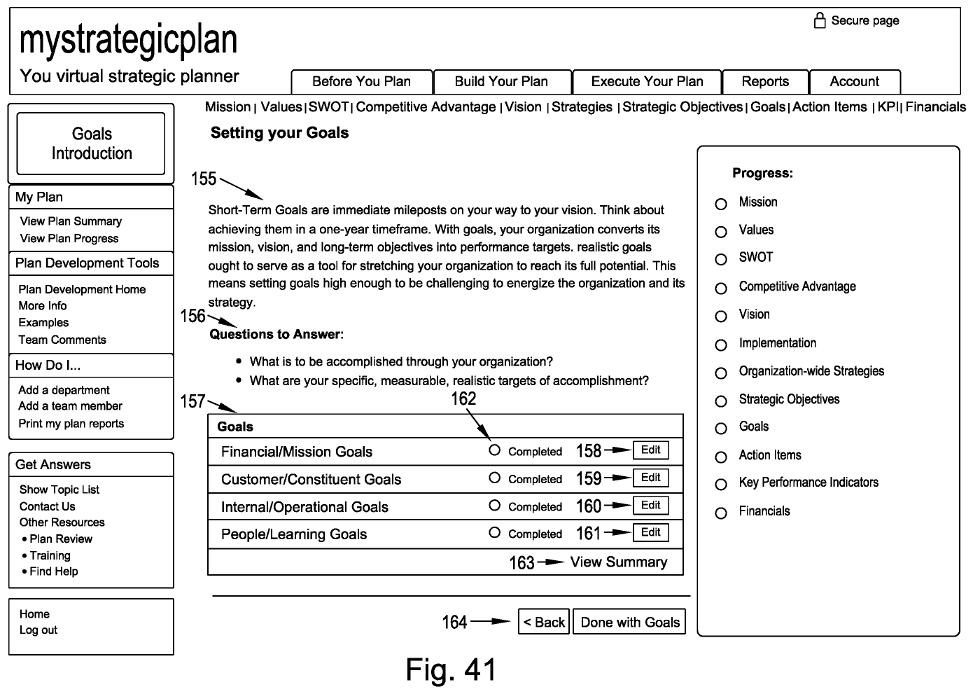

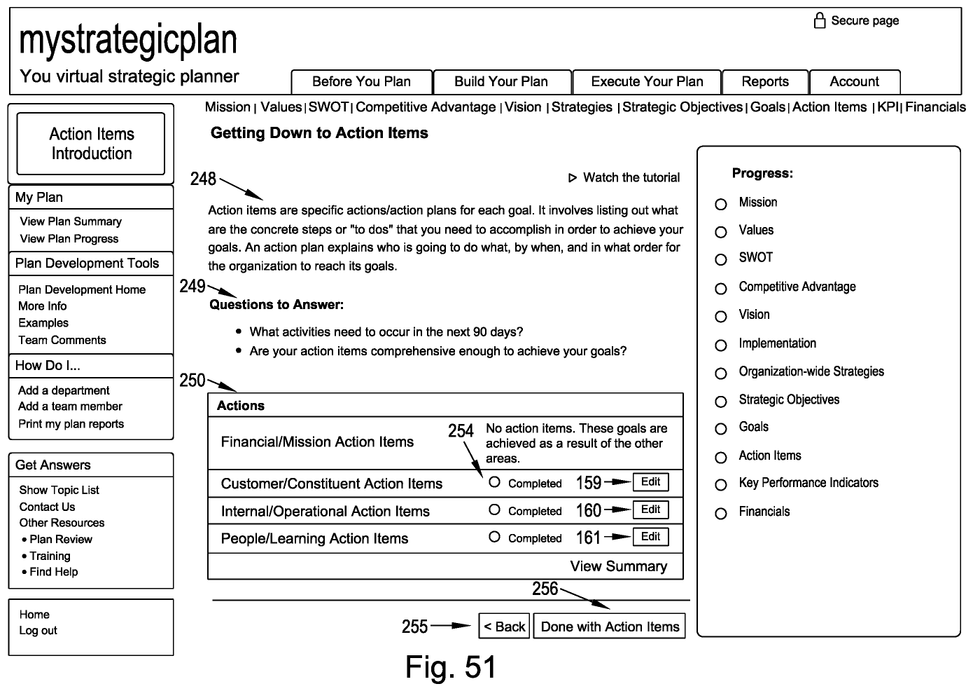

FIG. 35 shows a page that describes the concept of Strategic Objectives 125 as long-term general areas that state how the organization will get from its mission (where they are now) to its vision (where they are going) 125. A set of questions, such as the Questions to Answer 126 can be used to provide a perspective for developing objectives. A narrative, Writing Strategic Objectives in Four Key Areas 127, explains that the user will be writing strategic objectives in key areas to have a balanced and holistic strategy. The areas, in an exemplary implementation are: Financial/Mission, Customer/Constituent; Internal/Operational and People/Learning. Strategies developed for these areas may subsequently be pulled throughout to provide the organizational framework for developing Goals, as shown with reference to, e.g., FIG. 41, and Action Items, as shown with reference to, e.g., FIG. 51. The Strategic Objectives groups in the designated areas are pulled through to the respective outputs outlined in the page of FIG. 90. The user may click the “Back” button to view the previous page viewed or “Continue” button 128 to view the next page.

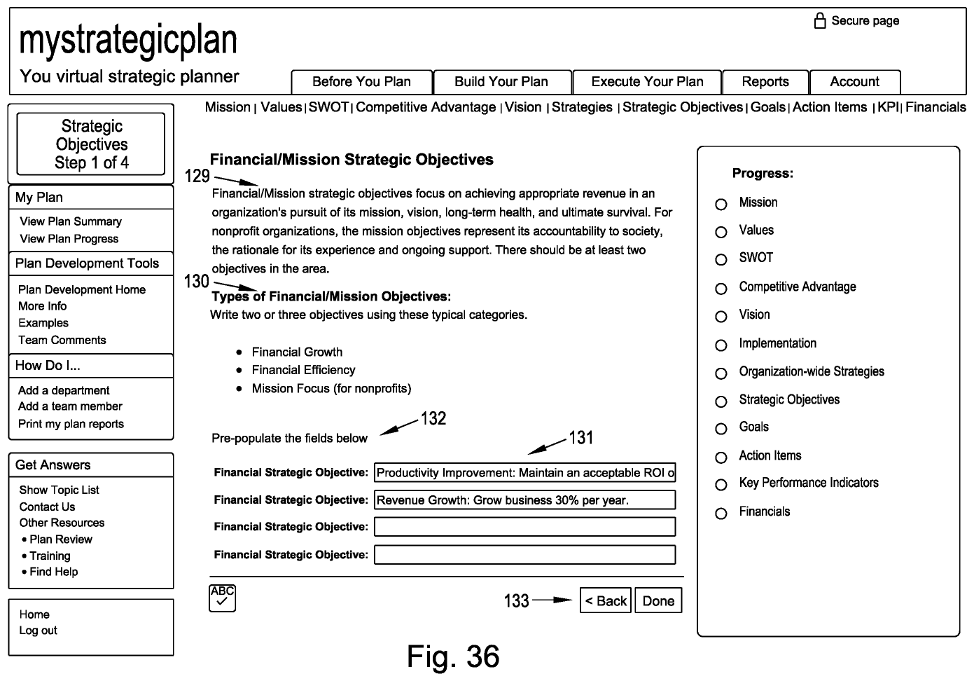

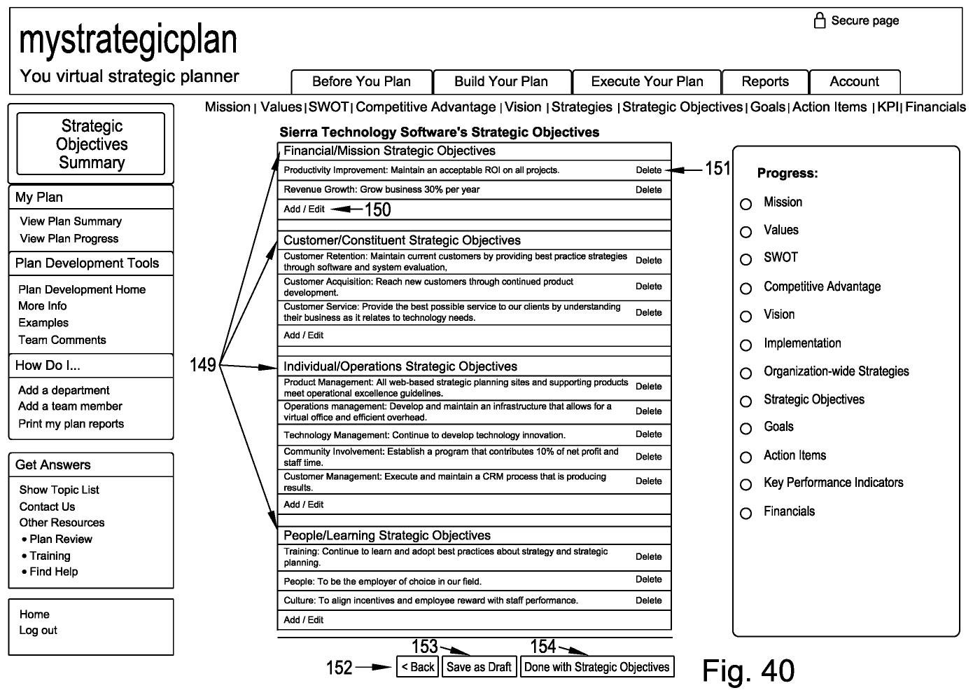

FIG. 36 shows a page that can be used to direct the user to write Financial/Mission Strategic Objectives 131. A narrative 129 explains the purpose of financial objectives in achieving its mission/vision. Typical types of Financial/Mission Objectives 130 are listed. The user can record appropriate financial strategic objectives in input field 131. The user also has the option of clicking on “Pre-populate the fields below” link 132, which will automatically insert typical financial objective categories. These financial objectives may be pulled through to the Strategic Objectives Summary page as shown in FIG. 40, and to respective outputs outlined in the page of FIG. 90. A “Back” button may be used to view the previous page viewed or a “Continue” button 133 may be use to view the next page, which continues the process.

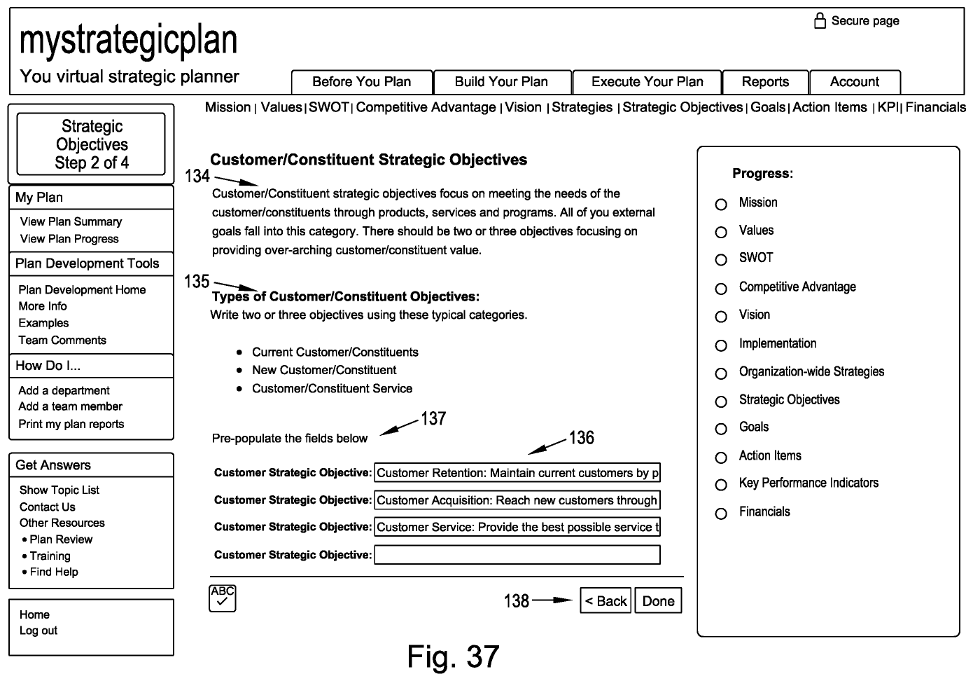

FIG. 37 shows a page that may be used to direct the user to write Customer/Constituent Strategic Objectives 136. A narrative 134 explains the purpose of customer/constituent objectives in meeting the needs of customers. Typical types of Customer/Constituent Objectives 135 are also listed 135. The user then records the customer/constituent strategic objectives in the input field 136. The user has the option of clicking on “Pre-populate the fields below” link 137, which will insert the customer/constituent objective categories automatically. These Customer/Constituent objectives are pulled through to the Strategic Objectives Summary page as shown in FIG. 40, and may also be pulled through to the respective outputs outlined in the page described with reference to FIG. 90. The user may click the “Back” button to view the previous page viewed or “Continue” button 138 to view the next page.

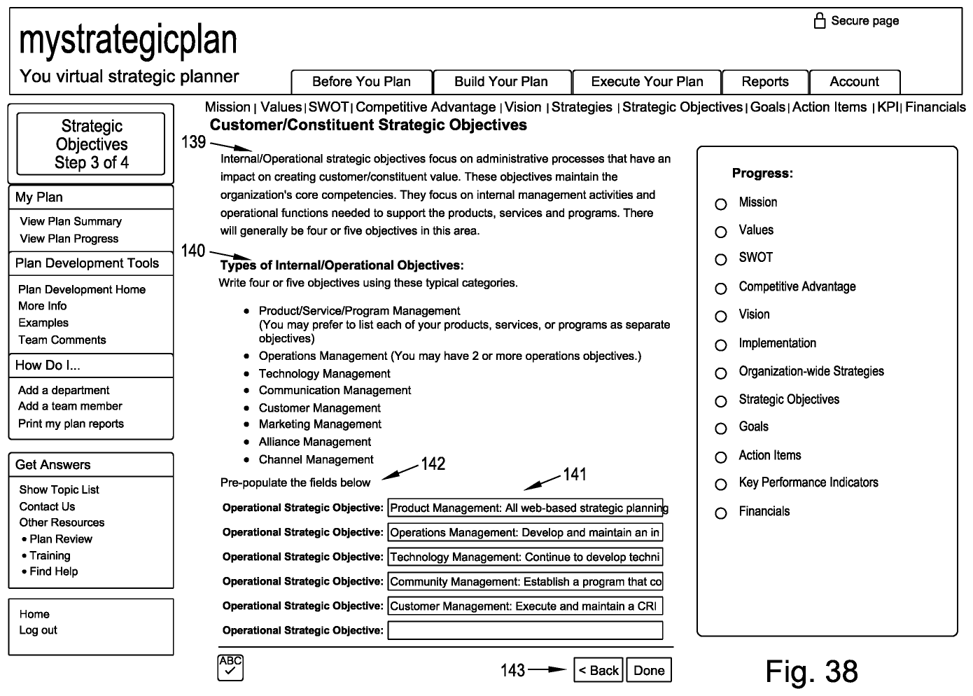

FIG. 38 shows a page that can be used to direct the user to write Internal/Operational Strategic Objectives 141. A narrative 139 explains the purpose of Internal/Operational objectives that focus on internal management activities and operational functions. Typical types of Internal/Operational Objectives 140 can also be listed to give a user an idea of objectives which might be appropriate. An input field 141 can be used to record chosen Internal/Operational strategic objectives. The user has the option of clicking on “Pre-populate the fields below” link 142, which will insert typical Internal/Operational objective categories automatically. These Internal/Operational objectives may be pulled through to the Strategic Objectives Summary page as shown in FIG. 40, and/or to the respective outputs such as those outlined in the page of FIG. 90. The user may click the “Back” button to view the previous page viewed or “Continue” button 143 to view the next page, which continues this stage.

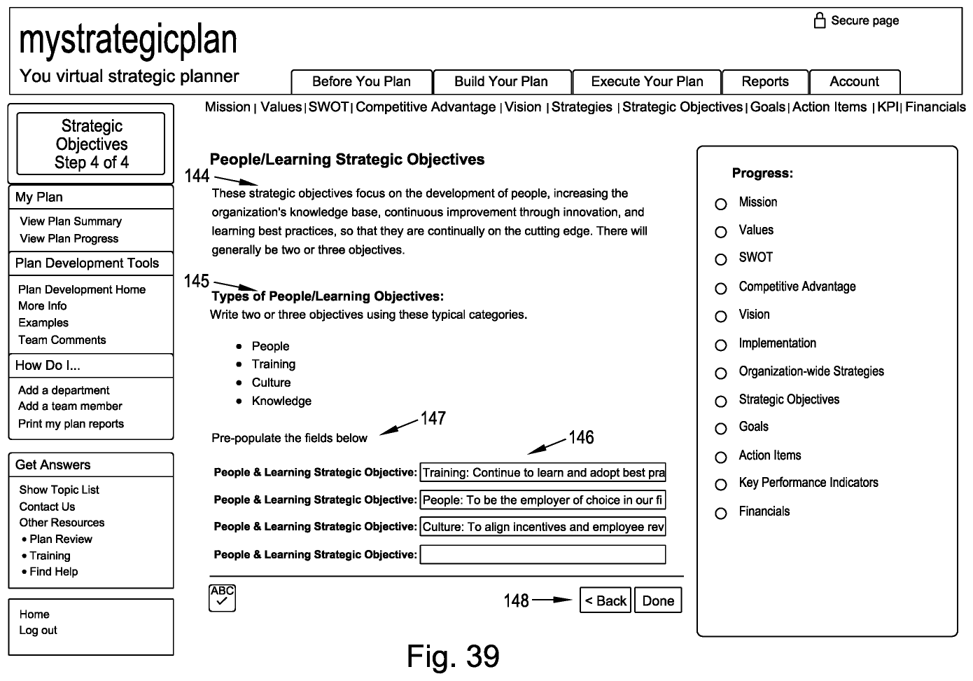

FIG. 39 shows a page that directs the user to write People/Learning Strategic Objectives 146. First, a narrative explains the purpose of People/Learning objectives that focus on internal management activities and operational functions 144. Next typical Types of People/Learning Objectives are listed 145. The user then records the People/Learning strategic objectives in the input field 146. The user has the option of clicking on “Pre-populate the fields below” link 147, which will insert typical People/Learning objective categories automatically 147. These People/Learning objectives may be pulled through to the Strategic Objectives Summary page as shown in FIG. 40, and/or to the respective outputs outlined in the page of FIG. 90. The user may click the “Back” button to view the previous page viewed or “Continue” button 148 to view the next page.

FIG. 40 shows a page that can be used to displays a summary of strategic objectives areas areas 149, in an exemplary implementation—Financial/Mission, Customer/Constituent, Internal/Operational, and People/Learning. These areas may subsequently be pulled throughout to provide the organizational framework for developing Goals in FIG. 41 and Action Items beginning in FIG. 51. The Strategic Objectives may also be pulled through to the respective outputs outlined in the page of FIG. 90. The user can add or edit an objective by clicking the “Add/Edit” button 150. The user can delete an objective by clicking the “Delete” button 151. The user makes the necessary revisions and then clicks on the “Save as Draft” button 153 or “Done with Strategic Objectives” button 154 located at the bottom of this page. The user may also click on the “Back” button 152 to view the previous page.

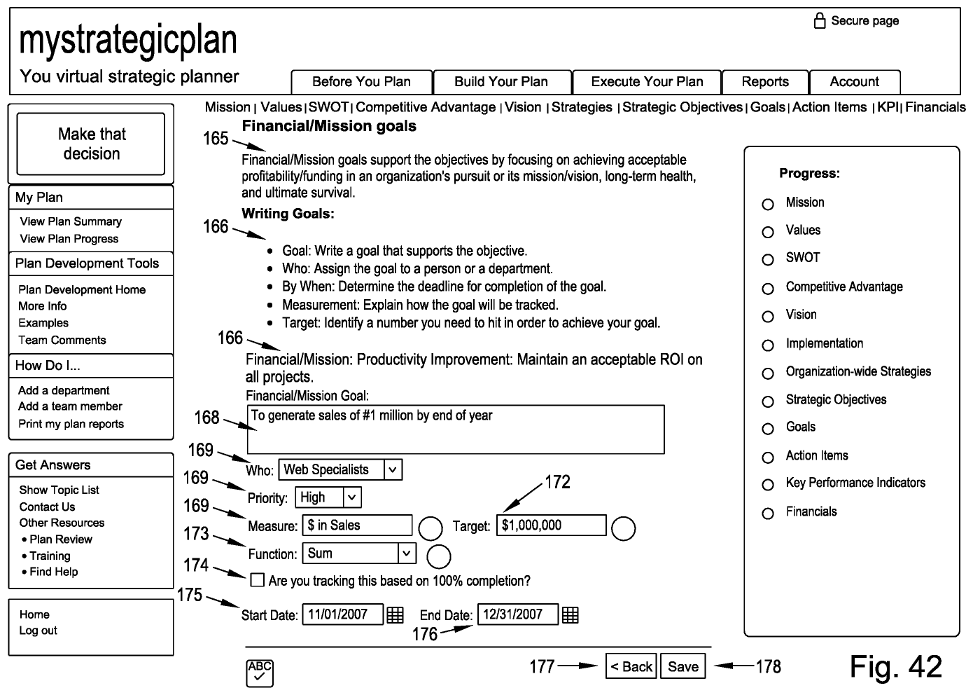

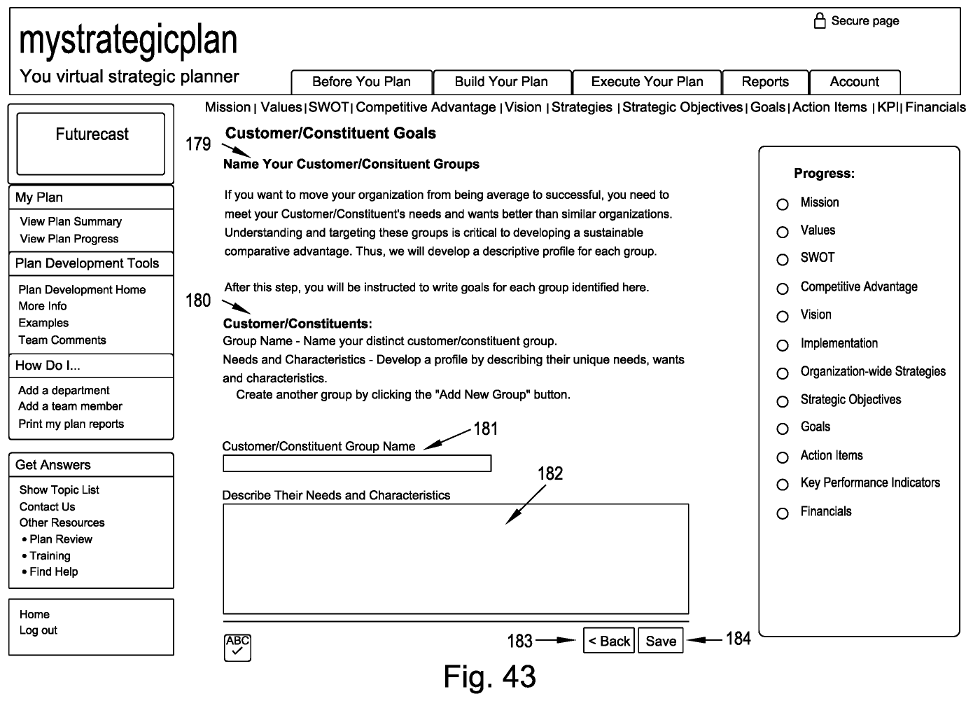

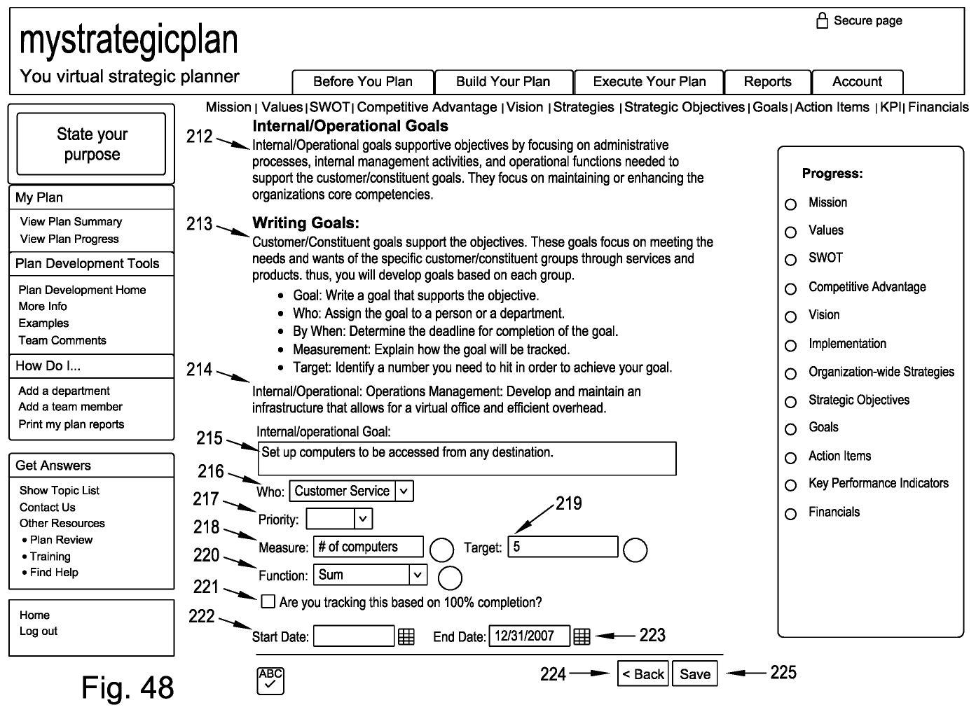

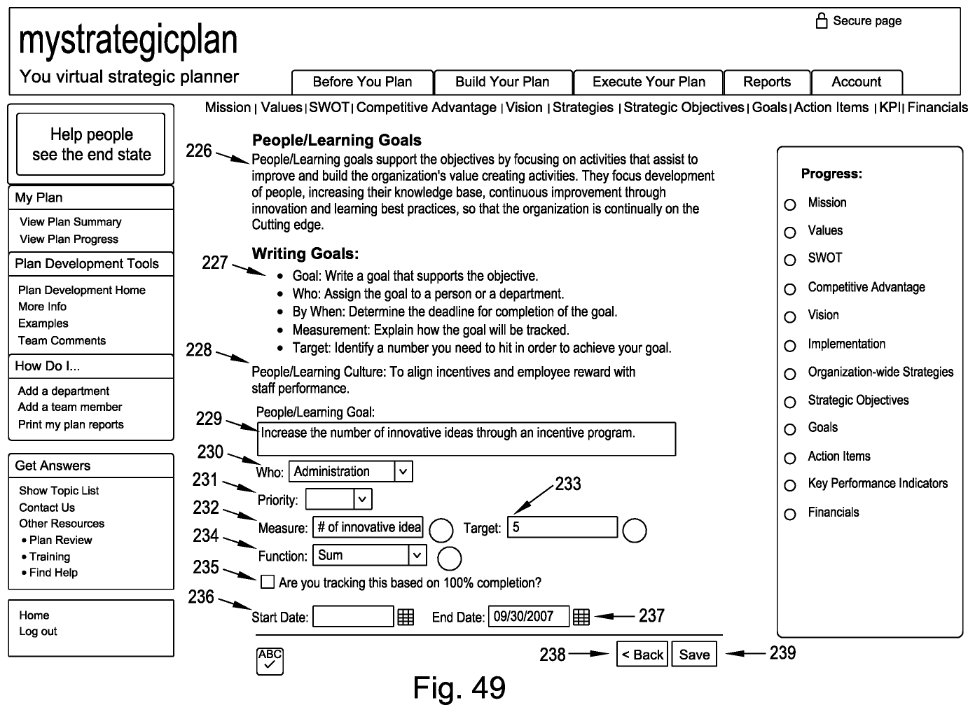

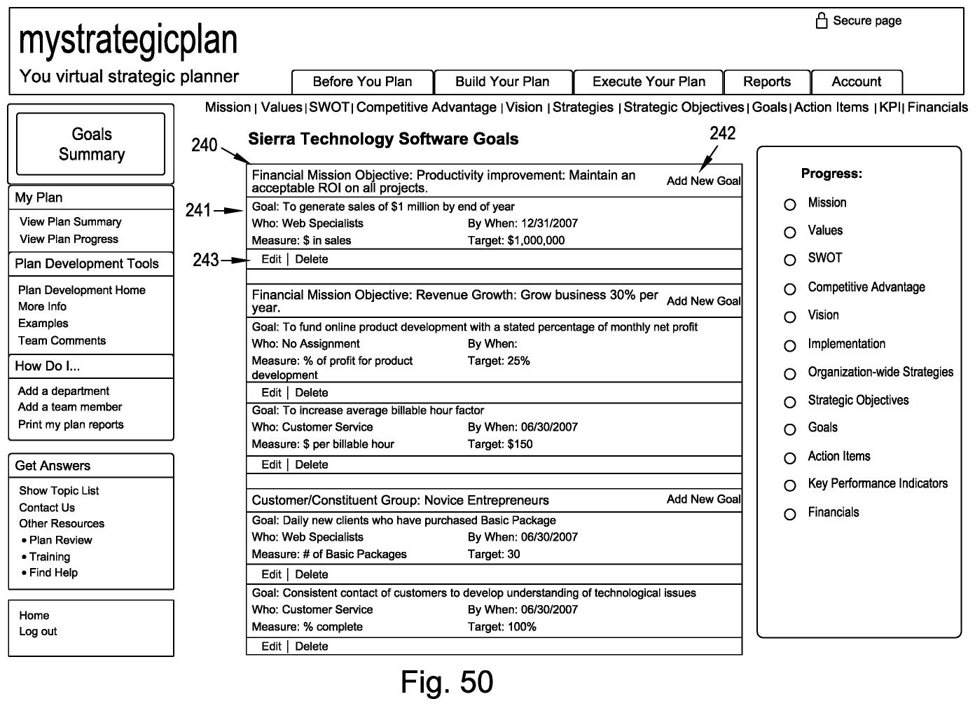

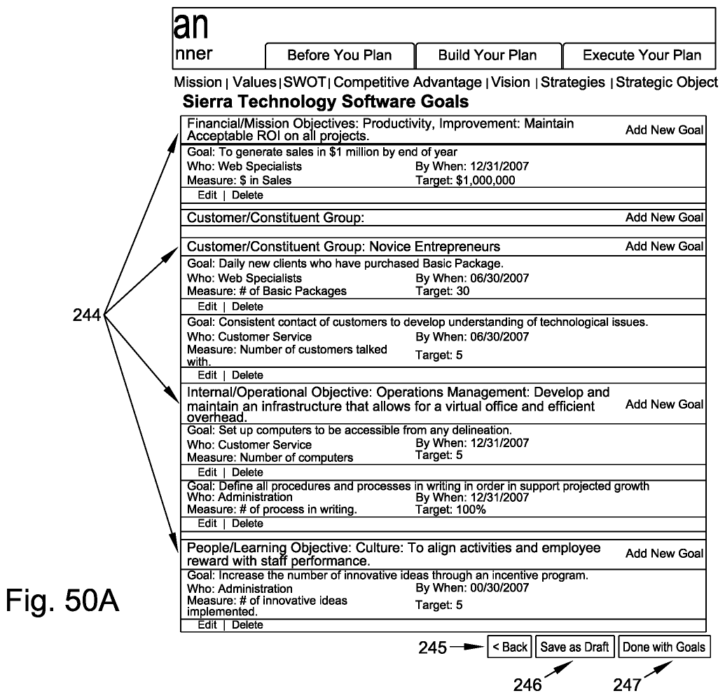

FIG. 41 shows a page that can be used to describe the overall process of Goal setting as it relates to key objective areas, such as those determined with reference to the screen shown in FIG. 35. A narrative 155 may be used to explain the overall goal setting process as mileposts on the way to reaching the company's vision. Goals may be based upon the Internal and External Assessment (FIGS. 12 through 17) and Competitive Advantage (FIG. 18 through 22). Goals are intended to be realistic, measurable, time-dated targets of accomplishment that support the Objectives, such as may be written with reference to FIGS. 36 through 40. Questions to Answer 156 may be presented to support the goal writing process. This continues the framework initiated with the Broad Objectives (FIG. 35). Goals 157 may be written in key areas as initially set up. This embodiment lists such key areas as: Financial/Mission Goals, Customer/Constituent Goals, Internal/Operational Goals, and People/Learning Goals. The user may write Financial/Mission Goals by clicking on the “edit” button 158 which goes to the page shown in FIG. 42. The Customer/Constituent Goals page is reached by clicking on the “edit” button 159 which goes to the page shown in FIG. 43. Internal/Operational Goals can be written by clicking on the “edit” button 160. This button sends a user to the page shown in FIG. 48. People/Learning Goals can be reached by clicking on the “edit” button 161, which goes to the page shown in FIG. 49. The progress lights 162 remain gray if the goals area has not been visited and green if the goal area has been visited, and a non-draft document saved, in some versions. The user may click on “View Summary” 163 to view all the written goals that support the objectives as shown in FIGS. 50 and 50A. When finished, the user may select the “Done with Goals” button 164 or the “Back” button, both located at the bottom of this page, to view the previous page.

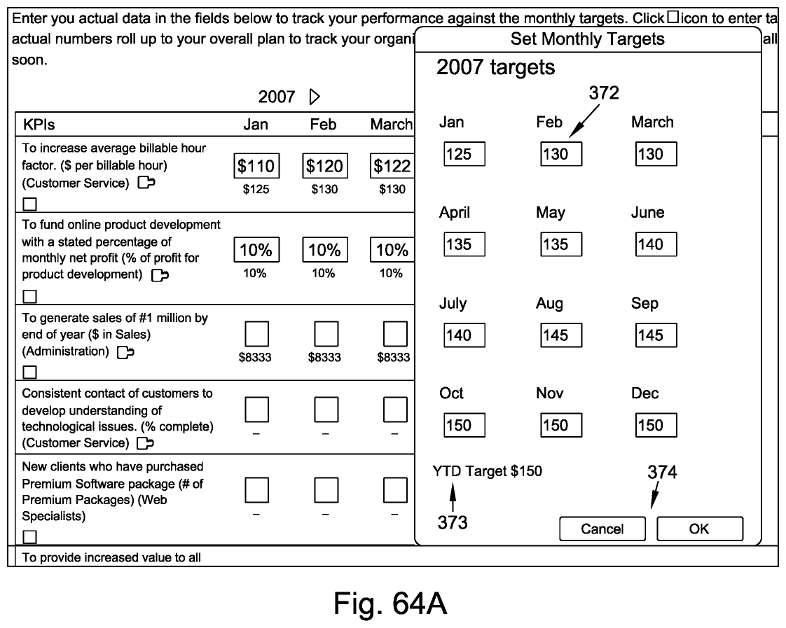

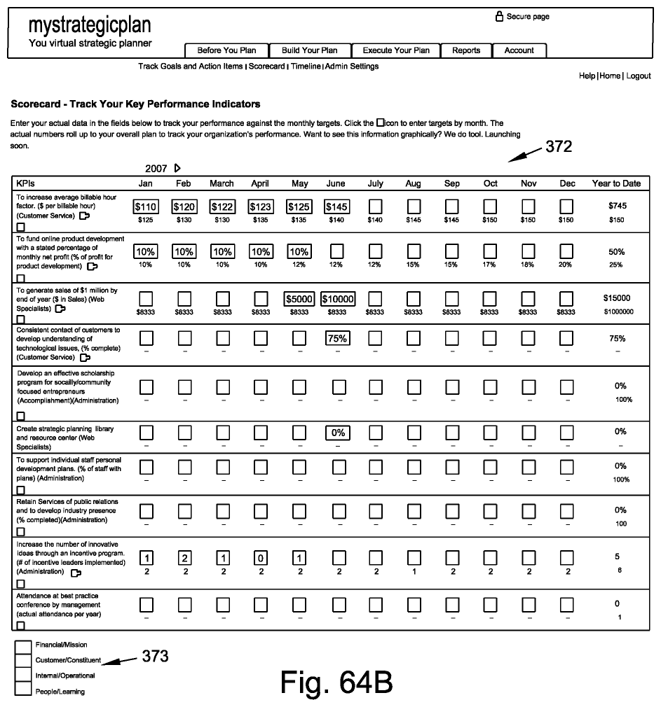

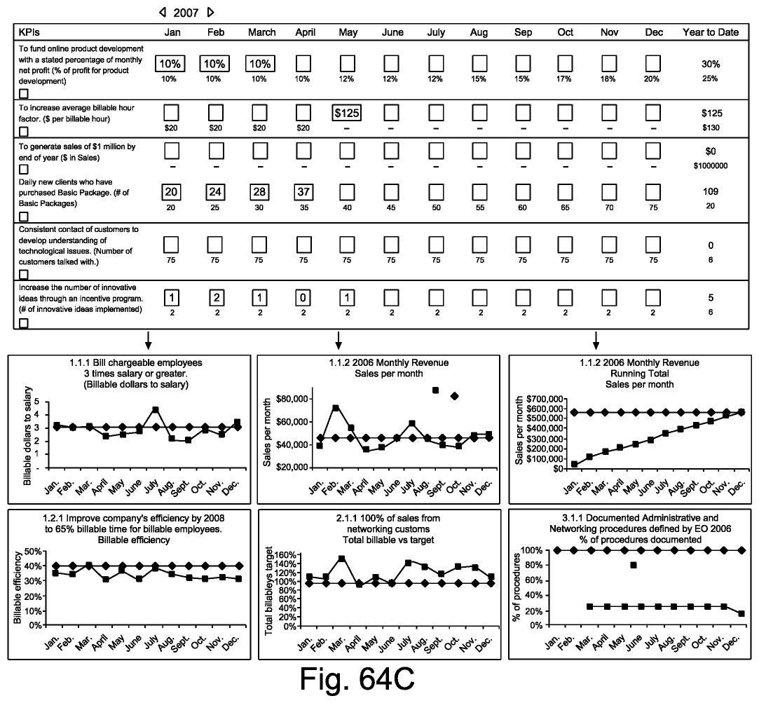

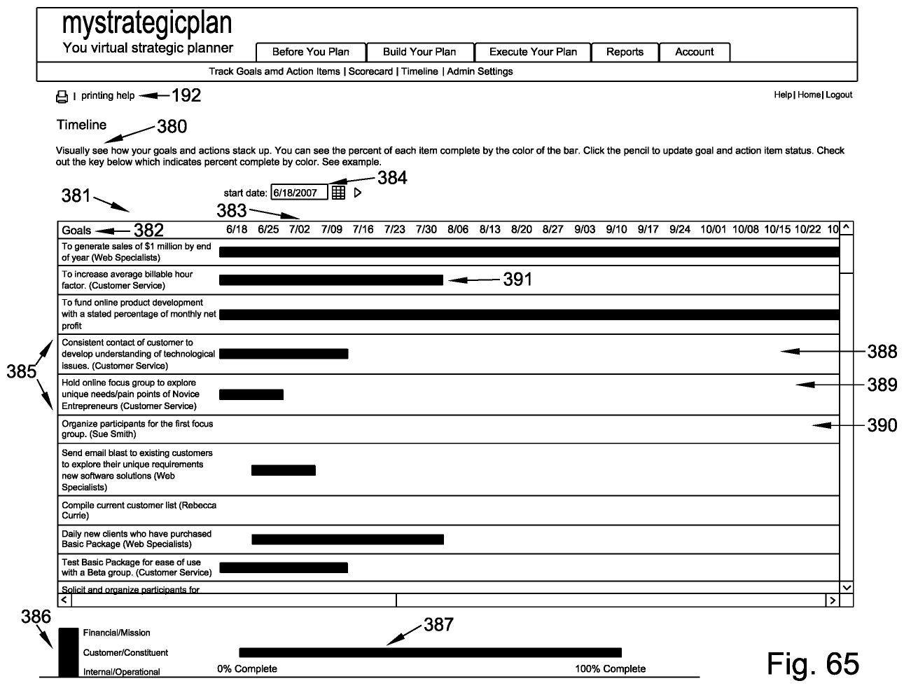

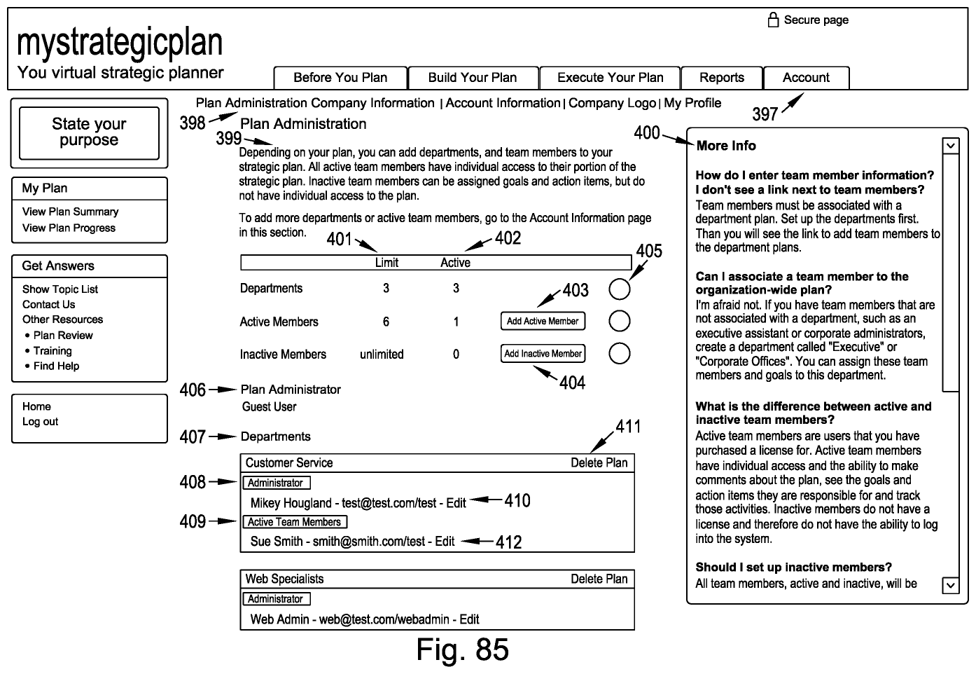

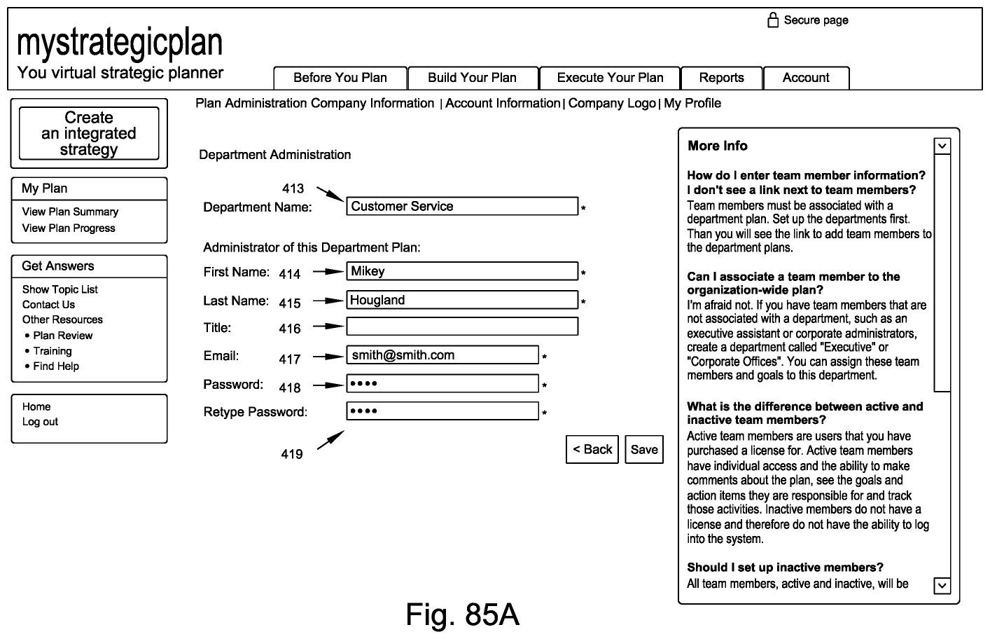

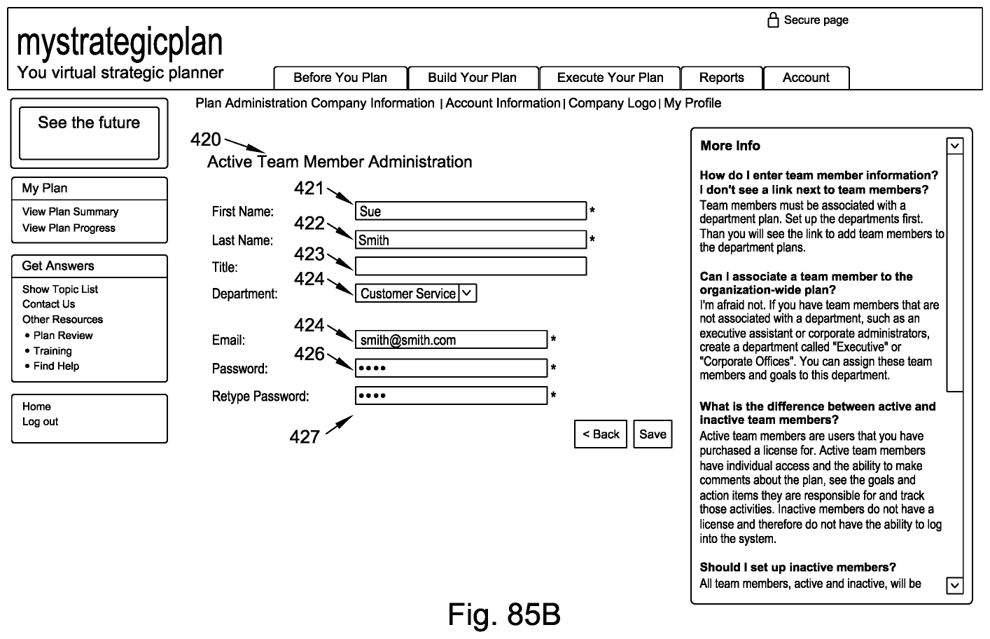

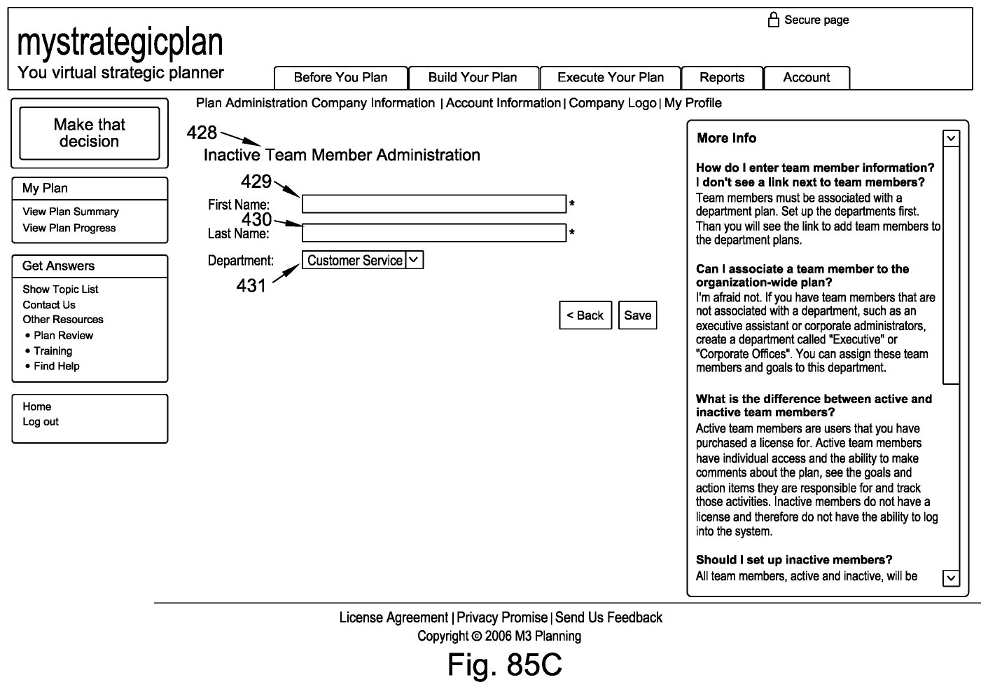

FIG. 42 shows a page that can be used to describe writing Financial/Mission Goals 167. First, a narrative 165 explains the concept of writing financial/mission goals to support the respective objective. Then helpful criteria are presented for developing a goal 166. Next the Financial/Mission Objective 167 (such as the one shown on FIG. 36) is pulled through and displayed on this page. The user then records a “Financial/Mission Goal” in an input field 168 to support the respective objective. The user can write as many goals as necessary to accomplish supporting the overarching objectives. The user selects “Who” is responsible to implement the goal from a drop down menu 169, pre-populated from the department/team members account information entered with reference to FIG. 85. For tracking purposes, a user may assign a “Priority” to the goal, by selecting the drop down menu 170, which is pulled through to Executing Your Plan as shown with reference to FIG. 62. The user may also establish a specific “Measure” 171 for the goal in the input field 168 and a “Target” 172, a measurable effect, such as an amount of money. For tracking purposes the user may assign a “Function.” from the drop down menu 173, which is used in a Executing Your Plan Scorecard to calculate year-to-date totals, such as shown with reference to FIG. 64. For tracking purposes the user may check the box 174, if the goal is based on a percentage completed, which may be used in Executing Your Plan Tracking under “% Complete” as shown in FIG. 62. For tracking purposes, a user may assign a “Start Date” 175 and an “End Date” 176, which is used in Executing Your Plan Timeline as shown in FIG. 65. In Build Your Plan, the fields Goal 168, Who 169, Measure 170, Target 172 and End Date 176 may be are pulled through to and displayed on the Goal Summary as shown ith reference to FIGS. 50 and 50A, also may be displayed or otherwise used with respect to outputs such as outlined with reference to FIG. 90. The user may click the “Back” button 177 to view the previous page viewed or “Save” button 178 to view the next page.

FIG. 43 shows a page that can be used to set goals relating to customers and constituents. A narrative 179 explains that such goals are used to support the company's efforts in meeting the needs and preferences of specific customer groups. In this regard, conventional strategic plans are typically internally focused whereas this embodiment of the System can be externally focused on the customer and marketplace. Before writing Customer/Constituent Goals, the user is directed to name and describe such Customer/Constituent groups 181, 182. At 180, the user may be further instructed that goals will be written based on the needs and characteristics of the named group 180. The user Names the Group in the input field 181 and describes their Needs and Characteristics in the input field 182. This information is pulled through to the page shown on 47 and the respective outputs outlined in the page of FIG. 90. The user may click the “Back” button 183 to view the previous page viewed or “Save” button 184 to view the next page, which continues this stage.

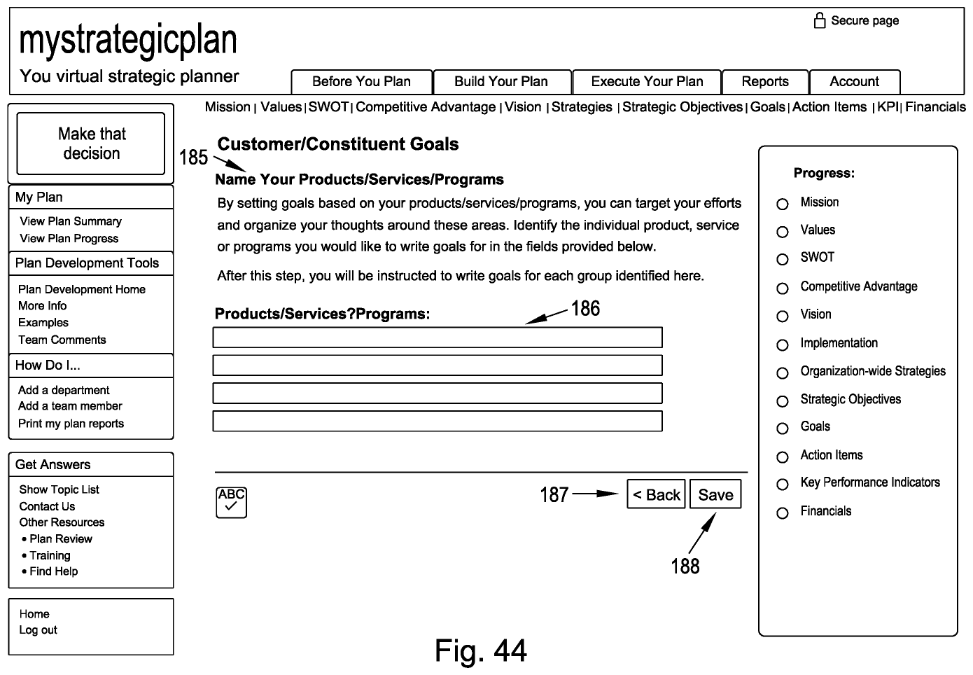

FIG. 44 shows a page that can be used to set up specific products, services, or programs that may need separate goals. At 185 a narrative briefly explains the purpose of this page, i.e., to name and describe Product, Services and/or Program groups which might need separate goals in furtherance of, e.g., meeting the needs and preferences of their customers. The user lists such Products, Services and/or Programs in an input field 186. The information listed here may then be pulled through and/or displayed on the page shown on 47 and the respective outputs outlined as shown in FIG. 90. The user may click the “Back” button 187 to view the previous page viewed or “Save” button 188 to view the next page, which continues this stage.

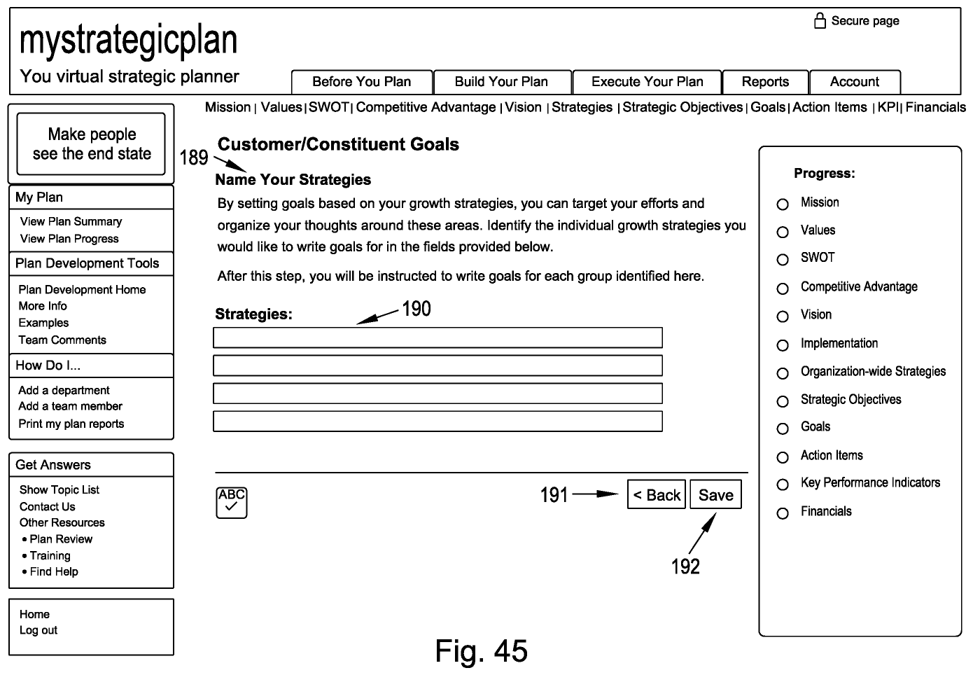

In the page associated with FIG. 45, a user is given the option to name and describe their growth Strategies 190 prior to writing Customer/Constituent goals. FIG. 45 shows a page that first contains a narrative explaining that the goals may be written to support the company's efforts based on their growth strategies 189. Next the user is instructed that goals will be written for each group identified. The user lists the Strategies in the input field 190. This information may then be pulled through and displayed on, e.g., the page shown on 47 and may also by displayed as the respective outputs outlined as shown FIG. 90. The user may click the “Back” button 191 to view the previous page viewed or “Save” button 192 to view the next page, which continues this stage.

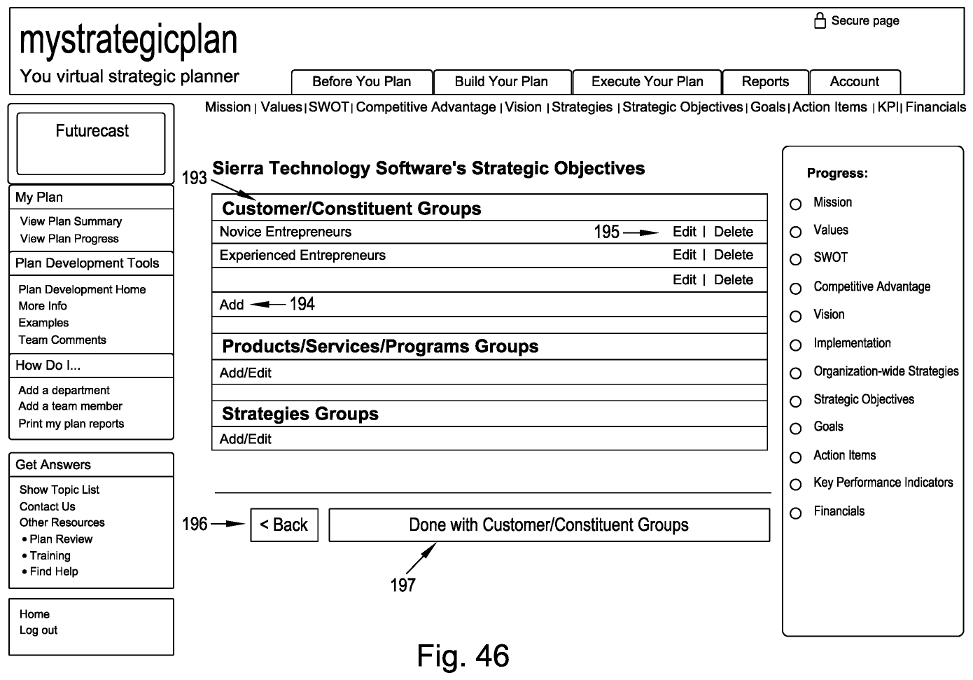

FIG. 46 shows a page that can be used to summarize the Customer/Constituent Groups, Products/Services/Programs Groups and/or Strategies Groups 193. The user clicks the respective “Add” button 194 to add an additional group or the respective “Edit” button 195 to return to a respective edit page, such as those shown with reference to FIGS. 43 through 45. The user clicks on the “Delete” button 195 to delete a group. The user may click the “Back” button 196 to view the previous page viewed or “Done with Customer/Constituent Groups” button 197 to view the next page, which continues this stage. The groups are pulled through under to the Customer/Constituent area under the respective outputs outlined in the page of FIG. 90.

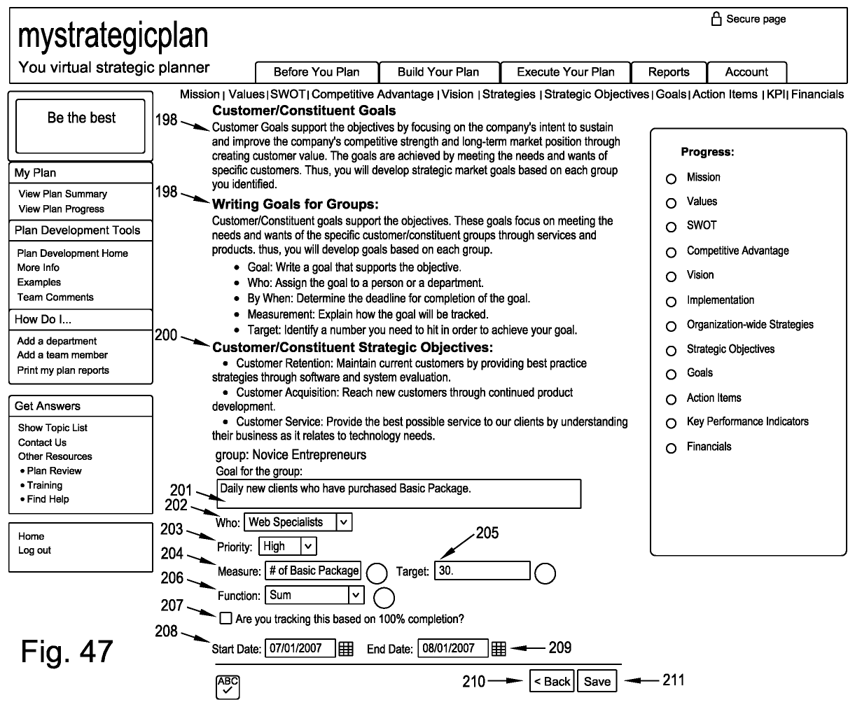

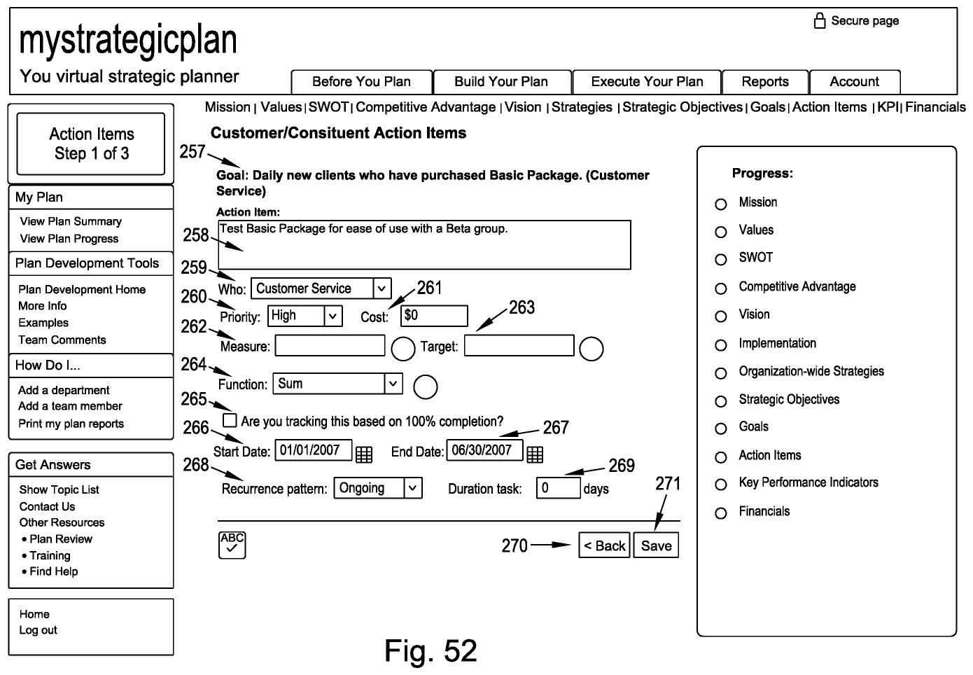

FIG. 47 shows a page that can be used to describe writing Customer/Constituent Goals 201. First, a narrative 198 may be used to explain the concept of writing customer/constituent goals to support a respective objective. Then, helpful criteria 199 may be presented for developing such a goal. Next, the Customer/Constituent Objective 200, such as those written using, e.g., a page such as that shown with reference to FIG. 37 may be pulled through and displayed on this page. A Group 201 (defined previously, using, e.g., pages FIGS. 43 through 45, and summarized with reference to, e.g., FIG. 46) may be pulled through and displayed. The user then may record a “Customer/Constituent Goal” in the input field to support a respective objective for the defined group. Goals may be written for each specific group defined previously. Thus, goals may be created to support the company's efforts in meeting the needs and preferences of specific customers. The user selects “Who” is responsible to oversee the goal from the drop down menu 202, which may be pre-populated from the department/team members account information entered with reference to FIG. 85. For tracking purposes the user may assign a “Priority” to the goal, by selecting the drop down menu 203, which may then be pulled through and displayed with regards to the Executing Your Plan section as, for example shown in FIG. 62. A specific “Measure” input field 204 and matching “Target” 205 can also be assigned. For, e.g., tracking purposes, a user may assign a “Function” from the drop down menu 206, which may be used, for example, in the Executing Your Plan Scorecard section to calculate the year-to-date totals of these defined goals as shown in FIG. 64. For tracking purposes the user may check the box 207, if the goal is based on a percentage completed, which may then be used in, e.g., Executing Your Plan Tracking under “% Complete” as shown in FIG. 62. For tracking purpose the user may assign a “Start Date” 208 and an “End Date” 209, used, e.g., in Executing Your Plan Timeline as shown in FIG. 65. The user may write as many goals as necessary to accomplish supporting the overarching objectives. In Build Your Plan the Goal, Who, Measure, Target and End Date values defined her may be pulled through and displayed on a Goal Summary sheet, as shown on in FIGS. 50 and 50A and respective outputs outlined as shown with respect to FIG. 90. This information may also be pulled through and displayed on FIG. 52, where Action Items are created to complete each goal. The user may click the “Back” button 210 to view the previous page viewed or “Save” button 211 to view the next page, which continues this stage.

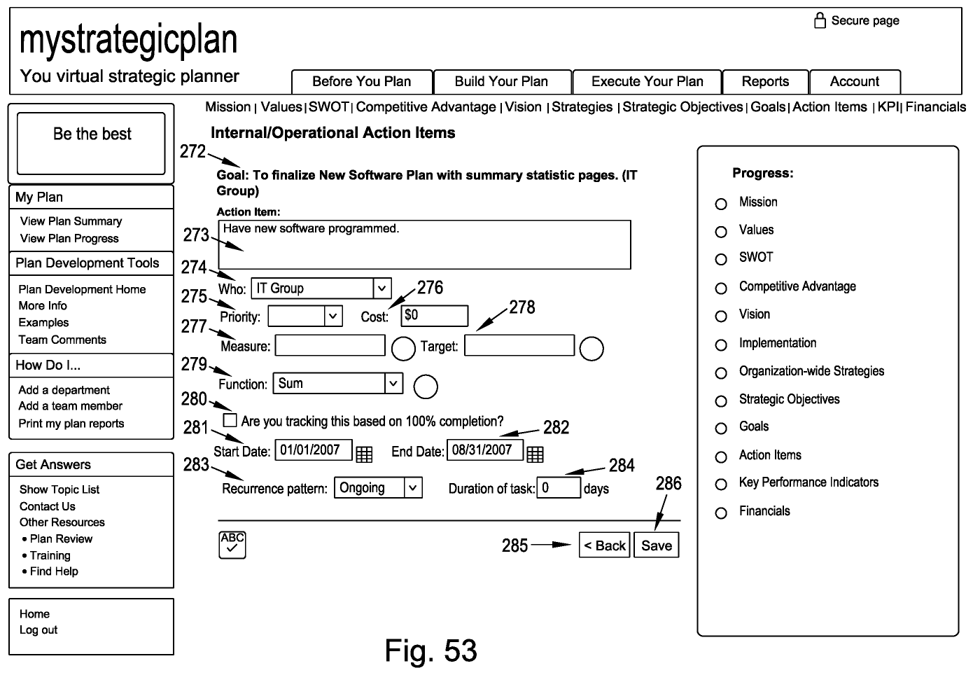

FIG. 48 shows a page that can be used to describe writing Internal/Operational Goals 215. First, a narrative 213 explains the concept of writing internal/operation goals to support the respective objective. Then, helpful criteria 213 are presented for developing a goal. Next, the Internal/Operational 214 written on the page of FIG. 38 is pulled through to this page. The user then records an “Internal/Operational Goal” to support the respective objective in the input field 215. The user selects “Who” is responsible to oversee the goal from the drop down menu 216, which is pre-populated from the department/team members account information entered in FIG. 85. For tracking purposes the user may assign a “Priority” to the goal, by selecting the drop down menu 217, which is pulled through to Executing Your Plan as shown in FIG. 62. Next, the user establishes a specific “Measure” for the goal in the input field 218 and the “Target” of accomplishment in the input field 219. For tracking purposes the user may assign a “Function” from the drop down menu 220, which is used in Executing Your Plan Scorecard to calculate the year-to-date totals as shown in FIG. 64. For tracking purposes the user may check the box 221, if the goal is based on a percentage completed, which may be used in Executing Your Plan Tracking under “% Complete,” as shown in FIG. 62. For tracking purposes, the user may assign a “Start Date” 222 and an “End Date” 223, which is used in Executing Your Plan Timeline as shown in FIG. 65. The user may write as many goals as necessary to accomplish supporting the overarching objectives. In Build Your Plan the Goal, Who, Measure, Target and End Date are are pulled through to the Goal Summary as shown on in FIGS. 50 and 50A and respective outputs outlined in the page of FIG. 90. The information entered is pulled through to FIG. 53 where Action Items are created to complete each goal. The user may click the “Back” button 224 to view the previous page viewed or “Save” button 225 to view the next page, which continues this stage.

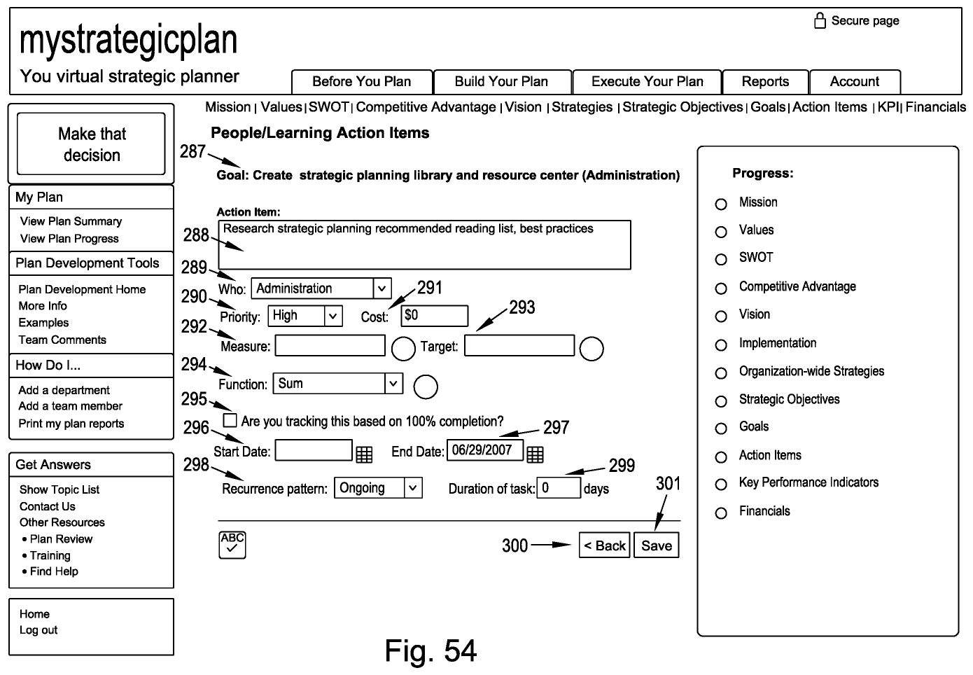

FIG. 49 shows a page that describes writing People/Learning Goals 229. First, a narrative explains the concept of writing internal/operation goals to support the respective objective 226. Then helpful criteria are presented for developing a goal 227. Next the Internal/Operational 228 written on the page of FIG. 38 is pulled through to this page shown in FIG. 49. The user then records a “People/Learning Goal” to support the respective objective in the input field 229. The user selects “Who” is responsible to oversee the goal from the drop down menu 230, which is pre-populated from the department/team members account information entered in FIG. 85. For tracking purposes the user may assign a “Priority” to the goal, by selecting the drop down menu 231, which is pulled through to Executing Your Plan as shown in FIG. 62. Next the user establishes a specific “Measure” for the goal in the input field 232 and the “Target” of accomplishment in the input field 233. For tracking purposes the user may assign a “Function” from the drop down menu 234, which is used in Executing Your Plan Scorecard to calculate the year-to-date totals as shown in FIG. 64. Similarly, for tracking purposes the user may check the box 235, if the goal is based on a percentage completed, which is used in Executing Your Plan Tracking under “% Complete” as shown in FIG. 62. For tracking purpose the user may assign a “Start Date” 2236 and an “End Date” 237, used, e.g., in Executing Your Plan Timeline, as shown in FIG. 65. The user may write as many goals as necessary to accomplish supporting the overarching objectives. In Build Your Plan the values input in the Goal, Who, Measure, Target and End Date are pulled through to the Goal Summary as shown on in FIGS. 50 and 50A and respective outputs outlined in the page of FIG. 90. The information is pulled through to FIG. 54 where Action Items are created to complete each goal. The user may click the “Back” button 238 to view the previous page viewed or “Save” button 239 to view the next page, which continues this stage.

FIG. 50 shows a page that displays a close-up summary of Goals 240 written by the user on, e.g. one or more of the areas of interest 9600A (FIG. 96) such as: Financial/Mission (FIG. 42), Customer/Constituent (FIG. 47), Internal/Operational (FIG. 48), and People/Learning (FIG. 49). The goals are grouped under the corresponding Objectives. Each Goal hs information that was, e.g., pulled through from the input fields in FIGS. 42, 47, 48 and 49, as follows 241: Goal, Who, By When, Measure, and Target. The user can add a goal by clicking the “Add New Goal” button 242 under the respective objective. The user can edit or delete a goal by clicking the “Edit/Delete” button 243. These four areas are subsequently pulled throughout to provide the organizational framework for developing Action Items beginning in FIG. 51. The Goals are pulled through in the, e.g., four areas to the respective outputs outlined in the page of FIG. 90.

FIG. 50A shows a page that displays a summary of the Goals written by the user on the, e.g., areas of interest 244: Financial/Mission, Customer/Constituent, Internal/Operational, and People/Learning. The goals are grouped under the corresponding Objectives. The user makes revisions and then clicks on the “Save as Draft” button 246 or “Done with Goals” button 247 located at the bottom of this page. The user may also click on the “Back” button 245 to view the previous page.

FIG. 51 shows a page that describes the overall process for developing Action Items used to achieve the Goals written, e.g., in the page of FIGS. 42 through 49. First, a narrative 248 explains the general Action Item writing process so that the tactics provide an action to-do list for each goal. Next, Questions to Answer 249 are presented to support the action item writing process.

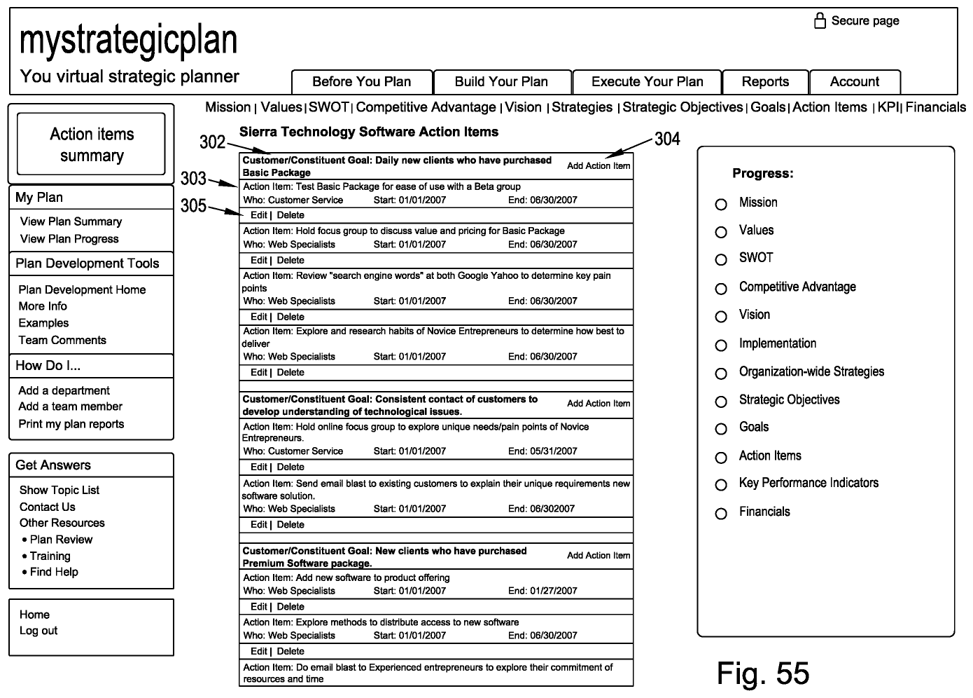

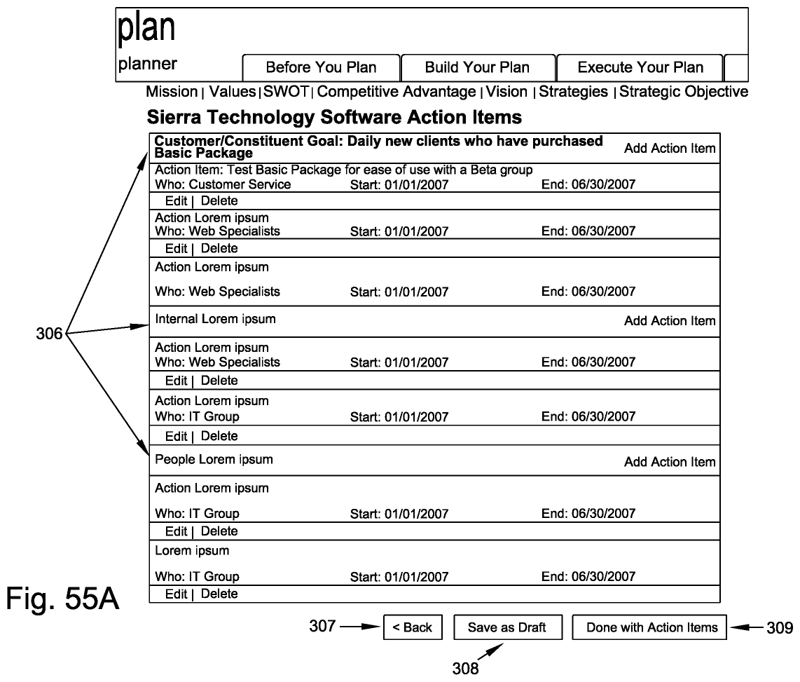

FIG. 51 shows a page that continues the framework initiated with the Broad Objectives (FIG. 35) and continued with the Goals (FIG. 41) written in areas areas of interest 250: e.g., Financial/Mission Goals, Customer/Constituent Goals, Internal/Operational Goals, and People/Learning Goals. However, the Financial/Mission Goals, in some embodiments, do not have Action Items, as these goals are the result of achieving the goals in the other three areas. The user may write Customer/Constituent Goals by clicking on the “edit” button 251 which goes to the page shown in FIG. 52; Internal/Operational Goals by clicking on the “edit” button 252 which goes to the page shown in FIG. 53; or the People/Learning Goals by clicking on the “edit” button 253 which goes to the page shown in FIG. 54. The progress lights 254 remain gray if the action item area has not been visited and green if the action item area has been visited. The user may click on “View Summary” 256 to view the written goals that support the objectives as shown in FIGS. 55 and 55A. When finished the user may select “Done with Action Items” button 164 located at the bottom of this page or the “Back” button 255 to view the previous page.

FIG. 52 shows a page that describes writing Customer/Constituent Action Items 258. First, the Customer/Constituent Goal 257 written on the page of FIG. 47 is pulled through to this page shown in FIG. 52. The user then records a Customer/Constituent “Action Item” to support the respective goal in the input field 258. The user selects “Who” is responsible to oversee the action item from the drop down menu 216, which is pre-populated from the department/team members account information entered in FIG. 85. For tracking purposes the user may assign a “Priority” to the action item, by selecting the drop down menu 260, which is pulled through to Executing Your Plan as shown in FIG. 62 and an estimated cost associated with the action item 261. If this cascades down to a department level plan, the user can establish a specific “Measure” for the action item in the input field 262 and the “Target” of accomplishment in the input field 263. If this cascades down to a departmental level plan, the user may assign a “Function” from the drop down menu 264, which is used in Executing Your Plan Scorecard to calculate the year-to-date totals as shown in FIG. 64. For tracking purposes the user may check the box 265, if the action item is based on a percentage completed, which is used in Executing Your Plan Tracking under “% Complete” as shown in FIG. 62. For tracking purposes, the user may assign a “Start Date” 266 and an “End Date” 267, which is used in Executing Your Plan Timeline as shown in FIG. 65. For the Timeline tracking purposes the user may indicate of the “Recurrence pattern” of the action item from a drop down menu 268 and the “Duration of task” 269. The user may write as many action items as necessary to accomplish the goal. In Build Your Plan the Action Item, Who and End Date are are pulled through to the Action Item Summary as shown on in FIGS. 55 and 55A and respective outputs outlined in the page of FIG. 90. The user may click the “Back” button 270 to view the previous page viewed or “Save” button 271 to view the next page, which continues this stage.

FIG. 53 shows a page that describes writing Internal/Operational Action Items 273. First, the Internal/Operational Goal 272 written on the page of FIG. 48 is pulled through to this page shown in FIG. 53. The user then records an Internal/Operational “Action Item” to support the respective goal in the input field 273. The user selects “Who” is responsible to oversee the action item from the drop down menu 274, which is pre-populated from the department/team members account information entered in FIG. 85. For tracking purposes the user may assign a “Priority” to the action item, by selecting the drop down menu 275, which is pulled through to Executing Your Plan as shown in FIG. 62 and an estimated cost associated with the action item 276. If the plan cascades down to the department level, the user may establish a specific “Measure” for the action item in the input field 277 and the “Target” of accomplishment in the input field 278. If the plan cascades down to the department level, the user may assign a “Function” from the drop down menu 279, which is used in Executing Your Plan Scorecard to calculate the year-to-date totals as shown in FIG. 64. For tracking purposes the user may check the box 280, if the action item is based on a percentage completed, which is used in Executing Your Plan Tracking under “% Complete” as shown in FIG. 62. For tracking purpose the user may assign a “Start Date” 281 and an “End Date” 282, which is used in Executing Your Plan Timeline as shown in FIG. 65. For Timeline tracking purposes the user may indicate of the “Recurrence pattern” of the action item from a drop down menu 283 and the “Duration of task” 284. The user may write as many action items as necessary to accomplish the goal. In Build Your Plan the Action Item, Who and End Date are pulled through to the Action Item Summary as shown on in FIGS. 55 and 55A and respective outputs outlined in the page of FIG. 90. The user may click the “Back” button 285 to view the previous page viewed or “Save” button 286 to view the next page, which continues this stage.

FIG. 54 shows a page that describes writing People/Learning Action Items 288. First, the People/Learning Goal 287 written on the page of FIG. 49 is pulled through to this page. The user then records a People/Learning “Action Item” to support the respective goal in the input field 288. The user selects “Who” is responsible to oversee the action item from the drop down menu 289, which may be pre-populated from the department/team members account information entered in FIG. 85. For tracking purposes the user may assign a “Priority” to the action item, by selecting the drop down menu 290, which is pulled through to Executing Your Plan (as shown in FIG. 62) and an estimated cost associated with the action item 291. If the plan cascades down to a lower hierarchical level, such as the department level, the user may establish a specific “Measure” for the action item in the input field 292 and the “Target” of accomplishment in the input field 293. The user may assign a “Function” from the drop down menu 294, used in Executing Your Plan Scorecard to calculate the year-to-date totals as shown in FIG. 64. For tracking purposes, the user may check the box 295, if the action item is based on a percentage completed, which is used in Executing Your Plan Tracking under “% Complete” as shown in FIG. 62. For further tracking purposes, the user may assign a “Start Date” 296 and an “End Date” 297, used in Executing Your Plan Timeline as shown in FIG. 65. For Timeline tracking purposes the user may indicate the “Recurrence pattern” of the action item from a drop down menu 298 and the “Duration of task” 299. The user may write as many action items as necessary to accomplish the goal. In Build Your Plan the Action Item, Who and End Date are pulled through to the Action Item Summary as shown on in FIGS. 55 and 55A and respective outputs outlined in the page of FIG. 90. The user may click the “Back” button 300 to view the previous page viewed or “Save” button 301 to view the next page, which continues this stage.

FIG. 55 shows a page that displays a close-up summary of the Action Items written by the user on, e.g., three areas 302: Customer/Constituent (FIG. 52), Internal/Operational (FIG. 53), and People/Learning (FIG. 54). The Action Items are groups under the corresponding Goals. Each Action Item has information that was pulled through from the input fields in FIGS. 52, 53 and 54, as follows 303: Action Item, Who, By When, Start and End. The user can add an Action Item by clicking the “Add Action Item” button 304 under the respective goal. The user can edit or delete an Action Item by clicking the “Edit/Delete” button 305. The Action Items are pulled through in the three areas to the respective outputs outlined in the page shown in FIG. 90.

FIG. 55A shows a page that displays an entire summary of the Action Items written by the user in, e.g., the three areas 306: Customer/Constituent, Internal/Operational, and People/Learning. The Action Items are grouped under the corresponding Goals. The user makes the necessary revisions and then clicks on the “Save as Draft” button 308 or “Done with Goals” button 309 located at the bottom of this page. The user may also click on the “Back” button 307 to view the previous page.

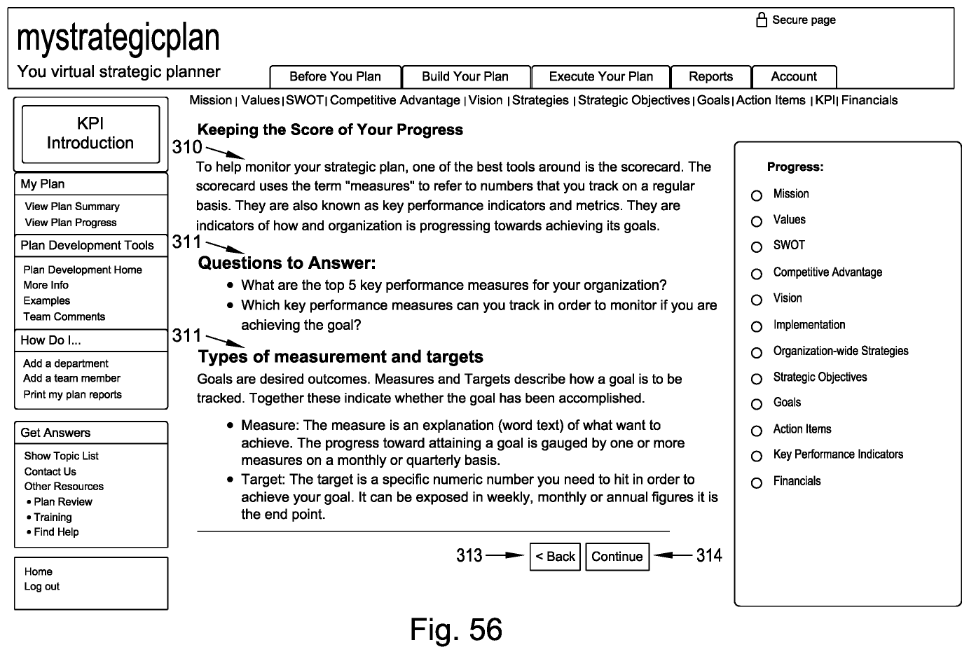

FIG. 56 describes the Scorecard, which is a framework for holistic performance measurement, and aligning such performance with the firm's mission and vision. Additionally, the Scorecard can be used both as a measurement a management tool for implementing the strategic plan. A narrative 310 explains “measures that you track on a regular basis” and “key performance indicators” that are metrics of how an organization is progressing towards achieving its goal. Questions 311 are presented for the user to answer in the process of developing key performance metrics. A narrative 312 describes the concept of “measures” and “targets” when tracking goals. The user may click the “Back” button 313 to view the previous page viewed or “Continue” button 314 to view the next page, which continues this stage.

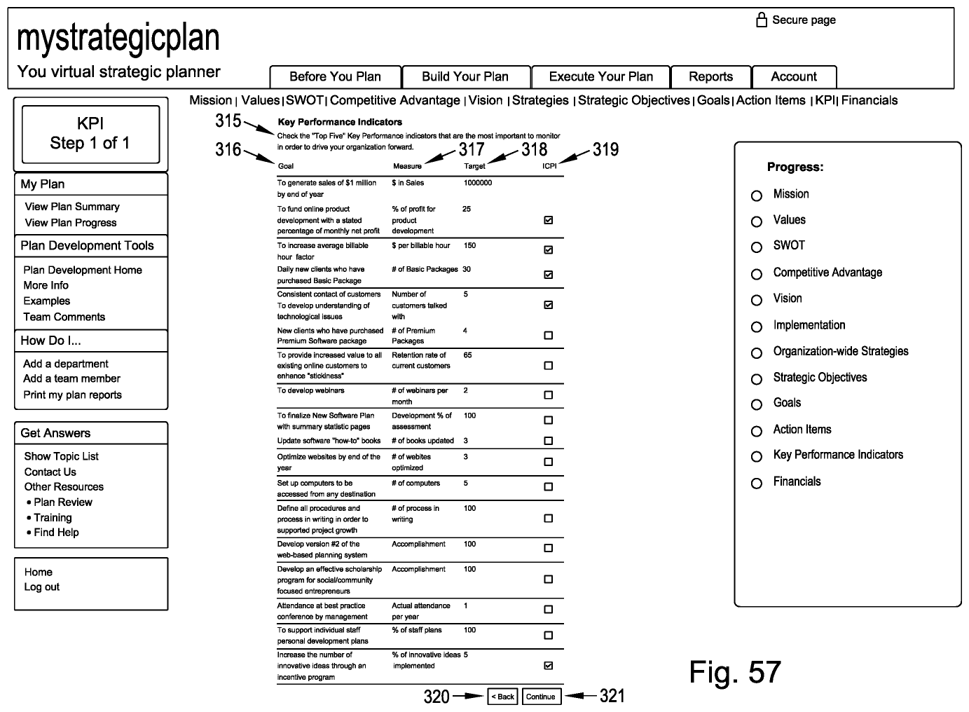

FIG. 57 shows a page that allows a user to choose certain performance indicators as Key Performance Indicators. Instructions 315 are given to check the “Top Five” Key Performance Indicators (KPIs) that are important to monitor to drive the organization forward. Goals developed, as shown in FIGS. 42, 47, 48, 49 and 50, are listed in the left-hand column 316. The associated Measures 317 and Targets 318 are listed for Goals previously established as shown in FIGS. 42, 47, 48, 49 and 50. The user is asked to select a number, e.g., five KPIs by putting a check mark in the appropriate boxes 319. The user may click the “Back” button 320 to view the previous page viewed or “Continue” button 321 to view the next page, which continues this stage.

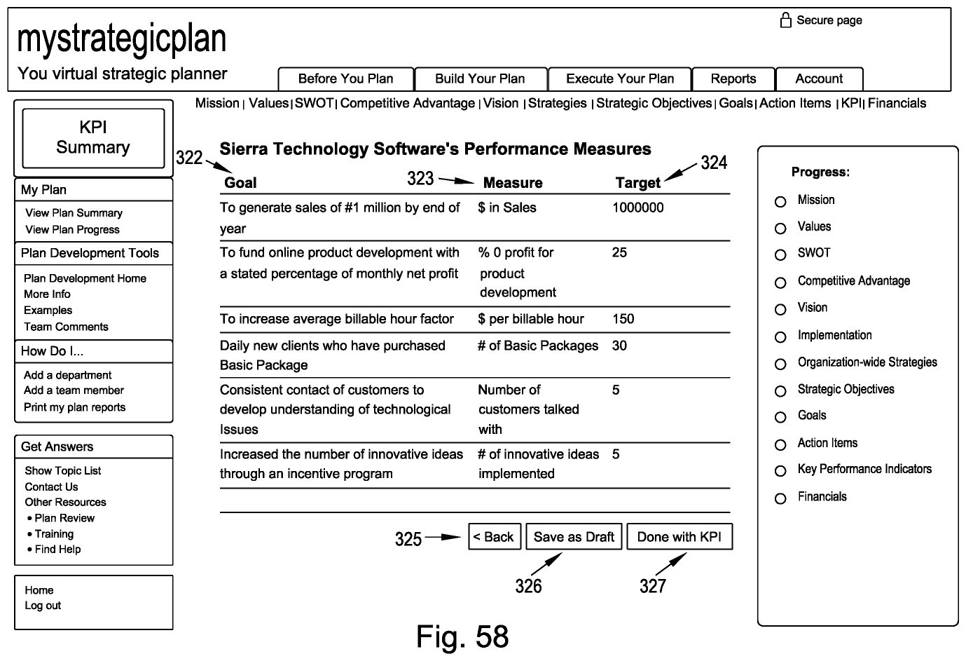

FIG. 58 shows a page that displays the Key Performance Indicator (KPI) summary. Goals that were selected on the page shown in FIG. 57 are displayed in the left-hand column 322. The associated Measures 323 and Targets 324 for each of selected Goals is displayed in the next two columns. The user may make revisions by clicking the “Back” button 325 to view the previous page. The user may click on the “Save as Draft” button 326 or “Done with KPI” button 327 located at the bottom of this page. The selected KPIs are pulled through to Executing Your Plan as shown in on the page of FIGS. 62 and 64. The KPIs are identified with a “key” icon. The KPIs are pulled through to the respective outputs outlined in the page of FIG. 90.

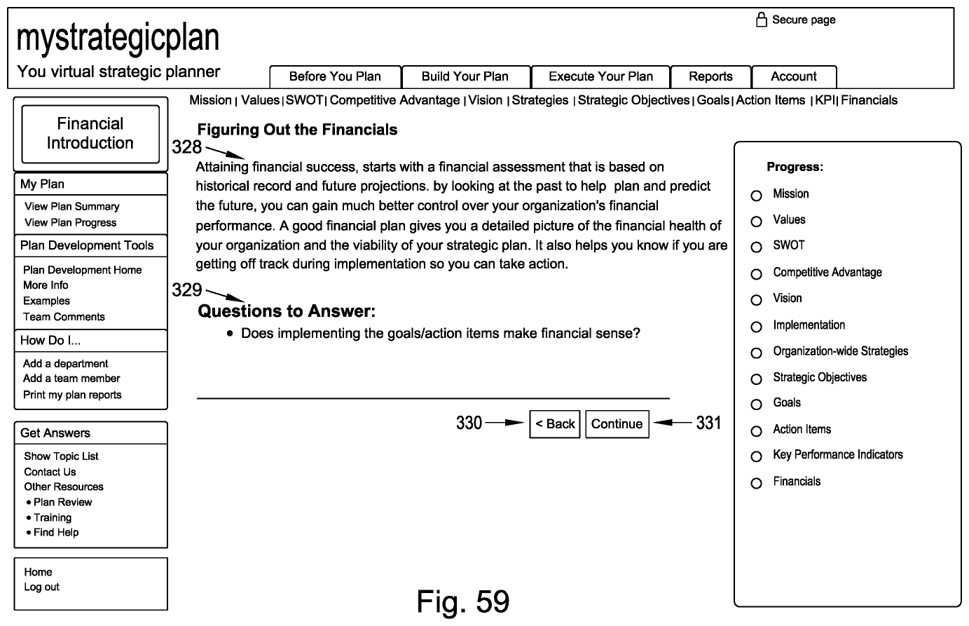

FIG. 59 shows a page for the initial discussion regarding a Financial Assessment of the user's strategic plan development. An initial discussion regarding usefulness of financial assessment of the goals and action items created can focus the user on the issue of limited resources 328. A Question to Answer 329 asks the user if implementing the goals and action items make financial sense. The user may click the “Back” button 330 to view the previous page viewed or “Continue” button 331 to view the next page, which continues this stage.

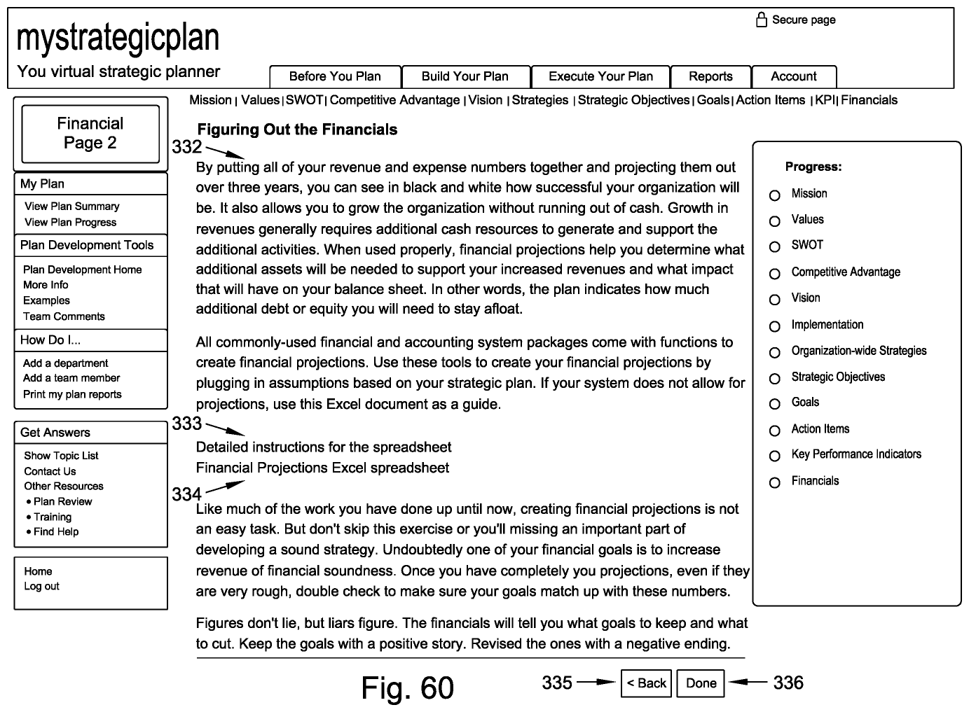

FIG. 60 shows a Financial Projections discussion page. Such projections involve listing potential revenue and expenses for goals and projecting them out over coming years 332. A link showing “Detailed instructions for the spreadsheet 333 is provided. A link to the “Financial Projection Excel spreadsheet” 334,) the pages shown with reference to FIGS. 61 and 61A) is also provided. The user may click the “Back” button 335 to view the previous page viewed or “Continue” button 336 to view the next page, which continues this stage.

FIGS. 61 and 61A shows a page that contain the “Financial Projection” spreadsheet. The user may use this spreadsheet to create financial projections based on the company's strategic plan. The plan may need to be revised based on the financial projections. This concludes the last stage under Build Your Plan tab as shown on the page of FIG. 2.

FIG. 62 shows a page which begins the implementation phase of the strategic plan. The implementation phase is housed under “Execute Your Plan” tab 337. Main sub-headings under Execute Your Plan, are, e.g.,: Track Goals and Action Items, Scorecard, Timeline and Admin Settings 338. FIG. 62 shows a page for Tracking Goals and Action Items, which provides information that reflects the plan progress to date 339. The “Achievements” accomplished are at the top 340 followed by the “To Dos” 341. Under both Achievements and To Dos, progress information is provided in columns. The user can click the top of any of the columns to sort the information. The second column labeled “Item” 343 lists all the goals and action items entered on the pages shown in FIGS. 42, 47, 48, 49, 52, 53, and 54. The first column labeled “Priority” 342 lists the priority indicated for each Item (goal and action item) entered in FIGS. 42, 47, 48, 49, 52, 53, and 54. The third column labeled “Who” 344 lists the person responsible for each Item entered in FIGS. 42, 47, 48, 49, 52, 53, and 54. The fourth column labeled “% Complete” 345 lists the percent completed for each item entered as shown on the page of FIG. 62A. The fifth column labeled “Due Date” 346 lists the end date for each Item entered in FIGS. 42, 47, 48, 49, 52, 53, and 54. The sixth column labeled “Status” 347 lists the progress status for each item based on the status entered as shown on the page of FIG. 62A. The status light key 352 is as follows: green for on target, yellow for not on target, red for past due, and gray for no status. The seventh column labeled “Comments” 348 lists team comments for each item entered as shown on the page of FIG. 62A. The last column labeled. “Updated” 349 lists the last time the Item was updated.

After each Item in, e.g., FIG. 62, there is a “pencil” icon 350. The user may click on the pencil and a pop-up screen appears as shown in FIG. 62A. With reference to FIG. 62A, for the selected Item, the user may select from a drop down menu the Status of the Item, which, in certain embodiments, the possibilities are: Achieved, In Progress, Not Started, Deferred, or Waiting on Someone 354. This information is reflected in the Status 347 progress lights in FIG. 62. For the Item the user may indicate the % Complete, which is reflected under % Complete 345 in FIG. 62. For the Item the user may write a Comment 356, which is reflected under Comments 348 in FIG. 62. Additionally, with reference to FIG. 62, after some Items there is a “key” icon 351. This indicates that the goal was selected by the user as a KPI as shown in FIG. 57. When the user clicks on the key 351 the page of FIG. 64 displays. All the goals and action items 357 written on the pages of FIGS. 42, 47, 48, 49, 52, 53 and 54 can be tracked as shown on the page displayed in FIG. 62B.

FIG. 63 shows a page that displays the report output for Tracking Goals and Action Items 358: This report is printed at the top of the page 353 displayed in FIG. 62. The Achievements are listed at the top 359 and followed by the To Dos 360. When an item is accomplished it automatically is listed under Achievements.

FIG. 64 shows a page which contains the Scorecard for the implementation phase of the strategic plan. The Scorecard tracks plan performance. First, instructions are provided which explain how to track goal performance by entering monthly numbers against monthly targets based on yearly targets 361. Following the instructions is a chart 362 listing company goals, monthly entry field and year-to-date totals. On the left-hand side of the chart all the goals 363 entered on the pages of FIGS. 42, 47, 48 49 are listed. The middle of the chart contains months based on the year selected 364. The right-hand side of the chart contains Year-to-Date number 365. Goals that are KPI, as selected on page shown in FIG. 57, have a “key” icon after them 366.

To enter monthly targets, the user selects the icon below the goal on the page shown in FIG. 64. A pop-screen is display as shown on the page in FIG. 64A. The user enters the monthly target numbers for each month 372. The YTD Target number 373 is shown at the bottom of the page in FIG. 64A. When finished the user may select “Cancel” or “OK” button 374. The pop-up screen closes and the user is taken back to the Scorecard on the page of FIG. 64. The monthly target numbers 368 are displayed under the actually monthly entry boxes 369. Under Year-To-Date the target number 370 is displayed under the actually Year-To-Date number 371. The calculation is based on the “Function” (sum, average, highest number) selected for each goal in FIGS. 42, 47, 48 and 49.

FIG. 64B shows a page that displays the complete Scorecard with all of the company goals 372. On the left hand side is a narrow colored bar. The goals are grouped based on the four key areas as discussed on the page of FIG. 41. The color key is as follows 373: Financial/Mission is black, Customer/Constituent is dark blue, Internal/Operational is medium blue, and People/Learning is light blue.

FIG. 64C shows a page that displays the Scorecard graphically. The numbers entered in the page on FIG. 64 is displayed in excel chart form 364.

FIG. 65 shows a page which contains the Timeline for the implementation phase of the strategic plan. The Timeline gives a visual representation of the goals and action items over time. Instructions 380 are provided which explain the functionalities of the Timeline chart. A chart 381 lists company goals and calendar dates with bars indicating start and end date for the goals. On the left-hand side of the chart, goals entered on the pages of FIGS. 42, 47, 48 49 and action items 382 entered on the pages of FIGS. 52, 53, and 54 are listed. The middle of the chart contains calendar dates 383. The start date can be changed by entering a date for by using the calendar 384. On the left hand side is a narrow colored bar 385. The goals and action items are grouped based on, e.g., four key areas as discussed on the page of FIGS. 41 and 51, and with reference to FIG. 96A. The color key 386, in some embodiments, is as follows: Financial/Mission is black, Customer/Constituent is dark blue, Internal/Operational is medium blue, and People/Learning is light blue. The chart displays a colored bar 191 with a start and end date as entered in FIGS. 42, 47, 48, 49, 52, 53, and 54. The percent complete is indicated by the shaded color of the bar 387. The information for the percent complete was entered on the pop-up screen page in FIG. 62A. The goals may be shaded a dark gray 388, action items may be a medium gray 389, and individual action items may be a light gray 390.

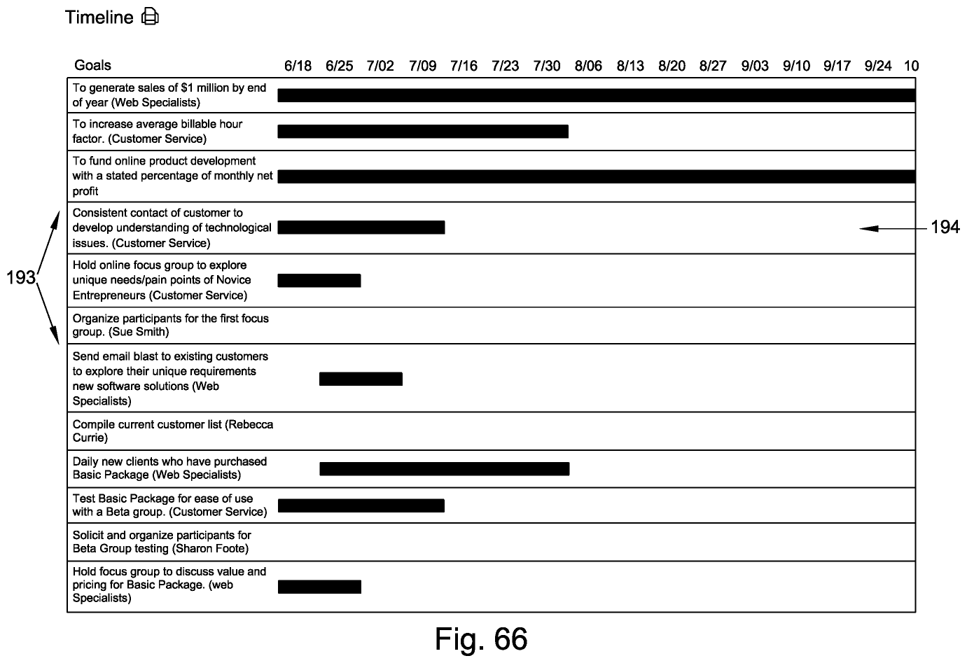

The Timeline Report output can be printed as shown at the top of the page of FIG. 65. The actual Timeline Report is shown in FIG. 66. The report includes the all goals and action items group according to their key area 193, shaded based on their category 194, start 195 and end 196 dates, and percent completed 197.

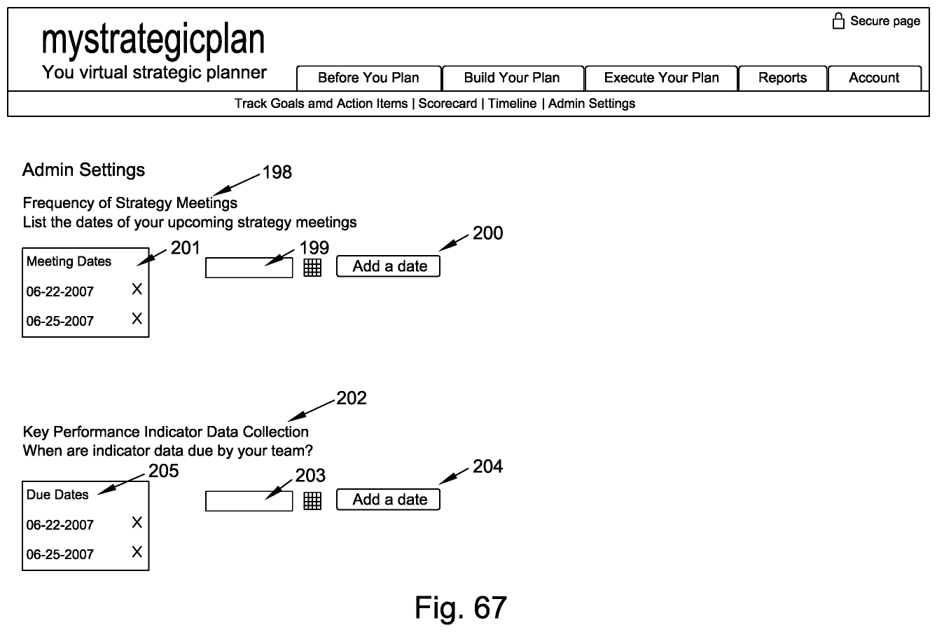

FIG. 67 shows Admin Settings for the implementation phase of the strategic plan. The “Frequency of Strategy Meetings” 198 list the dates of the upcoming strategy meetings. The user inputs the meeting date in the entry field 199 and clicks “Add a date” button 200. The Meeting Dates are listed on the left side 201. The Admin Settings also show the “Key Performance Indicator Data Collection” 202 to list the dates when the data is due by the team. The user input the meeting date in the entry field 203 and click “Add a date” button 204. The Meeting Dates are listed on the left side 205. This concludes the four areas for implementation listed under “Execute Your Plan”.

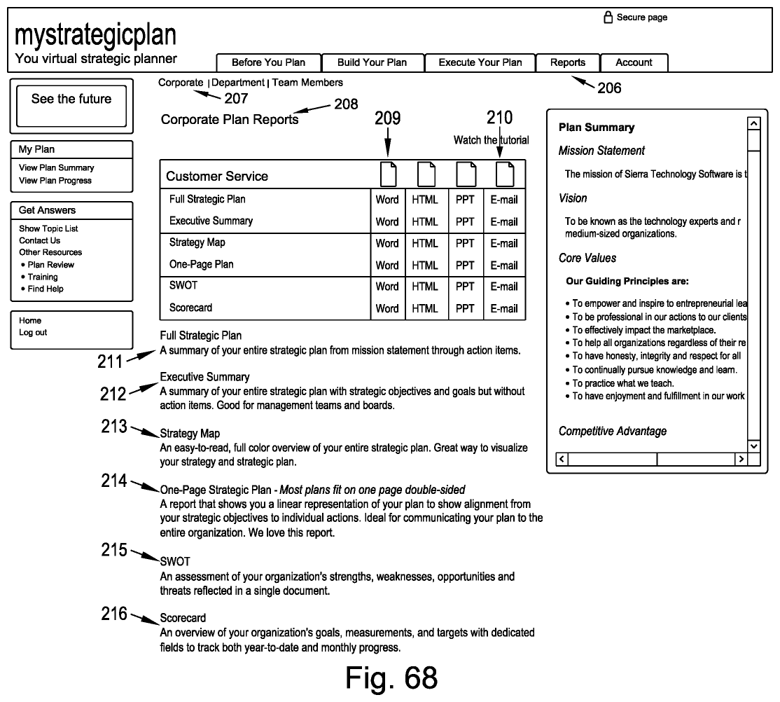

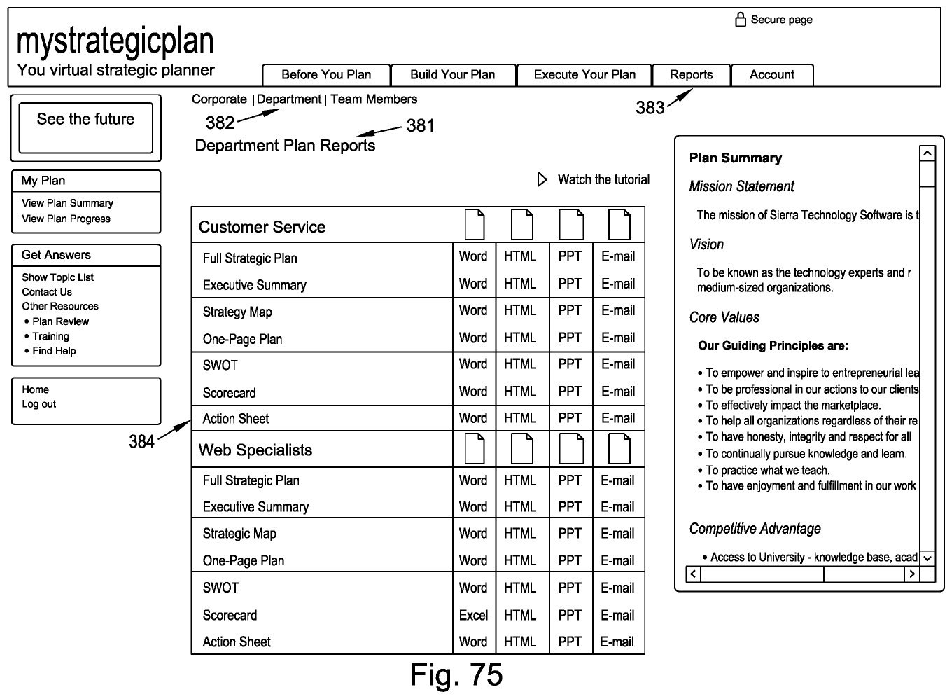

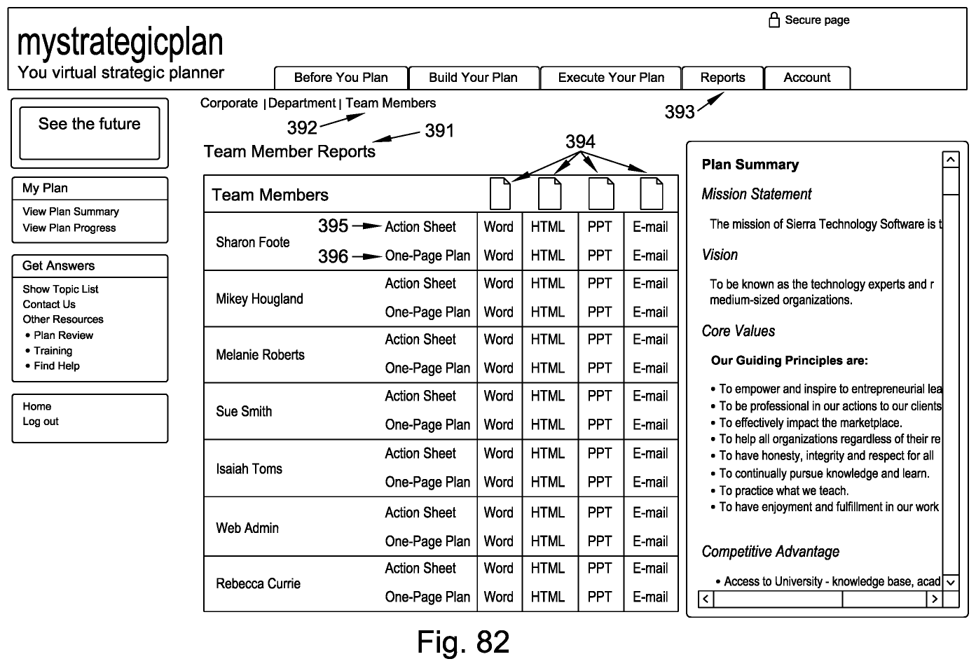

FIG. 68 shows a page which begins the Report outputs of the strategic plan. The outputs are found under “Reports” tab 206. There are, e.g., three main sub-headings under Reports, which, in some embodiments are: Corporate, Department and Team Members 207 referring to the Corporate Report outputs listed in FIG. 68, Department Report outputs listed in FIG. 75 and Team Members Reports outputs listed in FIG. 82. Since the system is dynamic, the user can make revisions whenever new information is available. The new information is entered in the appropriate input field and pulled through to the various Reports as displayed in FIG. 90.

FIG. 68 shows a page that lists, e.g., six outputs for the Corporate Plan Reports 208. The output reports can be exported to various formats, such as Word, HTML, and PPT 209. In a Word document, revisions can be made, but these revisions must be re-entered in the appropriate entry input fields to be in the planning system. Outputs can be emailed to a colleague 210 as well. Output reports provide an integration (which, in some embodiments is a complete integration) of the user's inputs made in the strategic planning process.

The Full Strategic Plan 211 is a summary of the organization's strategic plan from mission through objectives, goals and action items. It is an outline summary of all the inputs under Build Your Plan from FIGS. 4 through 55. It presents the entire strategic plan in an easy to use format.

The Executive Summary 212 is a summary of the strategic plan with strategic objectives and goals, but without action items. It is an outline summary of all the inputs under Build Your Plan from FIGS. 4 through 50. It is a high level plan that is good for management teams and boards.

The Strategy Map 213 is an easy-to-read, full-color overview of the strategic plan. The colorful categorization is a great way to visualize and communicate the strategic plan to everyone in the organization. It is an outline summary of the inputs under Build Your Plan from FIGS. 4 through 50 and 57.

The One-Page Strategic Plan 214 is a linear representation of the plan to show alignment from the strategic objectives to individual action items. It is ideal for communicating the plan to the entire organization.

The SWOT (or Internal and External Assessment) 215 is an assessment of the organization's strengths, weaknesses, opportunities and threats reflected in a single document. This visual summary is a tool for producing a fit between the organization's internal and external environment.

The Scorecard 216 is an overview of the organization's goals, measurements and targets with dedicated fields to track both year-to-date and monthly progress. It is a management tool to monitor an measure performance of organizational activities. It can be exported to an Excel file for monthly tracking purposes.

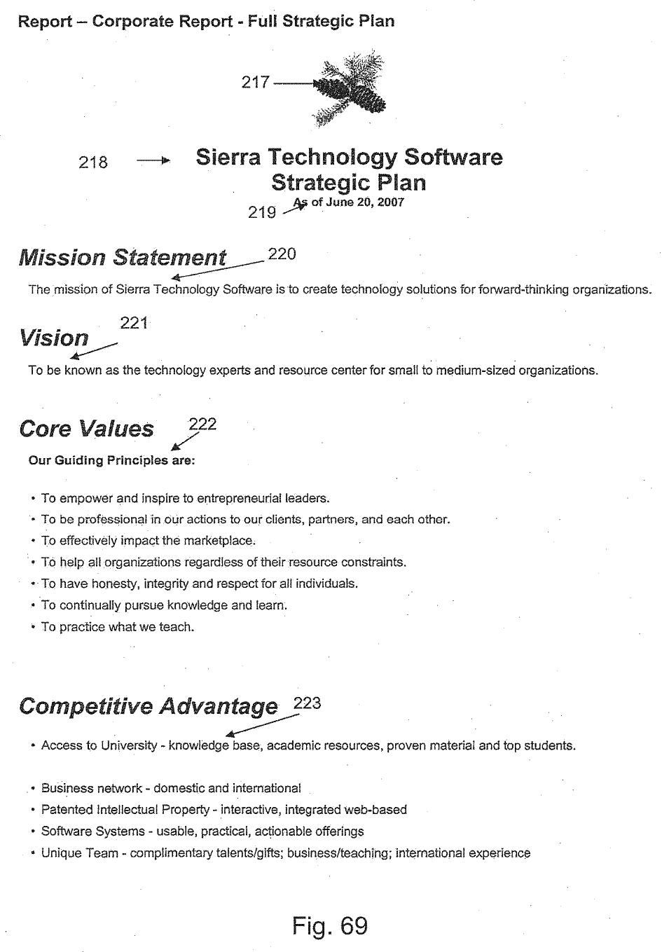

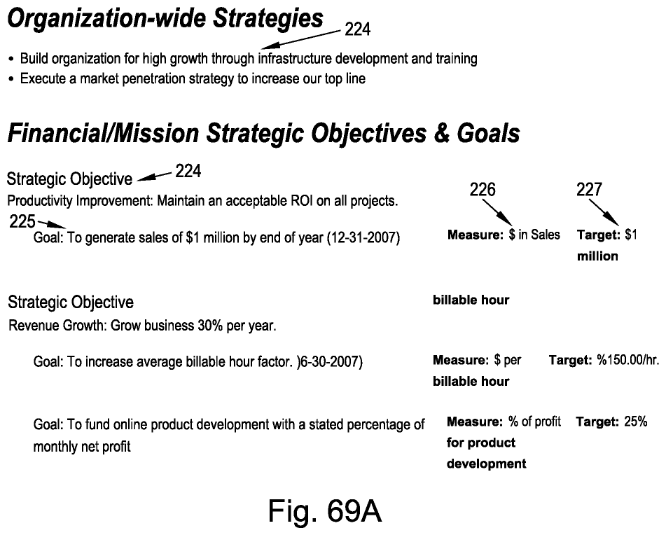

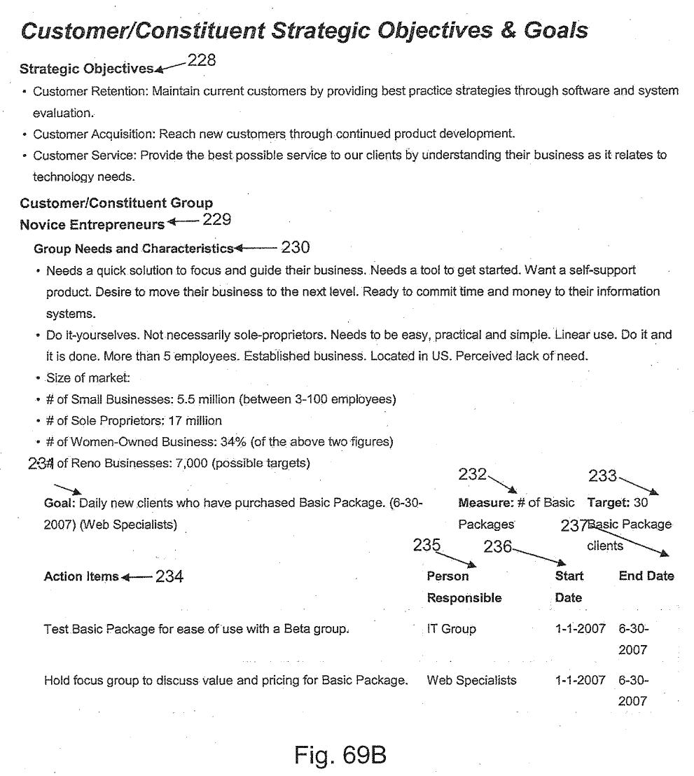

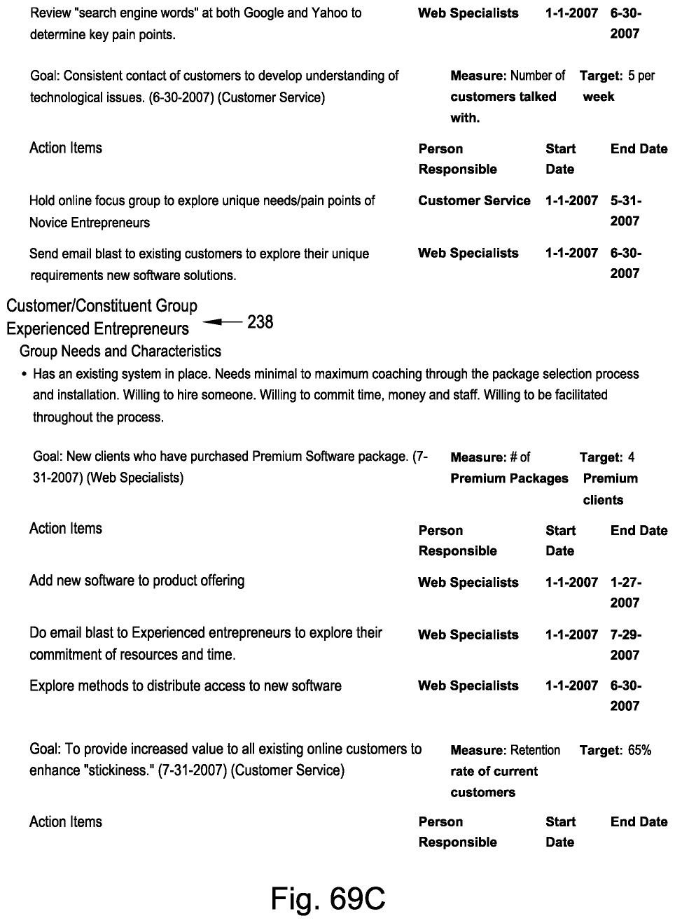

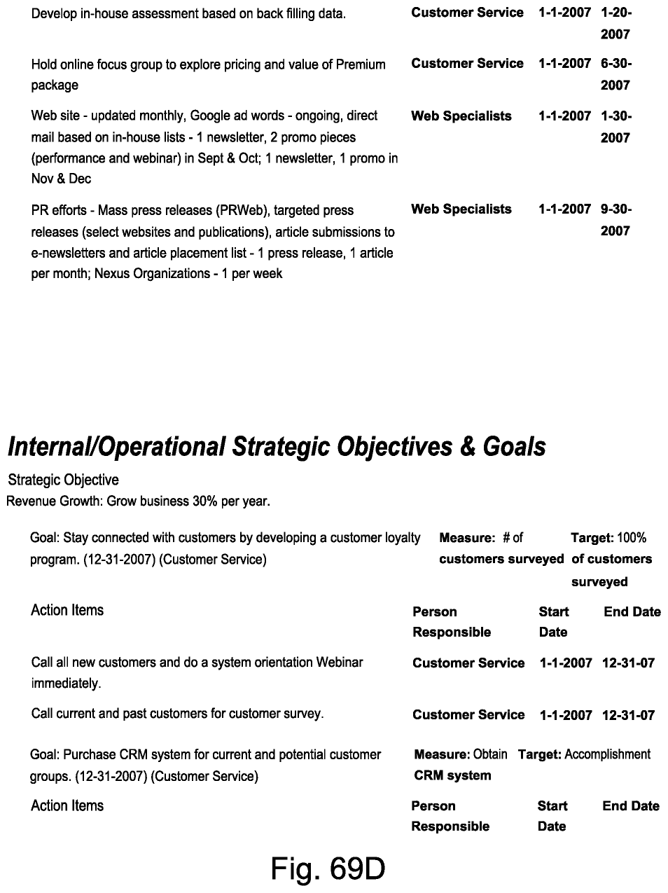

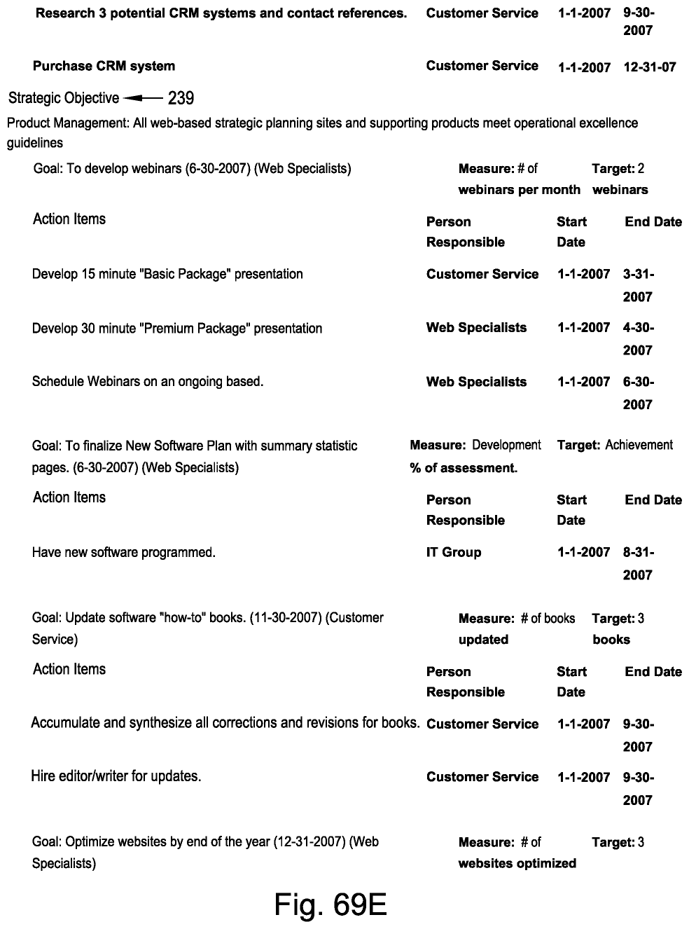

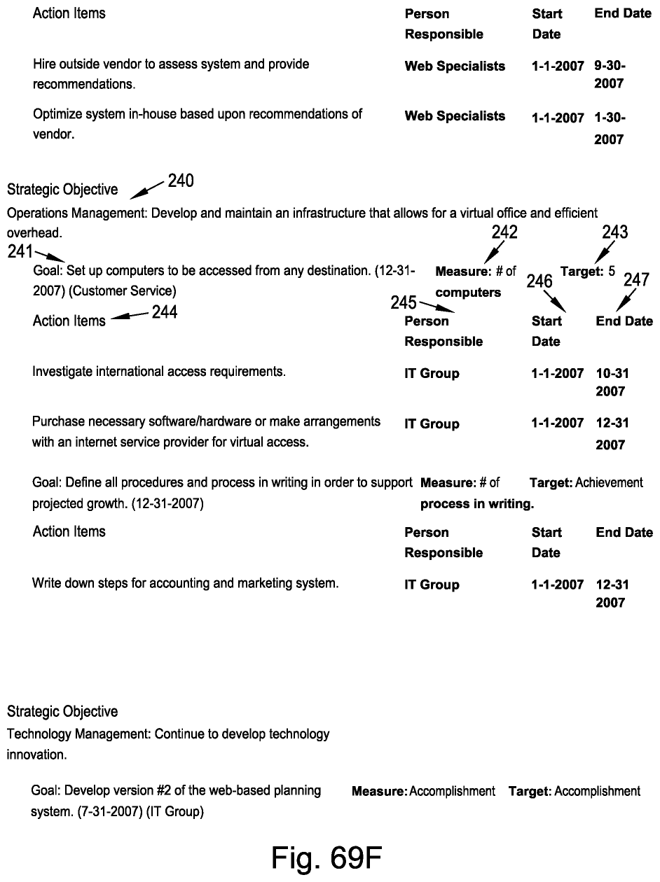

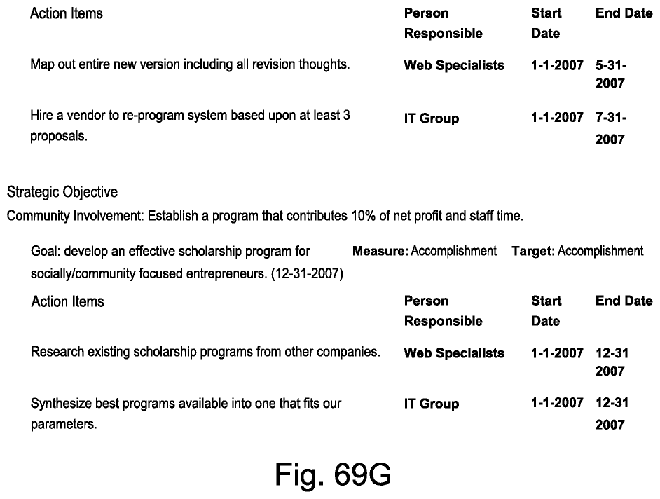

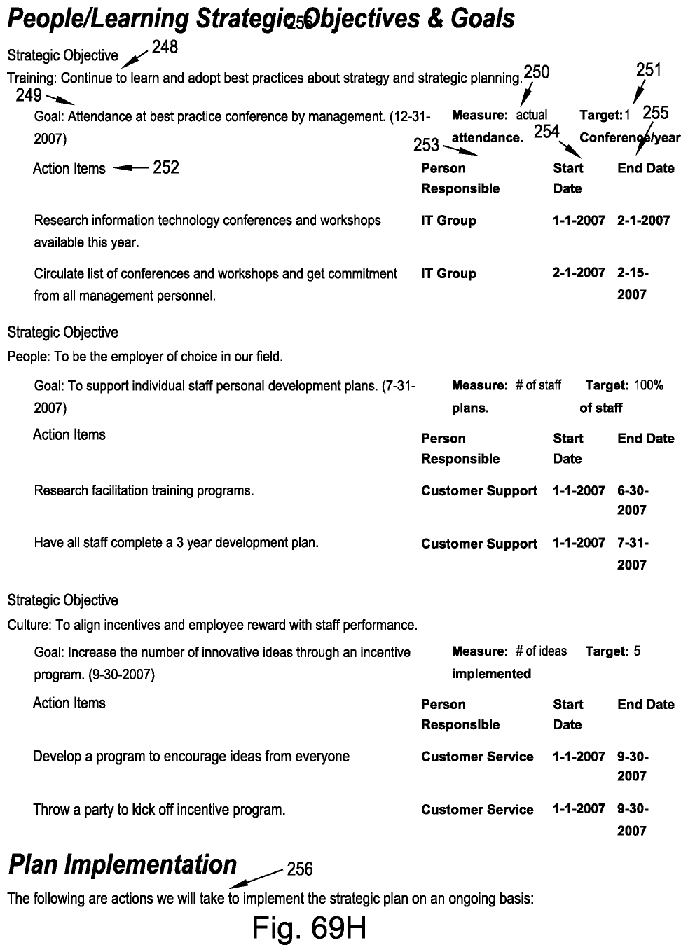

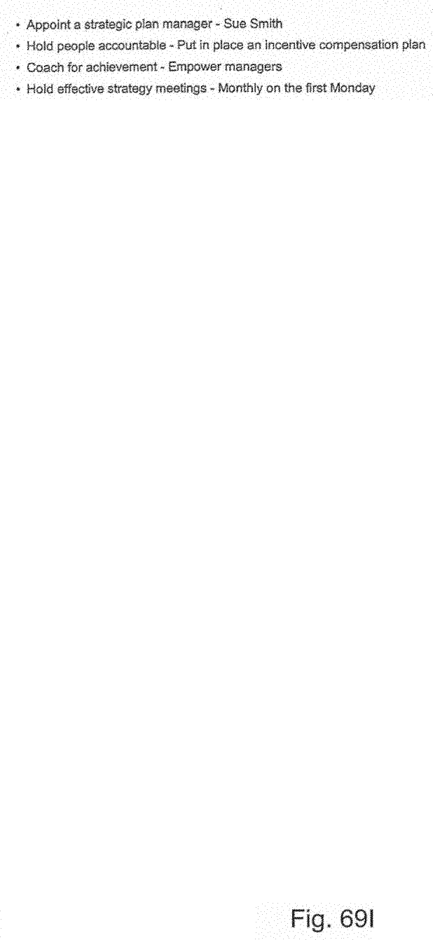

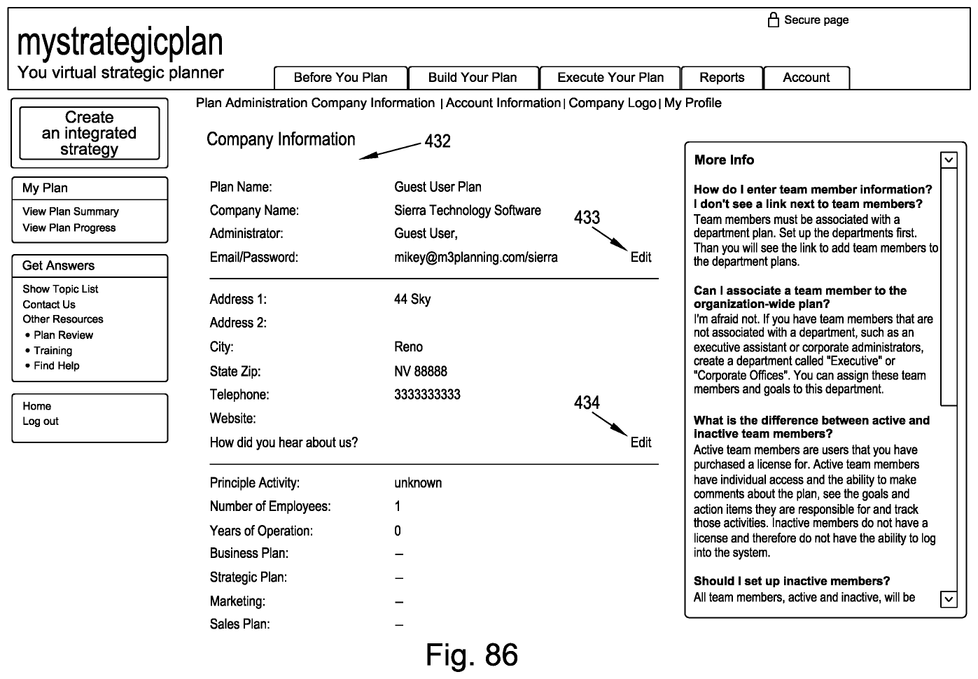

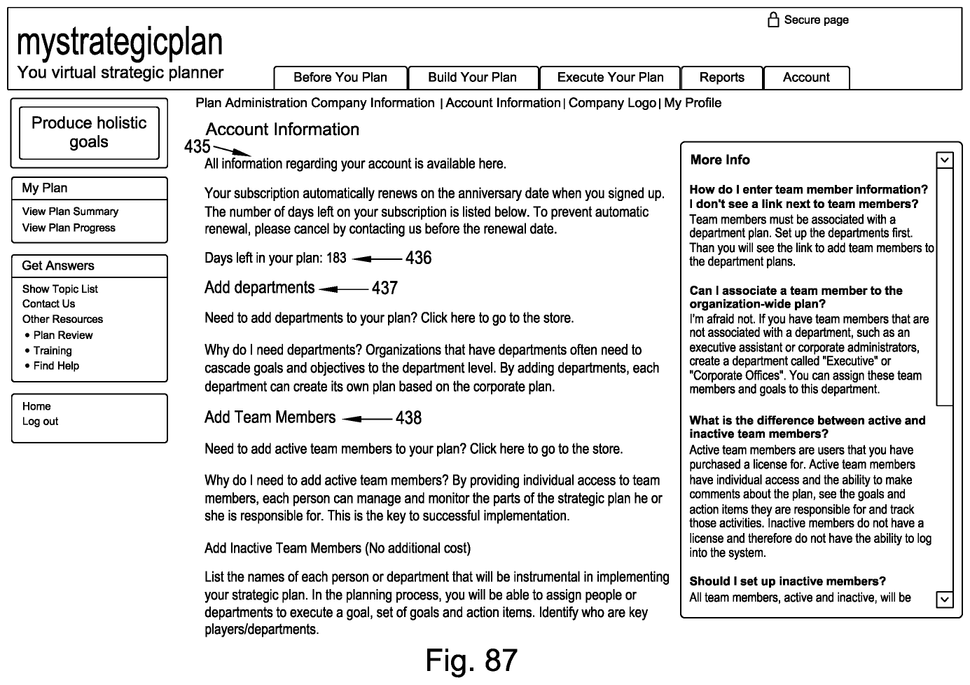

FIG. 69 shows a page for the Full Strategic Plan at the Corporate level. Stages to compile the Full Strategic Plan summary are as follows: The company logo 217 is uploaded in the “Company Logo” sub-heading under the Account tab as shown on the page of FIG. 87. The company name 218 is pulled through from the “Company Information” sub-heading under the Account tab as shown on the page of FIG. 86. The date 219 can automatically be updated by the system based on the date the report is printed.

FIG. 69 shows a page that displays the beginning of the Full Strategic Plan report at the Corporate level. The information under the Mission Statement heading 220 is pulled through from the page of FIG. 8, reference 19. The information under the Vision heading 221 is pulled through from the page of FIG. 26, reference 88. The information under the Core Values heading 222 is pulled through from the page of FIG. 10, reference 26. The information under the Competitive Advantage heading 223 is pulled through from the page of FIG. 21, reference 69. The information under the Organization-wide Strategies 224 is pulled through from the page of FIG. 33, reference 118.

FIG. 69A shows a page that displays the Financial/Mission Strategic Objectives & Goals. The information under the Strategic Objective heading 224 is pulled through from the page of FIG. 36, reference 131. The information under the Goals heading 225 is pulled through from the page of FIG. 42, reference 168. The Measure heading 226 is from the page of FIG. 42, reference 171. The information under the Target heading 227 is from the page of FIG. 42, reference 172.

FIG. 69B shows a page that displays the Customer/Constituent Strategic Objectives & Goals. The information under the Strategic Objectives heading 228 is pulled through from the page of FIG. 37, reference 136. Subsequently, information is grouped by the respective Customer/Constituent Groups 229 identified in the page of FIG. 43, reference 181. The information for the Group Needs and Characteristics 230 is pulled through from the page of FIG. 43, reference 182. Information under the Goals 231 is pulled through from FIG. 47, reference 201 for the goal, 209 for the end date, and 202 designating who is responsible for the goal. The Measure information 232 is from the page of FIG. 47, reference 204. The Target information 233 is from the page of FIG. 47, reference 205. The Customer/Constituent Group Action Items 234 are pulled through from the page of FIG. 52, reference 258. The information for the Person Responsible 235 is from the page of FIG. 52, reference 259. The information for the Start Date 236 is from the page of FIG. 52, reference 266. The information for the End Date 237 is from the page of FIG. 52, reference 267. This process is repeated for as many Customer/Constituent Groups that were identified in the page of FIG. 43. In this particular example, there are two Customer Groups as shown in FIG. 69C, reference 238.

FIG. 69D shows a page that displays the Internal/Operational Strategic Objectives & Goals. The information under the Strategic Objectives heading 239 is pulled through from FIG. 38, reference 141. The information is grouped according to objective. For example, FIG. 69E shows a page that displays Objective 240. The respective Internal/Operational Goals 241 are pulled through from the page of FIG. 48, reference 215. The information under the Goal 241 is pulled through from FIG. 48, reference 215 for the goal, 223 for the end date, and 216 designating who is responsible for the goal. The Measure 242 for these Goals are pulled through from the page of FIG. 48, reference 218. The Target 243 for these Goals are pulled through from the page of FIG. 48, reference 219. The Action Items 244 necessary to accomplish the Goals are pulled through from the page of FIG. 53, reference 273. The information for the Person Responsible 245 is from the page of FIG. 53, reference 274. The information for the Start Date 246 is from the page of FIG. 53, reference 281. The information for the End Date 247 is from the page of FIG. 53, reference 282. This process is repeated for the Internal/Operational Objectives identified in the page of FIG. 38 as shown in FIGS. 69D, 69E, 69F.

FIG. 69G shows a page that displays the People/Learning Strategic Objectives & Goals. The information under the People/Learning Objectives heading 248 is pulled through from the page of FIG. 39, reference 146. The information is grouped according to objective. Under the Objective 248, the respective Goals 249 are pulled through from the page of FIG. 49, reference 229. The Measure 250 for these Goals are pulled through from the page of FIG. 49, reference 232. The Target 251 for these Goals are pulled through from the page of FIG. 49, reference 233. The Action Items 252 necessary to accomplish the Goals are pulled through from the page of FIG. 54, reference 288. The information for the Person Responsible 253 is from the page of FIG. 54, reference 289. The information for the Start Date 254 is from the page of FIG. 54, reference 296. The information for the End Date 2255 is from the page of FIG. 55, reference 297. This process is repeated for the People/Learning Objectives identified in the page of FIG. 39.

FIG. 69G shows a page that displays Plan Implementation action that the organization will take to implement the strategic plan on an ongoing basis 256. The information is pulled through from the page of FIG. 30, reference 107.

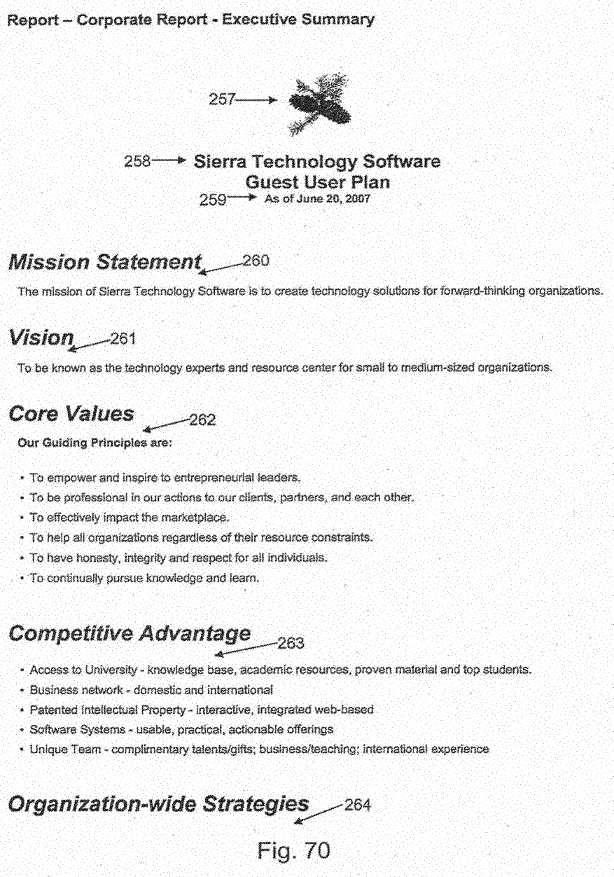

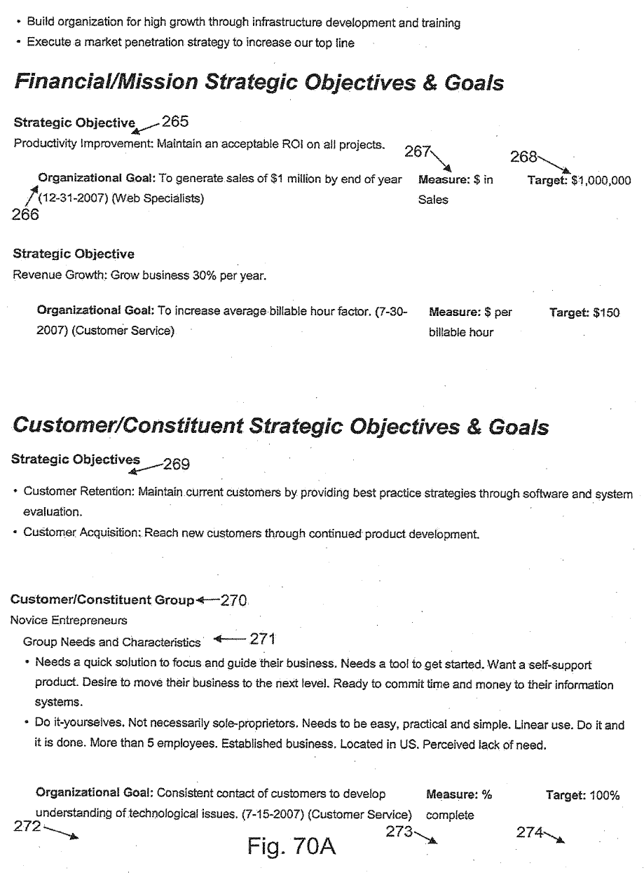

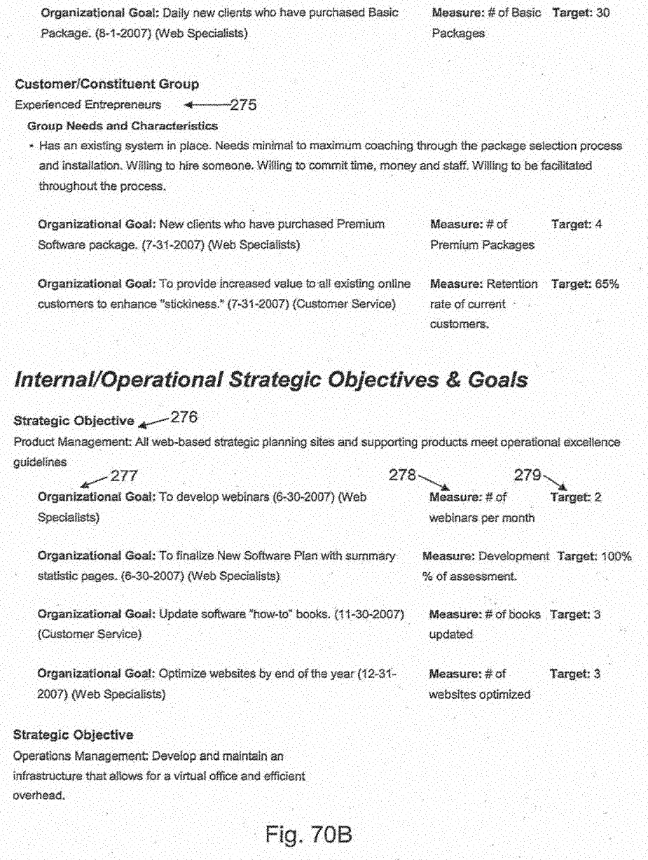

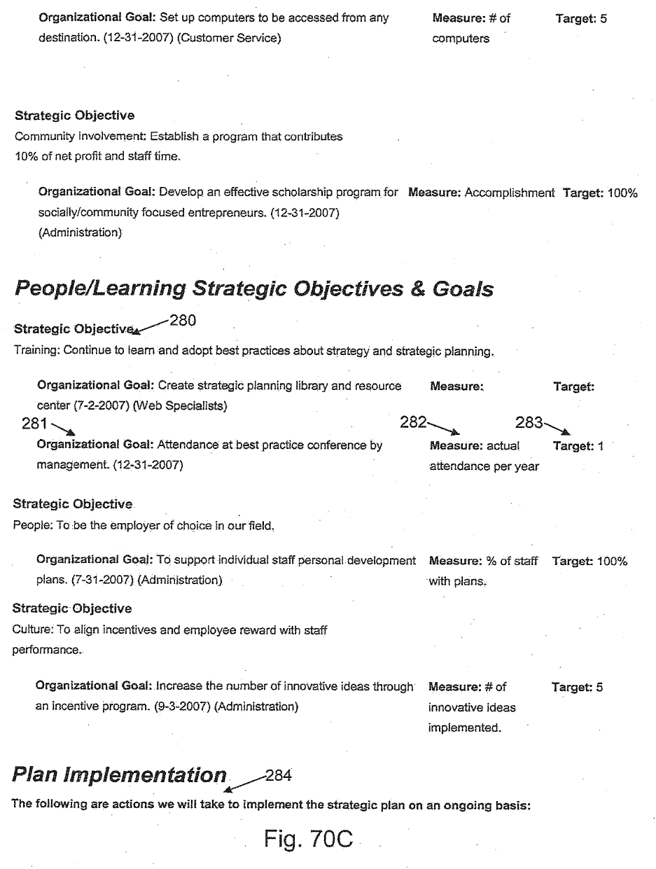

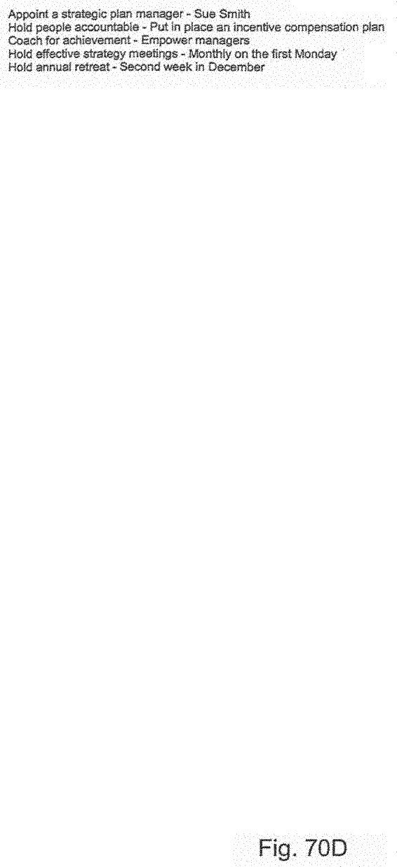

FIG. 70 shows pages for the Executive Summary Plan at the Corporate level. Stages to compile the Executive Summary Plan are as follows: The company logo 257 is uploaded in the “Company Logo” sub-heading under the Account tab as shown on the page of FIG. 87. The company name 258 is pulled through from the “Company Information” sub-heading under the Account tab as shown on the page of FIG. 86. The date 259 is automatically updated by the system based on the date the report is printed.

FIG. 70 shows a page that displays the beginning of the Executive Summary Plan report at the Corporate level. The information under the Mission Statement heading 260 is pulled through from the page of FIG. 8, reference 19. The information under the Vision heading 261 is pulled through from the page of FIG. 26, reference 88. The information under the Core Values heading 262 is pulled through from the page of FIG. 10, reference 26. The information under the Competitive Advantage heading 263 is pulled through from the page of FIG. 21, reference 69. The information under the Organization-wide Strategies 264 is pulled through from the page of FIG. 33, reference 118.

FIG. 70A shows a page that displays the Financial/Mission Strategic Objectives & Goals. The information under the Strategic Objective heading 265 is pulled through from the page of FIG. 36, reference 131. The information under the Goals heading 266 is pulled through from the page of FIG. 42, reference 168. The Measure heading 267 is from the page of FIG. 42, reference 171. The information under the Target heading 268 is from the page of FIG. 42, reference 172.

FIG. 70A shows a page that displays the Customer/Constituent Strategic Objectives & Goals (shown halfway down the page). The information under the Strategic Objectives heading 269 is pulled through from the page of FIG. 37, reference 136. Subsequently all information is grouped by the respective Customer/Constituent Groups 270 identified in the page of FIG. 43, reference 181. The information for the Group Needs and Characteristics 271 is pulled through from the page of FIG. 43, reference 182. The information under the Goals 272 is pulled through from FIG. 47, reference 201 for the goal, 209 for the end date, and 202 designating who is responsible for the goal. The Measure information 273 is from the page of FIG. 47, reference 204. The Target information 274 is from the page of FIG. 47, reference 205. This process is repeated for the Customer/Constituent Groups identified in the page of FIG. 43. In this particular example, there are two Customer Groups as shown in FIG. 70B, reference 275.

FIG. 70B shows a page that displays the Internal/Operational Strategic Objectives & Goals. The information under the Strategic Objectives heading 276 is pulled through from FIG. 38, reference 141. The information is grouped according to objective. For example, FIG. 70B shows a page that displays Objective 276. The respective Internal/Operational Goals 277 are pulled through from the page of FIG. 48, reference 215. The information under the Goal 277 is pulled through from FIG. 48, reference 215 for the goal, 223 for the end date, and 216 designating who is responsible for the goal. The Measure 278 for these Goals are pulled through from the page of FIG. 48, reference 218. The Target 279 for these Goals are pulled through from the page of FIG. 48, reference 219. This process is repeated for the Internal/Operational Objectives identified in the page of FIG. 38, as shown in FIGS. 70B and 70C.

FIG. 70C shows a page that displays the People/Learning Strategic Objectives & Goals. The information under the People/Learning Objectives heading 280 is pulled through from the page of FIG. 39, reference 146. The information is grouped according to objective. Under the Objective 280, the respective Goals 281 are pulled through from the page of FIG. 49, reference 229. The Measure 282 for these Goals are pulled through from the page of FIG. 49, reference 232. The Target 283 for these Goals are pulled through from the page of FIG. 49, reference 233. This process is repeated for the People/Learning Objectives identified in the page of FIG. 39.

FIG. 70C shows a page that displays Plan Implementation action that the organization will take to implement the strategic plan on an ongoing basis 284. The information is pulled through from the page of FIG. 30, reference 107.

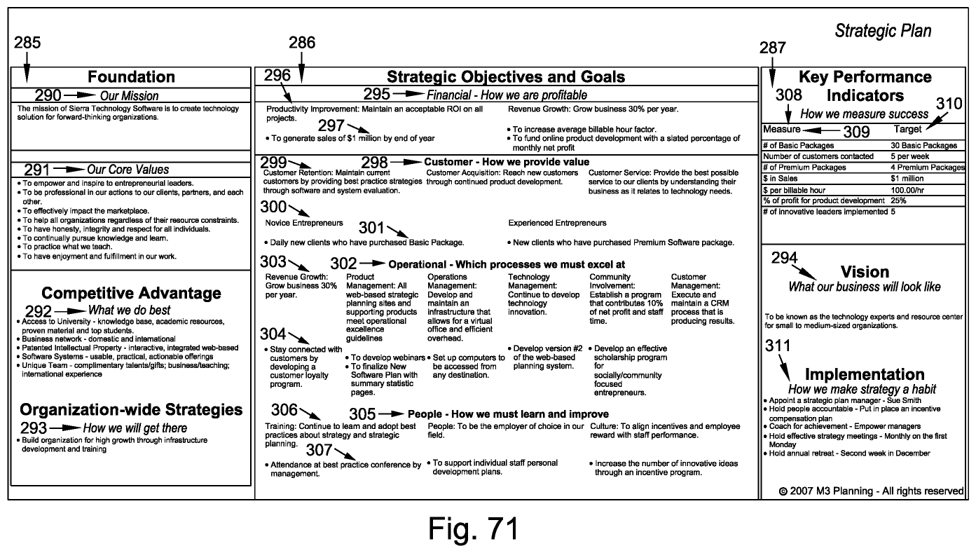

FIG. 71 shows pages for the Strategy Map plan at the Corporate level. Stages to compile the Strategy Map plan follow below. This output is different than FIGS. 69 and 70 in three primary aspects. First, an organization's plan can be viewed on a single sheet of paper for easily communicating the plan to the entire organization. The file can be printed, for example, on 11″×17″ paper. It can also be made into poster size and displayed in the company's office, such that someone can quickly visualize the strategic plan. Second, the headings and content are color-coded to match the reports of FIGS. 9, 11, 22, 27, 31, 34, 40, 46, 50 and 58. The subsequent reports provide more detail. Third, the report is laid out as a visual roadmap.

As shown in FIG. 71, the Strategy Map is a type of road map that can be divided into, e.g., three main areas, similar to that shown in FIG. 2. The left-hand column contains the area—Where we are now? 285: Our Mission, Our Core Values, Competitive Advantage, and Organization-wide Strategies. The right-hand column contains the area—Where are we Going? 286: Key Performance Indicators, Vision, and Implementation. The middle column contains the area—How are we going to get there? 287: Strategic Objectives and Goals divided into the, e.g., four key area of Financial 295, Customer 298, Operational 302 and People 305.

The Strategy Map as shown in FIG. 71 begins by stating the Company name. The information under the Account tab and sub-heading Company Information is pulled from the page of FIG. 86, reference 432. The Plan name is under the Account tab and sub-heading Company Information is pulled from the page of FIG. 86, Plan Name reference 432.

The left-hand column of the Strategy Map 285 as shown in FIG. 71 contains Our Mission, Our Core Values, Competitive Advantage and Organization-wide Strategies. The information under Our Mission heading 290, is pulled through from the page of FIG. 8, reference 19. The information under the Core Values heading 291 is pulled through from the page of FIG. 10, reference 26. The information under the Competitive Advantage heading 292 is pulled through from the page of FIG. 21, reference 69. The information under the Organization-wide Strategies 293 is pulled through from the page of FIG. 33, reference 118.

The middle column of the Strategy Map 286 as shown in FIG. 71 contains Strategic Objectives and Goals divided into the, e.g., four key area: Financial 295, Customer 298, Operational 302 and People 305. The Financial area 295 Strategic Objectives listed in. bold 296 are pulled through from the page of FIG. 36, reference 131. The Financial Goals listed 297 under the objectives are pulled through from the page of FIG. 42, reference 168. The Customer area 298 Strategic Objectives listed 299 are pulled from the page of FIG. 37, reference 136. Subsequently, the information is grouped by the respective Customer groups listed in bold 300 as identified in the page of FIG. 43, reference 181. The Customer Goals 272 listed 301 under each Customer group are pulled through from FIG. 47, reference 201 for the goal. The Operational area 302 Strategic Objectives listed in bold 303 are pulled through from FIG. 38, reference 141. The Operational Goals listed 304 under the objectives are pulled through from the page of FIG. 48, reference 215. The People area 305 Strategic Objectives listed in bold 306 are pulled through from the page of FIG. 39, reference 146. The People Goals listed 307 under the objectives are pulled through from the page of FIG. 49, reference 229.

The right-hand column of the Strategy Map 287, as shown in FIG. 71, contains Key Performance Indicators, Vision and Implementation. The information under Key Performance Indicators 308 is pulled from the page of FIG. 57, reference 317, 318 and 319. The information under the Vision heading 294 is pulled through from the page of FIG. 26, reference 88. The information under Implementation 311 is pulled through from the page of FIG. 30, reference 107.

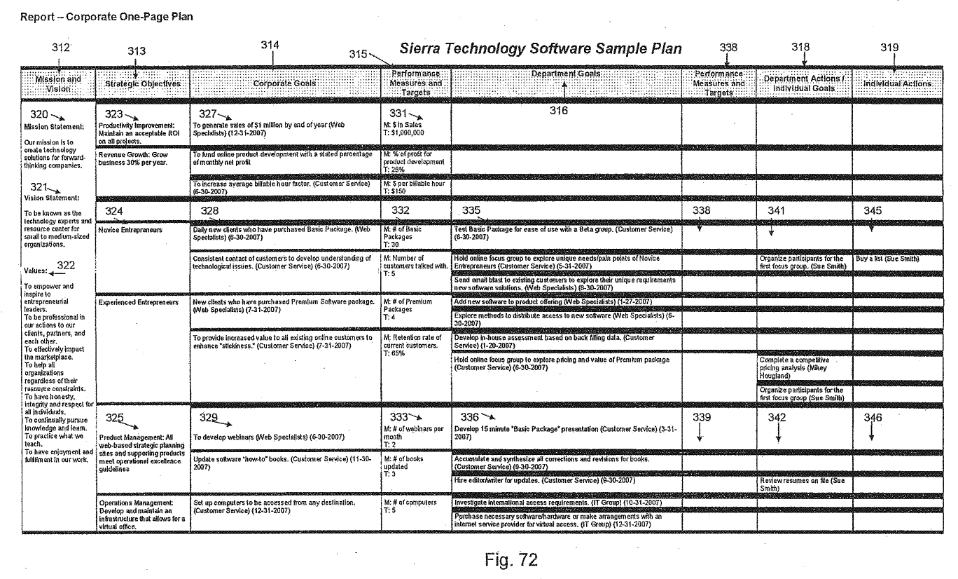

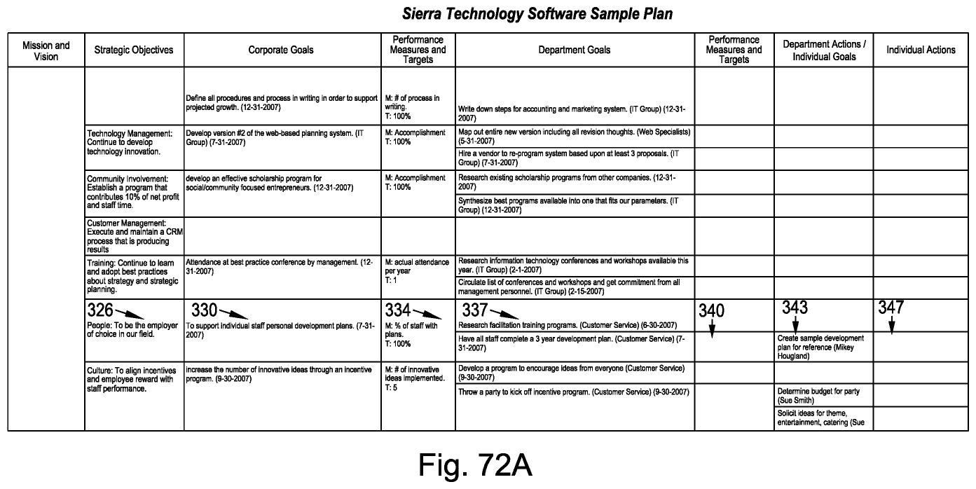

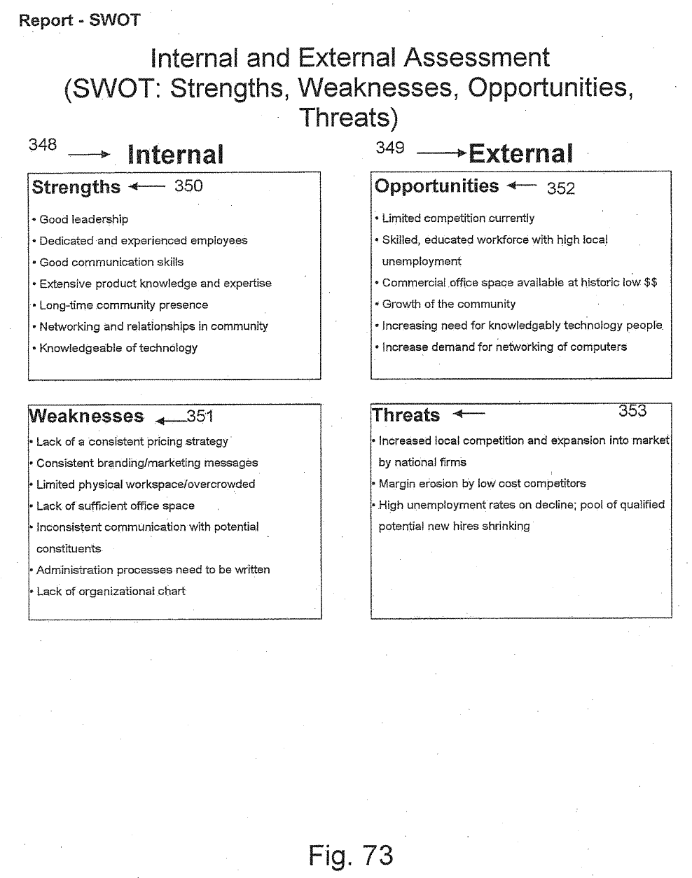

FIG. 72 shows pages for the One-Page Strategy Plan at the Corporate level. Stages to compile the Strategy Map plan follow below. This output is different than FIGS. 69, 70 and 71 in three primary aspects. First, this report shows a linear representation of the organization's plan. It shows alignment from the strategic objectives to goals it individual actions. Second, this report shows e.g., three level of alignment, specifically Corporate, Departmental, and Team Member levels. Third, an organization's plan can be viewed on a single sheet of paper (depending on the length of the plan) for easily communicating the plan to the entire organization. The file can be printed on 11″×17″ paper. It can also be made into poster size and displayed in the company's office for all to quickly what they are responsible for and how it aligns with the overall plan.

As shown in FIG. 72 the One-Page Strategy Plan at the Corporate level is divided into the following eight linear columns: Mission and Vision 312, Strategic Objectives 313, Corporate Goals 314, Performance Measures and Targets for Corporate Goals 315, Corporate Action/Department Goals 316, Performance Measures and Targets for Department Goals 317, Department Actions/Individual Goals 318, and Individual Action 319.

The number of columns displayed in the One-Page Strategy Plan is dependent on what options the user chooses. If the user signs up for only the Corporate Plan, the following columns would appear: Mission and Vision 312, Strategic Objectives 313, Corporate Goals 314, Performance Measures and Targets 315 and Corporate Actions 316. If the user signs up for the Corporate Plan and a Department Plan the following columns would appear: Mission and Vision 312, Strategic Objectives 313, Corporate Goals 314, Performance Measures and Targets 315, and Department Goals 316, Performance Measures and Targets 317, and Department Actions 318.

If the user signs up for the Corporate Plan, Department Plan, and Team Member Plan the following columns would appear: Mission and Vision 312, Strategic Objectives 313, Corporate Goals 314, Performance Measures and Targets 315, Department Goals 316, Performance Measures and Targets 317, and Individual Goals 318, and Individual Actions 319. If the user signs up for the Corporate Plan and Team Member Plan the following columns would appear: Mission and Vision 312, Strategic Objectives 313, Corporate Goals 314, Performance Measures and Targets 315, and Individual Goals 318, and Individual Actions 319.

The One-Page Plan at the Corporate level as shown in FIG. 71 begins on the left side in the first column by stating the Mission Statement 320, Vision Statement 321 and Values 322. The information under the Mission Statement heading 320 is pulled through from the page of FIG. 8, reference 19. The information under the Vision heading 321 is pulled through from the page of FIG. 26, reference 88. The information under the Core Values heading 322 is pulled through from the page of FIG. 10, reference 26.

The One-Page Plan at the Corporate level as shown in FIG. 71 displays in the second column 313 the following four key Strategic Objectives: Financial/Mission 323, Customer/Constituent Groups 324, Internal/Operational 329, and People/Learning 330 as shown in FIG. 40. The report is linear and is to be read from left to right. Thus the information is complied as outlined below.

The Financial Strategic Objectives 32 is pulled through from the page of FIG. 36, reference 131. The associated Goals 327 to the right are pulled through from the page of FIG. 42, reference 168. The Performance Measures and Targets 331 are pulled from the page of FIG. 42, reference 171 and 172. There are no Corporate Action Items/Department Goals 316 as these are achieved as a result of the other areas.

The Customer Groups 324 is pulled through from the page of FIG. 43, reference 181. The associated Goals 328 to the right are pulled through from the page of FIG. 47, reference 201. The Performance Measures and Targets 332 are pulled from the page of FIG. 47, reference 204 and 205. The associated Corporate Actions/Department Goals 335 are pulled from FIG. 52, reference 258. The Performance Measures and Targets 338 are pulled from FIG. 52, reference 262 and 263. The Department Action Items/Individual Goals 318, and Individual Actions 319 are pulled from their respective plans as above.

The Internal/Operational Objectives 325 are pulled through from the page of FIG. 38, reference 141. The associated Goals 329 to the right are pulled through from the page of FIG. 48, reference 215. The Performance Measures and Targets 333 are pulled from the page of FIG. 48, reference 218 and 219. The associated Corporate Actions/Department Goals 336 are pulled from FIG. 53, reference 273. The Performance Measures and Targets 339 are pulled from FIG. 53, reference 277 and 278. The Department Action Items/Individual Goals 318, and Individual Actions 319 are pulled from their respective plans as above.

The People/Learning Objectives 326 are pulled through from the page of FIG. 39, reference 146. The associated Goals 330 to the right are pulled through from the page of FIG. 49, reference 229. The Performance Measures and Targets 334 are pulled from the page of FIG. 49, reference 232 and 233. The associated Corporate Actions/Department Goals 337 are pulled from FIG. 54, reference 288. The Performance Measures and Targets 340 are pulled from FIG. 54, reference 292 and 293. The Department Action Items/Individual Goals 318, and Individual Actions 319 are pulled from their respective plans as above.

FIG. 73 shows pages for the SWOT, which is the Internal and External Assessment system output. Stages in compiling the Strategy Map plan follow below. This colorful, graphical output summarizes the company's Strengths, Weaknesses, Opportunities, and Threats into a one-page SWOT matrix. The Internal Assessment 348 includes Strengths 350 and Weaknesses 351. The External Assessment 349 includes Opportunities 352 and Threats 353. The Strengths 350 are pulled from the page of FIG. 13, reference 39. The Weaknesses 351 are pulled from the page of FIG. 14, reference 42. The Opportunities 352 are pulled from the page of FIG. 15, reference 45. The Threats 353 are pulled from the page of FIG. 16, reference 48.

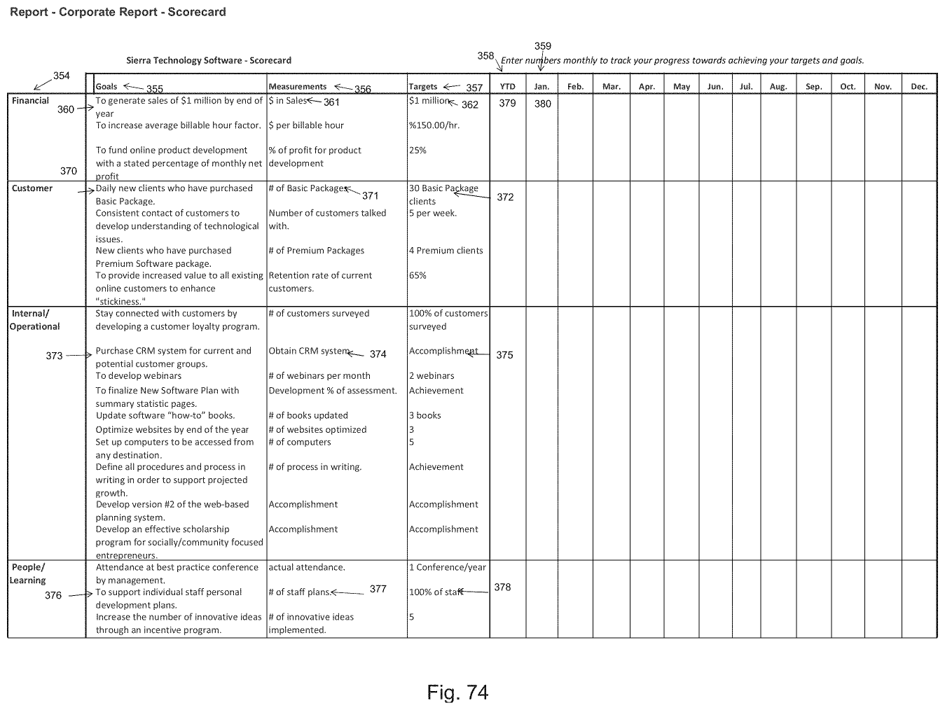

FIG. 74 shows pages for the Scorecard Report at the Corporate level. Stages in compiling the Scorecard output follow below. The Scorecard output downloads into an Excel spreadsheet. The Goals 355, Measurements 356, Targets 357, YTD 358 and months 359 are summarized in the four foundational areas of a balanced business: Financial, Customer, Internal/Operational, and People/Learning. The Financial Goals 360 are pulled through from the page of FIG. 42, reference 168; Financial Measurements 371 are from reference 171; and Financial Targets 372 are from reference 172. The Customer Goals 370 are brought forward from the page of FIG. 47, reference 201; Customer Measurements 371 are from reference 204; and Customer Targets 372 are from reference 205. The Internal/Operational Goals 373 are pulled through from the page of FIG. 48, reference 215; Internal/Operational Measurements 374 are from reference 218; and Internal/Operational Targets 375 are from reference 219. The Innovation/Learning Goals 376 are brought forward from the page of FIG. 49, reference 229; Innovation/Learning Measurements 337 are from reference 232; and Innovation/Learning Targets 378 are from reference 233. The YTD 379 number is calculated based on the monthly numbers 380 that are entered each month.

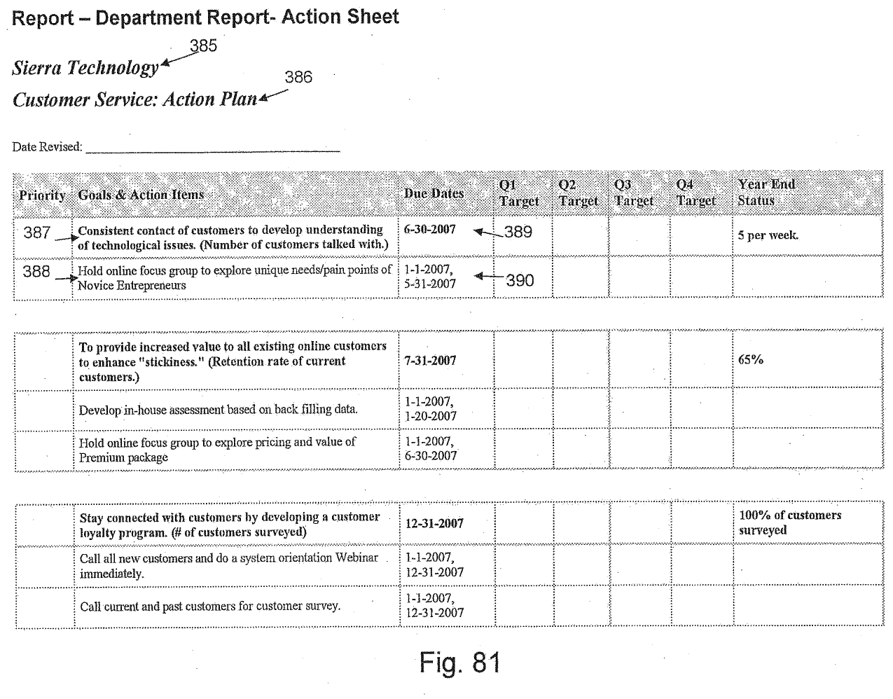

FIG. 75 shows a page that lists seven outputs for the Department Plan Reports 381. The main sub-navigational heading “Department” 382 is located under the “Report” tab 383. All the output reports can be exported to Word, HTML, and PPT or emailed to a colleague 384. The output reports provide a complete integration of the user's inputs made in the strategic planning process at the Department level. Since the system is dynamic, the user can make revisions whenever new information is available. The new information is entered in the appropriate input field and pulled through to the various Reports as, for example, displayed in FIG. 90 at the Department level. All of the Departmental level report outputs are the same as the Corporate level report outs as described above in FIG. 68. The Departmental level report has one additional report, the Action Sheet report 384. The report, as described on the page of FIG. 81, is used to the goals and action items assigned to the Department.

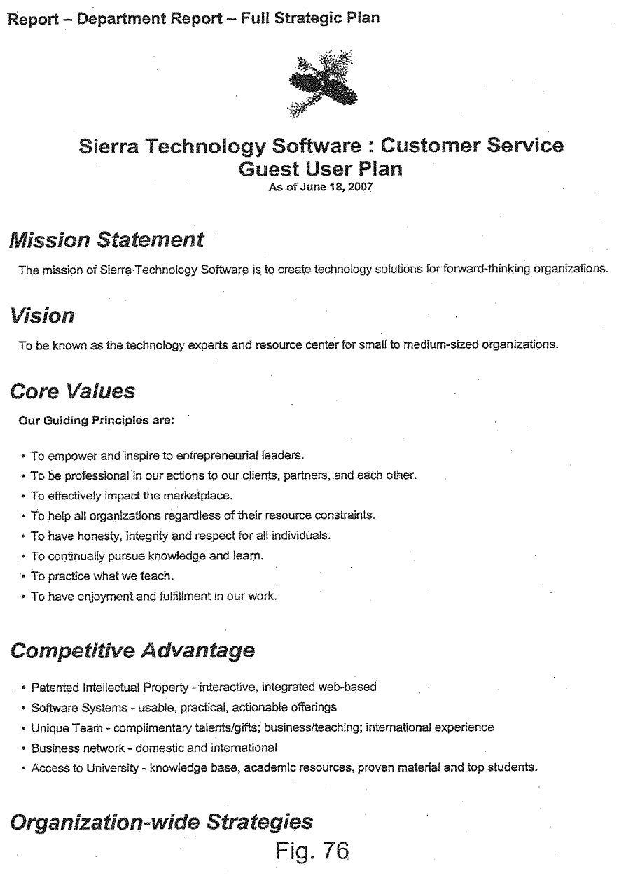

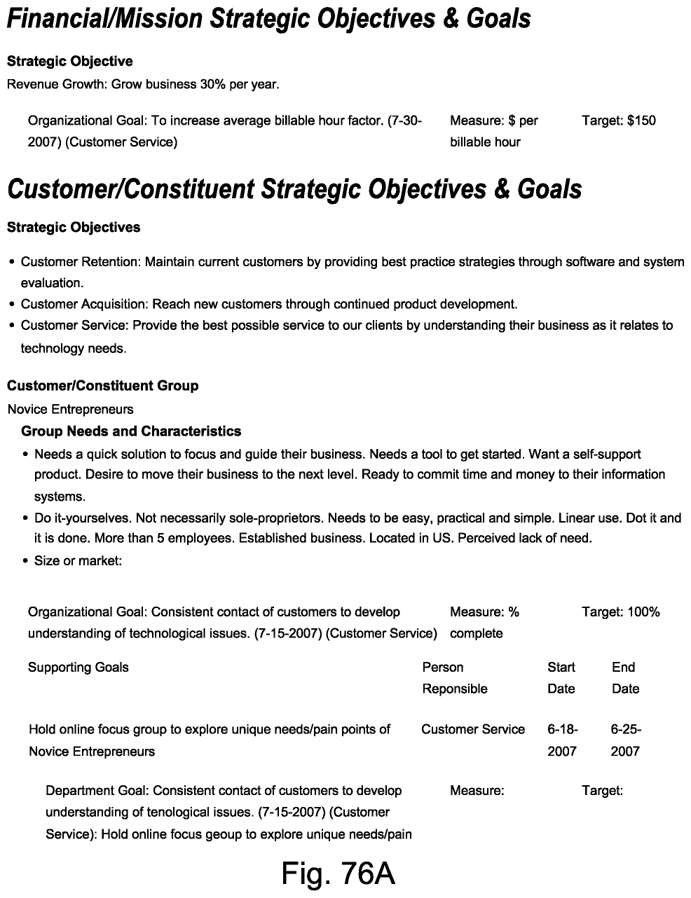

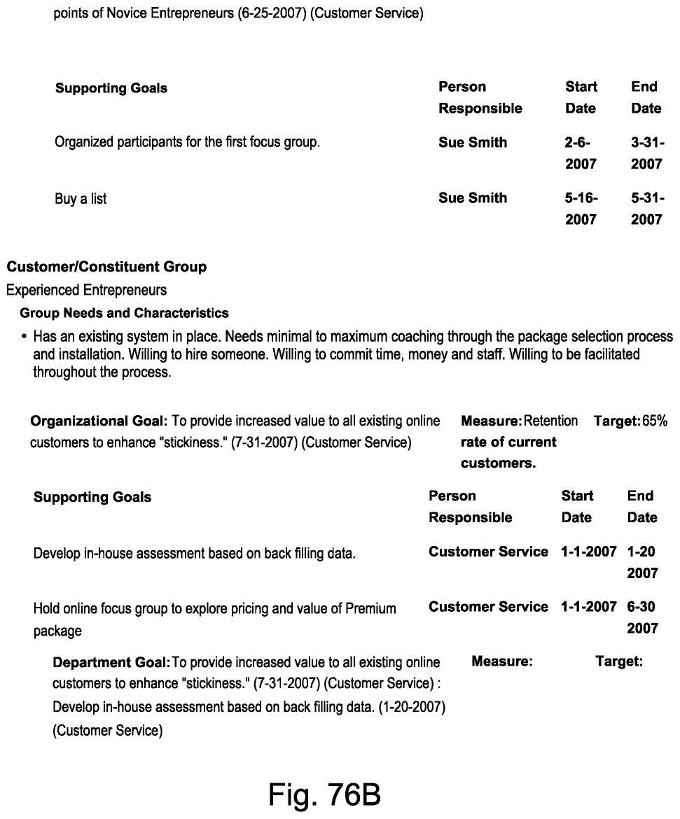

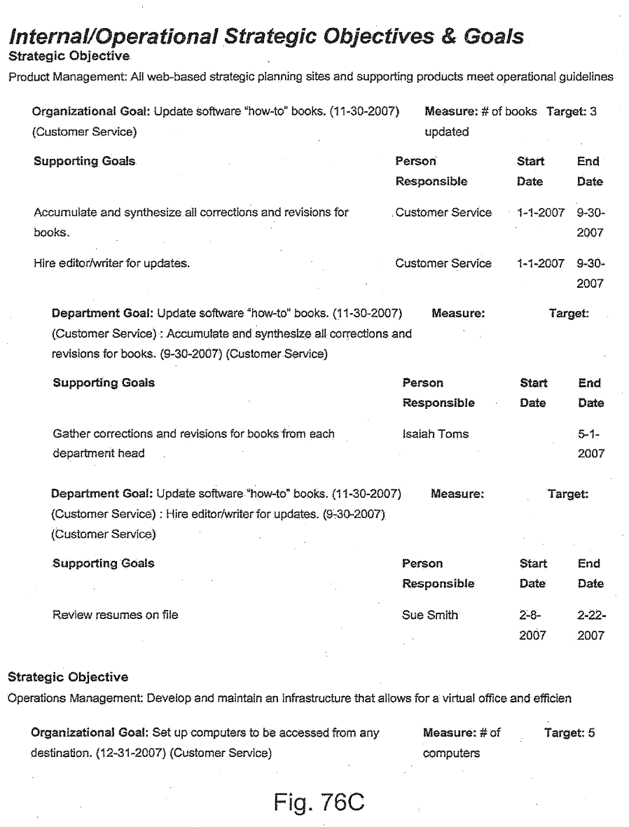

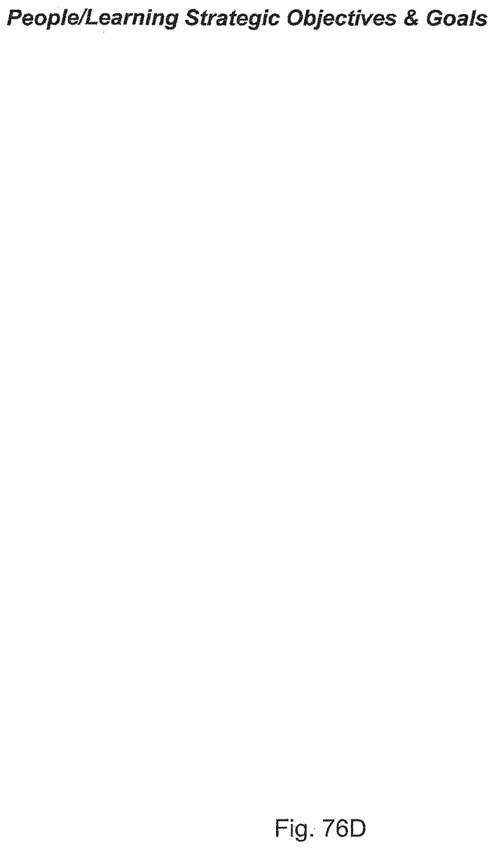

FIGS. 76, 76A, 76B, 76C show pages for the Full Strategic Plan at the Department level. Stages in compiling the Full Strategic Plan at the department level are the same as described in FIGS. 69, 69A, 69B, 69C, 69D, 69E, 69F and 69G. Only information relevant to the department will be shown as described in FIG. 91.

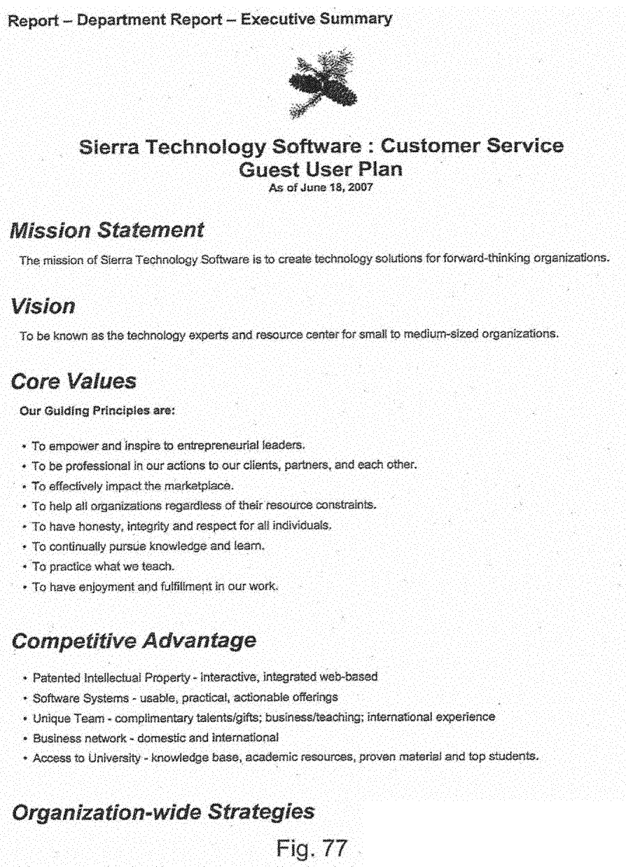

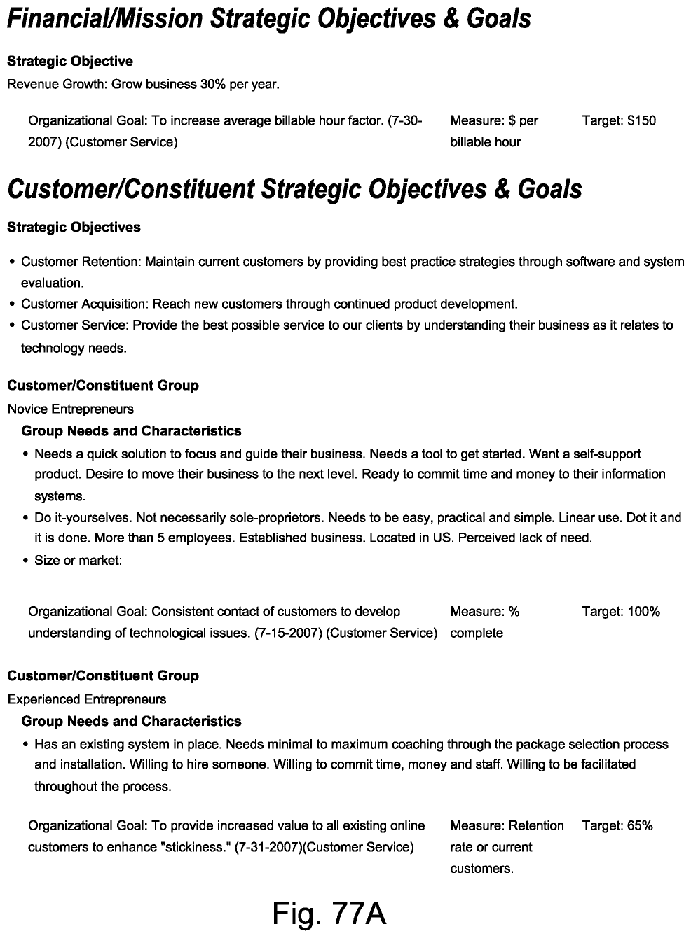

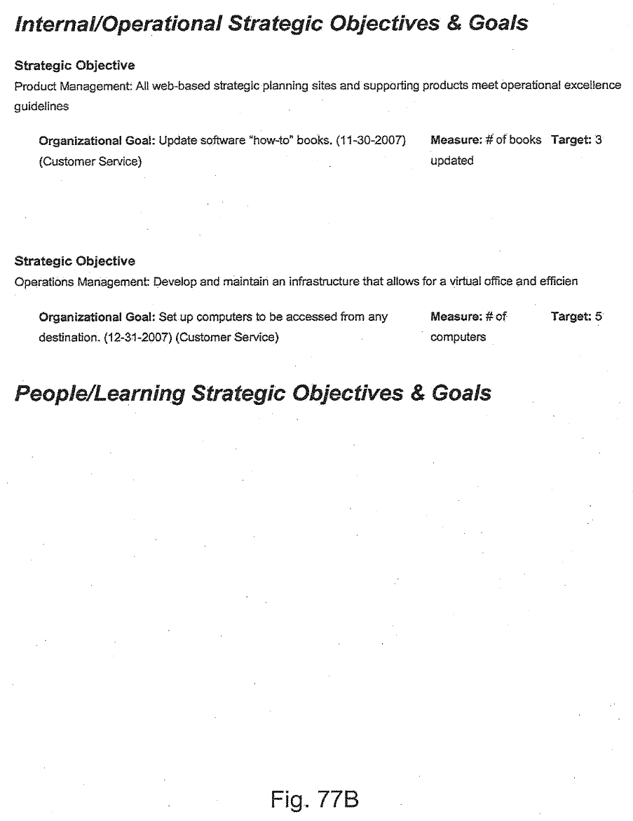

FIGS. 77, 77A, and 77B show pages for the Executive Summary Plan at the Department level. Stages in compiling the Executive Summary plan at the department level are the same as described in FIGS. 70, 70A, 70B and 70C. Only information relevant to the department will be shown as described in FIG. 91.

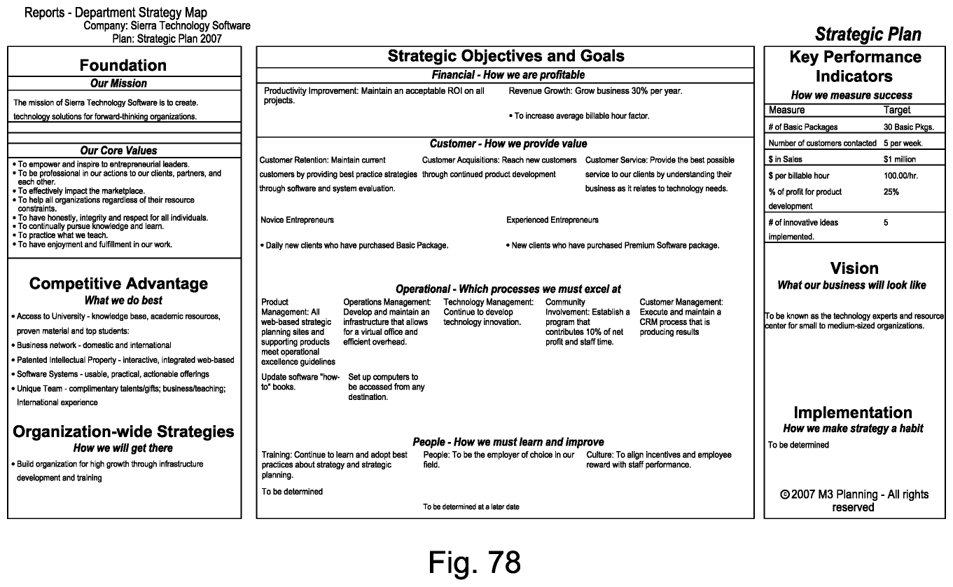

FIG. 78 shows a page for the Strategy Map at the Department level. Stages in compiling the Strategy Map at the department level are the same as described in FIG. 71. Only information relevant to the department will be shown as described in FIG. 91.

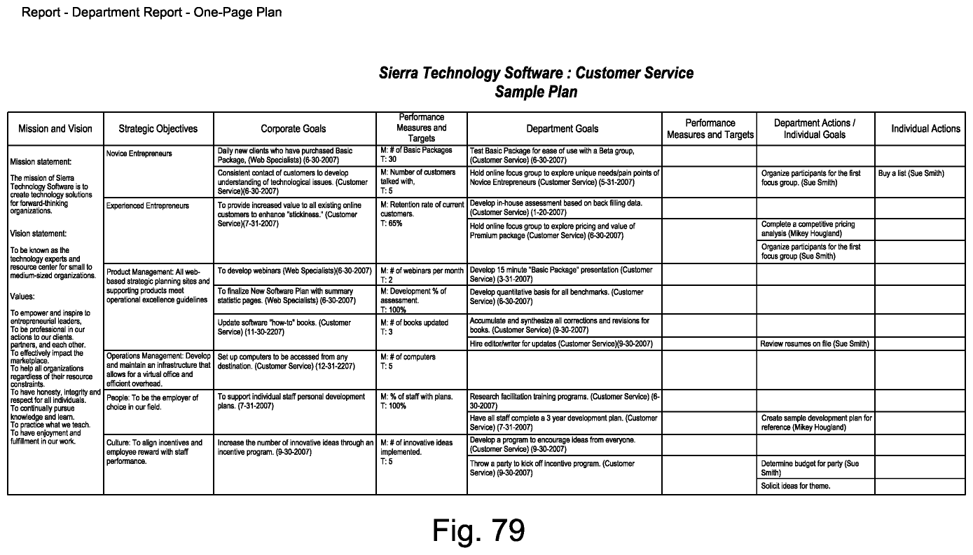

FIG. 79 shows a page for the One-Page Plan at the Department level. Stages in compiling the One-Page Plan at the department level are the same as described in FIGS. 72 and 72A. Only information relevant to the department will be shown as described in FIG. 91.

The SWOT at the Department level is the same as the Corporate level as in FIG. 73. The information is different if the department does their own SWOT. Thus, for this example, a department SWOT is not shown.

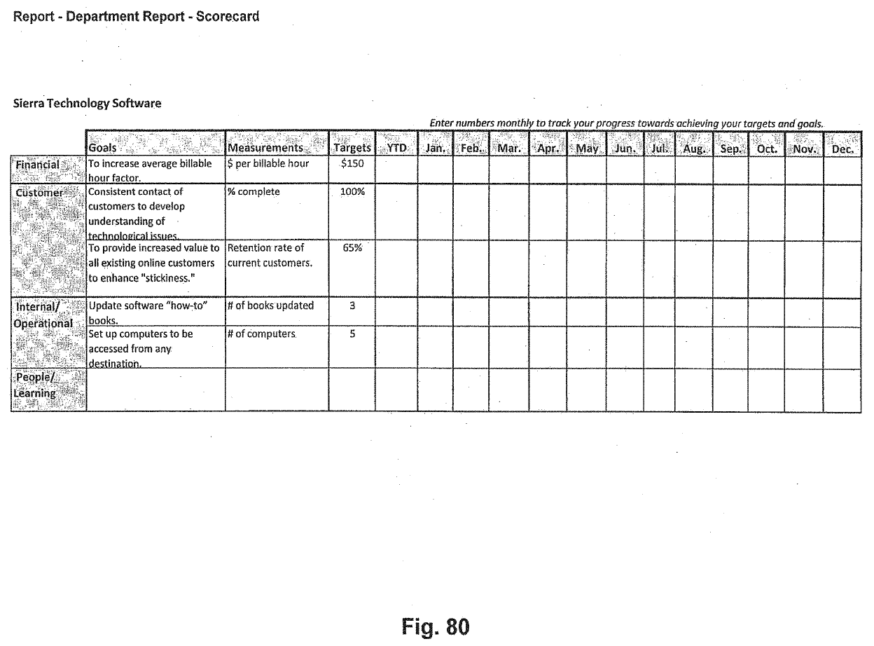

FIG. 80 shows a page for the Scorecard at the Department level. Stages in compiling the Scorecard at the department level are the same as described in FIGS. 74. Only information relevant to the department will be shown as described in FIG. 91.

FIG. 81 shows a page for the Action Sheet Report at the Department level. The company name 385 is pulled from the page of FIG. 86, reference 432. The department name 386 is pulled from the page of FIG. 85, reference 432. Only those action items assigned to the specific department 388 are pulled through to the Action Sheet report output. The action items information is pulled through from FIG. 52, reference 259, FIG. 53, reference 274, and FIG. 54, reference 289. The associated action item due dates 390 are pulled through from FIG. 52, reference 266 and 267; FIG. 53, reference 281 and 282; FIG. 54, reference 296 and 297. The associated goal also is pulled through 387. The goal and the due date information 389 is pulled through from FIG. 47, reference 201 and 209; FIG. 48, reference 215 and 223; FIG. 49, reference 229 and 237.

FIG. 82 shows a page that lists two outputs for the Team Members Plan Reports 391. The main sub-navigational heading “Team Members” 392 is located under the “Report” tab 393. The output reports can be exported to, e.g., Word, HTML, and PPT, emailed to a colleague 394, or output using a different method or format. The output: reports provide an integration (in some implementations, a complete integration) of the user's inputs made in the strategic planning process at the Team Member level. Since the system is dynamic, the user can make revisions whenever new information is available. The new information is entered in the appropriate input field and pulled through to the various Reports as displayed in FIG. 90 at the Team Member level. The Team Member Reports are Action Item 395 and One-Page Plan 396. The Team Member Action Sheet report output is the same as the Department level report as described above in FIG. 75. The Team Member One-Page Plan level report outputs is, in some embodiments, the same as the Corporate level report as described, above, with reference to FIG. 68.

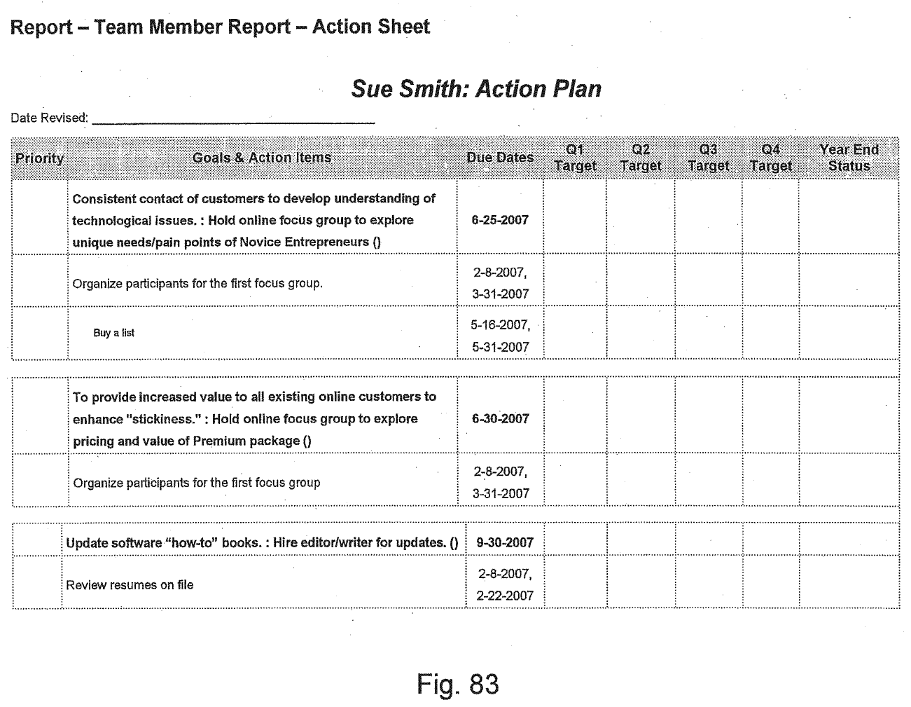

FIG. 83 shows a page for the Action Sheet Report at the Team Member level. Stages in compiling the Action Sheet Report at the team member level are the same as described in FIG. 81. Only information relevant to the team member is pulled through as described in FIG. 91.

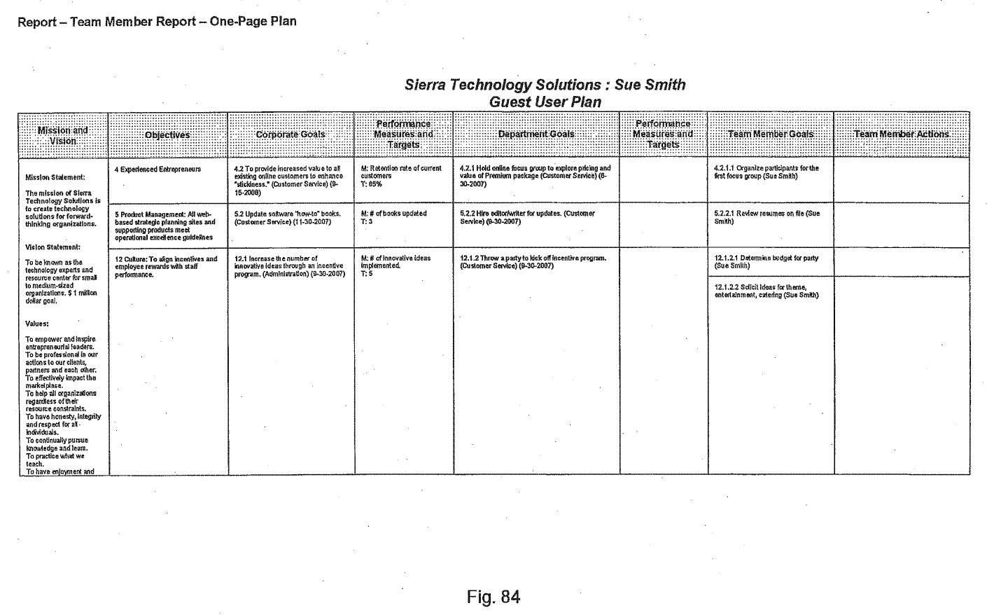

FIG. 84 shows a page for the One-Page Plan Report at the Team Member level. Stages in compiling the One-Page Plan Report at the team member level are the same as described in FIGS. 72 and 72A. Only information relevant to the team member is pulled through as described in FIG. 91.

FIG. 85 shows a page which begins the Account information for the strategic plan. The setup information is found under “Account” tab 397. There are six main sub-headings under Accounts, which are: Plan Administration, Company Information, Account Information, Company Logo, My Profile 398.

FIG. 85 shows a page for Plan Administration. First a narrative 399 explains how the user can add Departments, Active Members and Inactive Members. The More information 400 iframes box answers questions and explains the difference between Active and Inactive Members. The number of plans that the company has purchased is indicated under “Limit” 401. The number of plans that the company has activated is indicated under “Active” 402. The user can add additional Active Members by clicking the “Add Active Member” button 403, which will take them to the shopping cart. The user can add additional Inactive Members by clicking the “Add Inactive Member” button 404. The user can obtain additional help by clicking the “?” icon 405. The person who originally purchased the plan is listed as the “Plan Administrator” 406. This information can be changed as shown on the page of FIG. 86, reference 432. The Departments 407 that have been purchased are listed in dark gray color under the “Department” heading. The Administrator 408 for each Department is listed under each department heading. The Active Team Members 409 are listed under the “Active Team Member” heading associated with each department. To change the Department Administrator the user would click on the “Edit” link 410, which would take them to the page shown on FIG. 85A. To change the Active Team Member the user would click on the “Edit” link 412, which would take them to the page shown on FIG. 85B. To delete a department the user would click on the “Delete” button 411.

FIG. 85A shows a page for editing the Department information. The Department Name is changed in the input field 413. The Administrator for the department is changed in input fields 414 and 415. The Title is changed in input field 416. The Email and Password is changed in input fields 417, 418 and 419.

FIG. 85B shows a page for editing the Active Team Members. The Active Team Member name is changed in the input fields 421 and 422. The Title changed in input field 423. The Department assigned is changed in the drop down menu 424. The Email and Password can be changed in input fields 425, 426 and 427.

FIG. 85B shows a page for editing the Inactive Team Members. The Inactive Team Member name is changed in the input fields 429 and 430. The Department assigned is changed in the drop down menu 431.

FIG. 86 shows a page for editing the Company Information. This information was automatically populated when the user initially purchased the plan 432. The user may edit the information by clicking the “edit” button 433 and 434.

FIG. 87 shows a page that contains Account Information. First a narrative 435 explains information regarding the user's account. The number of days left in the annual plan is indicated in reference 436. The user may add Department by clicking the link in reference 437. The user may add Active Team Member by clicking the link in reference 438. Both links will take the user to the shopping cart.

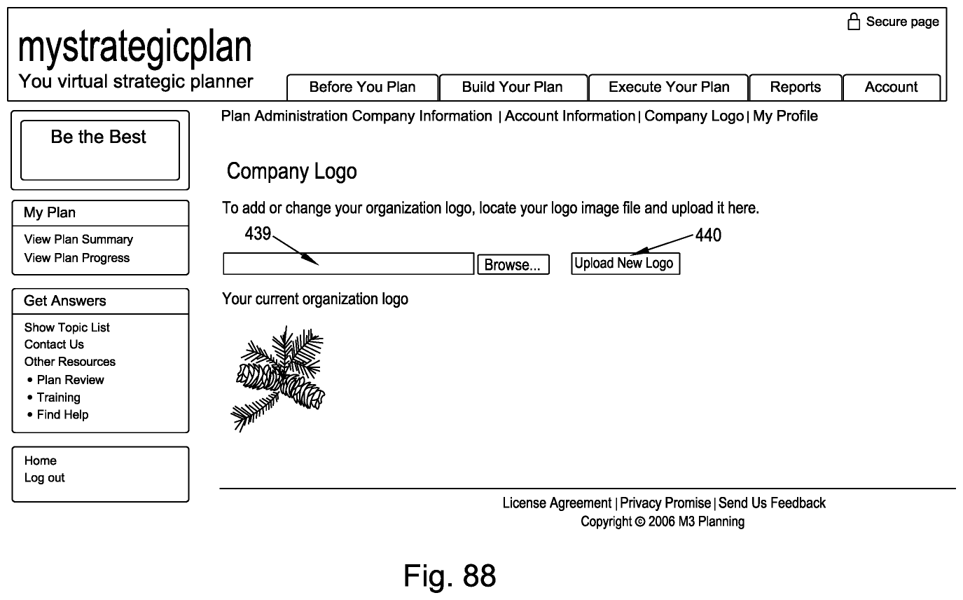

FIG. 88 shows a page for uploading the Company Logo. The user places their company logo in input field 439. The user uploads their logo by clicking the “Upload New Logo” button 440.

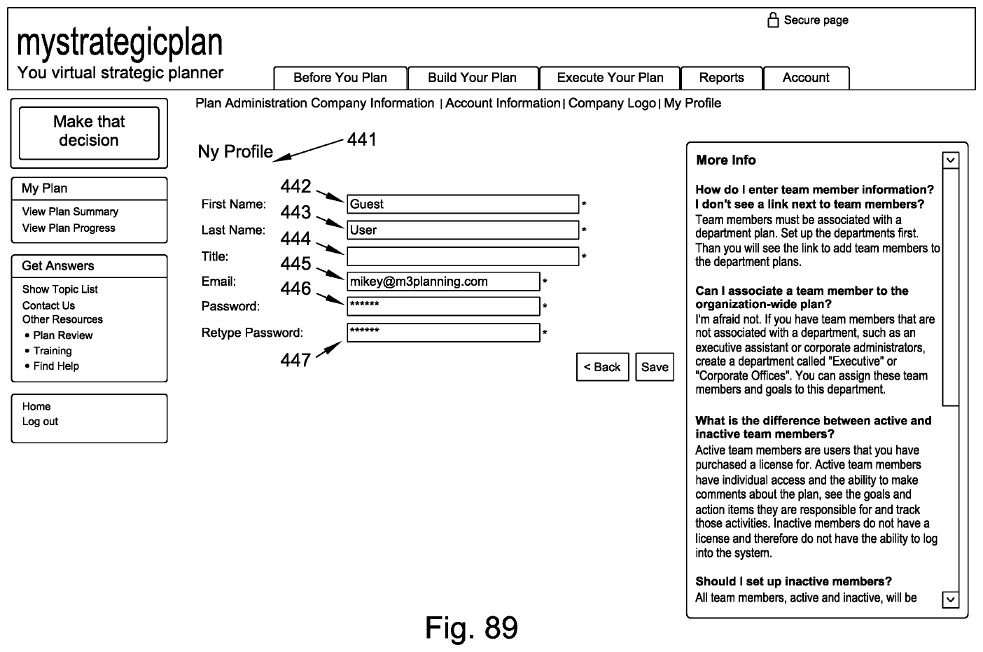

FIG. 89 shows a page that contains My Profile information. The user may change their name and login access on this page 441. The User's Name is changed in the input fields 442 and 443. The Title is changed in input field 444. The Email and Password is changed in input fields 445, 446 and 447. This concludes the Account Information area.

FIG. 90 provides an overview of the entire system and the interrelationship of the respective stages in the process and the outputs that can be developed. “Build Your Plan” process blocks 1 through 12 in the Strategic Plan system 448 are depicted in white boxes that do not have a bold border. The Strategic Plan “Report Outputs” 450 are shown in the center of the page with in medium gray boxes with bold borders. “Execute Your Plan” monitoring functions in the Strategic Plan system 449 are depicted in dark gray boxes with bold boarders.

As shown in FIG. 90 the stages depicted include components of each stage within the body. For example, the stage described at process block 7, Strategic Objectives 457 is composed of, in this example, Financial/Mission Objectives, Customer/Constituent Objectives and Internal/Operational Objectives, and People/Learning Objectives. Other implementations may have different objectives. These are elements of process block 7. The thoughts developed by the user as represented by the input Strategic Objectives then flow into process block 8 Goals 458. The transition is illustrated by an arrow. In this stages, the user develops, e.g., Financial/Mission Goals, Customer/Constituent Goals based on, e.g., customer needs and characteristics, Internal/Operational Goals and People/Learning Goals. For at least some Goals the user identifies at least one of: a priority, who is responsible, how the goal is measured, target, start date and end date. The user can, as desired, proceed through the system recording inputs as appropriate in each stage. The Build Your Plan process block are described, e.g., in the page of FIGS. 5 through 61A.

As shown in FIG. 90, system also has Strategic Plan Report Outputs 450. The Plan outputs are described in the page which refer to FIGS. 68 through 84, 61, 61A, 63, 64B, 64C, and 66. However, the interconnectedness of the system is highlighted by this page. For example, the Full Strategic Plan 463 may be composed of one or more of the process blocks: Mission, Values, Competitive Advantage, Vision, Organization-wide Strategies, Strategic Objectives, Goals, Action Items with Measures and Targets, and Implementation that are accumulated and integrated from process blocks 1, 2, 4 through 10 and 12. A solid line 473 connects the appropriate blocks to the box for the Full Strategic Plans summary, which indicates the necessary inputs for this output. The Executive Summary 463 is composed of similar inputs as the Full Strategic Plan without the action Items. The Strategy Map 464 is composed of similar inputs as the Full Strategic Plan. The One-Page Plan 465 is composed of similar inputs as the Full Strategic Plan.

As shown in FIG. 90, another feature of the system is the ability to monitor progress and track performance. The “Execute Your Plan” 449 is both for tracking and reporting purposes. The Executing outputs are described in the pages of FIGS. 62 through 66. Again the interconnectedness of the system is highlighted by this page. For example, Plan Progress 470 is composed of Goals and Action Items that are accumulated and integrated from process blocks 8 and 9. A dotted line 474 and 475 connects the appropriate blocks to the box for the Plan Progress 470. A Report Output is generated as shown on the page of FIG. 63.

As shown in FIG. 91 another feature is the ability of the Strategic Plan system to cascade information downward through the hierarchical levels of the corporation, shown here as three levels. Information is able to flow from the Corporate Plan 478 to Department Plans 479 to the Team Member Plans 480. A user with access to the Corporate Plan, in this embodiment, has full write access 481 to corporate mission, vision and values; strategic objectives; corporate goals and KPIs; and corporate action items which become the department goals. A user with access to the Department Plan has write access, in this embodiment, 482 to department mission, vision, and values; department actions which become the team member goals. A user with write access to The Team Member Plan, in this embodiment, has write access 483 to Team Member Goals and/or Team Member Action Items. As many departments and team members as needed can be added to the corporate plan.

As shown in FIG. 92 information can cascade downward through the hierarchical, e.g., three levels. As shown in FIG. 92 the stages for the Corporate Plan 484, Department Plan 485 and Team Member Plan 486 are the stages described in FIG. 90, references 451 through 462. The plan that is developed in the Corporate Plan 487 flows down to the Department Plan 488 and then to the Team Member Plan 489.

As shown in FIG. 92, the levels have different write access permission levels for each of the stages. Permission by user level with write access in the illustrated embodiment is as follows: Corporate Plan has full write access 484 to the corporate SWOT, mission, values, vision competitive advantage, implementation, strategic objectives; goals, action items and KPIs. The corporate action items 490 become at least a portion of the department goals 491. Department Plan has full write access 485 to the department SWOT, mission, values, vision competitive advantage, implementation, action items and KPIs. The Department Plan has limited write access to the strategic objectives 492 and goals 491. The department action items 493 become at least a portion of the Team Member Plan goals 494. Team Member Plan has full write access 486 to the team member action items 495. The Team Member Plan has limited write access to the SWOT, mission, values, vision competitive advantage, implementation, strategic objectives, and goals. The department action items 493 become at least a portion of the Team Member Plan goals 494. Reports are generated for each level, reference 496, 497, and 498 as part of execution of the 499.

As shown in FIG. 93, The Strategic Plan system cascades information upward through the hierarchical, e.g, in this embodiment, three, levels. Information that is entered at the Corporate, Department, and Team Member level in “Build Your Plan” 500 is tracked and monitored in executing the plan at the Team Member Plan 501, Department Plan 502 and Corporate Plan 503 corresponding levels. Team Members track their progress for individual goals and action item 504. Their progress numbers are reported upwards to the department 506 and corporate 510. The team members can view their individual goals and action items in a timeline 505.

As shown in FIG. 93, Departments can track their progress for goals and action item 506. Their numbers are reported upwards to Corporate 510. Departments can view their goals and actions in a timeline 507. Departments can track their performance for Department KPIs 508 and Corporate KPIs 509. Both their progress and performance numbers are reported upwards to corporate.

As shown in FIG. 93 Corporate can track their progress for goals and action items 510. Corporate can view their goals and actions in a timeline 511. Corporate can track their performance for Corporate KPIs 512.

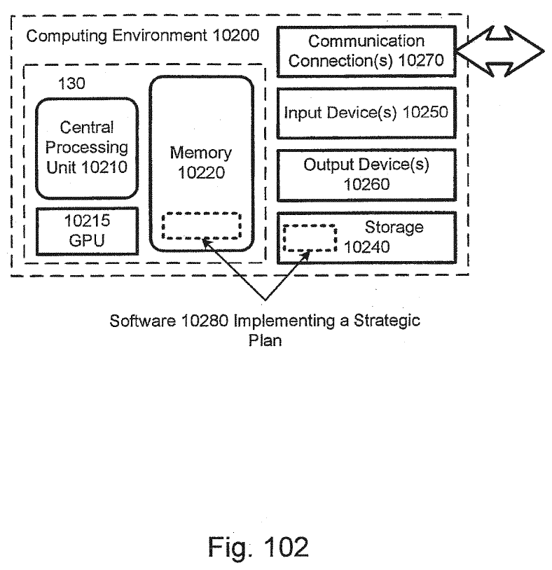

FIG. 102 and the following discussion are intended to provide a brief, general description of an exemplary computing environment in which the disclosed technology may be implemented. Although not required, the disclosed technology can be implemented with computer-executable instructions being executed by a computer such as personal computer (PC), a networked system, or other computing device including portable ones such as those found in hand-held devices such as TV remote controllers, cell phones, and the like. Generally, program modules include routines, programs, objects, components, data structures, etc., that perform particular tasks or implement particular abstract data types. Moreover, the disclosed technology may be implemented with other computer system configurations, including multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 102 illustrates a generalized example of a suitable computing environment 10200 in which described embodiments may be implemented. The computing environment 10200 is not intended to suggest any limitation as to scope of use or functionality of the technology, as the present technology may be implemented in diverse general-purpose or special-purpose computing environments.

With reference to FIG. 102, the computing environment 10200 includes at least one central processing unit 10210 and memory 10220. In FIG. 102, this most basic configuration 10230 is included within a dashed line. The central processing unit 10210 executes computer-executable instructions and may be a real or a virtual processor. In a multi-processing system, multiple processing units execute computer-executable instructions to increase processing power and as such, multiple processors can be running simultaneously. The computing environment 10200 may also include a graphics processing unit (GPU) 10215, which assists in creating or speeding up graphics processing and display. Memory 10220 may be volatile memory (e.g., registers, cache, RAM), non-volatile memory (e.g., ROM, EEPROM, flash memory, etc.), or some combination of the two. The memory 10220 stores software 10280 implementing the described methods for building, executing, measuring and reporting for a strategic plan. The memory may also store portions of a strategic plan software implementation as it is running. A computing environment may have additional features. For example, the computing environment 10200 includes storage 10240, one or more input devices 10250, one or more output devices 10260, and one or more communication connections 10270. An interconnection mechanism (not shown) such as a bus, a controller, or a network, interconnects the components of the computing environment 10200. Typically, operating system software (not shown) provides an operating environment for other software executing in the computing environment 10200, and coordinates activities of the components of the computing environment 10200.

The storage 10240 may be removable or non-removable, and includes magnetic disks, magnetic tapes or cassettes, CD-ROMs, CD-RWs, DVDs, or any other computer-readable medium which can be used to store information and which can be accessed within the computing environment 10200. The storage 10240 stores instructions for the software 10280 implementing methods for building, executing, and tracking strategic plans.

The input device(s) 10250 may be a touch input device, such as a keyboard, mouse, pen, or trackball, a voice input device, a scanning device, or another device, that provides input to the computing environment 10200 such as a gaming pad, a joystick, a dance pad, or a nonstandard device such as one or more multidirectional input devices working together used for character input. For audio, the input device(s) 10250 may be a sound card or similar device that accepts audio input in analog or digital form, or a CD-ROM reader that provides audio samples to the computing environment 10200. The output device(s) 160 may be a display, printer, speaker, CD-writer, or another device that provides output from the computing environment 10200.

The communication connection(s) 10270 enable communication over a communication medium to another computing entity. The communication medium conveys information such as computer-executable instructions, compressed graphics information, or other data in a modulated data signal. Computer-readable media are any available media that can be accessed within a computing environment 10200. By way of example, and not limitation, with the computing environment 10200, computer-readable media include memory 10220, storage 10240, communication media (not shown), and combinations of any of the above.

The system software in the CD ROM Appendix is written in the PHP server-side scripting environment. The specific languages used in the development were VBScript and Javascript. The database was developed in MySQL.

The system software runs on a web server capable of processing PHP pages. As the operating system, the system software runs on Linux CentOS 4 Server. The system may be adapted to run on other server environments as well.

However, Firefox 2.0 and above also provides full system functionality.

The system may, but need not necessarily be Web-based. It can be adapted to run on a standalone stand-alone system or on a private network. The system can also be written in numerous other computing languages and be adapted to run on other operating systems and, if desired, network environments.

The present system may be supplemented by providing, along with the web-based application, a web-based help and consulting desk. These latter services may be provided via instant messaging or e-mailing systems, or via dial-in live conferencing service. Video and on-site visiting services may also be added. Additional revenues may be generated in connection with such services, in addition to the revenue to be generated from sale, licensing, or use of the strategic planning software, system, and methods described above.

It is to be understood that the foregoing is a detailed description of the preferred embodiment and aspects of various features of the preferred and other embodiments. It is therefore not itself limiting of the scope of the invention.

We claim:

1. An automated strategic planning method comprising, through a computer system and a strategic planning computer software program running on the computer system:
(A) providing an automated first user-interface computer page display requesting user identification on the first user-interface page of a plurality of hierarchy level actions for an organization including a first hierarchy level action and a second hierarchy level action;
(B) providing a second user-interface computer page display (1) automatically identifying the first hierarchy level action among the plurality of hierarchy level actions for the organization and (2) requesting user identification on the second user-interface page of a first sub-entity action for a first sub-entity among a plurality of sub-entities within the hierarchy level of the organization; and
(C) providing an automated project management user-interface computer display (1) automatically identifying the first sub-entity action and (2) including an action item execution tracking section.

2. The automated strategic planning method of claim 1 also including, said computer system and strategic planning computer software program:
(D) providing, in the second user-interface page display or a third user-interface computer page display, (1) automatic identification of the second hierarchy level action among the plurality of hierarchy level action for the organization and (2) a request for user identification of a second sub-entity action for a second entity among the plurality of entities within the organization; and
(E) in the project management user-interface computer display, automatically identifying the second entity action.

3. The automated strategic planning method of claim 2 wherein each of the first, second, and third user-interface computer page displays include a strategic plan development progress report.

4. The automated strategic planning method of claim 3 wherein the project management user-interface computer display includes the strategic plan development progress report.

5. The automated strategic planning method of claim 4 also including, through said computer system and said strategic planning software program:
(F) providing an automated financial assessment user-interface computer display requesting identification of financial information associated with executing at least strategic plan portion.

6. The automated strategic planning method of claim 5 also including, through said computer system and said strategic planning software program:
(G) providing an automated learning user-interface computer page display requesting identification of at least one learning goal associated with executing a strategic plan.

7. An automated strategic planning method comprising, with at least one computer including a processor unit and a storage medium, executing software instructions for providing on one or more among a plurality of computer displays:
(A) an automated entity strategic planning section including an entity mission user input field, an entity strategic goals user input field, an entity actions user input field, and an entity level report generating section;
(B) an automated department strategic planning section (1) automatically displaying an entity action item and (2) including a department action user input field and a department level report generating section; and
(C) an automated team member strategic planning section (1) automatically displaying a department action item and (2) including a member action user input field and a team level report generating section.

8. The automated strategic planning method of claim 7 wherein the software instruction executing step includes executing software instructions to further provide on the one or more among the computer displays:
(D) an automated entity action execution management section (1) automatically displaying an entity action item and (2) including an entity action execution status field;
(E) an automated department action execution management section (1) automatically displaying a department action item and (2) including a department action execution status field; and
(F) an automated team member action execution management section (1) automatically displaying a department action item and (2) including a team member action execution status field.

9. The automated strategic planning method of claim 8 wherein the automated entity strategic planning section, the automated department strategic planning section, and the automated team member strategic planning section each include an overall strategic planning status report section.

10. The automated strategic planning method of claim 9 wherein the instructions are configured to further provide on the one or more computer displays:
(G) an automated learning goal section automatically displaying operational information and including a learning goal input field; and
(H) an automated financial assessment section automatically displaying plan action information.

11. An automated strategic planning method comprising,
with a computer system and strategic planning software loaded in the computer system:
(A) providing a first automated user-interface page display requesting user identification on the first user-interface page of a top level action item for an organization;
(B) providing a second automated user-interface page display
(1) automatically identifying the top level action item for the organization and
(2) requesting user identification on the second user-interface page of a department goal and an action item for each among a plurality of departments in the organization, including
(a) a first department goal and a first department action item and
(b) a second department goal and a second department action item; and
(C) providing a third automated user-interface page display
(1) automatically identifying the first department among the plurality of departments and the first department action item of said first department and
(2) requesting user identification on the third user-interface page of a first department member goal for a first department entity among a plurality of department entities in the department.

12. The automated strategic planning method of claim 11 also including, with said computer system and the strategic planning software:
(D) providing, in the third automated user-interface page display or a fourth automated user-interface page display, (1) automatic identification of the second department among the plurality of departments and the second department action item of said second department, and (2) a request for user identification of a second department entity goal for a second department entity among the plurality of entities of the department.

13. The automated strategic planning method of claim 12 also including, with said computer system and said strategic planning software:
(E) providing an automated learning user-interface page display (1) automatically displaying user-provided operational strategic planning information and (2) requesting user identification of a learning goal associated with executing a strategic plan.

14. The automated strategic planning method of claim 11 also including, with said computer system and the strategic planning software:
(D) providing at least an automated financial assessment user-interface page display requesting identification of financial projections associated with developing at least a strategic plan portion.

15. The automated strategic planning method of claim 14 also including, with said computer system and said strategic planning software:
(E) in the automated financial assessment user-interface page display, requesting identification of financial impact associated with executing at least the strategic plan portion.

16. The automated strategic planning method of claim 14 also including, with said computing system and said strategic planning software:
(E) providing an automated learning user-interface page display (1) automatically displaying user-provided operational strategic planning information and (2) requesting user identification of a learning goal associated with executing a strategic plan.

17. The automated strategic planning method of claim 16 wherein the automated financial assessment user-interface page display provides access to a financial projection worksheet.

18. The automated strategic planning method of claim 16 also including, with said computer system and said strategic planning software—
(F) providing an automated learning user-interface page display (1) automatically displaying an operational strategic planning objective and (2) requesting user identification of a learning goal associated with executing a strategic plan.

19. The automated strategic planning method of claim 16 also including, with the computing system and strategic planning software:
(F) automatically providing a report of all goals and action items entered during the automated strategic planning method.

20. The automated strategic planning method of claim 17 also including, with said computer system and said strategic planning program:
(F) providing an automated learning user-interface page display (1) automatically displaying an operational strategic planning objective and (2) requesting user identification of a learning goal associated with executing a strategic plan.

21. The automated strategic planning method of claim 20 wherein each of the automated first, second, and third user-interface page displays include a strategic plan development progress report.

22. The automated strategic planning method of claim 11 also including, with said computer system and said strategic planning software:
(D) providing an automated financial assessment user-interface page display requesting identification of financial impact associated with executing at least a strategic plan portion.

23. The automated strategic planning method of claim 22 also including, with said computer system and said strategic planning software:
(E) providing an automated learning user-interface page display (1) automatically displaying user-provided operational strategic planning information and (2) requesting user identification of a one learning goal associated with executing a strategic plan.

24. The automated strategic planning method of claim 23 wherein each of the automated first, second, and third user-interface page displays include a strategic plan development progress report.

25. The automated strategic planning method of claim 11 also including, with said computer system said strategic planning software:
(D) providing an automated learning user-interface page display (1) automatically displaying user-provided operational strategic planning information and (2) requesting user identification of a one learning goal associated with executing a strategic plan.
